(19) United States
(12) Patent Application Publication
(10) Pub. No.: US 2013/0028336 A1
(43) Pub. Date: Jan. 31, 2013

(54) Receivers for COFDM digital television transmissions

(71) Applicant: Allen LeRoy Limberg, Port Charlotte, FL (US)

(72) Inventor: Allen LeRoy Limberg, Port Charlotte, FL (US)

(21) Appl. No.: 13/555,114

(22) Filed: Aug. 16, 2012

Related U.S. Application Data
(60) Provisional application No. 61/574,138, filed on Jul. 28, 2011.
(60) Provisional application No. 61/574,640, filed on Aug. 6, 2011.
(60) Provisional application No. 61/626,437, filed on Sep. 27, 2011.
(60) Provisional application No. 61/627,495, filed on Oct. 13, 2011.
(60) Provisional application No. 61/628,832, filed on Nov. 7, 2011.
(60) Provisional application No. 61/687,516, filed on Apr. 26, 2012.

(51) Int. Cl. H04N 7/26

(52) U.S. Cl. 375/240.27; 375/E07.279

(57) ABSTRACT

A receiver of COFDM digital television signals includes an inner decoder for iterative soft-decision decoding of concatenated convolutional coding (CCC) and an outer decoder for Reed-Solomon (RS) coding. The receiver generates error flags for identifying code symbols to be erased before the output symbols from the inner decoder are byte de-interleaved and supplied to the outer decoder. Generation of those flags depends on soft decoding results from the inner decoder. The method of locating errors ascribes to each byte supplied to the outer decoder for RS coding the highest lack-of-confidence level specified by the soft data bits associated with that byte. The method is described as being extended to locate byte errors in plural-dimension cross-interleaved Reed-Solomon codes (CIRC) apt to be employed in DTV broadcasting to mobile and handheld receivers.

This application claims the benefit of the filing dates of provisional U.S. Pat. App. Ser. No. 61/574,138 filed 28 Jul. 2011, of provisional U.S. Pat. App. Ser. No. 61/574,640 filed 6 Aug. 2011, of provisional U.S. Pat. App. Ser. No. 61/626,437 filed 27 Sep. 2011, of provisional U.S. Pat. App. Ser. No. 61/627,495 filed 13 Oct. 2011, of provisional U.S. Pat. App. Ser. No. 61/628,832 filed 7 Nov. 2011 and of provisional U.S. Pat. App. Ser. No. 61/687,516 filed 26 Apr. 2012.

### FIELD OF THE INVENTION

In general the invention relates to systems of over-the-air broadcasting of digital television (DTV) signals suited for reception by mobile and handset receivers commonly referred to collectively as “M/H” receivers and by “stationary” receivers that customarily remain at one reception site. Each system employs forward-error-correction (FEC) coding of the DTV signals, which are subsequently transmitted using coded orthogonal frequency-division multiplexing (COFDM) of a plurality of carrier waves. The various aspects of the invention more specifically concern both stationary and M/H receivers for such systems.

### BACKGROUND OF THE INVENTION

DTV broadcasting in Europe has employed coded orthogonal frequency-division multiplexing (COFDM) that employs a multiplicity of RF carrier waves closely spaced across each 8-MHz-wide television channel, rather than a single RF carrier wave per television channel. Adjacent carrier waves are orthogonal to each other. Successive multi-bit symbols are selected from a serial data stream and used to modulate respective ones of the multiplicity of RF carrier waves in turn, in accordance with a conventional modulation scheme—such as quaternary phase shift keying (QPSK) or quadrature amplitude modulation (QAM). QPSK is preferably DQPSK, using differential modulation that is inherently insensitive to slowly changing amplitude and phase distortion. DPSK simplifies carrier recovery in the receiver. Customarily, the QAM is either 16QAM or 64QAM using square 2-dimensional modulation constellations. In actual practice, the RF carrier waves are not modulated individually. Rather, a single carrier wave is modulated at high symbol rate using QPSK or QAM. The resulting modulated carrier wave is then transformed in a fast inverse discrete Fourier transform (I-DFT) procedure to generate the multiplicity of RF carrier waves each modulated at low symbol rate.

In Europe, broadcasting to hand-held receivers is done using a system referred to as DVB-H. DVB-H (Digital Video Broadcasting—Handheld) is a digital broadcast standard for the transmission of broadcast content to handheld receivers, published in 2004 by the European Telecommunications Standards Institute (ETSI) and identified as EN 302304. DVB-H, as a transmission standard, specifies the physical layer as well as the elements of the lower protocol layers. It uses a power-saving technique based on the time-multiplexed transmission of different services. The technique, called “time slicing”, allows substantial saving of battery power. Time slicing allows soft hand-over as the receiver moves from network cell to network cell. The relatively long power-save periods may be used to search for channels in neighboring radio cells offering the selected service. Accordingly, at the border between two cells, a channel hand-over can be performed that is imperceptible by the user. Both the monitoring of the services in adjacent cells and the reception of the selected service data can utilize the same front-end tuner.

In contrast to other DVB transmission systems, which are based on the DVB Transport Stream adopted from the MPEG-2 standard, the DVB-H system is based on Internet Protocol (IP). The DVB-H baseband interface is an IP interface allowing the DVB-H system to be combined with other IP-based networks. Even so, the MPEG-2 transport stream is still used by the base layer. The IP data are embedded into the transport stream using Multi-Protocol Encapsulation (MPE), an adaptation protocol defined in the DVB Data Broadcast Specification. At the MPE level, DVB-H employs an additional stage of forward error correction called MPE-FEC, which is essentially (255, 191) transverse Reed-Solomon (TRS) coding. The transverse direction is orthogonal to the direction of the “lateral” (204, 188) Reed-Solomon (RS) coding employed both in DVB-H and in DVB-T terrestrial broadcasting to stationary DTV receivers. This TRS coding reduces the S/N requirements for reception by a handheld device by a 7 dB margin compared to DVB-T. The block interleaver used for the TRS coding creates a specific frame structure, referred to as the “FEC frame”, for incorporating the incoming data of the DVB-H codec.

The physical radio transmission of DVB-H is performed according to the DVB-T standard and employs OFDM multi-carrier modulation. DVB-T employed coded orthogonal frequency division multiplexing (COFDM) in which an 8-MHz-wide radio-frequency (RF) channel comprises somewhat fewer than 2000 or somewhat fewer than 8000 evenly-spaced carriers for transmitting to stationary DTV receivers. DVB-T2, an upgrade of DVB-T proposed in 2011, further permits somewhat fewer than 4000 evenly-spaced carrier waves better to accommodate transmitting to mobile receivers using DVB-H. These three choices as to number of carrier waves are commonly referred to as 2K, 8K and 4K options. DVB-H uses only a fraction (e.g., one quarter) of the digital payload capacity of the RF channel.

COFDM has been considered for DTV broadcasting in the United States of America (US), where 6-MHz-wide, rather than 8-MHz-wide, RF channels are employed for such broadcasting. The 2K, 8K and 4K options are retained in proposals for such DTV broadcasting, with bit rates being scaled back to suit 6-MHz-wide RF channels. COFDM of plural carrier waves may eventually supplant the 8-VSB amplitude-modulated single-carrier-wave system of DTV broadcasting used in the US at the time this specification was written. A driving force behind the adoption of COFDM for DTV broadcasting in the US is apt to be that its performance in single-frequency networks (SFNs) is superior to that of the 8-VSB AM single-carrier-wave system of broadcasting used in the US.

The DVB-T and DVB-H standards for European broadcasting employ Reed-Solomon (RS) coding followed by convolutional coding in the forward-error-correction (FEC) coding of DTV data. Decoding of the convolutional coding is effective in overcoming corruption caused by Johnson noise, which has additive White Gaussian noise (AWGN) characteristics, but occasionally decoding generates a running error. Subsequent RS coding after a byte de-interleave can suppress such running error and can also suppress burst errors in the COFDM demodulation results.

If COFDM is adopted for DTV broadcasting in the US, the convolutional coding used together with Reed-Solomon (RS) coding in the forward-error-correction (FEC) coding of DTV data is apt to be replaced by some form of coding that can be decoded using iterative soft-decision decoding procedures referred to as “turbo” decoding. Such forms of coding are commonly referred to as “turbo coding” and comprise parallel concatenated convolutional coding (PCCC), serial concatenated convolutional coding (SCCC), and product coding composed of concatenated block and convolutional coding. Low-density parity-check (LDPC) codes that are parallel concatenated provide another type of turbo coding that is decoded using iterative soft-decision decoding procedures. The iterative soft-decision decoding procedures used for turbo coding reduce AWGN errors in DTV data significantly better than the decoding of simple convolutional coding can. Turbo coding is less susceptible to running errors than simple convolutional coding because the component codes of the turbo coding exhibit temporal diversity between their respective coding algorithms. This phenomenon is referred to as “interleaver gain”, and the interleaving between the component codes of the turbo coding can be designed to obtain substantially as much interleaver gain as possible.

Just a few iterations of the iterative soft-decision decoding of PCCC and parallel concatenated LDPC coding markedly reduces substantial AWGN errors in DTV data. As AWGN errors in the DTV data become less frequent, fewer errors are corrected per iteration of the soft-decision decoding procedures, which phenomenon is referred to as “bit-error floor”. Decoding of the Reed-Solomon (RS) coding of the data bits in the results of the iterative soft-decision decoding procedures as so far performed can correct infrequent errors in those results. Accordingly, iterative soft-decision decoding of a successive block of the turbo decoding can be discontinued, and the data bits resulting from that turbo decoding can be replaced by correct data bits resulting from subsequent decoding of the RS coding of the data bits resulting from turbo decoding. The transport-stream (TS) data packets defined by these corrected bits are sorted to the decoders for compressed video data, compressed audio data, and any other kind or kinds of data. Such early conclusion of turbo decoding procedures has been used in mobile receivers for digital communications.

U.S. Pat. No. 7,310,768 titled “Iterative decoder employing multiple external code error checks to lower the error floor” granted Dec. 18, 2007 to Donald Brian Eidson, Abraham Krieger and Ramaswamy Murali describes receivers for concatenated convolutional coding (CCC) of convolutionally byte-interleaved RS codewords in which the CCC decoding and subsequent decoding of the RS coding are iteratively performed. Results of successfully decoding RS coding recovered from an earlier stage of the iteratively performed decoding are convolutionally byte-interleaved, concatenated convolutionally coded and used to update the CCC coding of convolutionally byte-interleaved RS codewords for the succeeding stage of the CCC decoding and subsequent decoding of the RS coding that is iteratively performed. In practice, the technique is not very useful until enough corrected RS codewords are available in close parallel disposition with each other to provide a fairly continuous data bitstream, which can then be recoded to CCC for updating previous CCC to generate CCC for the next stage of the CCC decoding and subsequent decoding of the RS coding to be performed.

Locating erroneous bytes in RS codewords externally to the codewords themselves and replacing those bytes with erasures permits a byte-error-correction-only algorithm to be used for decoding the RS codewords. This byte-error-correction-only algorithm doubles byte-error-correction capability over that of the more familiar byte-error-location-and-correction algorithm. U.S. Pat. No. 5,708,665 titled “Digital receiver using equalization and block decoding with erasure and error correction” granted Jan. 13, 1998 to Daniel A. Luthi, Ravi Bhaskaran, Dojun Rhee and Advait M. Mogre describes this being done according to the following first method. The output symbols from an inner decoder for convolutional coding are re-coded and compared with the received sequence of code symbols to locate errors, and any portion of the output symbols from the inner decoder that includes an excessive number of code symbol errors is flagged for erasure before those output symbols are de-interleaved and supplied to an outer decoder for RS coding.

U.S. Pat. No. 5,708,665 also describes an alternative method of generating flags for identifying code symbols to be erased before the output symbols from an inner decoder for convolutional coding are de-interleaved and supplied to an outer decoder for RS coding. A circuit makes hard symbol decisions on the received sequence of code symbols before they are submitted to the inner decoder for convolutional coding, and the hard symbol decisions are compared to the received sequence of code symbols for identifying regions that include excessive numbers of code symbol errors. Error flags are generated for output symbols from the inner decoder from those regions, before those output symbols are de-interleaved and supplied to an outer decoder for RS coding. This second method of generating flags for identifying code symbols to be erased is inferior to the preferred first method that U.S. Pat. No. 5,708,665 describes, in that the error-correction capability of the inner decoder is not taken into account.

The latent delay in the inner decoder for simple convolutional coding is well-defined. If one seeks to replace the inner decoder for simple convolutional coding with an inner decoder that performs turbo decoding, the latent delay of the turbo decoder is generally far longer than the latent delay of an inner decoder for simple convolutional coding. Furthermore, the latent delay of the turbo decoder is subject to variation, being dependent on the number of iterations of soft decoding procedures that are performed. Accordingly, the timing of a comparison of recoded output symbols from the inner decoder with the codestream as received is somewhat more complicated to do when the DTV receiver employs turbo decoding in a variant of the first method that U.S. Pat. No. 5,708,665 describes for locating symbol errors.

A principal drawback of this first method of Luthi et alii is the additional memory required for temporarily storing the received sequence of code symbols for later comparison with recoded output symbols from the inner decoder in order to generate error flags. There is some further additional memory required for delaying the output symbols from the inner coding that are supplied to the outer decoder for RS coding, which further additional memory compensates for the delay in recoding the output symbols from the inner decoder and comparing them with the received sequence of code symbols to generate error flags.

Also, arranging for suitable delay of error flags is somewhat more complicated to do when alternatively the DTV receiver employs turbo decoding in a variant of the second method that U.S. Pat. No. 5,708,665 describes for locating symbol errors. Delaying the error flags requires some additional memory for their temporary storage. This memory can be operated for de-interleaving the flags for application to the outer decoder for RS coding as well as delaying them, however, saving memory for de-interleaving the error flags were they appended to turbo decoding results.

### SUMMARY OF THE INVENTION

A receiver of digital signals which embodies the invention includes an inner decoder for iterative soft-decision decoding of turbo coding and an outer decoder for Reed-Solomon coding, output symbols from which inner decoder are rearranged for application to said outer decoder as input symbols thereto. An aspect of the invention is a method of generating flags for identifying code symbols to be erased before the output symbols from the inner decoder are de-interleaved and supplied to the outer decoder for RS coding, which method is novel in that the generation of those flags depends primarily on soft decoding results from the inner decoder. More particularly, this novel method of locating errors ascribes to each byte supplied to the outer decoder for RS coding the highest lack-of-confidence level specified by the soft data bits associated with that byte. This novel method of locating byte errors takes into account the error-correction capability of the inner decoder, which is substantially greater for a turbo decoder than for a decoder of simple convolutional coding. Also, this novel method of locating byte errors avoids any need for additional memory to store received sequences of code symbols for later comparison with recoded output symbols from the inner decoder to locate regions with large numbers of symbol errors.

A further aspect of the invention is that this novel method of locating byte errors is that it can be extended to locate byte errors in plural-dimensional cross-interleaved Reed-Solomon codes (CIRC) that are apt to be employed in DTV broadcasting to mobile and handheld receivers. In a preferred such extension of the novel method of locating byte errors, the results of decoding RS codes in one of the dimensions of the CIRC are used to update the byte-error information used for decoding RS codes in another dimension of the CIRC.

In another aspect of the invention the results of successfully decoding RS coding recovered from an earlier stage of iteratively performed decoding of CCC and RS coding are used to update just the soft data bits of the CCC of convolutionally byte-interleaved RS codewords for the succeeding stage of the iteratively performed decoding of CCC and RS coding. This allows improved turbo decoding of the CCC without the receiver having to wait until a large number of corrected RS codewords disposed in parallel have been recovered.

### BRIEF DESCRIPTION OF THE DRAWING FIGURES

FIGS. 1 and 2 combine to provide a schematic diagram of a portion of a COFDM transmitter for transmitting turbo-coded Reed-Solomon codewords to be received by stationary DTV receivers.

FIGS. 3 and 4 combine to provide a schematic diagram of a portion of a COFDM transmitter for transmitting turbo-coded Reed-Solomon codewords to be received by mobile and handheld DTV receivers.

FIGS. 5, 6 and 7 are schematic diagrams each depicting a respective encoder for one-third-code-rate PCCC that can be used in either of the portions of a COFDM transmitter depicted in FIGS. 2 and 4, each of which respective encoders is novel in construction and operation.

FIGS. 8 and 9 combine to provide a schematic diagram of a portion of a COFDM transmitter for transmitting pairs of one-half-code-rate convolution-coded Reed-Solomon codewords for iterative-diversity reception by stationary DTV receivers.

FIGS. 10 and 11 combine to provide a schematic diagram of a portion of a COFDM transmitter for transmitting pairs of one-half-code-rate convolution-coded Reed-Solomon codewords for iterative-diversity reception by mobile and handheld DTV receivers.

FIG. 12 is a schematic diagram showing in more detail the connections of each of the data-storage memories in FIGS. 1, 3, 8 and 10 with a respective microprocessor for calculating the addresses of byte-storage locations in the data-storage memory that store the initial bytes of IP packets.

FIGS. 13 and 14 combine to provide an informal flow chart of the operations of the microprocessor depicted in FIG. 12.

FIGS. 15, 16 and 17 combine to provide a schematic diagram of a stationary DTV receiver for COFDM signals that convey turbo-coded Reed-Solomon codewords.

FIG. 18 is a schematic diagram showing in greater detail the adaptive threshold detector used to locate byte errors for decoding (204, 188) Reed-Solomon coding in the FIG. 17 portion of a DTV receiver.

FIGS. 19, 20, 21 and 22 combine to provide a schematic diagram of an M/H DTV receiver for COFDM signals that convey turbo-coded Reed-Solomon codewords.

FIG. 23 is a schematic diagram showing the adaptive threshold detector used to locate byte errors for decoding (255, 191) Reed-Solomon coding in the FIG. 21 portion of a DTV receiver.

FIG. 24 is a schematic diagram of receiver apparatus replacing apparatus of FIGS. 15 and 20 in an M/H DTV receiver that is an alternative embodiment of aspects of the invention.

FIGS. 25 and 26 combine with FIG. 17 to provide a schematic diagram of a stationary DTV receiver for iterative-diversity reception of COFDM signals that convey repeated turbo-coded Reed-Solomon codewords.

FIGS. 27 and 28 combine with FIGS. 21 and 22 to provide a schematic diagram of an M/H DTV receiver for iterative-diversity reception of COFDM signals that convey repeated turbo-coded Reed-Solomon codewords.

FIG. 29 is a more detailed schematic diagram of the maximal-ratio code combiner as shown in FIGS. 26 and 28, which code combiner is connected for receiving pilot-carrier-energy information from one of the pilot and TPS carriers processors as shown in FIGS. 25 and 27.

FIG. 30 is a schematic diagram of a modification of the FIG. 9 portion of a COFDM transmitter for a DTV system, which modified transmitter embodies a further aspect of the invention.

FIG. 31 is a schematic diagram of a modification of the FIG. 11 portion of a COFDM transmitter for a DTV system, which modified transmitter embodies a further aspect of the invention.

FIGS. 32, 33 and 17 combine to provide a generic schematic diagram of a stationary DTV receiver adapted for iterative-diversity reception of COFDM signals as transmitted by the portions of the DTV transmitter as depicted in FIGS. 8 and 30, which DTV receiver embodies aspects of the invention.

FIGS. 34, 35, 21 and 22 combine to provide a generic schematic diagram of a mobile DTV receiver of mobile/handheld type adapted for iterative-diversity reception of COFDM signals as transmitted by the portions of the DTV transmitter depicted in FIGS. 10 and 31, which DTV receiver embodies aspects of the invention.

FIG. 36 is a detailed schematic diagram of a modification of any of the turbo decoders shown in FIGS. 16, 20, 26, 28, 33 and 35, in which modification a (204, 188) Reed-Solomon decoder is used to increase the confidence levels of data bits of correct (204, 188) Reed-Solomon codewords as an aid to turbo decoding procedures.

FIG. 37 is a schematic diagram of apparatus for addressing memories of any of the turbo decoders shown in FIGS. 16, 20, 26, 28, 33 and 35 that include the FIG. 36 modification.

FIG. 38 is a detailed schematic diagram of a modification of any of the turbo decoders shown in FIGS. 20, 28 and 35, in which modification a (255, 191) Reed-Solomon decoder is used to increase the confidence levels of data bits of correct (255, 191) Reed-Solomon codewords as an aid to turbo decoding procedures.

FIG. 39 is a schematic diagram of apparatus for addressing memories of any of the turbo decoders shown in FIGS. 20, 28 and 35 that include the FIG. 38 modification.

FIG. 40 is an informal flow chart illustrating the method by which turbo decoding procedures are aided by the (204, 188) Reed-Solomon decoder in the FIG. 36 modification of any of the turbo decoders shown in FIGS. 16, 20, 26, 28, 33 and 35. Alternatively, the informal flow chart of FIG. 40 illustrates the method by which turbo decoding procedures are aided by the (255, 191) Reed-Solomon decoder in the FIG. 38 modification of any of the turbo decoders shown in FIGS. 20, 28 and 35.

FIG. 41 is a detailed schematic diagram of a modification of any of the turbo decoders shown in FIGS. 16, 20, 26, 28, 33 and 35, in which modification a CRC decoder is used to detect those IP packets received with valid cyclic-redundancy-check coding and to increase the confidence levels of data bits in those IP packets as an aid to turbo decoding procedures.

FIG. 42 is a schematic diagram of apparatus for addressing memories of any of the turbo decoders shown in FIGS. 16, 20, 26, 28, 33 and 35 that include the FIG. 41 modification.

FIG. 43 is a schematic diagram of a modification of the FIG. 9 portion of the DTV transmitter so as to generate PCCC in which the first and second sets of parity bits have different coded interleaving.

FIG. 44 is a schematic diagram of a modification of the FIG. 11 portion of the DTV transmitter so as to generate PCCC in which the first and second sets of parity bits have different coded interleaving.

FIG. 45 is a schematic diagram of a modification of the FIG. 30 portion of the DTV transmitter so as to generate PCCC in which the first and second sets of parity bits have different coded interleaving.

FIG. 46 is a schematic diagram of a modification of the FIG. 31 portion of the DTV transmitter so as to generate PCCC in which the first and second sets of parity bits have different coded interleaving.

FIG. 47 is a schematic diagram of a modification or further modification of any of the turbo decoders shown in FIGS. 16, 20, 26, 28, 33 and 35 so it can decode PCCC in which the first and second sets of parity bits have different coded interleaving.

FIG. 48 is a schematic diagram of turbo decoding apparatus alternative to any of those shown in FIGS. 16, 20, 26, 28, 33, 35 and 47, which alternative turbo decoding apparatus employs a single SISO decoder instead of two SISO decoders.

### DETAILED DESCRIPTION

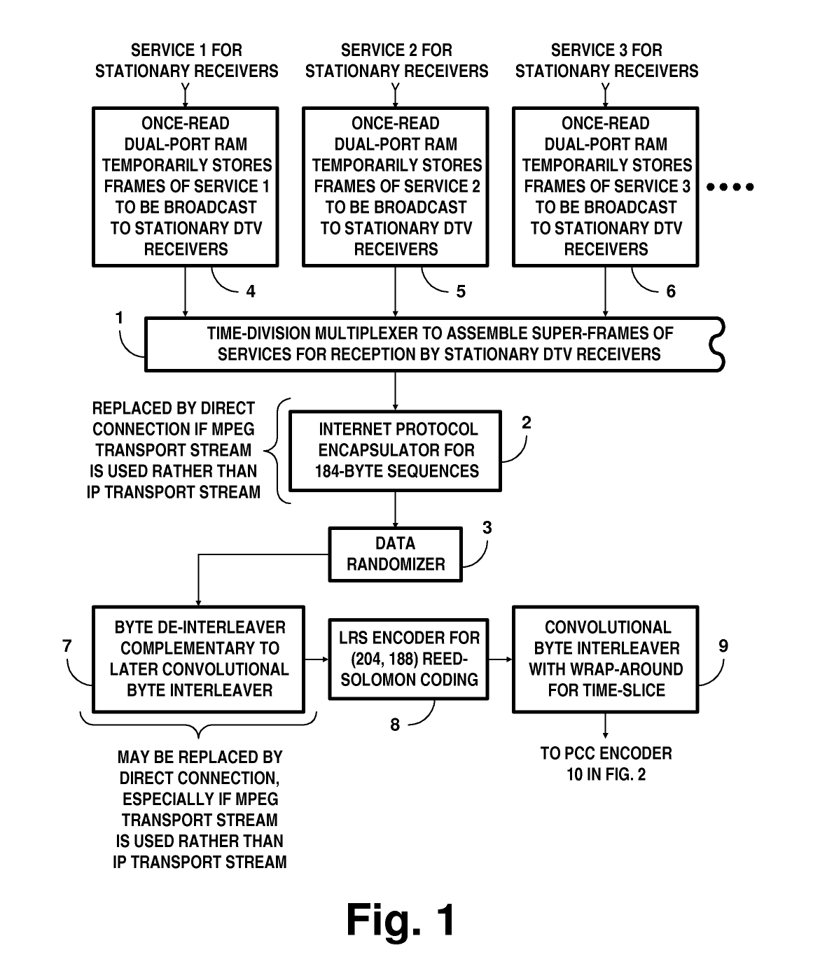

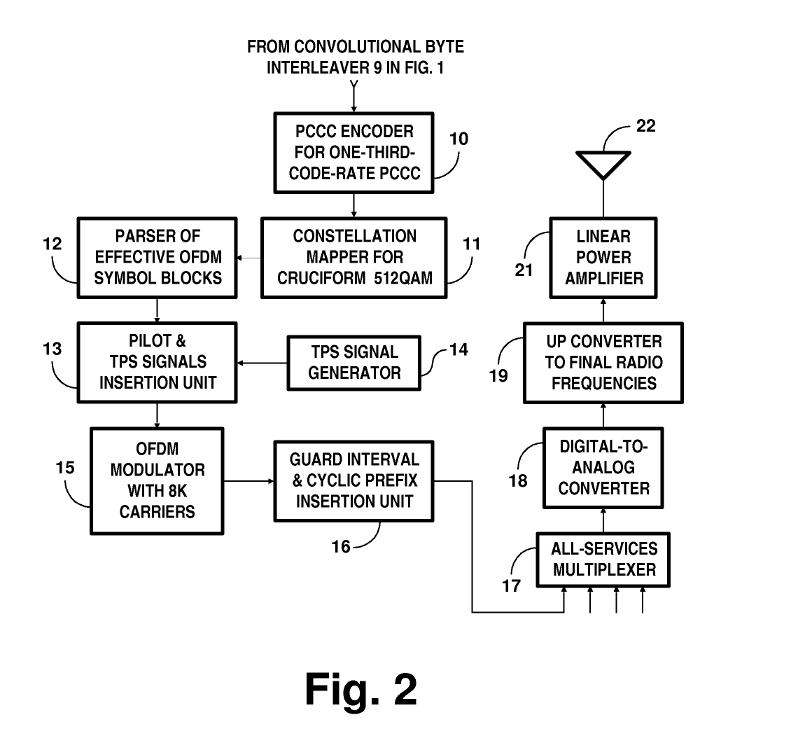

FIGS. 1 and 2 together show a portion of a DTV transmitter generating COFDM signals for reception by stationary DTV receivers. Apparatus for generating parallel concatenated convolutional coding (PCCC) and subsequent COFDM signals is shown in FIG. 2. FIG. 1 depicts apparatus for processing frames of services to be broadcast to stationary DTV receivers.

A time-division multiplexer 1 for interleaving time-slices of services to be broadcast to stationary DTV receivers is depicted near the middle of FIG. 1. The time-division multiplexer 1 successively selects time-slices of these various services to be reproduced in its response, which is supplied from its output port.

FIG. 1 shows the output port of the multiplexer 1 connected to the input port of an internet protocol encapsulator 2, the output port of which IPE 2 connects to the input port of a data randomizer 3.

The internet protocol encapsulator 2 is used only if the services for reception by stationary DTV receivers use internet-protocol (IP) transport-stream (TS) packets, which packets have varying lengths. The original format for services broadcast for reception by stationary DTV receivers may be composed of successive MPEG-2 TS packets, rather than successive IP TS packets. In such case, the IPE 2 is either selectively by-passed or is replaced by a direct connection from the output port of multiplexer 1 to the input port of the data randomizer 3.

An internet-protocol encapsulator (IPE) encapsulates incoming IP-datagrams within MPE (MultiProtocol Encapsulation) sections. In DVB-H the MPE sections are subsequently segmented to fit within the final 184 bytes of 188-byte MPEG-2 TS packets, as defined by the Motion Picture Experts Group (MPEG), which TS packets are referred to as IPE packets. The IPE further encapsulates the required PSI/SI (Program Specific Information/Service Information) signaling data that accompany each frame. The IPE also introduces signaling regarding the time-slicing transmissions of data in bursts, each burst including a respective FEC frame together with MPE timing information that let receivers know when to expect the next burst of data. The relative amount of time from the beginning of this MPE frame to the beginning of the next burst is indicated within a burst in the header of each MPE frame. This enables an M/H receiver to shut down between bursts, thereby minimizing power consumption and preserving battery life.

In transmissions made per the DVB-H standard, further signaling information in regard to time-slicing, such as burst duration, is included in the time_slice_fec_identifier_descriptor in the INT (IP/MAC Notification Table). Some of this information is also sent within Transmission Parameters Signaling (TPS) bits that are transported by dedicated carriers (TPS Pilots) in the COFDM (Coded Orthogonal Frequency Division Multiplexing) signal so as to be more quickly and easily available to receivers. This relieves a receiver of the need to decode MPEG2 and PSI/SI information. Such further time-slicing signaling information can be transmitted in tabular format prescribed in a standard developed for broadcasting in the United States of America, as well as some of this information being sent as TPS bits.

In a variant of DVB-H for use in the US, it is preferable that each IPE packet has a 5-byte header, rather than a 4-byte header, and that the MPE sections are subsequently segmented to fit within the final 183 bytes of the 188-byte IPE packet. In this preferred variant the final two bytes of an IPE packet header are used for conveying information that locates the respective starts of IP packets in MPE sections.

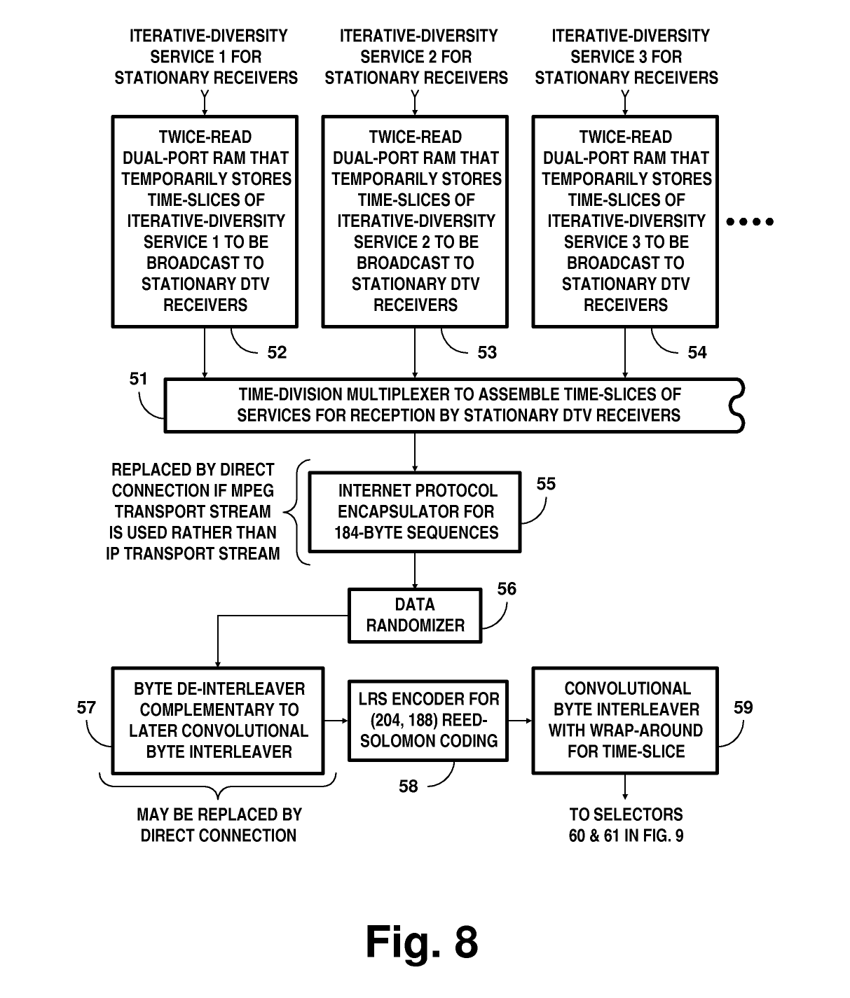

By way of illustration, the DTV transmitter is presumed to transmit successive super-frames of DTV signal, each of which super-frames is composed of four successive frames of DTV signal. The four frames are presumed to be of equal durations, and each may convey a separate service to be received by stationary DTV receivers. Alternatively, one (or more) of the four frames is used for broadcasting to mobile and handheld (M/H) DTV receivers. Each frame is presumed to be composed of eight successive time-slices of equal durations. In each of the frames used for broadcasting to M/H DTV receivers, the respective eight successive time-slices can convey a separate service to be received by those receivers. Each frame presumably being composed of eight successive time-slices is a consideration in broadcast transmissions for iterative-diversity reception, also, as will be explained further on in this specification in regard to FIG. 8.

Data concerning a first of the services to be transmitted for reception by stationary DTV receivers are written to a dual-port random-access memory 4 via a random-access port thereof. The RAM 4 is capable of temporarily storing a number of time-slices of that service, more than the number of them in a frame. Within each super-frame interval a prescribed number of consecutive time-slices of that service are read from the serial output port of the RAM 4 to a first input port of the multiplexer 1.

Data concerning a second of the services to be transmitted for reception by stationary DTV receivers are written to a dual-port random-access memory 5 via a random-access port thereof. The RAM 5 is capable of temporarily storing a number of time-slices of that service, more than the number of them in a frame. Within each super-frame interval a prescribed number of consecutive time-slices of that service are read from the serial output port of the RAM 5 to a second input port of the multiplexer 1.

Data concerning a third of the services to be transmitted for reception by stationary DTV receivers are written to a dual-port random-access memory 6 via a random-access port thereof. The RAM 6 is capable of temporarily storing a number of time-slices of that service, more than the number of them in a frame. Within each super-frame interval a prescribed number of consecutive time-slices of that service are read from the serial output port of the RAM 6 to a third input port of the multiplexer 1. If the DTV transmitter does not transmit services for reception by M/H receivers, data concerning a fourth service are read to a fourth input port of the multiplexer 1 from a dual-port random-access memory that FIG. 1 does not explicitly show.

The bits of the concluding 187-byte portion of each of the data packets supplied to the input port of the data randomizer 3 are exclusive-ORed with a prescribed repeating pseudo-random binary sequence (PRBS) in the data randomizer 3. However, initial synchronizing bytes accompanying the data packets are excluded from such data randomization procedure. By way of example, the PRBS can be the maximal-length 16-bit one prescribed in §§4.3.1 of the 1996 European Telecommunication Standard 300 744 titled “Digital Video Broadcasting (DVB); Framing Structure, Channel Coding and Modulation for Digital Terrestrial Television (DVB-T)”. Alternatively, the PRBS can be the maximal-length 16-bit one prescribed in §4.2.2 of the 1995 ATSC Digital Television Standard, Annex D. The 16-bit register used to generate the PRBS for data randomization is reset to initial condition at the beginning of each time-slice supplied from the multiplexer 1.

If the services broadcast for reception by stationary DTV receivers employ IP TS packets, the output port of the data randomizer 3 is connected for supplying data-randomized IPE packets to the input port of a byte de-interleaver 7. The output port of the byte de-interleaver 7 is then connected for supplying its byte-interleaved response to the input port of an LRS encoder 8 for (204, 188) Reed-Solomon (RS) forward-error-correction (FEC) coding. In this specification and its claims, the (204, 188) RS FEC coding is referred to as “lateral Reed-Solomon” FEC coding or “LRS” FEC coding to distinguish it from transverse RS FEC coding or “TRS” coding. The words “lateral” and “transverse” also refer in a general way to respective directions in which RS coding is done with respect to IPE packets. The output port of the LRS encoder 8 is connected for supplying serially generated (204, 188) LRS FEC codewords to the input port of a convolutional byte interleaver 9. The pattern of byte de-interleaving that the byte de-interleaver 7 employs is complementary to the pattern of byte interleaving employed by the subsequent convolutional byte interleaver 9. The byte de-interleaver 7 arranges for the convolutional byte interleaver 9 to provide “coded” or “implied” byte interleaving of (204, 188) LRS FEC codewords from the LRS encoder 8.

In a DTV receiver, the decoding of the (204, 188) LRS FEC codewords implements error correction, but is not used to validate the correctness of IP packets. The correctness of the IP packets is validated by cyclic-redundancy-check (CRC) coding within them. Some burst errors may exceed the error-correction capability of the decoder for the (204, 188) LRS FEC codewords. If the byte interleaving of (204, 188) LRS FEC codewords at the transmitter is not “coded”, byte de-interleaving in the receiver disperses these burst errors that cannot be corrected among a greater number of IP packets than those affected by such burst error when initially received. With “coded” byte interleaving of the (204, 188) LRS FEC codewords, the DTV receiver can confine to fewer data-randomized IP packets those burst errors that cannot be corrected. The dispersal of burst errors that cannot be corrected that occurs in byte de-interleaving prior to decoding the (204, 188) LRS FEC codewords is counteracted in byte re-interleaving performed after such decoding and before decoding of TRS-coded IP packets.

In M/H DTV receivers that embody certain aspects of the invention, the results of decoding (204, 188) LRS FEC codewords are one of the bases for locating byte errors for subsequent decoding of (255, 191) TRS FEC codewords. Another advantage of “coded” byte interleaving of the (204, 188) RS FEC codewords is error location capability afforded by decoding the (204, 188) RS FEC codewords differs more from the error location capability afforded by decoding the CRC coding of IP packets.

If the original format for services broadcast for reception by stationary DTV receivers is composed of successive MPEG-2 TS packets, rather than successive IP TS packets, the byte de-interleaver 7 is either selectively by-passed or is replaced by a direct connection from the output port of the data randomizer 3 to the input port of the RS encoder 8. In the DTV receiver, the decoding of the (204, 188) RS FEC codewords not only implements error correction, but is used directly to validate the correctness of the MPEG-2 TS packets. Accordingly, “coded” convolutional byte interleaving is not used when the original format for services broadcast for reception by stationary DTV receivers is composed of successive MPEG-2 TS packets.

Preferably, the pattern of byte interleaving for the convolutional byte interleaver 9 is one that wraps around from the conclusion of each time-slice to its beginning. Otherwise, the pattern of byte interleaving can be similar to that used in DVB-T and DVB-H. The convolutional byte interleaver 9 is preferably similar in construction and operation to the convolutional byte interleaver 35 described in more detail further on in this specification. The output port of the convolutional byte interleaver 9 is connected for supplying its response to apparatus for further FEC coding of individual bits of that response, which apparatus is shown in FIG. 2.

FIG. 2 shows apparatus for generating PCCC and subsequent COFDM signals subsequently transmitted over the air to be received by stationary DTV receivers. The output port of the convolutional byte interleaver 9 shown in FIG. 1 is connected for supplying the response therefrom to the input port of a PCCC encoder 10 shown in FIG. 2. The PCCC encoder 10 generates one-third-code-rate parallel concatenated convolutional coding that is supplied from its output port to the input port of a constellation mapper 11 for cruciform 512QAM symbol constellations. The nature of the preferred cruciform 512QAM symbol constellations and the Gray mapping used in them are disclosed in detail in the U.S. patent application Ser. No. 13/493,198 filed for A. L. R. Limberg on 11 Jun. 2012 with the title “Digital television system employing COFDM for transmissions to mobile receivers”.

The output port of the constellation mapper 11 is connected to the input port of a parser 12 for effective OFDM symbol blocks. The block parser 12 parses a stream of complex samples supplied from the constellation mapper 11 into uniform-length sequences of complex samples, each of which sequences is associated with a respective effective OFDM symbol. The output port of the block parser 12 is connected to a first input port of a pilot and TPS signal insertion unit 13, a second input port of which unit 13 is connected to receive Transmission Parameters Signaling (TPS) bits from a TPS signal generator 14. The pilot and TPS signal insertion unit 13 inserts these TPS bits, which are to be transported by modulated dedicated carriers (TPS Pilots), into each effective OFDM symbol block. The pilot and TPS signal insertion unit 13 inserts other bits descriptive of unmodulated carriers of predetermined amplitude and predetermined phase into each effective OFDM symbol block. An output port of the pilot and TPS signal insertion unit 13 is connected for supplying the effective OFDM symbol blocks, with pilot carriers inserted therein, to the input port of an OFDM modulator 15. The OFDM modulator 15 has 8K carriers capability, suitable for transmissions to stationary DTV receivers.

A transmission signal in an OFDM system is transmitted by a unit of a symbol called an OFDM symbol. This OFDM symbol includes an effective symbol that is a signal period in which I-DFT is performed during transmission and a guard interval in which the waveform of a part of the latter half of this effective symbol is directly copied. This guard interval is provided in the former half of the OFDM symbol. In the OFDM system, such a guard interval is provided to improve performance during multi-path reception. Plural OFDM symbols are collected to form one OFDM transmission frame. For example, in the ISDB-T standard, ten OFDM transmission frames are formed by two hundred four OFDM symbols. Insertion positions of pilot signals are set with this unit of OFDM transmission frames as a reference.

The OFDM modulator 15 includes a serial-to-parallel converter for converting the serially generated complex digital samples of the effective OFDM symbols to parallel complex digital samples for inverse discrete Fourier transformation (I-DFT). The OFDM modulator 15 further includes a parallel-to-serial converter for converting the parallel complex digital samples of the I-DFT results to serial complex digital samples of the I-DFT results supplied from the output port of the OFDM modulator 15 to the input port of a guard-interval-and-cyclic-prefix-insertion unit 16. The output port of the guard-interval-and-cyclic-prefix-insertion unit 16 is connected for supplying successive complex digital samples of a COFDM signal to a first input port of an all-services multiplexer 17.

The output port of the all-services multiplexer 17 is connected to the input port of a digital-to-analog converter 18. FIG. 2 shows the output port of the DAC 18 connected for supplying its analog COFDM signal response to the input port of an up-converter 19 for converting baseband-frequency analog COFDM signal to very-high-frequency (VHF) or ultra-high-frequency (UHF) analog COFDM signal. The output port of the up-converter 19 is connected for supplying analog COFDM signal at radio frequencies to the input port of a linear power amplifier 20. FIG. 2 shows the output port of the linear power amplifier 20 connected for driving RF analog COFDM signal power to a transmission antenna 21. FIG. 2 omits showing certain customary details, such as band-shaping filters for the RF signals.

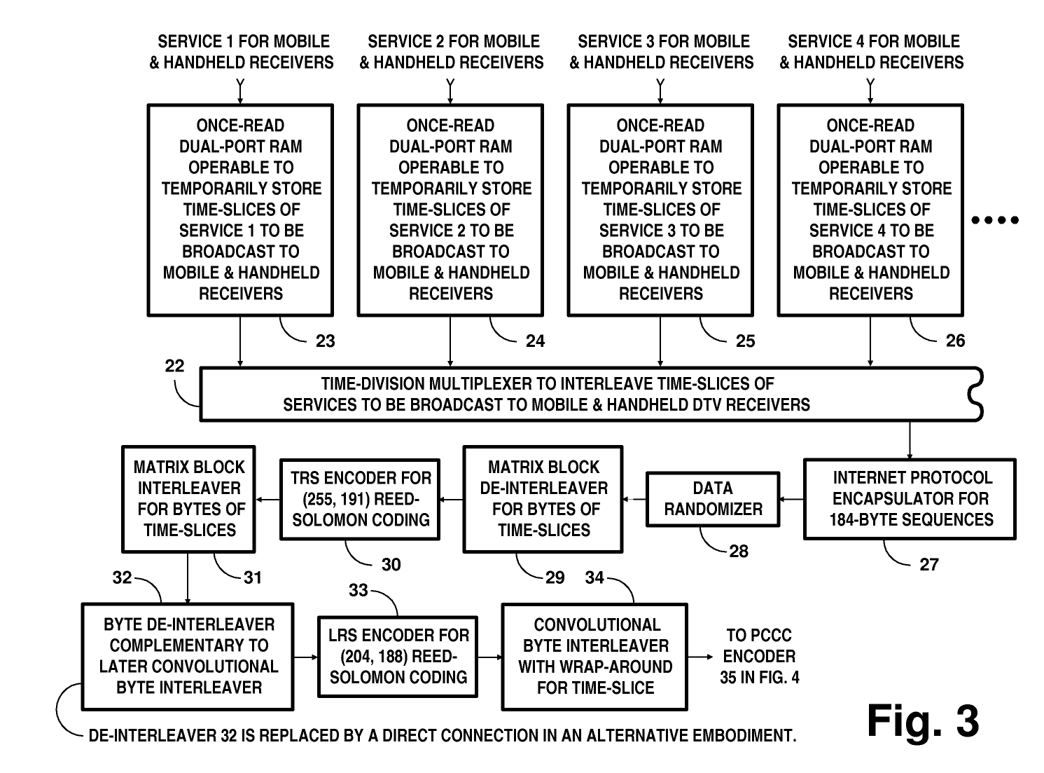

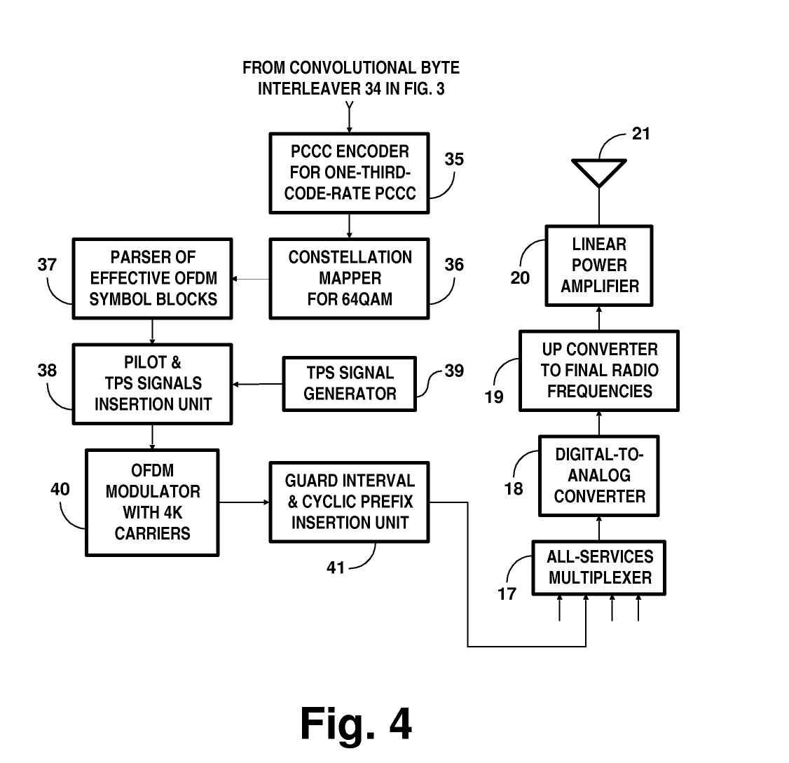

FIGS. 3 and 4 together show a further portion of the DTV transmitter generating COFDM signals for reception by M/H DTV receivers. Apparatus for generating PCCC and subsequent COFDM signals is shown in FIG. 4. FIG. 3 depicts apparatus for processing time-slices for subsequent encoding within PCCC. A time-division multiplexer 22 to assemble time-sliced services for reception by M/H DTV receivers is shown somewhat above the middle of FIG. 3.

Data concerning a first of the services to be transmitted for reception by M/H DTV receivers are written into storage locations within a dual-port random-access memory 23 via a random-access port thereof. Within each super-frame interval a successive time-slice of the first service for reception by M/H DTV receivers is read from the serial output port of the RAM 23 to a first input port of the multiplexer 22.

Data concerning a second of the services to be transmitted for reception by M/H DTV receivers are written into storage locations within a dual-port random-access memory 24 via a random-access port thereof. Within each super-frame interval a successive time-slice of the second service for reception by M/H DTV receivers is read from the serial output port of the RAM 24 to a second input port of the multiplexer 22.

Data concerning a third of the services to be transmitted for reception by M/H DTV receivers are written into storage locations within a dual-port random-access memory 25 via a random-access port thereof. Within each super-frame interval a successive time-slice of the third service for reception by M/H DTV receivers is read from the serial output port of the RAM 25 to a third input port of the multiplexer 22.

Data concerning a fourth of the services to be transmitted for reception by M/H DTV receivers are written into storage locations within a dual-port random-access memory 26 via a random-access port thereof. Within each super-frame interval a successive time-slice of the fourth service for reception by M/H DTV receivers is read from the serial output port of the RAM 26 to a fourth input port of the multiplexer 22.

Time-slices from four other services for reception by M/H receivers are supplied to fifth, sixth, seventh and eighth input ports, respectively, of the time-division multiplexer 22 from respective RAMs not explicitly depicted in FIG. 3. The respective time-slices from each of services for reception by M/H receivers that the multiplexer 22 assembles are supplied from the output port of the multiplexer 22 to the input port of an internet protocol encapsulator 27. The IPE 27 is the same in construction and operation as described supra with regard to the IPE 2 in FIG. 1. The output port of the IPE 27 connects to the input port of a data randomizer 28, the construction and operation of which are similar to those of the data randomizer 3 in FIG. 1. FIG. 3 shows the output port of the data randomizer 28 connected to the input port of a block de-interleaver 29 for bytes of time-slices. The block de-interleaver 29 is of matrix type and preferably is constructed from two banks of byte-organized dual-ported random-access memory. Each of these banks can have 35,717 m addressable byte-storage locations arranged in 187 m columns and 191 rows, m being a small positive integer. Byte-storage locations in a first bank of the RAM are written to during odd-numbered time-slice intervals, while byte-storage locations in the second bank of the RAM are read from. Byte-storage locations in the second bank of the RAM are written to during even-numbered time-slice intervals, while byte-storage locations in the first bank of the RAM are read from. The response of the data randomizer 28 is supplied to the random-access write-input port of the RAM to be written into byte-storage locations row by row in one of the banks of the RAM. After the 191 rows of byte-storage locations have been written or re-written by bytes of the data randomizer 28 response, the contents of the byte-storage locations are read column by column from the serial read-output port of the RAM to the input port of a TRS encoder 30, used for (255, 191) transverse Reed-Solomon (TRS) forward-error-correction (FEC) coding of the block de-interleaver 29 response.

The output port of the TRS encoder 30 is connected for supplying (255, 191) TRS codewords to the input port of a block interleaver 31 for bytes from those (255, 191) TRS codewords. The block interleaver 31 is of matrix type and preferably is constructed from two banks of byte-organized dual-ported random-access memory. Each of these banks can have 47,685 m addressable byte-storage locations arranged in 187 m columns and 255 rows. Byte-storage locations in a first bank of the RAM are written to during odd-numbered time-slice intervals, while byte-storage locations in the second bank of the RAM are read from. Byte-storage locations in the second bank of the RAM are written to during even-numbered time-slice intervals, while byte-storage locations in the first bank of the RAM are read from. The (255, 191) TRS codewords from the output port of the TRS encoder 30 are supplied to the random-access write-input port of the RAM to be written into byte-storage locations column by column. After the 187 m columns of byte-storage locations in a bank of the RAM have been written or re-written by respective (255, 191) TRS codewords, the contents of the byte-storage locations in that bank are read row by row from a serial read-output port of that bank to the output port of the block interleaver 31.

The codewords resulting from (255, 191) TRS coding of the initial three bytes of data-randomized IPE packets in a time-slice are the same for all time slices. So, a group or groups of three such codewords can be permanently stored in respective columns of byte-storage locations in each bank of memory in the block interleaver 31 for bytes of time-slices. That is, those byte-storage locations are not written to every time slice interval, but rather are read-only. This frees the TRS encoder 30 from having to code this group or these groups of three (255, 191) TRS codewords. Also, the block de-interleaver 29 for bytes of time-slices can omit actual byte-storage locations for the initial three bytes of data-randomized IPE packets.

FIG. 3 shows the output port of the block interleaver 31 connected to the input port of a byte de-interleaver 32. FIG. 3 further shows the output port of which is connected for supplying byte-deinterleaved data-randomized IPE packets to the input port of an LRS encoder 33 for (204, 188) lateral Reed-Solomon (LRS) forward-error-correction (FEC) coding. The output signal from the LRS encoder 33 reproduces the 188-byte segments of the byte de-interleaver 32 response, but appends to each of those 188-byte segments a respective set of sixteen parity bytes for the (204, 188) LRS FEC coding, as calculated by the LRS encoder 33. The output port of the LRS encoder 33 is connected for supplying the resulting (204, 188) LRS codewords as input signal to the input port of a convolutional byte interleaver 34, which is preferably similar in construction and operation to the convolutional byte interleaver 9. The output port of the convolutional byte interleaver 34 is connected for supplying its response to apparatus for further FEC coding of individual bits of that response, which apparatus can be as shown in FIG. 4 for example.

The pattern of byte de-interleaving the byte de-interleaver 32 employs is complementary to the pattern of byte interleaving employed by the subsequent convolutional byte interleaver 34. The byte de-interleaver 32 arranges for the convolutional byte interleaver 34 to provide “coded” or “implied” byte interleaving of (204, 188) LRS FEC codewords from the LRS encoder 33. Referring back to the TRS encoding operations, the pattern of byte de-interleaving the block interleaver 31 employs is complementary to the pattern of byte interleaving employed by the preceding block de-interleaver 29. The block de-interleaver 29 arranges for the block interleaver 31 to provide “coded” or “implied” byte interleaving of (255, 191) TRS FEC codewords from the TRS encoder 30. Some burst errors may exceed the error-correction capability of decoding the (204, 188) RS FEC codewords and may then also exceed the error-correction capability of decoding the (255, 191) RS FEC codewords. If the byte interleaving of (204, 188) LRS FEC codewords and of (255, 191) TRS FEC codewords at the transmitter is not “coded”, byte de-interleaving in the receiver disperses burst errors that cannot be corrected among a greater number of IP packets than those affected by such burst error when initially received. With “coded” byte interleaving of the (204, 188) LRS FEC codewords and of the (255, 191) TRS FEC codewords, the DTV receiver can confine to fewer data-randomized IP packets those burst errors that cannot be corrected.

In less preferred COFDM DTV broadcasting systems, byte interleaving of the (204, 188) LRS FEC codewords is not coded. In such case the byte de-interleaver 32 is replaced by direct connection from the output port of the block interleaver 31 to the input port of the LRS encoder 33. If byte interleaving of the (204, 188) LRS FEC codewords is coded, the byte de-interleaver 32 is apt not to be an element separate from the block interleaver 31. The block de-interleaving previous to the LRS encoder 33 can instead be implemented by suitable read addressing of the banks of RAM in the block interleaver 31.

FIG. 4 shows apparatus for generating PCCC components and subsequent COFDM signals subsequently transmitted over the air for reception by M/H receivers. The output port of the convolutional byte interleaver 34 shown in FIG. 3 is connected for supplying the response therefrom to the input port of a PCCC encoder 35 shown in FIG. 4. The PCCC encoder 35 generates one-third-code-rate parallel concatenated convolutional coding that is supplied from its output port to the input port of a constellation mapper 36 for square 64QAM symbol constellations. The nature of preferred square 64QAM symbol constellations and the Gray mapping used in them are disclosed in detail in the above-referenced U.S. patent application Ser. No. 13/493,198 filed 11 Jun. 2012.

The output port of the constellation mapper 36 is connected to the input port of a parser 37 for effective OFDM symbol blocks. The block parser 37 parses a stream of complex samples supplied from the constellation mapper 36 into uniform-length sequences of complex samples, each of which sequences is associated with a respective effective OFDM symbol. The output port of the block parser 37 is connected to a first input port of a pilot and TPS signal insertion unit 38, a second input port of which unit 38 is connected to receive Transmission Parameters Signaling (TPS) bits from a TPS signal generator 39. The pilot and TPS signal insertion unit 38 inserts these TPS bits, which are to be transported by dedicated carriers (TPS Pilots), into each effective OFDM symbol block. The pilot and TPS signal insertion unit 38 inserts other bits descriptive of unmodulated carriers of predetermined amplitude and predetermined phase into each effective OFDM symbol block. An output port of the pilot and TPS signal insertion unit 38 is connected for supplying the effective OFDM symbol blocks with pilot carriers inserted therein to the input port of an OFDM modulator 40. The OFDM modulator 40 has 4K carriers capability, suitable for transmissions to M/H DTV receivers.

The OFDM modulator 40 includes a serial-to-parallel converter for converting the serially generated complex digital samples of the effective OFDM symbols to parallel complex digital samples for inverse discrete Fourier transformation (I-DFT). The OFDM modulator 40 further includes a parallel-to-serial converter for converting the parallel complex digital samples of the I-DFT results to serial complex digital samples of the I-DFT results supplied from the output port of the OFDM modulator 40 to the input port of a guard-interval-and-cyclic-prefix-insertion unit 41. The output port of the guard-interval-and-cyclic-prefix-insertion unit 41 is connected for supplying successive complex digital samples of a COFDM signal to a second input port of the all-services multiplexer 17.

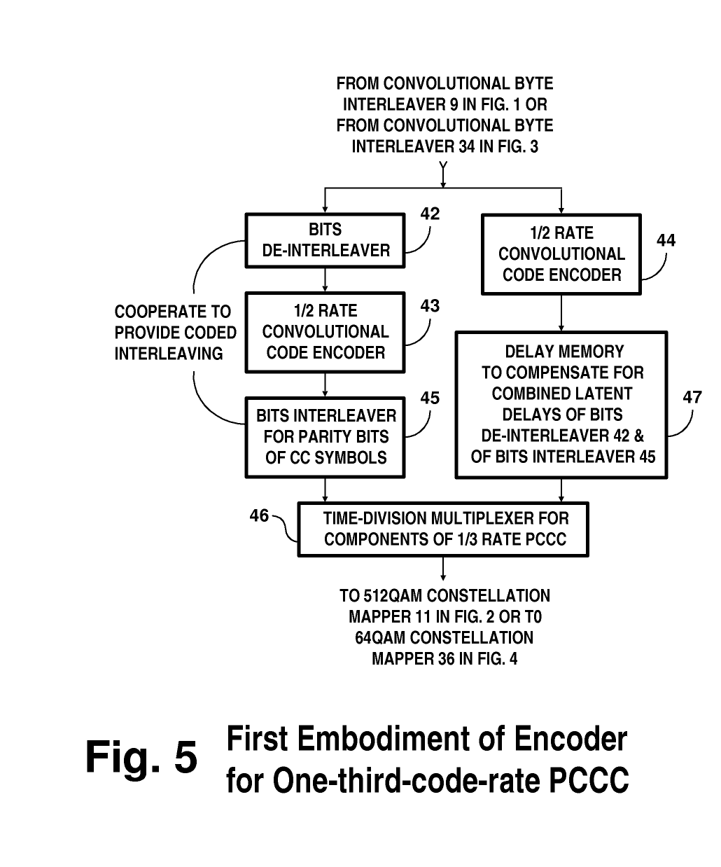

FIGS. 5, 6 and 7 each depict a respective encoder for one-third-code-rate PCCC that can be used in either of the portions of a COFDM transmitter depicted in FIGS. 2 and 4 in place of encoders for one-third-code-rate PCCC known from the prior art. Each of the PCCC encoders depicted in FIGS. 5, 6 and 7 is novel in that it includes a bits de-interleaver 42 to cause the symbol interleaving of a first set of parity bytes that are a component of the PCCC to be “implied” or “coded” interleaving. These new forms of PCCC allow simplification in the design of receivers of the COFDM transmissions originating from either of the portions of a COFDM transmitter depicted in FIGS. 2 and 4.

Each of the PCCC encoders depicted in FIGS. 5, 6 and 7 includes the bits de-interleaver 42, encoders 43 and 44 for one-half-code-rate convolutional coding (CC), a bits interleaver 45, and a time-division multiplexer 46 for interleaving components of the one-third-code-rate PCCC. The bits de-interleaver 42 is typically constructed using dual-ported random-access memory having a random-access input port connected for receiving the response from the convolutional byte interleaver 9 of the FIG. 2 portion of a COFDM transmitter or the response from the convolutional byte interleaver 34 of the FIG. 4 portion of a COFDM transmitter. The serial output port of this RAM is then connected for supplying the bits de-interleaved response of the byte interleaver 9 or 34 to the input port of the CC encoder 43. The output port of the CC encoder 43 connects to the input port of the interleaver 45 for parity bits of the half-nibble CC symbols that the CC encoder 43 generates. The bits interleaver 45 is typically constructed using dual-ported random-access memory having a random-access input port connected for receiving the parity bits generated by the CC encoder 43. The serial output port of this RAM is then connected for supplying the interleaved parity bits in the interleaver 45 response to a first of two input ports of the time-division multiplexer 46.

In the FIG. 5 PCCC encoder the input port of the CC encoder 44 is connected for directly receiving the response from the convolutional byte interleaver 9 of the FIG. 2 portion of a COFDM transmitter or the response from the convolutional byte interleaver 34 of the FIG. 4 portion of a COFDM transmitter. The output port of the CC encoder 44 connects to the input port of a delay memory 47, the output port of which connects to the second input port of the time-division multiplexer 46. The delay memory 47 has temporary-storage capability to delay the half-nibble symbols of CC encoder 44 response so as to compensate for the combined latent delays of the bits de-interleaver 42 and the bits interleaver 45.

In a variant of the FIG. 5 PCCC encoder, the bits interleaver 45 is replaced by a symbol interleaver that interleaves de-interleaved CC data bits as well as parity bits supplied from the output port of the CC encoder 43. Then, the delay memory 47 need only have the temporary-storage capability to delay the parity bits generated by the CC encoder 44. The parity bits supplied from the output port of the CC encoder 44 as delayed by the delay memory 47 for application to the second input port of the time-division multiplexer 46 are then time-interleaved by the multiplexer 46 with the output symbols from the CC encoder 43 as symbol-interleaved for application to the first input port of the multiplexer 46.

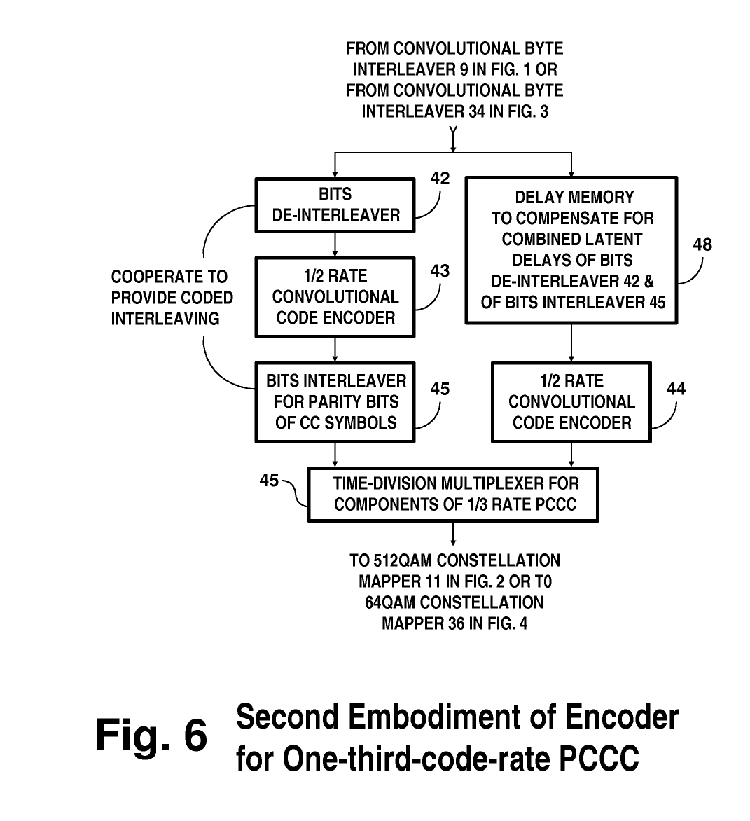

The FIG. 6 PCCC encoder differs from the FIG. 5 PCCC encoder in that a delay memory 48 delays the response from the convolutional byte interleaver 9 of the FIG. 2 portion of a COFDM transmitter or the response from the convolutional byte interleaver 34 of the FIG. 4 portion of a COFDM transmitter before that response is supplied to the input port of the CC encoder 44. The delay memory 47 is omitted, and the output port of the CC encoder 44 connects directly to the second input port of the time-division multiplexer 46. The delay memory 48 delays the CC encoder 44 response indirectly, to compensate for the combined latent delays of the bits de-interleaver 42 and the bits interleaver 45. Overall, the FIG. 6 PCCC encoder requires less temporary storage for bits than the FIG. 5 PCCC encoder, and accordingly is preferred over the FIG. 5 PCCC encoder. Modifications of the FIG. 5 and FIG. 6 PCCC encoders that replace the bits de-interleaver 42 in each of them by a respective direct connection results in previously known forms of PCCC encoder. Using either of these previously known forms of PCCC encoder complicates turbo decoding in DTV receivers to some extent.

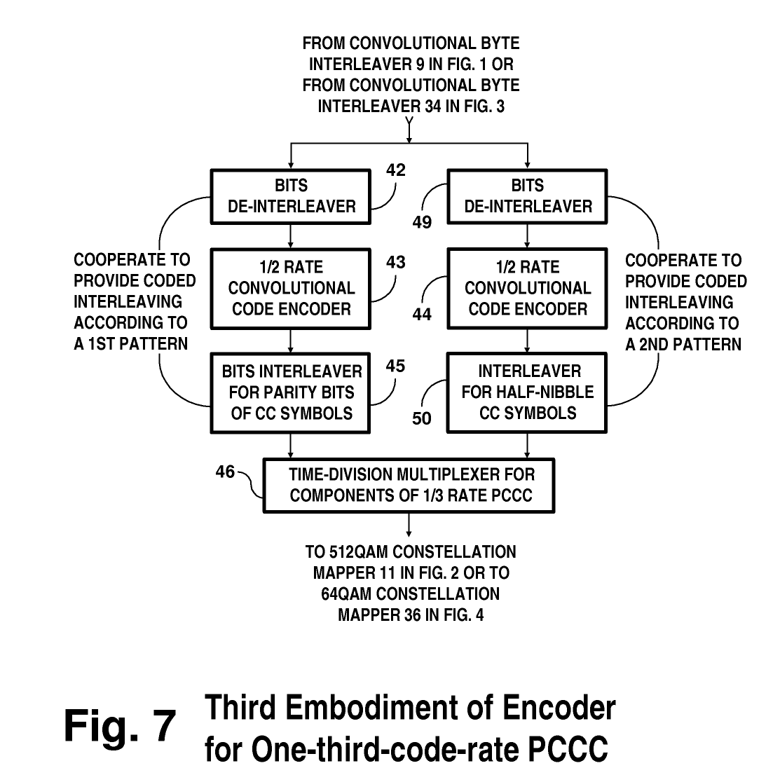

The FIG. 7 PCCC encoder uses neither the delay memory 47 nor the delay memory 48 to compensate for the combined latent delays of the bits de-interleaver 42 and the bits interleaver 45. Instead, the CC encoder 44 is preceded by another bits de-interleaver 49 and succeeded by an interleaver 50 for the half-nibble CC symbols that the CC encoder 44 generates. The bits de-interleaver 49 and the symbols interleaver 50 provide coded interleaving of the CC symbols generated by the CC encoder 44, which coded interleaving is performed in accordance with a second pattern. This second pattern differs from the first pattern of coded interleaving according to which the bits de-interleaver 42 and the bits interleaver 45 perform. The first and second patterns of coded interleaving are chosen to provide substantial temporal diversity between the parity bits from the two CC encoders 43 and 44.

The bits de-interleaver 49 is typically constructed using dual-ported random-access memory having a random-access input port connected for receiving the response from the convolutional byte interleaver 9 of the FIG. 2 portion of a COFDM transmitter or the response from the convolutional byte interleaver 34 of the FIG. 4 portion of a COFDM transmitter. The serial output port of this RAM is then connected for supplying the bits de-interleaved response of the byte interleaver 9 or 34 to the input port of the CC encoder 44. The output port of the CC encoder 44 connects to the input port of the interleaver 50 for half-nibble CC symbols. The symbols interleaver 50 is typically constructed using dual-ported RAM having a random-access input port connected for receiving the half-nibble CC symbols generated by the CC encoder 44. The serial output port of this RAM is then connected for supplying the interleaved half-nibble CC symbols of interleaver 50 response to the second input port of the time-division multiplexer 46.

The coded bits interleaving employed by each of PCCC encoders depicted in FIGS. 5, 6 and 7 follows at least one convolutional coding procedure with bits interleaving, which provides the following benefit during DTV reception. De-interleaving of the bits interleaving at a DTV receiver disperses burst noise before decoding the convolutional coding, resulting in bit errors being more likely to be occasional errors which a decoder for the convolutional coding is better able to correct than a sequence of frequent bit errors. Convolutional coding, which has customarily been viewed as implementing the correction of bit errors caused by additive White Gaussian noise (AWGN) or its like, acquires some capability for the correction of burst errors when combined with coded bits interleaving or coded half-nibble-symbols interleaving. Such coded interleaving further accommodates DTV reception in that it facilitates bits re-interleaving following decoding of the convolutional coding, which bits re-interleaving regroups back into bursts those data bits that convolutional coding is unable to correct. This reduces the number of bytes corrupted by data bits that convolutional coding is unable to correct, which reduction makes it less difficult for the DTV receiver subsequently to decode Reed-Solomon coding. The FIG. 7 PCCC encoder secures these benefits for both component convolutional codes and is preferred over other known types of one-third-rate PCCC encoders for this reason. Less preferred DTV receivers embodying other aspects of the invention are configured for receiving baseband DTV signals broadcast from DTV transmitters that just use bits interleaving before convolutional coding of PCCC components, rather than using coded bits interleaving or coded half-nibble-symbols interleaving.

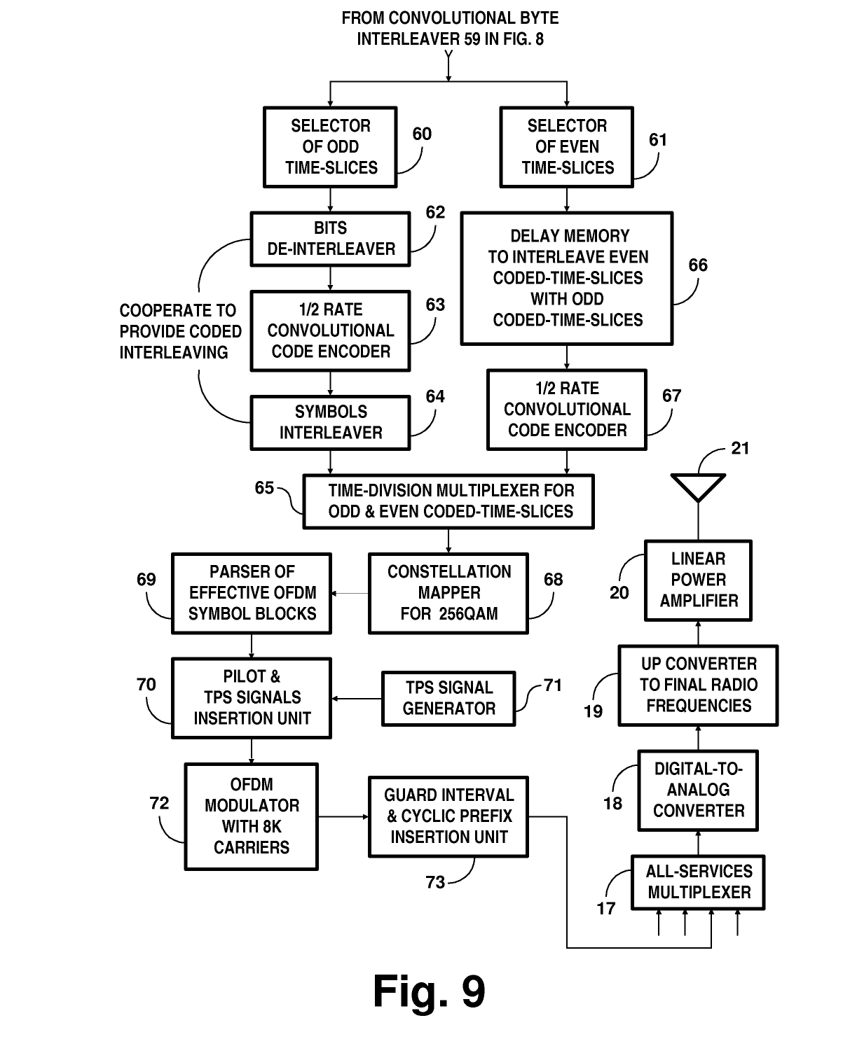

FIGS. 8 and 9 together show a portion of a DTV transmitter generating COFDM signals for iterative-diversity reception by stationary DTV receivers. Apparatus for generating PCCC and subsequent COFDM signals is shown in FIG. 9. FIG. 8 depicts apparatus for processing frames of services to be broadcast to stationary DTV receivers for iterative-diversity reception.

A time-division multiplexer 51 for interleaving time-slices of services to be broadcast to stationary DTV receivers is depicted at the middle of FIG. 8. The time-division multiplexer 51 successively selects time-slices of these various services to be reproduced in its response, which is supplied from its output port. FIG. 8 shows the multiplexer 51 connected for performing the time-division multiplexing time-slice by time-slice—i.e., one-eighth frame by one-eighth frame. There are various ways that the multiplexer 1 could time-division multiplex earlier and later transmissions of data scheduled for iterative-diversity reception by stationary DTV receivers. Time-division multiplexing could be done on a frame-by-frame basis, for example, as done in DVB-T practice. However, time-division multiplexing time-slice by time-slice is preferred, partly because it can afford greater flexibility to the broadcasting system insofar as scheduling different services is concerned, provided that the nature of that multiplexing is signaled. The three frames scheduled for reception by stationary DTV receivers altogether contain twenty-four time-slices. By way of example, these twenty-four time-slices can be reapportioned among four services, each provided with only six time-slices per super-frame, rather than eight time-slices per super-frame. Alternatively, adjustments of the time-division multiplexing can be made to take into account whether high-definition or standard-definition DTV signals are transmitted. Remnant pairs of time-slices left over from the services scheduled for reception by stationary DTV receivers can be scheduled for reception by M/H receivers.

Data concerning a first of the services to be transmitted twice to enable iterative-diversity reception by stationary DTV receivers are written to a dual-port random-access memory 52 via a random-access port thereof. The RAM 52 is capable of temporarily storing a number of time-slices of that service. Successive time-slices of that service are read from the serial output port of the RAM 52, ordinarily four odd-numbered time-slices in a single frame per super-frame, to a first input port of the multiplexer 52. After a delay of one time-slice more than N super-frames, the same successive time-slices of that first service are read again from the serial output port of the RAM 52 to enable iterative-diversity reception by stationary DTV receivers. Typically, there are several super-frames between the two transmissions, N being eight or more.

Data concerning a second of the services to be transmitted twice to enable iterative-diversity reception by stationary DTV receivers are written to a dual-port random-access memory 53 via a random-access port thereof. The RAM 53 is capable of temporarily storing a number of time-slices of that service. Successive time-slices of that service are read from the serial output port of the RAM 53, ordinarily four odd-numbered time-slices in a single frame per super-frame, to a second input port of the multiplexer 51. After a delay of one time-slice more than N super-frames, the same successive time-slices of that second service are read again from the serial output port of the RAM 53 to enable iterative-diversity reception by stationary DTV receivers.

Data concerning a third of the services to be transmitted twice to enable iterative-diversity reception by stationary DTV receivers are written to a dual-port random-access memory 54 via a random-access port thereof. The RAM 54 is capable of temporarily storing a number of time-slices of that service. Successive time-slices of that service are read from the serial output port of the RAM 54, ordinarily four odd-numbered time-slices in a single frame per super-frame, to a third input port of the multiplexer 51. After a delay of one time-slice more than N super-frames, the same successive time-slices of that third service are read again from the serial output port of the RAM 54 to enable iterative-diversity reception by stationary DTV receivers. If the DTV transmitter does not transmit services for reception by M/H receivers, data concerning a fourth service transmitted twice to enable iterative-diversity reception by stationary DTV receivers are read to a fourth input port of the multiplexer 51 from a dual-port random-access memory that FIG. 8 does not show.

FIG. 8 shows the output port of the multiplexer 51 connected to the input port of an internet protocol encapsulator 55, the output port of which IPE 55 connects to the input port of a data randomizer 56. The internet protocol encapsulator 55 is used only if the services for reception by stationary DTV receivers use internet-protocol (IP) transport-stream (TS) packets, which packets have varying lengths. If the original format for services broadcast for reception by stationary DTV receivers is composed of successive MPEG-2 TS packets, rather than successive IP TS packets, the IPE 55 is either selectively by-passed or is replaced by a direct connection from the output port of multiplexer 51 to the input port of the data randomizer 56. The IPE 55 and the data randomizer 56 are similar in their structures and operations to the IPE 2 and the data randomizer 3, respectively, depicted in FIG. 1. The bits of the concluding 187-byte portion of each of the data packets supplied to the input port of the data randomizer 56 are exclusive-ORed with a prescribed repeating pseudo-random binary sequence (PRBS) in the data randomizer 56. However, initial synchronizing bytes accompanying the data packets are excluded from such data randomization procedure. The 16-bit register used to generate the PRBS for data randomization is reset to initial condition at the beginning of each time-slice supplied from the multiplexer 51.

If the services broadcast for reception by stationary DTV receivers employ IP TS packets, preferably the output port of the data randomizer 56 is connected for supplying data-randomized IPE packets to the input port of a byte de-interleaver 57. The output port of the byte de-interleaver 57 is then connected for supplying its byte-interleaved response to the input port of a LRS encoder 58 for (204, 188) lateral Reed-Solomon (LRS) forward-error-correction (FEC) coding. The output port of the LRS encoder 58 is connected for supplying successively generated (204, 188) LRS FEC codewords to the input port of a convolutional byte interleaver 59. The pattern of byte de-interleaving that the byte de-interleaver 57 employs is complementary to the pattern of byte interleaving employed by the subsequent convolutional byte interleaver 59. The patterns are the same as those used in the byte de-interleaver 7 and the convolutional byte interleaver 9 depicted in FIG. 1. The byte de-interleaver 57 arranges for the convolutional byte interleaver 59 to provide “coded” or “implied” byte interleaving of (204, 188) LRS FEC codewords from the LRS encoder 58. If the original format for services broadcast for reception by stationary DTV receivers is composed of successive MPEG-2 TS packets, rather than successive IP TS packets, the byte de-interleaver 57 is either selectively by-passed or is replaced by a direct connection from the output port of the data randomizer 57 to the input port of the LRS encoder 58.

FIG. 9 shows apparatus for generating PCCC components and subsequent COFDM signals subsequently transmitted over the air for iterative-diversity reception by stationary DTV receivers. The output port of the convolutional byte interleaver 59 shown in FIG. 8 is connected for supplying the response therefrom to the respective input ports of selectors 60 and 61 shown in FIG. 9. The selector 60 selectively responds to the convolutionally byte-interleaved (204, 188) LRS codewords of odd-numbered time-slices supplied to its input port, reproducing them in bit-serial form at its output port. The selector 61 selectively responds to the convolutionally byte-interleaved (204, 188) LRS codewords of even-numbered time-slices supplied to its input port, reproducing them in bit-serial form at its output port.

The bit-serial, convolutionally byte-interleaved (204, 188) LRS codewords of odd-numbered time-slices are supplied from the output port of the selector 60 to the input port of a bits de-interleaver 62. The output port of the bits de-interleaver 62 is connected for supplying bit de-interleaved response to the input port of a CC encoder 63 for one-half-rate convolutional coding (CC). The output port of the CC encoder 63 is connected for supplying one-half-rate convolutional coding to the input port of a symbols interleaver 64. The bits de-interleaver 62 and the symbols interleaver 64 cooperate to provide coded (or “implied”) interleaving of the data bits and parity bits of the convolutional coding from the output port of the symbols interleaver 64. The symbols interleaver 64 interleaves half-nibble symbols in a way complementary to the way that the bits de-interleaver 62 de-interleaves data bits supplied to the CC encoder 63 for one-half-rate CC. Accordingly, data bits appear in their original order in the symbol-interleaved one-half-rate CC supplied from the output port of the symbol interleaver 64 to a first of two input ports of a time-division multiplexer 65 for odd-numbered and even-numbered coded time-slices.

The bit-serial, convolutionally byte-interleaved (204, 188) LRS codewords of even-numbered time-slices are supplied from the output port of the selector 61 to the input port of a delay memory 66. The output port of the delay memory 66 is connected to the input port of a CC encoder 67 for one-half-rate convolutional coding (CC). The CC encoder 67 is similar in construction and operation to the CC encoder 63. The output port of the CC encoder 67 is connected for supplying one-half-rate CC to the second input port of the time-division multiplexer 65 for odd-numbered and even-numbered coded time-slices. The delay memory 67 provides delay that compensates for the latent delays in the bit-de-interleaver 62 and the symbol interleaver 64. So, coded even-numbered time-slices that the CC encoder 67 supplies to the second input port of the time-division multiplexer 65 interleave in time with the odd-numbered coded time-slices that the symbol interleaver 64 supplies to the first input port of the time-division multiplexer 65.

The output port of the multiplexer 65 is connected for supplying the time-division-multiplexed odd-numbered and even-numbered coded time-slices to the input port of a constellation mapper 68 for 256QAM symbol constellations. The nature of the preferred square 256QAM symbol constellations and the Gray mapping used in them are disclosed in detail in the above-referenced U.S. patent application Ser. No. 13/493,198 filed 11 Jun. 2012. The output port of the constellation mapper 68 is connected to the input port of a parser 69 for effective OFDM symbol blocks. The block parser 69 parses a stream of complex samples supplied from the constellation mapper 68 into uniform-length sequences of complex samples, each of which sequences is associated with a respective effective OFDM symbol. The output port of the block parser 69 is connected to a first input port of a pilot and TPS signal insertion unit 70, a second input port of which unit 70 is connected to receive Transmission Parameters Signaling (TPS) bits from a TPS signal generator 71. The pilot and TPS signal insertion unit 70 inserts these TPS bits, which are to be transported by modulated dedicated carriers (TPS Pilots), into each effective OFDM symbol block. The pilot and TPS signal insertion unit 70 inserts other bits descriptive of unmodulated carriers of predetermined amplitude and predetermined phase into each effective OFDM symbol block. An output port of the pilot and TPS signal insertion unit 70 is connected for supplying the effective OFDM symbol blocks, with pilot carriers inserted therein, to the input port of an OFDM modulator 72. The OFDM modulator 72 has 8K carriers capability, suitable for transmissions to stationary DTV receivers.

The OFDM modulator 72 includes a serial-to-parallel converter for converting the serially generated complex digital samples of the effective OFDM symbols to parallel complex digital samples for inverse discrete Fourier transformation (I-DFT). The OFDM modulator 72 further includes a parallel-to-serial converter for converting the parallel complex digital samples of the I-DFT results to serial complex digital samples of the I-DFT results supplied from the output port of the OFDM modulator 72 to the input port of a guard-interval-and-cyclic-prefix insertion unit 73. The output port of the guard-interval-and-cyclic-prefix insertion unit 73 is connected for supplying successive complex digital samples of a COFDM signal to a third input port of the all-services multiplexer 17.

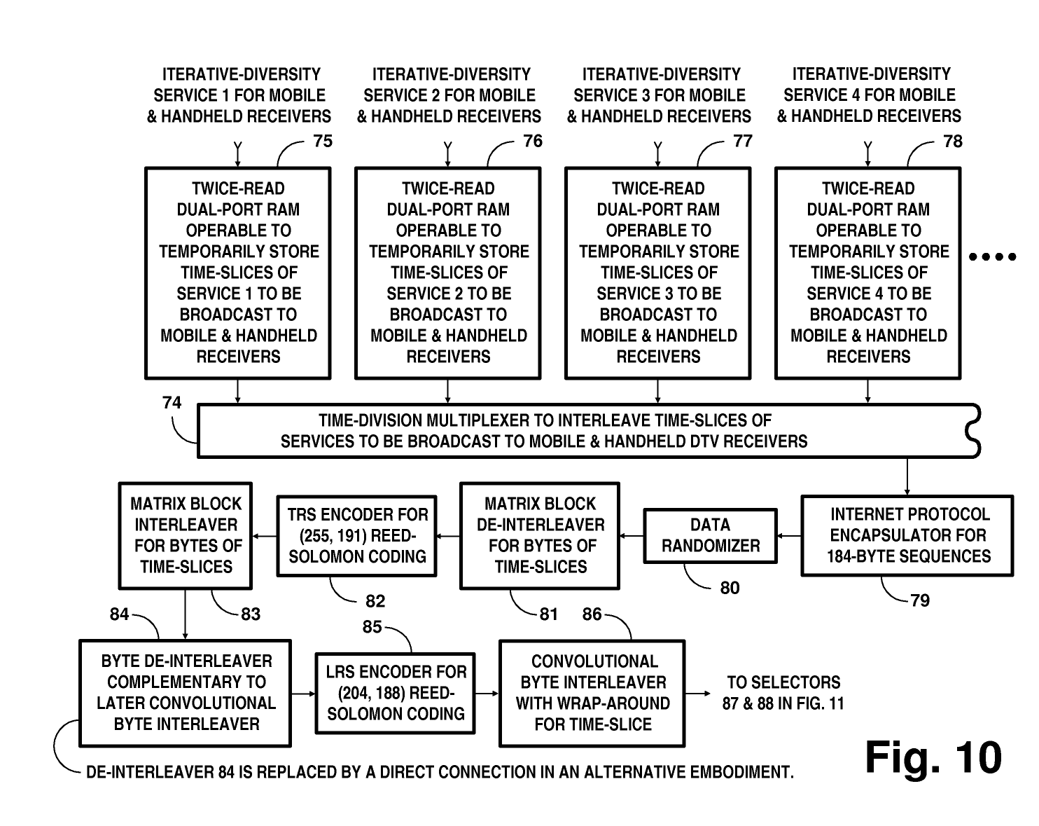

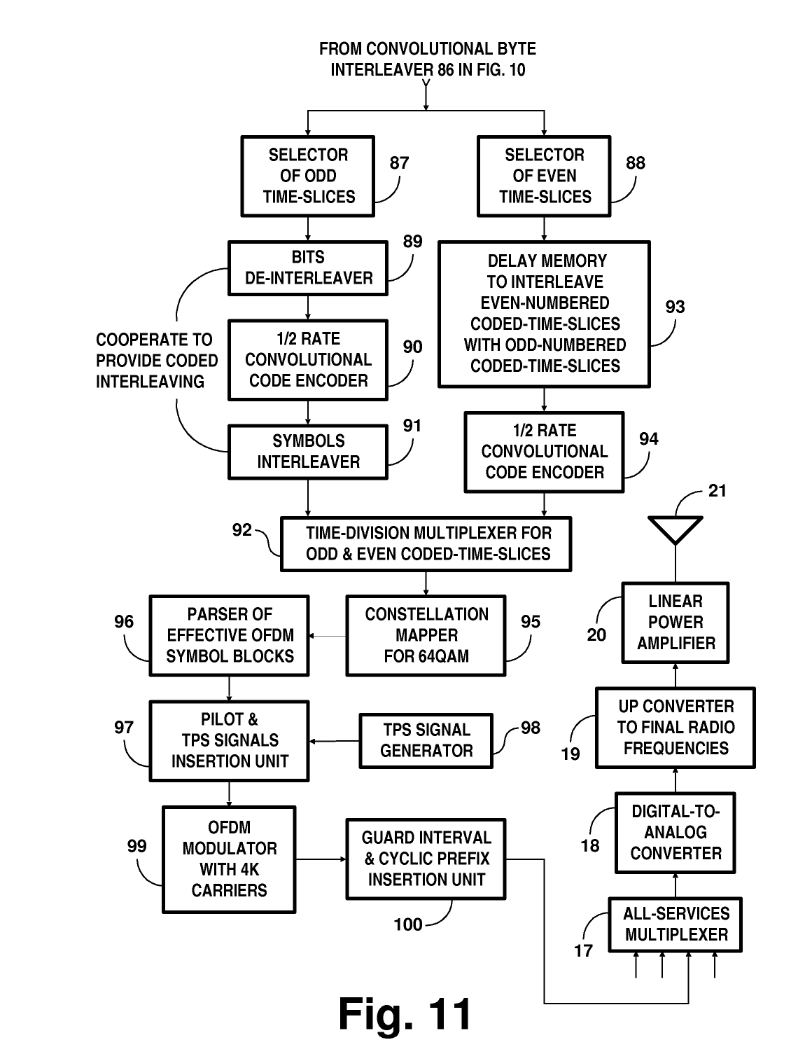

FIGS. 10 and 11 together show a further portion of the DTV transmitter generating COFDM signals for reception by M/H DTV receivers. Apparatus for generating PCCC and subsequent COFDM signals is shown in FIG. 11. FIG. 10 shows apparatus for processing time-slices for iterative-diversity reception by M/H DTV receivers. A time-division multiplexer 74 to assemble time-sliced services for reception by mobile and handheld receivers is shown somewhat above the middle of FIG. 10.

Data concerning a first of the services to be transmitted twice for reception by M/H DTV receivers are written into storage locations within a dual-port random-access memory 75 via a random-access port thereof. The RAM 75 is capable of temporarily storing a number at least N+1 of time-slices of the first service to be transmitted twice to enable iterative-diversity reception by M/H DTV receivers. The dual-port RAM 75 has a serial output port connected to a first input port of the multiplexer 74 of time-sliced services for reception by M/H receivers. Successive time-slices of the first service for iterative-diversity reception by M/H receivers are read from the serial output port of the RAM 75, one odd-numbered time-slice per super-frame, to support the initial transmissions of those time-slices. After a delay of one time-slice more than N super-frames, the same successive time-slices of that first service are read again from the serial output port of the RAM 75, one even-numbered time-slice per super-frame, to support the final transmissions of those time-slices.

Data concerning a second of the services to be transmitted twice to enable iterative-diversity reception by M/H DTV receivers are written into storage locations within a dual-port random-access memory 76 via a random-access port thereof. The RAM 76 is capable of temporarily storing a number at least N+1 of time-slices of the second service to be transmitted twice to enable iterative-diversity reception by M/H DTV receivers. The dual-port RAM 76 has a serial output port connected to a second input port of the multiplexer 74 of time-sliced services for reception by M/H receivers. Successive time-slices of the second service for iterative-diversity reception by M/H receivers are read from the serial output port of the RAM 76, one odd-numbered time-slice per super-frame, to support the initial transmissions of those time-slices. After a delay of one time-slice more than N super-frames, the same successive time-slices of that second service are read again from the serial output port of the RAM 76, one even-numbered time-slice per super-frame, to support the final transmissions of those time-slices.

Data concerning a third of the services to be transmitted twice to enable iterative-diversity reception by M/H DTV receivers are written into storage locations within a dual-port random-access memory 77 via a random-access port thereof. The RAM 77 is capable of temporarily storing a number at least N+1 of time-slices of the third service to be transmitted twice to enable iterative-diversity reception by M/H DTV receivers. The dual-port RAM 77 has a serial output port connected to a third input port of the multiplexer 74 of time-sliced services for reception by M/H receivers. Successive time-slices of the third service for iterative-diversity reception by M/H DTV receivers are read from the serial output port of the RAM 77, one odd-numbered time-slice per super-frame, to support the initial transmissions of those time-slices. After a delay of one time-slice more than N super-frames, the same successive time-slices of that third service are read again from the serial output port of the RAM 77, one even-numbered time-slice per super-frame, to support the final transmissions of those time-slices.

Data concerning a fourth of the services to be transmitted twice to enable iterative-diversity reception by M/H DTV receivers are written into storage locations within a dual-port random-access memory 78 via a random-access port thereof. The RAM 78 is capable of temporarily storing a number at least N+1 of time-slices of the fourth service to be transmitted twice to enable iterative-diversity reception by M/H DTV receivers. The dual-port RAM 78 has a serial output port connected to a fourth input port of the multiplexer 74 of time-sliced services for reception by M/H receivers. Successive time-slices of the fourth service for iterative-diversity reception by M/H receivers are read from the serial output port of the RAM 78, one odd-numbered time-slice per super-frame, to support the initial transmissions of those time-slices. After a delay of one time-slice more than N super-frames, the same successive time-slices of that fourth service are read again from the serial output port of the RAM 78, one even-numbered time-slice per super-frame, to support the final transmissions of those time-slices.

The respective time-slices from each of services for reception by M/H receivers that the time-division multiplexer 74 assembles are supplied from the output port of the multiplexer 74 to the input port of an internet protocol encapsulator 79. The IPE 79 is similar in its construction and operation to the IPE 27 depicted in FIG. 3. The output port of the IPE 79 is connected to the input port of a data randomizer 80, the construction of which is similar to that of each of the data randomizers 3, 28 and 56. FIG. 10 shows the output port of the data randomizer 80 connected to the input port of a matrix block de-interleaver 81 for bytes of time-slices. The block de-interleaver 81 is similar in its construction and operation to the matrix block de-interleaver 29 depicted in FIG. 3. The output port of the matrix block de-interleaver 81 is connected to the input port of a TRS encoder 82, used for (255, 191) transverse Reed-Solomon (TRS) forward-error-correction (FEC) coding of the de-interleaver 81 response.

The output port of the TRS encoder 82 is connected for supplying (255, 191) TRS codewords to the input port of a block interleaver 83 for bytes from those (255, 191) TRS codewords. The block interleaver 83 is similar in its construction and operation to the block interleaver 31 depicted in FIG. 3. FIG. 10 shows the output port of the block interleaver 83 connected for supplying data-randomized IPE packets to the input port of a byte de-interleaver 84 that is similar in its construction and operation to the byte de-interleaver 32 depicted in FIG. 3. FIG. 10 further shows the output port of the byte de-interleaver 84 connected to the input port of an LRS encoder 85 for (204, 188) Reed-Solomon (RS) forward-error-correction (FEC) coding. The output signal from the LRS encoder 85 reproduces the 188-byte segments of the byte de-interleaver 84 response, but appends to each of those 188-byte segments a respective set of sixteen parity bytes for the (204, 188) RS FEC coding, as calculated by the LRS encoder 85. The output port of the LRS encoder 85 is connected for supplying the resulting (204, 188) RS codewords as input signal to the input port of a convolutional byte interleaver 86, which is preferably similar in construction and operation to each of the convolutional byte interleavers 9, 34 and 59. The output port of the convolutional byte interleaver 86 is connected for supplying its response to apparatus for further FEC coding of individual bits of that response, which apparatus can be as shown in FIG. 11 for example.

Super-frames are customarily composed of four consecutive frames apiece, a fourth frame of each super-frame comprising eight respective time-slices for reception by M/H receivers. Preferably, these eight time-slices are apportioned in the following way among the services scheduled for iterative-diversity reception by M/H receivers. Initial and final transmissions of a first of the services scheduled for iterative-diversity reception by M/H receivers are transmitted in respective ones of the first and second of the time-slices in each fourth frame. Initial and final transmissions of a second of the services scheduled for iterative-diversity reception by M/H receivers are transmitted in respective ones of the third and fourth of the time-slices in each fourth frame. Initial and final transmissions of a third of the services scheduled for iterative-diversity reception by M/H receivers are transmitted in respective ones of the fifth and sixth of the time-slices in each fourth frame. Initial and final transmissions of a fourth of the services scheduled for iterative-diversity reception by M/H receivers are transmitted in respective ones of the seventh and eighth of the time-slices in each fourth frame. This protocol for apportioning time-slices among the services scheduled for iterative-diversity reception is well suited for selectively energizing an M/H receiver for receiving only a selected one of those services. This protocol permits the front-end tuner of the M/H receiver to be powered up just once in each fourth frame, rather than having to be powered up twice in each fourth frame. This reduces the time taken for settling of the front-end tuner before actively receiving the service selected for reception. If a service scheduled for iterative-diversity reception by M/H receivers requires more than two data slices within each fourth frame, arranging the data slices so as to be consecutive in time permits the front-end tuner of the M/H receiver still to be powered up just once in each fourth frame, rather than having to be powered up more times in each fourth frame.

The nature of the convolutional byte interleaving performed by each of the byte interleavers 9, 34, 59 and 86 is such that sustained burst noise extending for as many as sixteen rows of the 204-byte-wide data field will cause no more than sixteen byte errors in any (204, 188) LRS codeword. If byte errors in a (204, 188) LRS codeword are located externally to the codeword, as many as sixteen byte errors in the codeword can be corrected during its decoding in the M/H receiver. An “erasure” method of LRS decoding is used to secure such performance. The results of previous decoding of bit-wise FEC coding can be processed to locate byte-errors for erasure decoding of the (204, 188) LRS codewords. If byte errors in a (204, 188) LRS codeword have to be located internally, from within the codeword itself, only up to eight byte errors in the codeword can be corrected during its decoding in the M/H receiver. Sustained burst noise extending for as many as eight rows of the 204-byte-wide data field can still be corrected by the decoder for (204, 188) LRS codewords.

The nature of the convolutional byte interleaving by each of the byte interleavers 31 and 83 is such that sustained burst noise extending for as many as sixty-four rows of bytes in the MPE data field will cause no more than sixty-four byte errors in any (255, 191) TRS codeword. If byte errors in a (255, 191) TRS codeword are located internally, within the codeword itself, only up to thirty-two byte errors in the codeword can be corrected during its decoding in the M/H receiver. However, if byte errors in a (255, 191) TRS codeword are located externally to the codeword, as many as sixty-four byte errors in the codeword can be corrected during its decoding in the M/H receiver. The results of previous decoding of bit-wise FEC coding can be processed to locate byte-errors for erasure decoding of the (255, 191) TRS codewords. Alternatively, the results of decoding (204, 188) LRS codewords can be used to locate byte-errors for decoding (255, 191) TRS codewords. The results of decoding (204, 188) RS codewords can also be used to refine the locations of byte-errors for decoding (255, 191) TRS codewords, as determined by processing the results of previous decoding of bit-wise FEC coding. Another alternative is to use the results of decoding CRC coding of IP packets to locate byte-errors for decoding (255, 191) TRS codewords or to refine the locations of byte-errors for such decoding. Data-randomized IP packets can be extracted from IPE packets recovered from the results of decoding (204, 188) LRS codewords. The data-randomized IP packets are then de-randomized so the CRC coding of the IP packets can be decoded for determining which IP packets certainly contain erroneous bytes.

FIG. 11 shows apparatus for generating PCCC components and subsequent COFDM signals subsequently transmitted over the air for reception by M/H receivers. The output port of the convolutional byte interleaver 86 shown in FIG. 10 is connected for supplying the response therefrom to the respective input ports of selectors 87 and 88 shown in FIG. 11. The selector 87 selectively responds to the convolutionally byte-interleaved (204, 188) LRS codewords of odd-numbered time-slices supplied to its input port, reproducing them in bit-serial form at its output port. The selector 88 selectively responds to the convolutionally byte-interleaved (204, 188) LRS codewords of even-numbered time-slices supplied to its input port, reproducing them in bit-serial form at its output port.

The bit-serial, convolutionally byte-interleaved (204, 188) RS codewords of odd-numbered time-slices supplied from the output port of the selector 87 are supplied to the input port of a bits de-interleaver 89. The output port of the bits de-interleaver 89 is connected for supplying bit de-interleaved response to the input port of a CC encoder 90 for one-half-rate convolutional coding (CC). The output port of the CC encoder 90 is connected for supplying one-half-rate CC to the input port of a symbols interleaver 91. The bits de-interleaver 89 and the symbols interleaver 91 cooperate to provide coded (or “implied”) interleaving of the data bits and parity bits of the CC from the output port of the symbols interleaver 91. The symbols interleaver 91 interleaves half-nibble symbols in a way complementary to the way that the bits de-interleaver 89 de-interleaved data bits supplied to the CC encoder 90 for one-half-rate convolutional coding. Accordingly, data bits appear in their original order in the symbol-interleaved one-half-rate CC supplied from the output port of the symbol interleaver 91 to a first of two input ports of a time-division multiplexer 92 for odd-numbered and even-numbered coded time-slices.

The bit-serial, convolutionally byte-interleaved (204, 188) LRS codewords of even-numbered time-slices supplied from the output port of the selector 88 are delayed by delay memory 93 for application to the input port of a CC encoder 94 for one-half-rate convolutional coding (CC). The CC encoder 94 is similar in construction and operation to the CC encoder 90. The output port of the CC encoder 94 is connected for supplying one-half-rate CC to the second input port of the time-division multiplexer 92 for odd-numbered and even-numbered coded time-slices. The delay introduced by the delay memory 93 compensates for the latent delays in the bits de-interleaver 89 and the symbols interleaver 91. Accordingly, the even-numbered coded time-slices supplied from the output port of the CC encoder 94 to the second input port of the time-division multiplexer 92 interleave in time with the odd-numbered coded time-slices that the symbols interleaver 91 supplies to the second input port of the time-division multiplexer 92.

The output port of the time-division multiplexer 92 is connected for supplying the multiplexed odd-numbered and even-numbered coded time-slices to the input port of a constellation mapper 95 for 64QAM. The nature of the preferred square 64QAM symbol constellations and the Gray mapping used in them are disclosed in detail in the above-referenced U.S. patent application Ser. No. 13/493,198 filed 11 Jun. 2012. The output port of the constellation mapper 95 is connected to the input port of a parser 96 for effective OFDM symbol blocks. The block parser 96 parses a stream of complex samples supplied from the constellation mapper 95 into uniform-length sequences of complex samples, each of which sequences is associated with a respective effective OFDM symbol. The output port of the block parser 96 is connected to a first input port of a pilot and TPS signal insertion unit 97, a second input port of which unit 97 is connected to receive Transmission Parameters Signaling (TPS) bits from a TPS signal generator 98. The pilot and TPS signal insertion unit 97 inserts these TPS bits, which are to be transported by dedicated carriers (TPS Pilots), into each effective OFDM symbol block. The pilot and TPS signal insertion unit 97 inserts other bits descriptive of unmodulated carriers of predetermined amplitude and predetermined phase into each effective OFDM symbol block. An output port of the pilot and TPS signal insertion unit 97 is connected for supplying the effective OFDM symbol blocks with pilot carriers inserted therein to the input port of an OFDM modulator 99. The OFDM modulator 99 has 4K carriers capability, suitable for transmissions to M/H DTV receivers.

The OFDM modulator 99 includes a serial-to-parallel converter for converting the serially generated complex digital samples of the effective OFDM symbols to parallel complex digital samples for inverse discrete Fourier transformation (I-DFT). The OFDM modulator 99 further includes a parallel-to-serial converter for converting the parallel complex digital samples of the I-DFT results to serial complex digital samples of the I-DFT results supplied from the output port of the OFDM modulator 99 to the input port of a guard-interval-and-cyclic-prefix-insertion unit 100. The output port of the unit 100 is connected for supplying successive complex digital samples of a COFDM signal to a fourth input port of the all-services multiplexer 17.

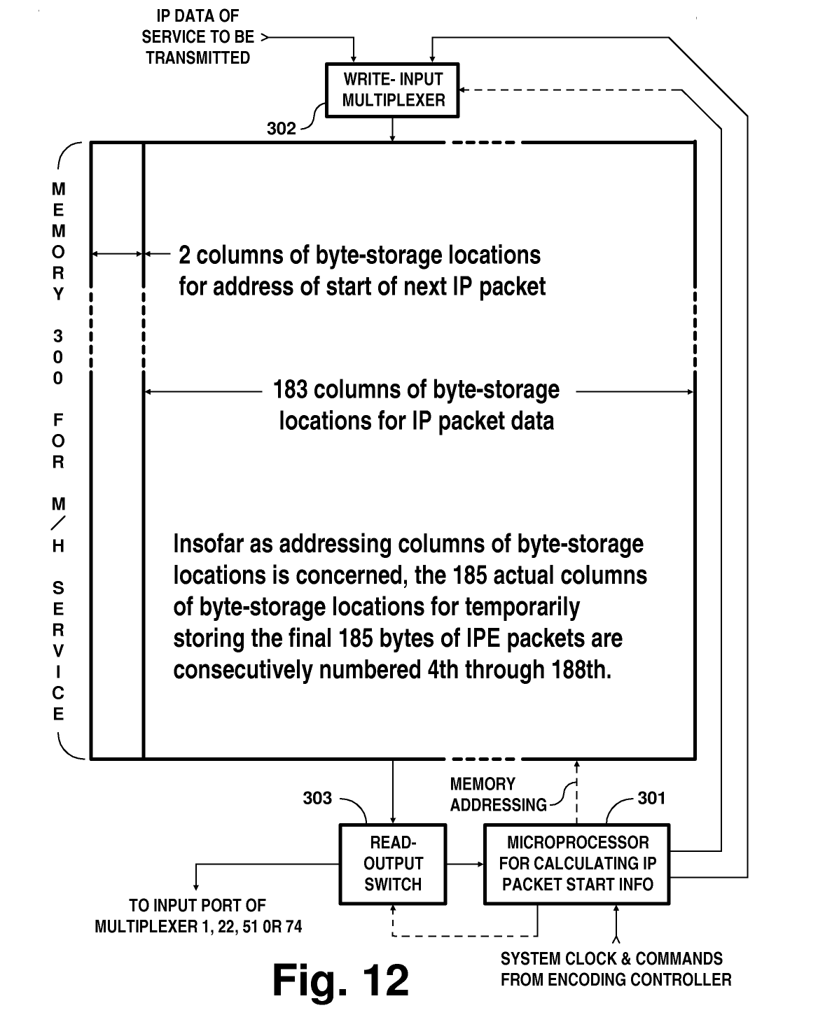

FIG. 12 depicts a memory 300 for replacing any one of the data-storage memories in FIGS. 1, 3, 8 and 10. FIG. 12 shows in more detail the connections of such memory 300 with a respective microprocessor 301 that generates the write addressing and the read addressing for the memory 300. The microprocessor 301 also calculates the addresses of byte-storage locations in the memory 300 that store the initial bytes of IP packets, which are written into the memory 300 so as to appear as the fourth and fifth bytes of IPE packets to be generated from read-out from the memory 300. Explanation of this operation is the principal reason for including FIGS. 12, 13 and 14 in the drawings. DTV receivers can then use the fourth and fifth bytes of IPE packets to parse IP packets without having to rely on daisy-chain operation through a time-slice, which sort of operation is prone to disruption by burst noise.

The memory 300 is considered to be byte-organized, with addressable storage locations for 8-bit bytes. FIG. 12 shows these byte-storage locations arranged, 185 to a row, in successive rows. The addressing regime may be one comprising a row address component and a modulo-185 column address component, for example. A respective memory 300 can replace each of the RAMs 23, 24, 25, 26 et cetera in FIG. 3, in which case the number of rows in each memory 300 is sufficient to store the IP packets in a time-slice. A respective memory 300 can replace each of the RAMs 75, 76, 77, 78 et cetera in FIG. 10, in which case the number of rows in each memory 300 is sufficient to store the IP packets in (N+1) time-slices. If transmissions to stationary receivers employ internet protocol, a respective memory 300 can replace each of the RAMs 4, 5, 6 et cetera in FIG. 1, in which case the number of rows in each memory 300 is sufficient to store the IP packets in a frame of eight time-slices. If iterative-diversity transmissions to stationary receivers employ internet protocol, a respective memory 300 can replace each of the RAMs 52, 53, 54 et cetera in FIG. 8, in which case the number of rows in each memory 300 is sufficient to store the IP packets in (N+1) frames.

The memory 300 has a random-access write-input port connected for receiving write-input signal from the output port of a write-input multiplexer 302, which multiplexer 302 is controlled by control signal from the microprocessor 301. The write-input multiplexer 302 has a first of two input ports connected for receiving IP data for a service to be transmitted. The write-input multiplexer 302 has its second input port connected for receiving from the microprocessor 301 the addresses of byte-storage locations in the memory 300 that store the initial bytes of IP packets. At selected times, the control signal from the microprocessor 301 conditions the write-input multiplexer 302 to reproduce from its output port the IP data for the service to be transmitted. At those selected times the microprocessor 301 enables writing of the memory 300 and supplies the memory 300 with suitable write addressing for writing IP data into successive rows of byte-storage locations in the memory 300.

The memory 300 has a random-access read-output port connected for supplying read-output signal to the input port of a read-output switch 303, which switch 303 is controlled by control signal from the microprocessor 301. The read-output switch 303 has a first of two output ports connected for supplying read-output signal to an input port of the multiplexer 1 in FIG. 1, of the multiplexer 22 in FIG. 3, of the multiplexer 51 in FIG. 8 or of the multiplexer 74 in FIG. 10. The read-output switch 303 has its second output port connected for supplying the microprocessor 301 with selected read-out signal. Each time the byte-storage locations in the memory 300 are completely re-written, this is followed by the microprocessor 301 performing procedures to calculate the addresses of byte-storage locations in the memory 300 that store the initial bytes of IP packets, and then to write these addresses into the memory 300 so as to appear as the fourth and fifth bytes of IPE packets to be generated from read-out from the memory 300 to an input port of the multiplexer 1 in FIG. 1, of the multiplexer 22 in FIG. 3, of the multiplexer 51 in FIG. 8 or of the multiplexer 74 in FIG. 10.

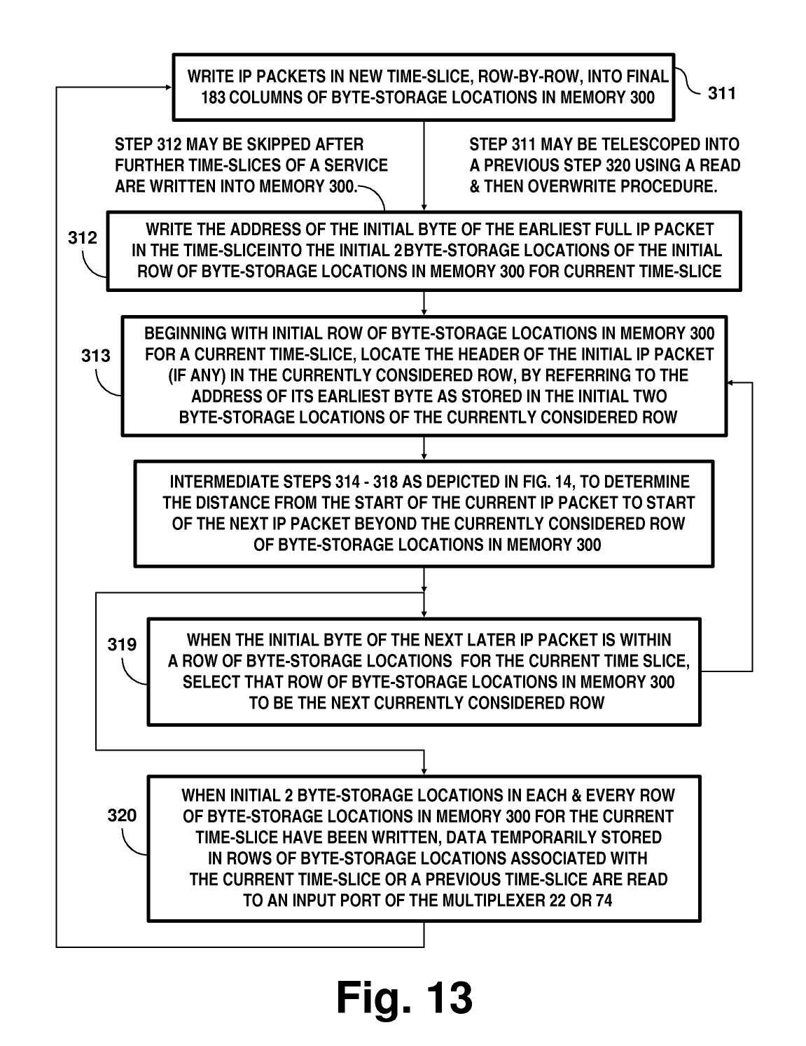

FIG. 13 is an informal flow chart of typical overall operation of the microprocessor 301 depicted in FIG. 12. In an initial step 311 of this overall operation, the IP packets for a time-slice are written row-by-row into the final 183 columns of byte-storage locations in the memory 300. The addressing of columns of byte-storage locations in the memory 300 is presumed to be done on a modulo-188 basis, so as to map to each row of byte-storage locations a group of 185 successive bytes as they will appear concluding respective IPE packets, each having a respective initial 3-byte header. During step 311, the microprocessor 301 generates control signal for the write-input multiplexer 302 that conditions the multiplexer 302 to apply to the write-input port of the memory 300 data from a time-slice of a service to be transmitted. The microprocessor 301 also generates write-enable signal and write addressing supplied to the memory 300 during step 311 and during a second step 312 of overall operation.

In the second step 312 of overall operation, the microprocessor 301 writes the address of the initial byte of the earliest IP packet in the time-slice into the initial two byte-storage locations in the initial row of byte-storage locations in the memory 300 that temporarily store the IP packets of the time-slice written in step 311. For example, if the initial IP packet starts in the byte-storage location with “sixth” modulo-188 columnar address in the first row of byte-storage locations, the byte-storage locations with “fourth” and “fifth” modulo-188 columnar addresses in that first row will be written to temporarily store 0000 0000 0000 1010. The address of the initial byte of the earliest IP packet in the time-slice may be provided to the microprocessor 301 from an IP packet sniffer responding to the IP-packet transport stream of the service to be temporarily stored in the memory 300. During step 312, the microprocessor 301 generates control signal for the write-input multiplexer 302 that conditions the multiplexer 302 to apply to the write-input port of the memory 300 the address of the initial byte of the earliest IP packet in the time-slice as supplied from an output port of the microprocessor 301. After an initial time-slice in a series of successive time-slices for the same service to be transmitted, the microprocessor 301 may skip step 312 for the succeeding time-slices.

In a succeeding step 313 of overall operation, the initial row of byte-storage locations in the memory 300 that temporarily store the IP packets of the current time-slice is the currently considered row. In the step 313 the microprocessor 301 locates the header of the initial IP packet, if any, in the currently considered row of byte-storage locations. This is done by referring to the address of the earliest byte of that initial IP packet temporarily stored in the initial two byte-storage locations of the currently considered row, those locations with “fourth” and “fifth” modulo-188 columnar addresses. In subsequent procedural steps 314-319 the microprocessor 301 uses this stored address as the basis for subsequent daisy-chain computation of the addresses of the initial bytes of subsequent IP packets in the time-slice. The microprocessor 301 generates read-enable signal and read addressing supplied to the memory 300 during selective reading therefrom during procedural steps 313 and 314. During step steps 313 and 314 the microprocessor 301 generates control signal for the read-output switch 303 that conditions the read-output switch 303 to route read-out from the memory 300 to an input port of the microprocessor 301.

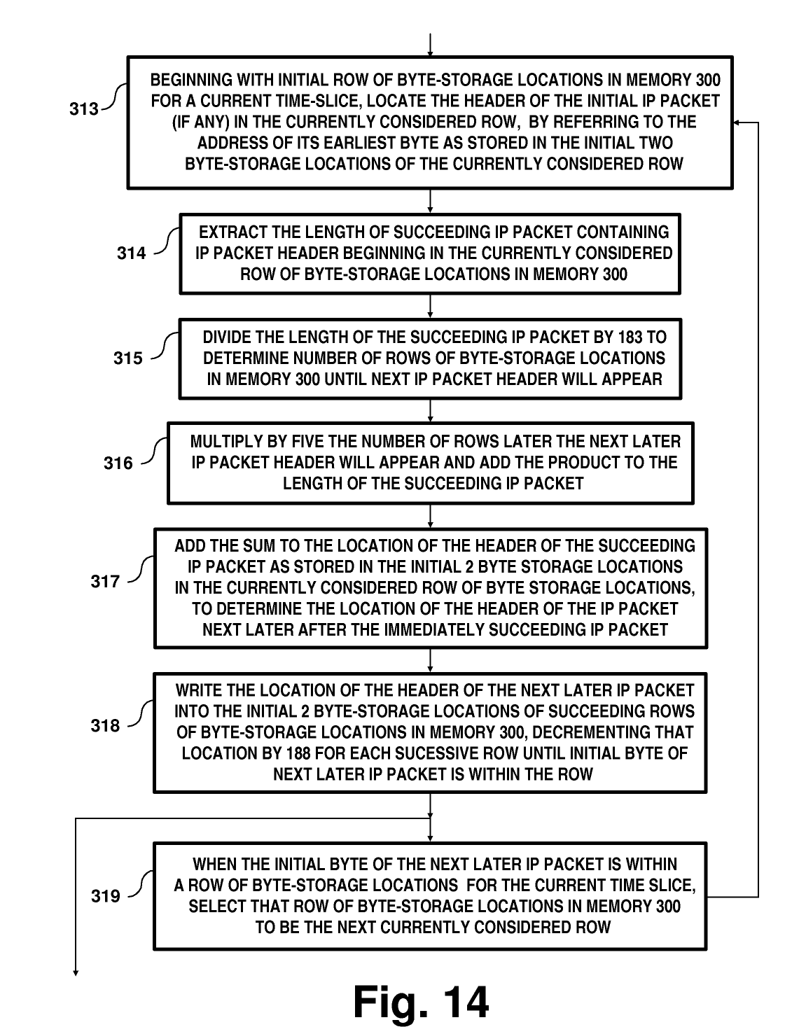

FIG. 14 is an informal flow chart showing in detail the successive procedural steps 314-319 the microprocessor 301 performs in the daisy-chain computation of the addresses of the initial bytes of subsequent IP packets in the time-slice. This daisy-chain computation being performed at the DTV transmitter, rather than in DTV receivers, is not prone to corruption by burst noise arising in over-the-air transmission channels.

In procedural step 314 the microprocessor 301 extracts the length in byte epochs of any succeeding IP packet beginning its header at the stored address in the initial two byte-storage locations in the currently considered row. This length appears in the third and fourth bytes of the IP packet header. Then, in procedural step 315 the microprocessor 301 divides the length in byte epochs of any succeeding IP packet by 183 to determine the number of rows of byte-storage locations in the memory 300 until the header of the next IP packet will appear. In a compound procedural step 316 the microprocessor 301 multiplies this number of rows by five, then adds the product to the length of the succeeding IP packet to generate a sum. This sum accounts for the addressed byte-storage locations (three of which are virtual in character) skipped over in writing IP packets into rows of byte-storage locations in the memory 300. In a subsequent procedural step 317 the microprocessor 301 adds this sum to the stored address in the initial two byte-storage locations in the currently considered row, thus to determine the distance in byte epochs to the initial byte of the succeeding IP packet from the beginning of the IP packet data field in the currently considered row of byte-storage locations in memory 300.

In a subsequent compound procedural step 318, the microprocessor 301 calculates the distances in byte epochs to the initial byte of the succeeding IP packet from the beginnings of the IP packet data fields in rows of byte-storage locations in memory 300 after the currently considered one. In step 318 the microprocessor 301 decrements the distance to the initial byte of the succeeding IP packet from the beginning of the IP packet data field in the currently considered row of byte-storage locations in memory 300 by 188 per row to determine these distances. The microprocessor 301 writes each decremented distance into the initial two byte-storage locations of the next row of byte-storage locations in memory 300. During its writing of selected byte-storage locations within the memory 300 in step 318, the microprocessor 301 generates control signal for the write-input multiplexer 302 that conditions the multiplexer 302 to connect an output port of the microprocessor 301 to the write-input port of the memory 300. The microprocessor 301 also generates write-enable signal and write addressing supplied to the memory 300 during step 318. The microprocessor 301 concludes this step 318 when the initial byte of the succeeding IP packet is within a next row of byte-storage locations in memory 300. The decremented distance written into the initial two byte-storage locations of this next row of byte-storage locations is reduced to no more than 183 byte epochs.

If this next row of byte-storage locations is still within the current time-slice, the microprocessor 301 performs procedural step 319. In step 319 the microprocessor 301 loops back operation to step 313 after selecting the row in which the decremented distance has been reduced to no more than 183 byte epochs as the next currently considered row in step 313. However, the next row of byte-storage locations in memory 300 in which the decremented distance is reduced to no more than 183 byte epochs in the initial byte thereof is sometimes within the time-slice next after the current time-slice. The initial two byte-storage locations in each and every row of byte-storage locations within memory 300 for the current time-slice will have been written, as well as possibly one or more rows of byte-storage locations within memory 300 for the time-slice next after the current time-slice. In such case operation does not loop back to step 313.

When the initial two byte-storage locations in each and every row of byte-storage locations within memory 300 for the current time-slice have been written, the microprocessor 301 institutes procedural step 320. In step 320 the microprocessor 301 arranges for the contents temporarily stored in the rows of byte-storage locations for the current time-slice (or for a previous time-slice) to be read from the memory 300 to an input port of the multiplexer 22 or 74. The microprocessor 301 generates read-enable signal and read addressing supplied to the memory 300 during this reading out of a time-slice during step 320. During step 320 the microprocessor 301 generates control signal for the read-output switch 303 that conditions the read-output switch 303 to apply the final 185 bytes of each IPE packet read from the memory 300 to the input port of the multiplexer 22 or 74. A previous time-slice is read from the memory 300 in each step 320 if the memory 300 is twice read to support repeated transmission of time-slices in support of iterative-diversity reception. If a time-slice is not to be repeated in support of iterative-diversity reception, a current time-slice can be read from the memory 300 in each step 320, so the number of rows of byte-storage locations in the memory 300 can be minimal.

After a time-slice is read from the memory 300 to an input port of the multiplexer 22 or 74 in step 320, the microprocessor 301 loops overall operation back to the procedural step 311 to write a new time-slice into the memory 300. In a variant of the described operation, the memory 300 is operated in a read-and-then-overwrite mode that telescopes the procedural step 311 of writing the memory 300 with a new time-slice into the procedural step 320 of reading a previous time-slice from the memory 300.

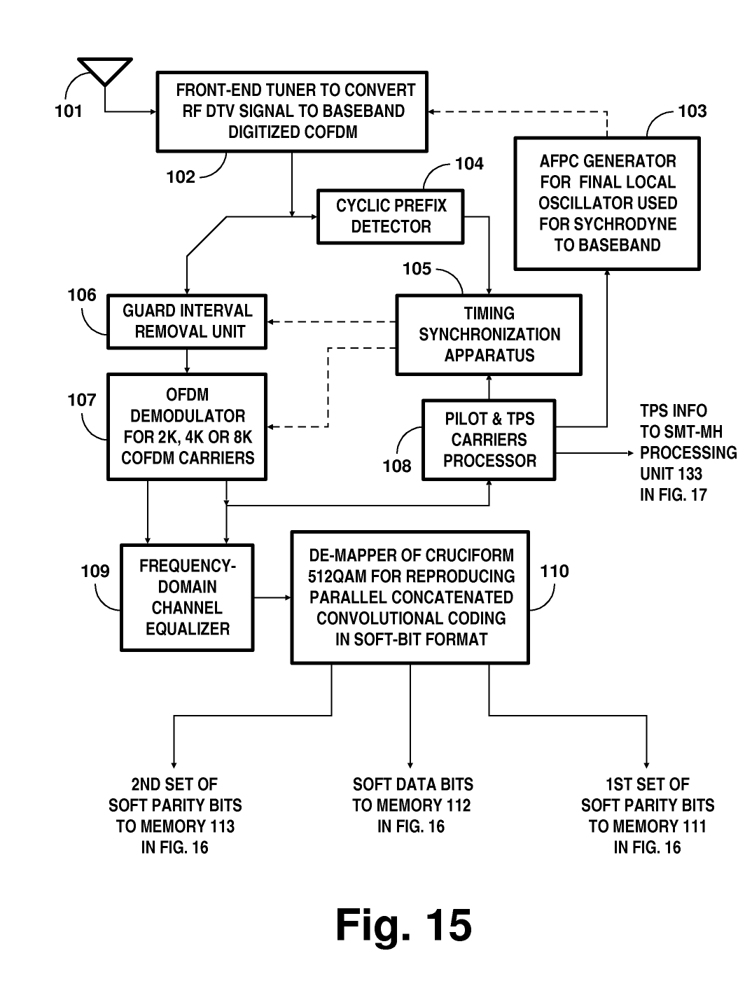

FIG. 15 shows the initial portion of a receiver designed for stationary reception of COFDM signals as transmitted at VHF or UHF by the portions of the DTV transmitter depicted in FIGS. 1 and 2. A reception antenna 101 captures the radio-frequency COFDM signal for application as input signal to a front-end tuner 102 of the receiver. Typically, the front-end tuner 102 is of a double-conversion type composed of initial single-conversion super-heterodyne receiver circuitry for converting radio-frequency (RF) COFDM signal to intermediate-frequency (IF) COFDM signal followed by circuitry for performing a final conversion of the IF COFDM signal to baseband COFDM signal. The initial single-conversion receiver circuitry typically comprises a tunable RF amplifier for RF COFDM signal incoming from the reception antenna, a tunable first local oscillator, a first mixer for heterodyning amplified RF COFDM signal with local oscillations from the first local oscillator to obtain the IF COFDM signal, and an intermediate-frequency (IF) amplifier for the IF COFDM signal. Typically, the front-end tuner 102 further includes a synchronous demodulator for performing the final conversion from IF COFDM signal to baseband COFDM signal and an analog-to-digital converter for digitizing the baseband COFDM signal. Synchronous demodulation circuitry typically comprises a final local oscillator with automatic frequency and phase control (AFPC) of its oscillations, a second mixer for synchrodyning amplified IF COFDM signal with local oscillations from the final local oscillator to obtain the baseband COFDM signal, and a low-pass filter for suppressing image signal that otherwise would accompany the baseband COFDM signal. FIG. 15 shows an AFPC generator 103 for generating the automatic frequency and phase control (AFPC) signal for controlling the final local oscillator within the front-end tuner 102. In some designs of the front-end tuner 102, synchronous demodulation is performed in the analog regime before subsequent analog-to-digital conversion of the resulting complex baseband COFDM signal. In other designs of the front-end tuner 102 analog-to-digital conversion is performed before synchronous demodulation is performed in the digital regime.

Simply stated, the front-end tuner 102 converts radio-frequency COFDM signal received at its input port to digitized samples of baseband COFDM signal supplied from its output port. Typically, the digitized samples of the real component of the baseband COFDM signal are alternated with digitized samples of the imaginary component of the baseband COFDM signal for arranging the complex baseband COFDM signal in a single stream of digital samples.

The output port of the front-end tuner 102 is connected for supplying digitized samples of baseband COFDM signal to the input port of a cyclic prefix detector 104. The cyclic prefix detector 104 differentially combines the digitized samples of baseband COFDM signal with those samples as delayed by the duration of an effective COFDM symbol. Nulls in the difference signal so generated should occur, marking the guard intervals of the baseband COFDM signal. The nulls are processed to reduce any corruption caused by noise and to generate sharply defined indications of the phasing of COFDM symbols. The output port of the cyclic prefix detector 104 is connected to supply these indications to a first of two input ports of timing synchronization apparatus 105.

A first of two output ports of the timing synchronization apparatus 105 is connected for supplying gating control signal to the control input port of a guard-interval-removal unit 106, the signal input port of which is connected for receiving digitized samples of baseband COFDM signal from the output port of the front-end tuner 102. The output port of the guard-interval-removal unit 106 is connected for supplying the input port of an OFDM demodulator 107 with windowed portions of the baseband COFDM signal that contain effective COFDM samples. A second of the output ports of the timing synchronization apparatus 105 is connected for supplying the OFDM demodulator 107 with synchronizing information concerning the effective COFDM samples. The indications concerning the phasing of COFDM symbols that the cyclic prefix detector 104 supplies to the timing synchronization apparatus 105 is sufficiently accurate for initial windowing of the baseband COFDM signal that the guard-interval-removal unit 106 supplies to the OFDM demodulator 107.

A first output port of the OFDM demodulator 107 is connected for supplying demodulated pilot carrier information to the input port of a pilot and TPS carriers processor 108. The information concerning unmodulated pilot carriers is processed in the processor 108 to support more accurate windowing of the baseband COFDM signal that the guard-interval-removal unit 106 supplies to the OFDM demodulator 107. Such processing can be done similarly to the way described by Nicole Alcouffe in US-20030138060-A1 published 24 Jul. 2003 with the title “COFDM demodulator with an optimal FFT analysis window positioning”, for example. A first of four output ports of the pilot and TPS carriers processor 108 is connected for supplying more accurate window positioning information to the second input port of the timing synchronization apparatus 105.

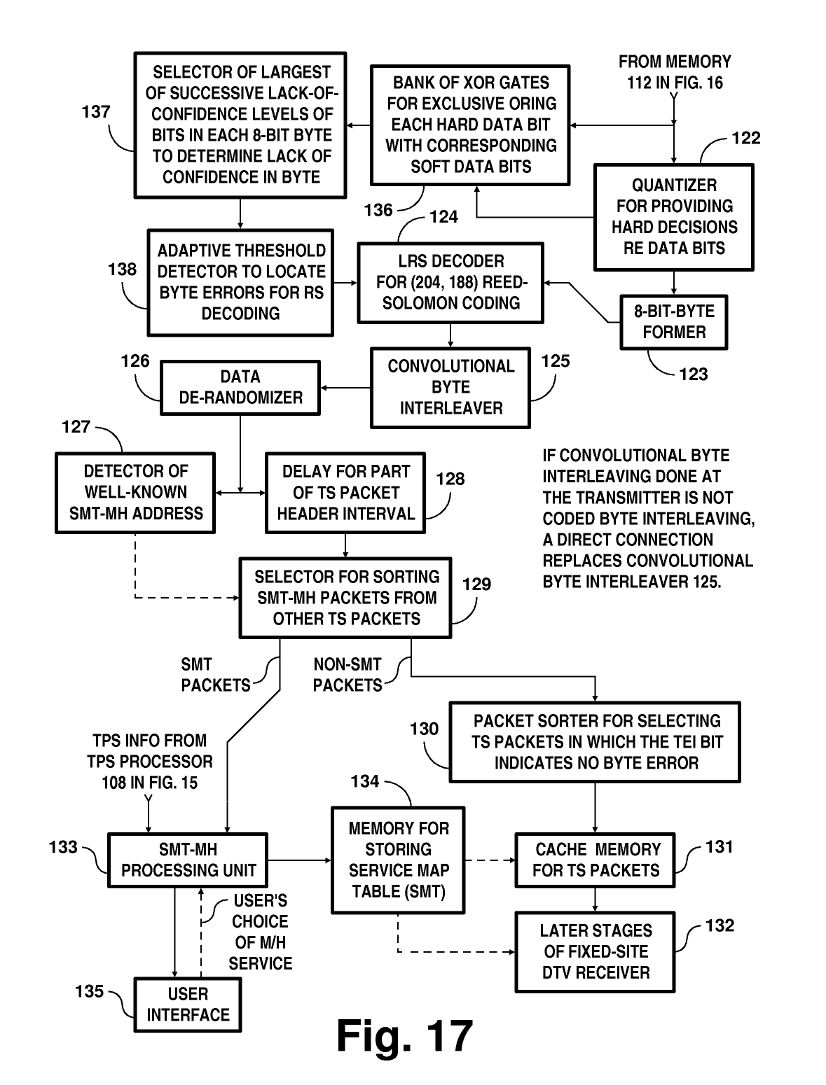

The pilot and TPS carriers processor 108 demodulates the TPS information conveyed by modulated pilot signals. The second output port of the pilot and TPS carriers processor 108 is connected for supplying the TPS information to an SMT-MH processing unit 133 shown in FIG. 17.

The third output port of the pilot and TPS carriers processor 108 is connected for forwarding unmodulated pilot carriers to the input port of the AFPC generator 103. The real components of the unmodulated pilot carriers are multiplied by their respective imaginary components in the AFPC generator 103. The resulting products are summed and low-pass filtered to develop the AFPC signal that the AFPC generator 103 supplies to the front-end tuner 102 for controlling the final local oscillator therein. Other ways of developing AFPC signals for the final local oscillator in the front-end tuner 102 are also known, which can replace or supplement the method described above. One such other way is described in U.S. Pat. No. 5,687,165 titled “Transmission system and receiver for orthogonal frequency-division multiplexing signals, having a frequency-synchronization circuit”, which was granted to Flavio Daffara and Ottavio Adami on 11 Nov. 1997. That patent describes complex digital samples from the tail of each OFDM symbol being multiplied by the conjugates of corresponding digital samples from the cyclic prefix of the OFDM symbol. The resulting products are summed and low-pass filtered to develop the AFPC signal that the AFPC generator 103 supplies to the front-end tuner 102 for controlling the final local oscillator therein.

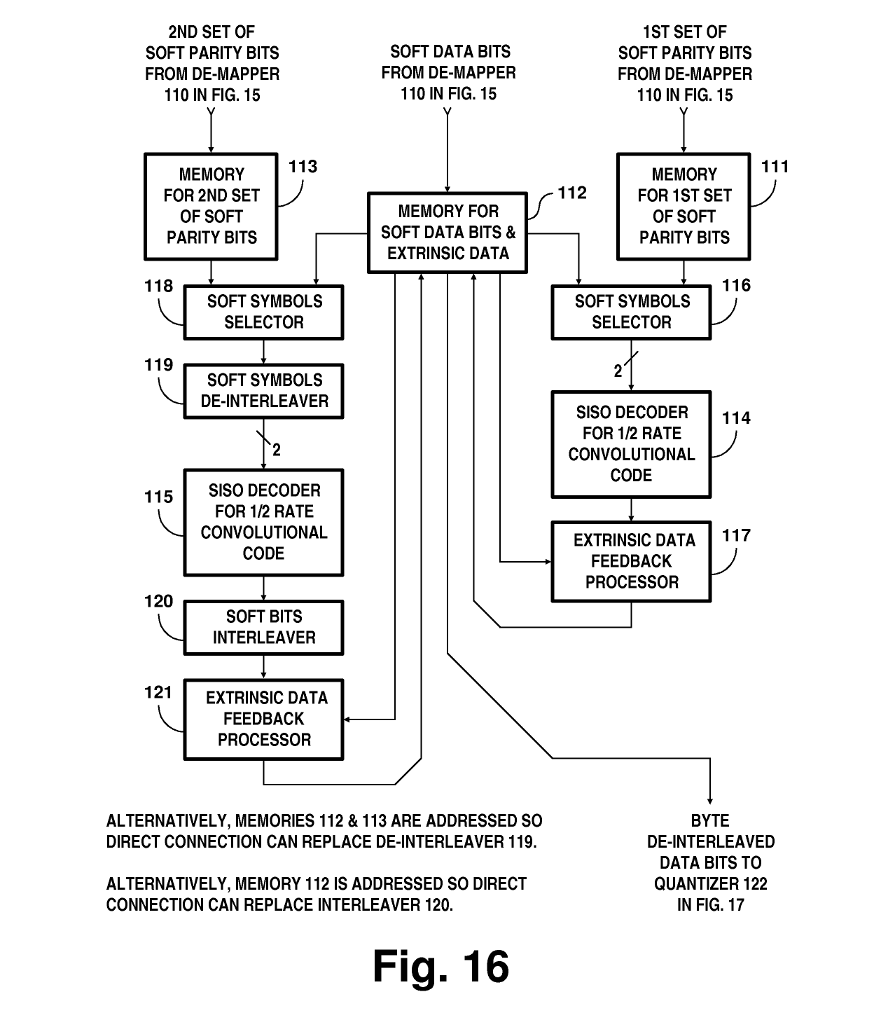

The fourth output port of the pilot and TPS carriers processor 108 is connected for supplying information concerning the respective energies of unmodulated pilot carriers. This information is used for maximal-ratio code combining to be performed in the FIG. 16 portion of the receiver.

A second output port of the OFDM demodulator 107 is connected to supply demodulated complex digital samples of 256QAM to a first input port of a frequency-domain channel equalizer 109. FIG. 15 shows the frequency-domain channel equalizer 109 having a second input port connected for receiving pilot carriers supplied from the first input port of the OFDM demodulator 107. A simple form of frequency-domain channel equalizer 109 measures the amplitude of the unmodulated pilot carriers to determine basic weighting coefficients for various portions of the frequency spectrum. The carriers conveying convolutional coding in QAM format are then multiplied by respective weighting coefficients determined by interpolation among the basic weighting coefficients determined by measuring the amplitudes of the unmodulated pilot carriers. Various alternative types of frequency-domain channel equalizer are also known. As thusfar described, the FIG. 15 initial portion of a COFDM receiver is similar to the initial portions of COFDM receivers used for DVB in Europe.

The output port of the channel equalizer 109 is connected for supplying equalized carriers conveying convolutional coding in QAM format to the input port of a de-mapper 110 for cruciform 512QAM symbol constellations. Preferably, the Gray mapping of the de-mapper 110 is such that the data bits of the PCCC change value with smaller changes in spatial frequency than the parity bits of the PCCC. The de-mapper 110 is operable for reproducing at output ports thereof soft decisions regarding the successive bits of the one-third-code-rate PCCC generated by the PCCC encoder 10 in the FIG. 2 portion of the DTV transmitter. Preferably, the de-mapper 110 generates these bit-soft decisions in the log-likelihood-ratio (LLR} format, or approximations thereto which are also suitable for subsequent turbo decoding. A way of generating bit-soft decisions that closely adhere to the LLR format is described in U.S. Pat. No. 6,907,084 granted 14 Jun. 2005 to Gibong Jeong and titled “Method and apparatus for processing modulation symbols for soft input decoders”. U.S. Pat. No. 7,076,000 granted 11 Jul. 2006 to Michael J. Rodriguez and titled “Soft-decision metric generation for higher order modulation” describes a simple method of de-mapping Gray-mapped QAM symbol constellations. One way of generating bit-soft decisions that approximate the LLR format is described in U.S. Pat. No. 7,139,335 granted 21 Nov. 2006 to Thomas J. Kolze and titled “Optimal decision metric approximation in bit-soft decisions”. Another way of generating bit-soft decisions that approximate the LLR format is described in U.S. Pat. No. 7,480,342 titled “Soft value calculation for multilevel signals”, which was granted 20 Jan. 2009 to Leif Wilhelmsson and Peter Maim.

The first output port of the de-mapper 110 is connected for supplying a first set of soft parity bits from the de-mapped PCCC to a memory 111 depicted in FIG. 16. The hard-decision bits in this first set of soft parity bits reproduce parity bits from the delay memory 47 depicted in FIG. 5, from the CC encoder 44 depicted in FIG. 6, or from the symbols interleaver 50 depicted in FIG. 7. The second output port of the de-mapper 110 is connected for supplying data bits from the de-mapped PCCC to a memory 112 depicted in FIG. 16. The third output port of the de-mapper 110 is connected for supplying a second set of soft parity bits from the de-mapped PCCC to a memory 113 depicted in FIG. 16. The hard-decision bits in this second set of soft parity bits reproduce parity bits as interleaved by the bits interleaver 45 depicted in FIG. 5, 6 or 7 as being included in the PCCC encoder 10 of the FIG. 2 portion of the DTV.

The memories 111, 112 and 113 together temporarily store all the components of the PCCC for a given service to be received by the stationary DTV receiver depicted in FIGS. 15, 16 and 17. The memory 112 also temporarily stores soft extrinsic data bits determined during the subsequent turbo decoding procedures. The PCCC is turbo decoded by soft-input/soft-output decoders 114 and 115 in FIG. 16, which preferably employ the sliding-window log-MAP algorithm. The term “log-MAP” is short for “logarithmic maximum a posteriori”. During the initial half of each cycle of turbo decoding, the SISO decoder 114 decodes one-half-rate CC that includes soft parity bits from an even-numbered time-slice of the service being received. During the final half of each cycle of turbo decoding, the SISO decoder 115 decodes one-half-rate CC that includes soft parity bits from an odd-numbered time-slice of the service being received. The soft data bits that the SISO decoders 114 and 115 supply from their respective output ports as respective decoding results are compared to combined soft data bits and soft extrinsic data bits read from the memory 112. This is done to generate updated soft extrinsic data bits to be written back to the memory 112. At the conclusion of turbo decoding, combined soft data bits and soft extrinsic data bits are read from the memory 112 to supply an ultimate turbo decoding result to the input port of a quantizer 122 shown in FIG. 17.

FIG. 16 shows a soft-symbols selector 116 that selects soft data bits and soft parity bits to be supplied from first and second output ports thereof, respectively, to first and second input ports of the SISO decoder 114 during the initial half of each cycle of turbo decoding. The soft-symbols selector 116 relays soft data bits additively combined with soft extrinsic data bits, if any, as read to a first input port thereof from the memory 112, thus to generate the soft data bits supplied to the first input port of the SISO decoder 114. The soft-symbols selector 116 reproduces the soft parity bits read to a second input port thereof from the memory 113, thus generating the soft parity bits supplied to the second input port of the SISO decoder 114. In actual practice, the soft-symbols selector 116 will usually be incorporated into the structures of the memories 111 and 112.

The soft data bits supplied from the output port of the SISO decoder 114 as decoding results during the initial half of each cycle of turbo decoding are supplied to a first of two input ports of an extrinsic-data-feedback processor 117. The processor 117 differentially combines soft data bits read from the memory 112 with corresponding soft data bits of the SISO decoder 114 decoding results to generate extrinsic data feedback written into the memory 112 to update the soft extrinsic data bits temporarily stored therein.

FIG. 16 shows a soft-symbols selector 118 that selects soft data bits and soft parity bits to be supplied as input soft symbols to a soft-symbols de-interleaver 119. The soft-symbols de-interleaver 119 responds to supply de-interleaved soft data bits and de-interleaved soft parity bits from first and second output ports thereof, respectively, to first and second input ports of the SISO decoder 115 during the final half of each cycle of turbo decoding. The soft symbols selector 118 relays soft data bits additively combined with soft extrinsic data bits, if any, as read to a first input port thereof from the memory 112, thus to generate the soft data bits supplied to the soft-symbols de-interleaver 119. The soft-symbols selector 118 reproduces the soft parity bits read to a second input port thereof from the memory 113, thus to generate the soft parity bits supplied to the soft symbols de-interleaver 119. The de-interleaving provided by soft-symbols de-interleaver 119 complements the bit interleaving provided by the bits interleaver 45 that either of FIGS. 5 and 6 shows being included in the PCCC encoder 10 or 35 of the DTV transmitter.

The soft data bits supplied from the output port of the SISO decoder 115 as decoding results during the final half of each cycle of turbo decoding are supplied to the input port of a soft-bits interleaver 120 in FIG. 16. FIG. 16 shows the output port of the soft-bits interleaver 120 connected to a first of two input ports of an extrinsic data feedback processor 121. The interleaving provided by soft-bits interleaver 120 complements the bit de-interleaving provided by the bits de-interleaver 42 that either of FIGS. 5 and 6 shows being included in the PCCC encoder 10 or 35 of the DTV transmitter. The processor 121 differentially combines soft data bits read to its second input port from the memory 112 with corresponding soft data bits of the soft-bits interleaver 120 response to generate extrinsic data feedback written into the memory 112 to update the soft extrinsic data bits temporarily stored therein.

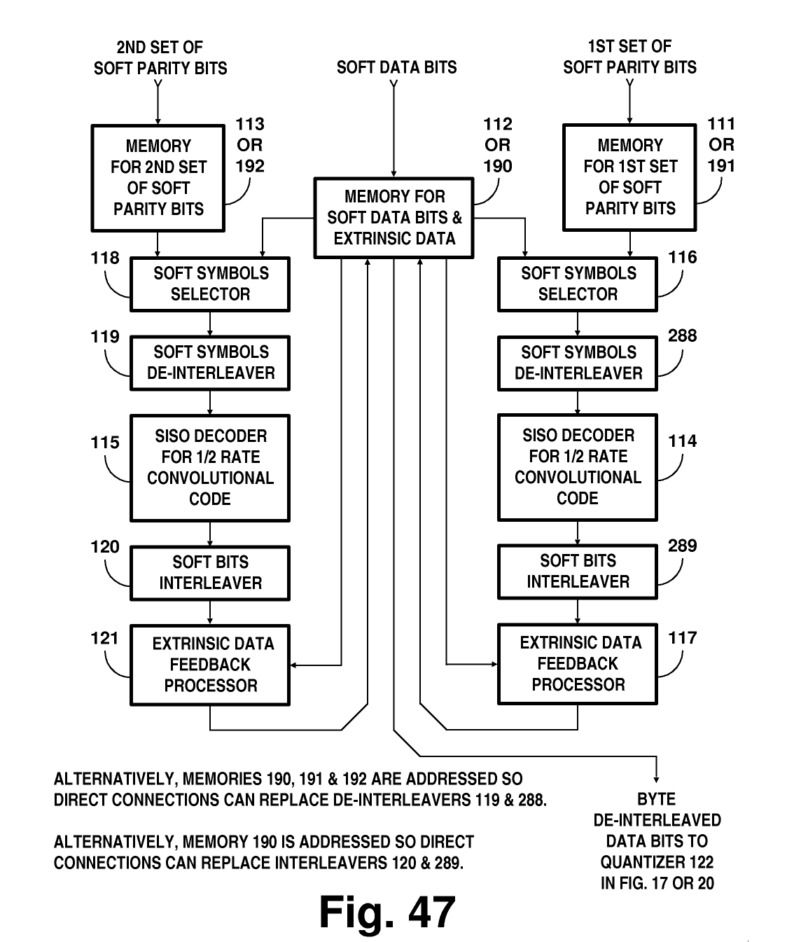

In actual practice, the soft-symbols selector 118 will usually be incorporated into the structures of the memories 112 and 113. The soft-symbols de-interleaver 119 will usually not appear as a separate physical element either. Instead, its function is subsumed into the memories 112 and 113 by suitable addressing of them when reading soft data bits and soft parity bits directly to the first and second input ports of the SISO decoder 115. The soft-bits interleaver 120 need not appear as a separate physical element either, its function being subsumed into the memory 112 by suitable addressing thereof during operation of the extrinsic feedback data processor 121. More particularly, the memory 112 is addressed in de-interleaved bits order during reading of soft data bits including soft extrinsic data from the memory 112 to the second input port of the processor 121; and the memory 112 is addressed in that same de-interleaved bits order during updating of the soft bits of extraneous data temporarily stored therein with soft bits supplied from the output port of the processor 121. Since the operations of the SISO decoders 114 and 115 alternate in time, a single decoder structure is apt be used for implementing both the SISO decoders 114 and 115, as will be described infra with regard to FIG. 47. The foregoing description of turbo decoding describes each cycle as beginning with decoding of an even-numbered time-slice and concluding with the decoding of an odd-numbered time-slice. The order of decoding is arbitrarily chosen, however. Alternatively, turbo decoding can be done with each cycle thereof beginning with decoding of an odd-numbered time-slice and concluding with the decoding of an even-numbered time-slice.

After a last half cycle of the iterative turbo decoding procedure, soft data bits as additively combined with respectively corresponding soft extrinsic data bits are read from the memory 112 to the input port of the quantizer 122 depicted in FIG. 17. The read addressing for the memory 112 is such that soft bits of (204, 188) lateral Reed-Solomon (LRS) coding are read to the input port of the quantizer 122. The output port of the quantizer 122 is connected for supplying hard decisions concerning de-interleaved soft data bits to the input port of an 8-bit-byte former 123. The 8-bit-byte former 123 responds to supply successive 204-byte LRS codewords from its output port to the input port of a LRS decoder 124 for (204, 188) lateral Reed-Solomon (LRS) coding.

FIG. 17 shows the output port of the LRS decoder 124 connected to the input port of a byte re-interleaver 125. The byte re-interleaver 125 performs convolutional byte interleaving similar to that performed by the byte interleaver 9 in FIG. 1 and by the byte interleaver 59 in FIG. 8. FIG. 17 further shows the output port of the byte re-interleaver 125 connected for supplying 188-byte packets to the input port of a data de-randomizer 126, which de-randomizes the final 187 bytes of each of those packets thereby to recover a succession of MPEG-2 transport-stream packets. If the byte de-interleaver 7 in FIG. 1 and the byte de-interleaver 57 in FIG. 8 are not used, the byte re-interleaver 125 is replaced by a direct connection from the output port of the LRS decoder 124 to the input port of the data de-randomizer 126.

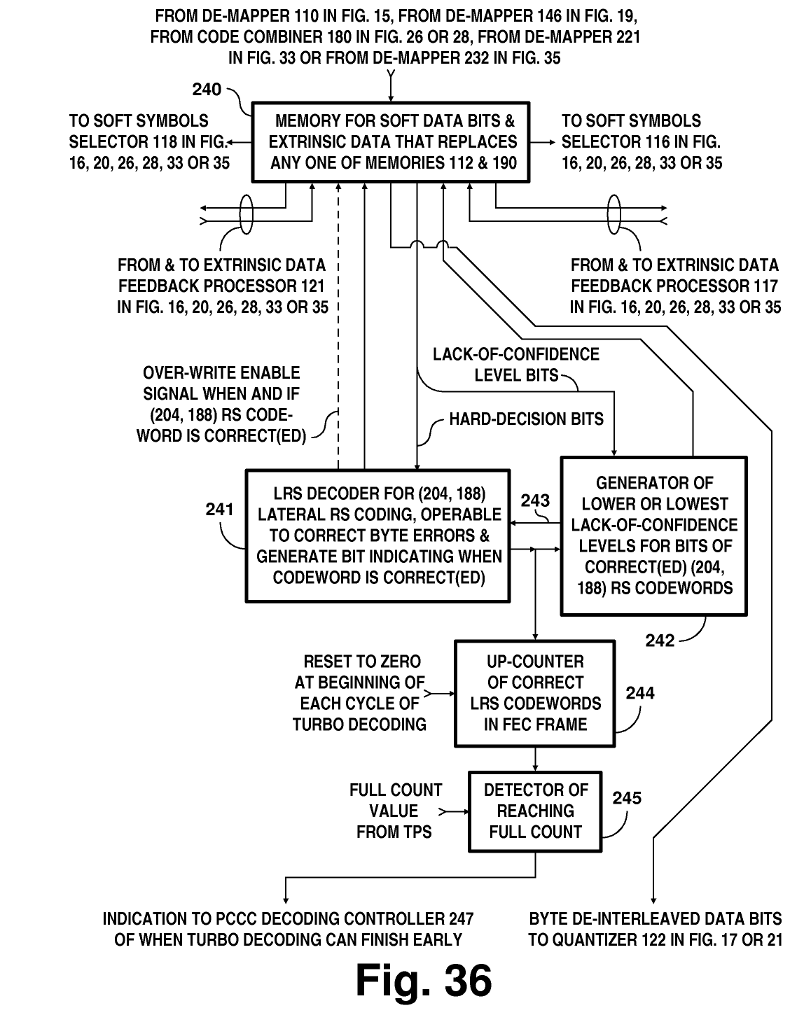

The byte re-interleaver 125 need not appear as separate hardware even if the byte de-interleaver 7 or 57 is used, providing that the LRS decoder 124 is incorporated into the FIG. 16 turbo decoding apparatus. Such incorporation can be done along the lines described further on in this specification, with reference to FIG. 36.

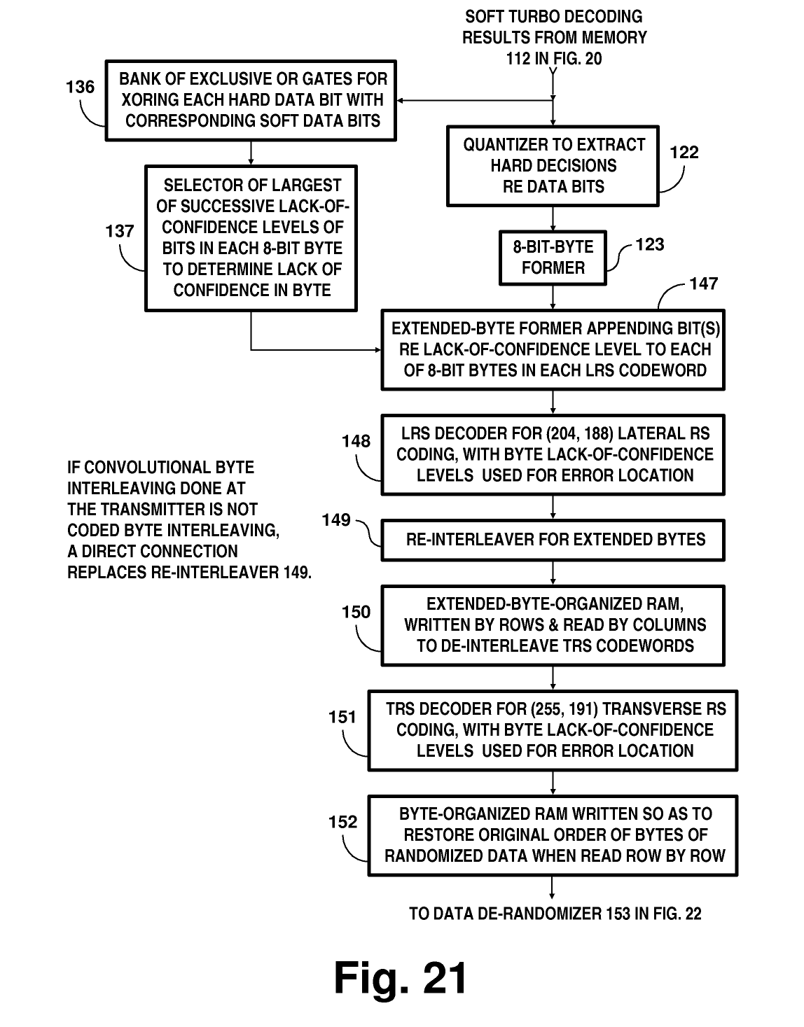

Presuming that the MPEG-2 transport-stream packets for services intended for reception by stationary DTV receivers do not encapsulate IP transport-stream packets, the data de-randomizer 126 supplies the MPEG-2 transport-stream packets it recovers to the input port of a detector 127 of a “well-known” SMT-MH address and to the input port of a delay unit 128. (If the MPEG-2 transport-stream packets for services intended for reception by stationary DTV receivers are IPE packets, the output port of the data randomizer 126 connects instead to the input port of a unit 154 for parsing IP packets and thence to ensuing elements 155-164 similar to those depicted in FIG. 21.) The delay unit 128 delays the MPEG-2 transport-stream (TS) packets supplied to a packet selector 129 for selecting SMT-MH packets from other TS packets. The delay unit 128 provides delay of a part of a TS-packet header interval, which delay is long enough for the detector 127 to ascertain whether or not the “well-known” SMT-MH address is detected.

If the detector 127 does not detect the “well-known” SMT-MH address in the TS packet, the detector 127 output response conditions the packet selector 129 to reproduce the TS packet for application to a packet sorter 130 as input signal thereto. The packet sorter 130 sorts out each TS packet in which the transport-error-indication (TEI) bit is ZERO-valued for writing to a cache memory 131 for TS packets. A ZERO-valued TEI bit in the header of each TS packet will have been toggled to a ONE if the TS packet were not successfully decoded by the RS decoder 124. The cache memory 131 temporarily stores those TS packets in which the TEI bit is ZERO-valued, for possible future reading to the later stages 132 of the receiver.

If the detector 127 does detect the “well-known” SMT-MH address in the TS packet, establishing it to be an SMT-MH packet, the detector 127 output response conditions the packet selector 129 to reproduce the SMT-MH packet for application to an SMT-MH processing unit 133, which includes circuitry for generating control signals for the later stages 132 of the M/H receiver. FIG. 17 shows the SMT-MH processing unit 133 connected for receiving Fast Information Channel (FIC) information from the TPS carriers processor 108 in FIG. 15. The SMT-MH processing unit 133 integrates this FIC information with information from SMT-MH packets during the generation of Service Map Data. The Service Map Data generated by the SMT-MH processing unit 133 is written into memory 134 for temporary storage therein and subsequent application to the later stages 132 of the M/H receiver. The SMT-MH processing unit 133 relays those SMT-MH packets that have ZERO-valued TEI bits to a user interface 135, which typically includes an Electronic Service Guide (ESG) and apparatus for selectively displaying the ESG on the viewing screen of the M/H receiver. A patent application filed for A. L. R. Limberg, published 11 Mar. 2010 as US-2010-0061465-A1, and titled “Sub-channel Acquisition in a Digital Television Receiver Designed to Receive Mobile/Handheld Signals” provides more detailed descriptions of the operations of the portion of an M/H receiver as shown in FIG. 17. The description with reference to the drawing FIGS. 12, 13 and 14 of that application describe operations relying on the SMT-MH tables prescribed by ATSC standard A/153.

In prior-art DTV receivers of COFDM signals, the LRS decoders for (204, 188) LRS coding used decoding algorithms that located byte errors as well as subsequently correcting them. These decoding algorithms are capable of correcting no more than eight byte errors. If the LRS decoder 124 for (204, 188) LRS coding is supplied the locations of byte errors by external means, it can employ an “erasure” decoding algorithm that is capable of correcting up to sixteen byte errors. The soft data bits read to the quantizer 122 from the memory 112 contain confidence-level information that can be analyzed to locate byte errors for the LRS decoder 124.

FIG. 17 shows a representative embodiment of byte-error-location apparatus for determining from the confidence levels of said soft bits of LRS codewords recovered by the turbo decoding apparatus which bytes in each LRS codeword are more likely to be in error. A bank 136 of exclusive-OR gates exclusively-ORs the hard data bit of each soft data bit read from the memory 112 with the remaining bits of that soft bit expressive of the level of confidence that the hard data bit is correct. The result of this operation is the generation of a plurality of bits expressing in absolute terms the level of lack of confidence that the hard data bit is correct. A selector 137 selects the largest level of lack of confidence in the bits of each successive 8-bit byte, to express the lack of confidence in the correctness of the byte considered as a whole. An adaptive threshold detector 138 compares the levels of lack of confidence for each byte in each successive (204, 188) LRS codeword to a threshold value to generate a byte error indication for each byte having a level of lack of confidence that exceeds the threshold value. The adaptive threshold detector 138 adjusts the threshold value for each (204, 188) LRS codeword individually, when necessary, so the number of byte errors in the codeword is no more than sixteen. The adaptive threshold detector 138 then supplies the LRS decoder 124 with indications of the locations of the byte errors in the (204, 188) LRS codeword that is to be corrected next. Alternative embodiments of the byte-error-location apparatus that provide equivalent performance can be constructed using logic of opposite sense.

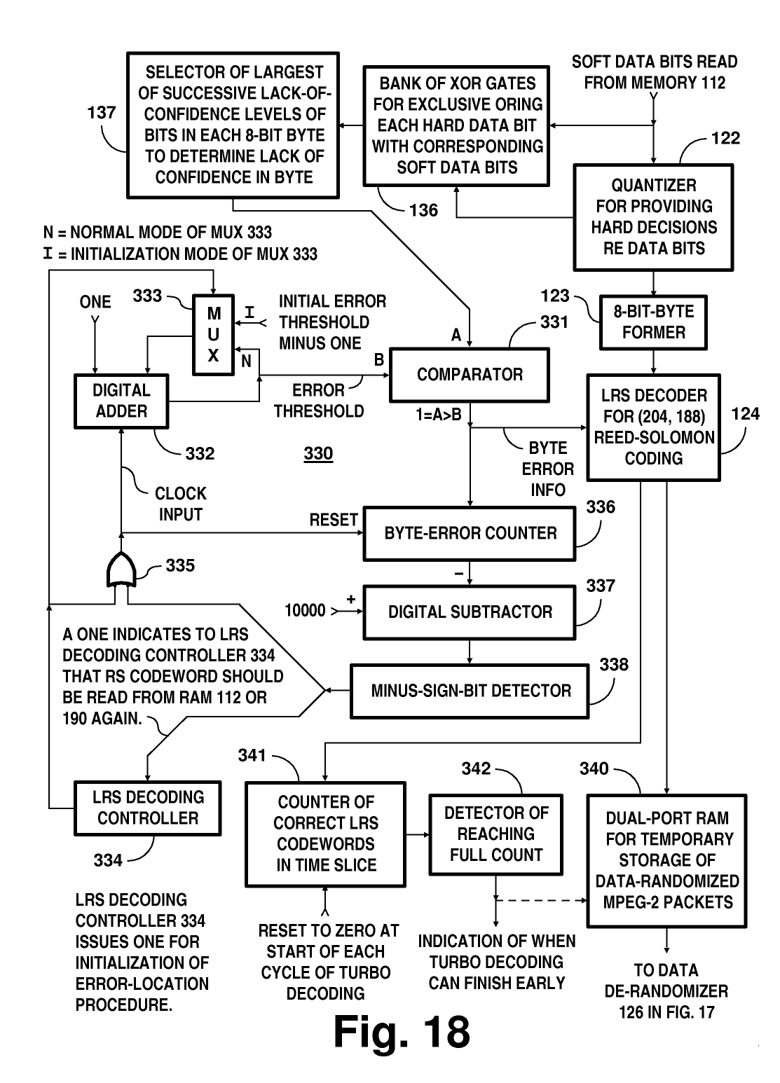

FIG. 18 is a schematic diagram showing in greater detail a representative embodiment 330 of the adaptive threshold detector 138 used to locate byte errors for decoding (204, 188) LRS coding in the FIG. 17 portion of a DTV receiver. The embodiment 330 of the adaptive threshold detector 138 depicted in FIG. 18 comprises elements 331-338. The output port of the selector 137 is connected for supplying lack-of-confidence levels for successive bytes of (204, 188) LRS codewords to first of two input ports of a comparator 331, the second input port of which is connected for receiving an adjustable error threshold. The adjustable error threshold, like each of the lack-of-confidence levels, is a binary number. So, the comparator 331 can be a simple digital subtractor connected for receiving the selector 137 response as minuend, for receiving the adjustable error threshold as subtrahend, and for supplying a difference response that locates byte errors for the LRS decoder 124. When the lack-of-confidence level in regard to a current byte exceeds the adjustable error threshold, the comparator 331 signals the erroneous byte by supplying a ONE to the LRS decoder 124 to indicate that the current byte contains bit error. When the lack-of-confidence level in regard to a current byte is below the adjustable error threshold, the comparator 331 supplies the LRS decoder 124 a ZERO to signal that the byte is error-free.

FIG. 18 shows the sum output signal from a clocked digital adder 332 supplied to the comparator 331 as the adjustable error threshold. The value of the error threshold is initialized in the following way at the outset of each (204, 188) LRS codeword being read from the memory 112. A two-input multiplexer 333 is connected to supply its response as a first of two summand signals supplied to the adder 332, the second summand signal being arithmetic one. The sum output signal from the clocked adder 332 is applied as one of two input signals to the multiplexer 333, and an initial error threshold value less one is applied as the other input signal to the multiplexer 333. Just before each (204, 188) LRS codeword is read from the memory 112 a respective pulsed logic ONE is generated by an LRS decoding controller 334. The pulsed logic ONE is applied as control signal to the multiplexer 333, conditioning it to reproduce the initial error threshold value less one in its response supplied to the adder 332 as a summand input signal. The clocked adder 332 receives its clock signal from an OR gate 335 connected to receive the pulsed logic ONE at one of its input connections. The OR gate 335 reproduces the pulsed logic ONE in its response, which clocks an addition by the adder 332. The adder 332 adds its arithmetic one summand input signal to the initial error threshold value less one summand input signal received from the multiplexer 333, generating the initial error threshold value as its sum output signal supplied to the comparator 331.

The pulsed logic ONE also resets to arithmetic zero the binary-number output count from a byte-error counter 336 that is connected for counting the number of logic ONEs that the comparator 331 generates during the decoding of each (204, 188) LRS codeword. This binary-number output count is applied as subtrahend input signal to a digital subtractor 337, the minuend input signal of which is sixteen expressed as a binary number. Sixteen is the number of parity bytes in a (208, 188) LRS codeword and is the maximum number of erroneous bytes that can be corrected in such a codeword by using erasure decoding. A minus-sign-bit detector 338 is connected for responding to the sign bit of the difference output signal from the subtractor 337. The minus-sign-bit detector 338 generates a logic ONE if and when the number of byte errors in a (204, 188) LRS codeword counted by the counter 336 exceeds sixteen. This logic ONE is supplied to the RS decoding controller 334 as an indication that the current (204, 188) LRS codeword is to be read again from the memory 112. This logic ONE is supplied to the OR gate 335 as an input signal thereto. The OR gate 335 responds with a logic ONE that resets the counter 336 to zero output count and that clocks the clocked digital adder 332. Normally, the multiplexer 333 reproduces the error threshold supplied as sum output from the adder 332. This reproduced error threshold is applied to the adder 332 as a summand input signal, connecting the clocked adder 332 for clocked accumulation of arithmetic ones in addition to the previous error threshold. The logic ONE from the OR gate 335 causes the error threshold supplied as sum output from the adder 332 to be incremented by arithmetic one. This tends to reduce the number of erroneous bytes located within the (204, 188) LRS codeword upon its being read again from the memory 112. If and when the number of erroneous bytes located in the (204, 188) LRS codeword is sixteen or less, the LRS decoding controller 334 will cause the next (204, 188) LRS codeword in the M/H Group to be processed, if there is such next RS codeword.

FIG. 18 shows a dual-port random-access memory 340 that provides for the temporary storage of data-randomized MPEG-2 data packets or data-randomized IPE packets. The output port of the LRS decoder 124 is connected to the random-access write input port of the RAM 340, and the serial read-output port of the RAM 340 is connected to the input port of the data de-randomizer 126 shown in FIG. 17. If the convolutional byte interleaving of (204, 188) LRS codewords in the DTV transmitter is coded byte interleaving, the 188-byte data packets that the LRS decoder 124 supplies for being written into addressable byte-storage locations in the RAM 340 will require convolutional byte interleaving to generate data-randomized MPEG-2 packets or data-randomized IPE packets to be read from the serial read-output port of the RAM 340 to the input port of the data de-randomizer 126 depicted in FIG. 17. Such byte interleaving is arranged for by suitable write addressing when the 188-byte data packets supplied from the LRS decoder 124 are written into addressable byte-storage locations in the RAM 340. The RAM 340 is operable as the convolutional byte interleaver 125 shown in FIG. 17.

If the convolutional byte interleaving of (204, 188) RS codewords in the DTV transmitter is not coded in nature, the LRS decoder 124 will supply data-randomized MPEG-2 packets or data-randomized IPE packets for being written into addressable byte-storage locations in the RAM 340. The write addressing of RAM 340 will be such that the data-randomized packets will simply be temporarily stored for subsequently being read out in original order from the serial read-output port of the RAM 340 to the input port of the data de-randomizer 126 depicted in FIG. 17.

Data-randomized MPEG-2 packets or data-randomized IPE packets from each time-slice are read from the RAM 340 only after completion of the respective turbo decoding of that time-slice, which can be arranged for as follows. The LRS decoder 124 is connected for supplying indications of when it supplies the input port of the RAM 340 with a randomized data packet that is correct. These indications are supplied as count input signal to a counter 341. The count output from the counter 341 is reset to arithmetic zero at the beginning of each cycle of turbo decoding a time-slice. The count output from the counter 341 is supplied to a detector 342 for determining when the counter 341 is able to reach full count by the conclusion of a cycle of turbo decoding a time-slice. The full count is the total number of correct (204, 188) LRS codewords in a time-slice, which information is supplied from the pilot and TPS carriers processor 108 in FIG. 16. If the full count of correct (204, 188) LRS codewords per time-slice is reached at the conclusion of a cycle of turbo decoding, the detector 342 supplies an indication of this condition to a PCCC decoding controller. The PCCC decoding controller, not shown in FIG. 18, can respond to this indication by concluding turbo decoding of the time-slice before the maximum allowed number of decoding iterations is reached. This indication also enables the reading of successive data-randomized MPEG-2 data packets or data-randomized IPE data packets from the serial read-output port of the RAM 340.

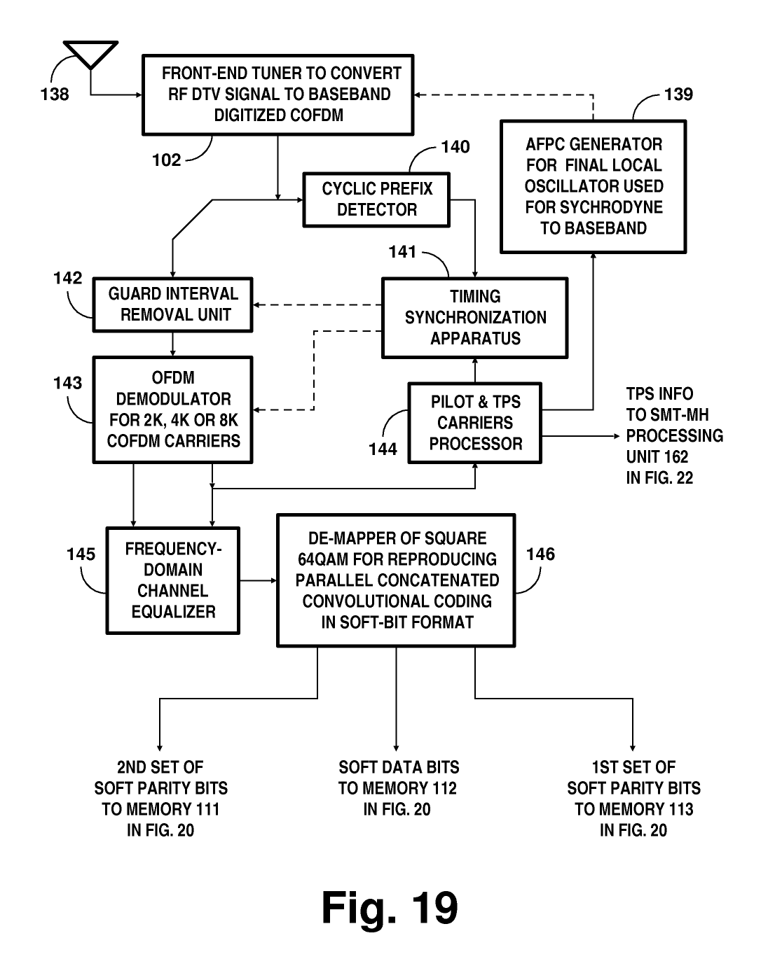

FIGS. 19, 20, 21 and 22 together depict an M/H DTV receiver for COFDM signals as transmitted at VHF or UHF by the portions of the DTV transmitter depicted in FIGS. 3 and 4. The M/H DTV receiver includes a front-end tuner 102, which is apt to be similar to that included in the stationary DTV receiver of FIGS. 15, 16 and 17. However, the reception antenna 102 that FIG. 15 shows for supplying RF input signal to the front-end tuner 102 is replaced in FIG. 19 by a reception antenna 138, such as whip antenna, suitable for an M/H DTV receiver. COFDM transmissions to M/H DTV receivers are presumed to employ square 64QAM symbol constellations, rather than the cruciform 512QAM symbol constellations used in transmissions to stationary DTV receivers. Rather than the 8K carrier waves in the COFDM used in transmissions to stationary DTV receivers, the COFDM used in transmissions to M/H DTV receivers uses only 4K carrier waves. The initial portion of the M/H DTV receiver shown in FIG. 19 differs from the initial portion of the stationary DTV receiver shown in FIG. 15 insofar as to take these differences into account. Otherwise, however, elements 139, 140, 141, 142, 143, 144, 145 and 146 shown in FIG. 19 correspond in general function to elements 103, 104, 105, 106, 107, 108, 109 and 110, respectively, shown in FIG. 15.

In FIG. 19 an AFPC generator 139 controls the final local oscillator within the front-end tuner 102, which local oscillator is used to synchrodyne the COFDM signal to baseband. The output port of the front-end tuner 102 is connected for supplying digitized samples of baseband COFDM signal to the input port of a cyclic prefix detector 140. The output port of the cyclic prefix detector 140 is connected to supply indications of the phasing of COFDM symbols to a first of two input ports of timing synchronization apparatus 141. A first of two output ports of the timing synchronization apparatus 141 is connected for supplying gating control signal to the control input port of a guard-interval-removal unit 142. The signal input port of the guard-interval-removal unit 142 is connected for receiving digitized samples of baseband COFDM signal from the output port of the front-end tuner 102. The output port of the guard-interval-removal unit 142 is connected for supplying the input port of an OFDM demodulator 143 with windowed portions of the baseband COFDM signal that contain effective COFDM samples. A second of the output ports of the timing synchronization apparatus 141 is connected for supplying the OFDM demodulator 143 with synchronizing information concerning the effective COFDM samples.

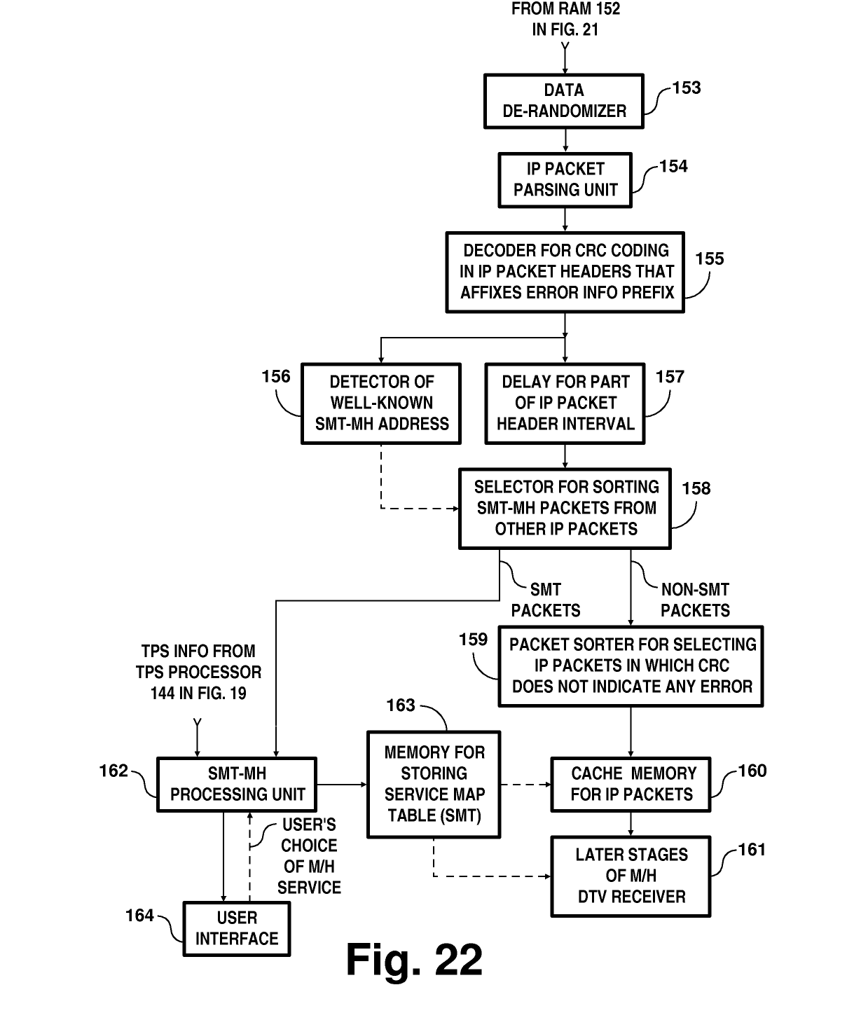

A first output port of the OFDM demodulator 143 is connected for supplying demodulated pilot carrier information to the input port of a pilot and TPS carriers processor 144. A first of three output ports of the pilot and TPS carriers processor 144 is connected for supplying more accurate window positioning information to the second input port of the timing synchronization apparatus 141. The second output port of the pilot and TPS carriers processor 144 is connected for supplying the TPS information to the SMT-MH processing unit 162 shown in FIG. 22. The third output port of the pilot and TPS carriers processor 144 is connected for forwarding unmodulated pilot carriers to the input port of the AFPC generator 139 that supplies AFPC signal to the front-end tuner 102 for controlling the final local oscillator therein.

A second output port of the OFDM demodulator 143 is connected to supply demodulated complex digital samples of 64QAM to a first input port of a frequency-domain channel equalizer 145. FIG. 19 shows the frequency-domain channel equalizer 145 having a second input port connected for receiving pilot carriers supplied from the first input port of the OFDM demodulator 143. The output port of the channel equalizer 145 is connected for supplying equalized carriers conveying CC in QAM format to the input port of a de-mapper 146 for square 64QAM symbol constellations. The de-mapper 146 is operable for reproducing at output ports thereof soft bits of the one-third-code-rate PCCC generated by the PCCC encoder 35 in the FIG. 4 portion of the DTV transmitter.

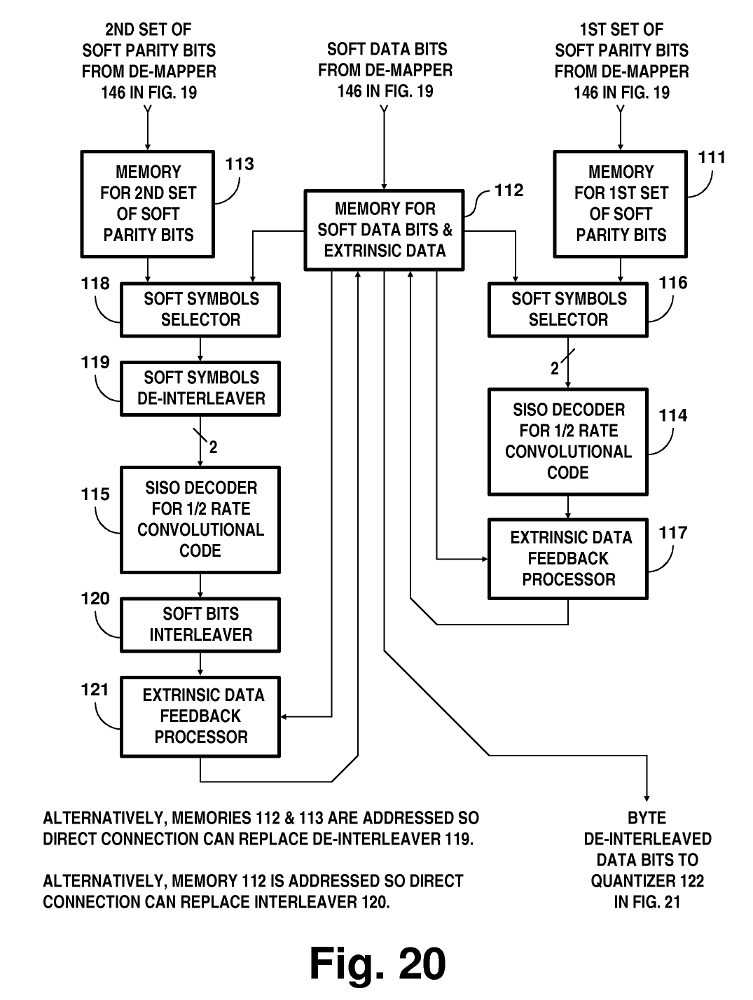

FIG. 19 shows the first output port of the de-mapper 146 connected for supplying a first set of soft parity bits from the de-mapped PCCC to a memory 111 depicted in FIG. 20. The hard-decision bits in this first set of soft parity bits reproduce parity bits from the delay memory 47 depicted in FIG. 5, from the CC encoder 44 depicted in FIG. 6, or from the interleaver 50 in FIG. 7. FIG. 19 shows the second output port of the de-mapper 146 connected for supplying data bits from the de-mapped PCCC to a memory 112 depicted in FIG. 20. FIG. 19 shows the third output port of the de-mapper 146 connected for supplying a second set of soft parity bits from the de-mapped PCCC to a memory 113 depicted in FIG. 20. The hard-decision bits in this second set of soft parity bits reproduce parity bits as interleaved by the bits interleaver 45 depicted in any one of FIGS. 5, 6 and 7 as being included in the PCCC encoder 35 of the FIG. 4 portion of the DTV transmitter.

The FIG. 20 portion of the M/H DTV receiver of FIGS. 19, 20, 21 and 22 is essentially the same as the FIG. 16 portion of the M/H DTV receiver of FIGS. 15, 16 and 17. The temporary storage requirements for the memories 111, 112 and 113 shown in FIG. 20 are substantially smaller than the temporary storage requirements for the memories 111, 112 and 113 shown in FIG. 16, however. The memories 111, 112 and 113 shown in FIG. 16 each store respective bits from an entire frame of 512QAM symbol constellations, which frame is customarily one quarter of a super frame in duration. The memories 111, 112 and 113 shown in FIG. 20 each store respective bits from a single time-slice of 64QAM symbol constellations, which time-slice is customarily one thirty-secondth of a super frame in duration. The temporary storage requirements for the memories 111, 112 and 113 shown in FIG. 20 are smaller than the temporary storage requirements for the memories 111, 112 and 113 shown in FIG. 16 by a factor of eight, owing to a frame being eight times longer than a time-slice. The temporary storage requirements for the memories 111, 112 and 113 shown in FIG. 20 are smaller than the temporary storage requirements for the memories 111, 112 and 113 shown in FIG. 16 by an additional factor of eight, owing to each 64QAM symbol constellation having eight times fewer lattice points than each 512QAM symbol constellation. The temporary storage requirements for the memories 111, 112 and 113 shown in FIG. 20 are smaller than the temporary storage requirements for the memories 111, 112 and 113 shown in FIG. 16 by another additional factor of two, presuming OFDM transmissions for stationary reception use 8K carriers and OFDM transmissions for mobile reception use 4K carriers.

The FIG. 20 portion of the M/H DTV receiver performs turbo decoding procedures on the one-third-code-rate PCCC supplied from the demapper 146 in FIG. 19. The turbo decoding procedures performed in the FIG. 20 turbo decoding apparatus culminate with soft data bits of (204, 188) LRS codewords being read from the memory 112 for soft data bits and extrinsic data. These soft data bits are supplied to the input ports of a quantizer 122 and a bank 136 of XOR gates in the FIG. 21 portion of the M/H DTV receiver.

FIG. 21 shows an 8-bit-byte former 123 connected for forming the serial-bit response of the quantizer 122 into eight-bit bytes. An extended-byte former 147 is connected for receiving the 8-bit bytes formed by the 8-bit-byte former 123 and appending to each of those bytes a number of bits indicative of the likelihood that that byte is in error. These bits, indicative of the level of lack of confidence that a byte is correct, are generated in the following way. The bank 136 of XOR gates is connected for exclusive-ORing the hard bit of each successive soft data bit in the turbo decoding results read from the memory 112 with each of the soft bits descriptive of the level of confidence that hard bit is correct. The bank 136 of XOR gates thus generates a respective set of bits indicative of the level of lack of confidence that each successive hard bit is correct. A selector 137 selects the largest of the successive lack-of-confidence levels regarding the eight bits in each 8-bit-byte, to determine a level of lack of confidence that the byte is correct. The selector 137 provides the extended-byte former 147 with bits indicative of the level of lack of confidence that the byte is correct, which bits are appended to the byte to generate an extended-byte. Typically, there are four to eight bits in the byte extensions. The output port of the extended-byte former 147 is connected for supplying successive extended-bytes to the input port of an LRS decoder 148 for (204, 188) lateral Reed-Solomon (LRS) coding.

FIG. 21 shows the LRS decoder 148 as being of a preferred type that uses a decoding algorithm for correcting up to sixteen byte errors in each (204, 188) LRS codeword, but requires that byte errors be located by means other than that decoding algorithm. Accordingly, the LRS decoder 148 can include a threshold detector that compares the levels of lack of confidence for each byte in each successive (204, 188) LRS codeword to a threshold value. This threshold detector generates a byte error indication for each byte having a level of lack of confidence that exceeds the threshold value. The threshold detector then provides the LRS decoder 148 with indications of the locations of the byte errors in the (204, 188) LRS codeword next to be corrected. The threshold detector is preferably an adaptive threshold detector similar to the adaptive threshold detector 330 in FIG. 18. The LRS decoder 148 is unusual also in that it is provided capability for adjusting the extension of each byte in the 188-byte IPE packets in the decoding results therefrom. The output port of the LRS decoder 148 supplies the input port of a re-interleaver 149 with 188-byte byte-deinterleaved IPE packets with each byte accompanied by a byte extension indicative of the level of lack of confidence in that byte being correct. If the LRS decoder 148 was capable of correcting the byte-deinterleaved IPE packet, the byte extensions are zero-valued. If the LRS decoder 148 was incapable of correcting the byte-deinterleaved IPE packet, the byte extensions retain the values they had upon entry into the LRS decoder 148.

The re-interleaver 149 for extended bytes supplies extended bytes of successive data-randomized IPE packets from its output port to the random-access write-input port of a random-access memory 150, to be written into row after row of extended-byte storage locations in that RAM 150. If the matrix block de-interleaver 29 is not preceded by the byte de-interleaver 28 in the FIG. 3 portion of the DTV transmitter, the re-interleaver 149 for extended bytes is replaced by a direct connection from the output port of the LRS decoder 148 to the write-input port of the RAM 150. The RAM 150 is operated to perform the matrix-type block de-interleaving procedure that is a first step of the TRS decoding routine. The re-interleaver 149 for extended bytes will usually be subsumed into the RAM 150 by modifying its write addressing appropriately.

After the extended bytes of data-randomized IPE packets are written into rows of extended-byte storage locations in the RAM 150, the RAM 150 is subsequently read column of extended-byte storage locations by column to a TRS decoder 151 of transverse (255, 191) Reed-Solomon code. The extension bits accompanying the 8-bit bytes of the TRS code are used to help locate byte errors for the TRS code. Such previous location of byte errors facilitates successful use of a Reed-Solomon erasure-decoding algorithm capable of correcting more byte errors than a decoding algorithm that must locate byte errors as well as correct them. So, as many as sixty-four erroneous bytes can be corrected in each (255, 191) TRS codeword. The 8-bit data bytes that have been corrected insofar as possible by the TRS decoder 151 are written, column by column, into respective columns of byte-storage locations of a random-access memory 152. In a final step of the TRS decoding routine, the byte-storage locations in the RAM 152 are read from row by row for supplying reproduced randomized M/H data to the input port of a data de-randomizer 153 in the FIG. 22 portion of the M/H receiver.

Referring now to FIG. 22, the data de-randomizer 153 is connected for receiving the output signal read from the byte-organized RAM 152 in FIG. 21. The data de-randomizer 153 de-randomizes the bytes of that signal by converting them to serial-bit form and exclusive-ORing the bits with the pseudo-random binary sequence (PRBS) prescribed for data randomization. The data de-randomizer 153 then converts the de-randomized bits into bytes of IP transfer-stream packets. From this point on, the DTV receiver resembles a mobile/handheld (M/H) receiver for M/H transmissions made using 8VSB specified by the standard adopted by ATSC on 15 Oct. 2009 that is directed to broadcasting digital television and digital data to mobile receivers. The IP transfer-stream packets essentially correspond to the IP transfer-stream packets that an M/H receiver recovers from M/H transmissions made in accordance with this standard.

The input port of a parsing unit 154 for parsing the data stream into internet-protocol (IP) packets is connected for receiving bytes of DVB-H data from the output port of the DVB-H data de-randomizer 153. The IP-packet parsing unit 154 performs this parsing responsive to two-byte row headers respectively transmitted at the beginning of each row of IP data in the FEC frame. This row header indicates where the earliest start of an IP packet occurs within the row of IP data bytes from the FEC frame. If a short IP packet is completely contained within a row of bytes within the FEC frame, the IP-packet parsing unit 154 calculates the start of a later IP packet proceeding from the packet length information contained in the earlier IP packet from that same row of bytes within the FEC frame.

The IP-packet parsing unit 154 is connected for supplying IP packets to a decoder 155 for cyclic-redundancy-check (CRC) coding in IP packets. Each IP packet begins with a nine-byte header and concludes with a four-byte, 32-bit checksum for CRC coding of that IP packet. The decoder 155 is constructed to preface each IP packet that it reproduces with a prefix bit indicating whether or not error has been detected in that IP packet. The decoder 155 is connected to supply these IP packets as so prefaced to a detector 156 of a “well-known” SMT-MH address and to a delay unit 157. The delay unit 157 delays the IP packets supplied to a packet selector 158 for selecting SMT-MH packets from other IP packets. The delay unit 157 provides delay of a part of an IP packet header interval, which delay is long enough for the detector 156 to ascertain whether or not the “well-known” SMT-MH address is detected.

If the detector 156 does not detect the “well-known” SMT-MH address in the IP packet, the detector 156 output response conditions the packet selector 158 to reproduce the IP packet for application to a packet sorter 159 as input signal thereto. The packet sorter 159 sorts out those IP packets in which the preface provides no indication of CRC coding error for writing to a cache memory 160 for IP packets. The prefatory prefix bit before each of the IP packets that indicates whether there is CRC code error in its respective bytes is omitted when writing the cache memory 160. The cache memory 160 temporarily stores at least those IP packets not determined to contain CRC code error for possible future reading to the later stages 161 of the receiver.

If the detector 156 does detect the “well-known” SMT-MH address in the IP packet, establishing it to be an SMT-MH packet, the detector 156 output response conditions the packet selector 158 to reproduce the SMT-MH packet for application to an SMT-MH processing unit 162, which includes circuitry for generating control signals for the later stages 161 of the M/H DTV receiver. FIG. 22 shows the SMT-MH processing unit 162 connected for receiving FIC information from the TPS carriers processor 144 in FIG. 19. The SMT-MH processing unit 162 integrates this information with information from SMT-MH packets during the generation of Service Map Data. The Service Map Data generated by the SMT-MH processing unit 162 is written into memory 163 for temporary storage therein and subsequent application to the later stages 164 of the M/H DTV receiver. The SMT-MH processing unit 162 relays those SMT-MH packets that have bit prefixes that do not indicate error in the packets to a user interface 164, which includes an Electronic Service Guide (ESG) and apparatus for selectively displaying the ESG on the viewing screen of the M/H DTV receiver.

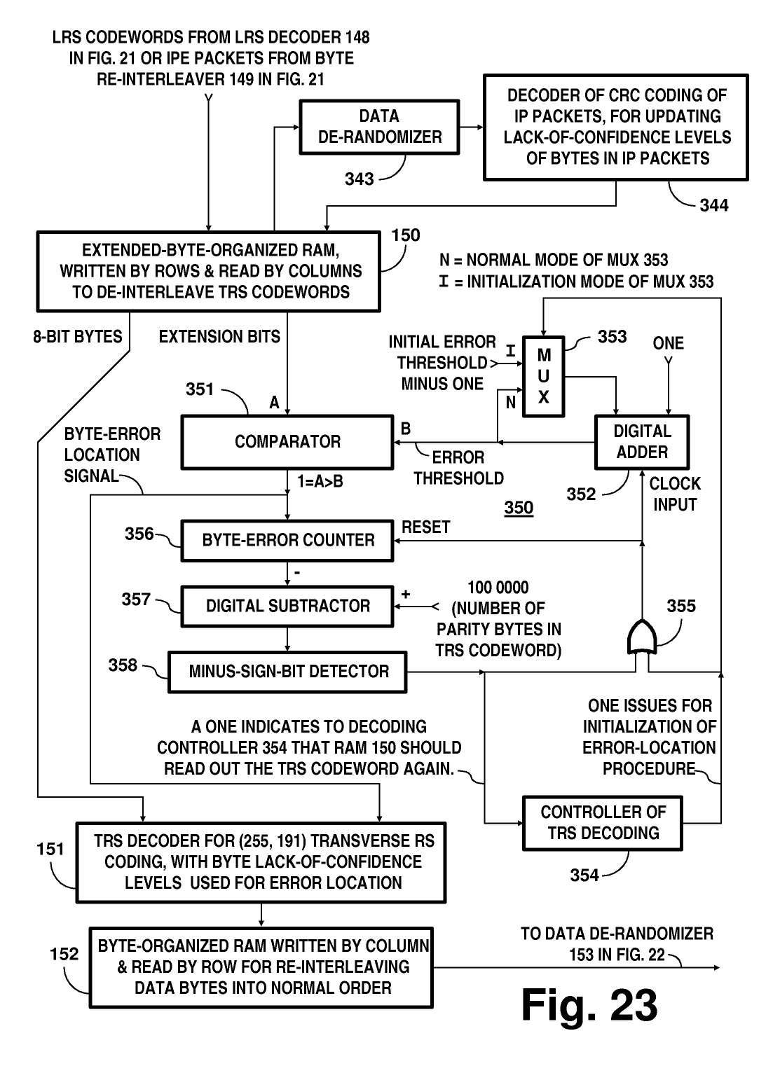

FIG. 23 shows in more detail the connections to and from the extended-byte-organized RAM 150 for de-interleaving extended bytes of (255, 191) TRS codewords and temporarily storing them in respective columns of extended-byte storage locations. A random-access write-input port of the RAM 150 is connected for receiving the extended bytes of data-randomized IPE packets from the re-interleaver 149 of extended bytes shown in FIG. 21, if the byte re-interleaver 149 is separate from the RAM 150. If the byte re-interleaver 149 is subsumed into the RAM 150, the random-access write-input port of the RAM 150 is connected for receiving the extended bytes of (204, 188) LRS codewords directly from the output port of the LRS decoder 148 shown in FIG. 21. In either case, the addressing of the extended-byte storage locations in the RAM 150 is such as to write the extended bytes of successive data-randomized IPE packets into rows of those extended-byte storage locations.

FIG. 23 shows the RAM 150 connected for reading successive data-randomized IPE packets to the input port of a data de-randomizer 343 the output port of which supplies IPE packets to the input port of a decoder 344 of the cyclic-redundancy-check (CRC) coding of IP packets. The CRC decoder 344 de-encapsulates the IP packets for CRC decoding. The CRC decoder 344 adjusts the byte extensions of IP packets it finds to be correct during CRC decoding so as to decrease their levels of lack-of-confidence—e.g., to arithmetic zero—and supplies the updated byte extensions to the RAM 150 for over-writing their previous values. Owing to drafting limitations, FIG. 23 does not explicitly show the details of how this over-writing is performed. However, arranging for such over-writing is within the average skill of digital systems designers. These procedures for updating the extensions of IP packet bytes improve the byte-error location capability of an adaptive threshold detector 350 that FIG. 23 shows for locating byte errors for the TRS decoder 151 used to decode (255, 191) Reed-Solomon coding in the FIG. 21 portion of a DTV receiver.

Preferably, the LRS decoder 148 shown in FIG. 21 is provided with capability for adjusting the extensions of bytes supplied from its output port. These adjustments can improve the byte-error location capability of the adaptive threshold detector 350 that FIG. 23 shows for locating byte errors for the TRS decoder 151 used to decode (255, 191) Reed-Solomon coding in the FIG. 21 portion of a DTV receiver. If the convolutional byte interleaving of the (204, 188) LRS codewords is coded or implied in nature, the byte-error location capability afforded by the LRS decoder 148 will be skewed respective to the byte-error location capability afforded by the CRC decoder 344. So, the byte-error location capabilities respectively afforded by the LRS decoder 148 and by the CRC decoder 344 will be substantially independent from each other. If the convolutional byte interleaving of the (204, 188) LRS codewords is not coded or implied, byte-error location capabilities respectively afforded by the LRS decoder 148 and by the CRC decoder 344 will overlap in considerable degree. Substantial independence of the byte-error location capabilities respectively afforded by the LRS decoder 148 and by the CRC decoder 344 provides subsequent TRS decoding operations more byte-error location information.

FIG. 23 shows the RAM 150 having a first read-output port for supplying the 8-bit bytes of (255, 191) TRS codewords to the TRS decoder 151 and having a second read-output port for supplying the extension bits for each of those bytes to the adaptive threshold detector 350 comprising elements 351-358. The second read-output port of the RAM 150 is connected for supplying lack-of-confidence levels for successive bytes of (255, 191) RS codewords to first of two input ports of a comparator 351, the second input port of which is connected for receiving an adjustable error threshold. The adjustable error threshold, like each of the lack-of-confidence levels, is a binary number. So, the comparator 351 can be a simple digital subtractor connected for receiving the byte extensions read from the second read-output port of the RAM 150 as minuend, for receiving the adjustable error threshold as subtrahend, and for supplying a difference response that locates byte errors for the TRS decoder 151. When the lack-of-confidence level in regard to a current byte exceeds the adjustable error threshold, the comparator 351 signals the erroneous byte by supplying a ONE to the TRS decoder 151 for indicating that the current byte contains bit error. When the lack-of-confidence level in regard to a current byte is below the adjustable error threshold, the comparator 351 supplies the TRS decoder 151 a ZERO to signal that the byte is error-free.

FIG. 23 shows the sum output signal from a clocked digital adder 352 supplied to the comparator 351 as the adjustable error threshold. The value of the error threshold is initialized in the following way at the outset of each (255, 191) TRS codeword being read from the RAM 150. A two-input multiplexer 353 is connected to supply its response as a first of two summand signals supplied to the adder 352, the second summand signal being arithmetic one. The sum output signal from the clocked adder 352 is applied as one of two input signals to the multiplexer 353, and an initial error threshold value less one is applied as the other input signal to the multiplexer 353. Just before each (255, 191) TRS codeword is read from the RAM 150 a respective pulsed logic ONE is generated by a TRS decoding controller 354. The pulsed logic ONE is applied as control signal to the multiplexer 353, conditioning it to reproduce the initial error threshold value less one in its response supplied to the adder 352 as a summand input signal. The clocked adder 352 receives its clock signal from an OR gate 355 connected to receive the pulsed logic ONE at one of its input connections. The OR gate 355 reproduces the pulsed logic ONE in its response, which clocks an addition by the adder 352. The adder 352 adds its arithmetic one summand input signal to the initial error threshold value less one summand input signal received from the multiplexer 353, generating the initial error threshold value as its sum output signal supplied to the comparator 351.

The pulsed logic ONE also resets to arithmetic zero the binary-number output count from a byte-error counter 356 that is connected for counting the number of logic ONEs that the comparator 351 generates during the decoding of each (255, 191) TRS codeword. This binary-number output count is applied as subtrahend input signal to a digital subtractor 357, the minuend input signal of which is sixty-four expressed as a binary number. A minus-sign-bit detector 358 is connected for responding to the sign bit of the difference output signal from the subtractor 357. The minus-sign-bit detector 358 generates a logic ONE if and when the number of byte errors in a (255, 191) TRS codeword counted by the counter 356 exceeds sixty-four. This logic ONE is supplied to the TRS decoding controller 354 as an indication that the current (255, 191) TRS codeword is to be read again from a column of extended-byte storage locations in the RAM 150. This logic ONE is supplied to the OR gate 355 as an input signal thereto. The OR gate 355 responds with a logic ONE that resets the counter 356 to zero output count and that clocks the clocked digital adder 352. Normally, the multiplexer 353 reproduces the error threshold supplied as sum output from the adder 352. This reproduced error threshold is applied to the adder 352 as a summand input signal, connecting the clocked adder 352 for clocked accumulation of arithmetic ones in addition to the previous error threshold. The logic ONE from the OR gate 355 causes the error threshold supplied as sum output from the adder 352 to be incremented by arithmetic one. This tends to reduce the number of erroneous bytes located within the (255, 191) TRS codeword upon its being read again from the RAM 150. If and when the number of erroneous bytes located in the (255, 191) TRS codeword is sixty-four or less, the TRS decoding controller 354 will cause the next (255, 191) TRS codeword in the M/H Group to be processed, if there is such next TRS codeword.

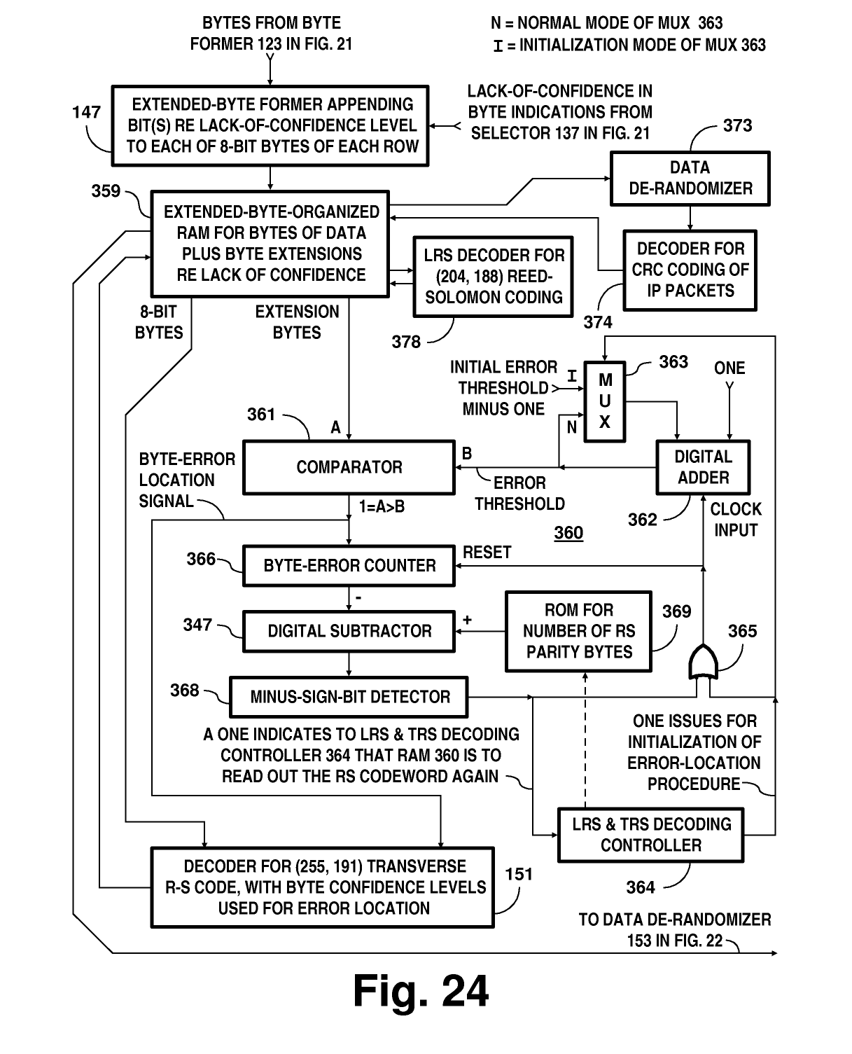

FIG. 24 shows receiver apparatus for replacing apparatus of FIGS. 15 and 20 in an M/H DTV receiver that is an alternative embodiment of aspects of the invention. In FIG. 24 a plural-port random-access memory 359 for temporarily storing 8-bit bytes of data plus respective byte extensions concerning the lack of confidence in each of those 8-bit bytes of data replaces the RAMs 150 and 152 shown in FIG. 21 and in FIG. 23. The extended-byte former 123 shown in FIG. 18 supplies a random-access first write-input port of the RAM 359 with 8-bit bytes of data, together with respective byte extensions.

FIG. 24 shows a first read-output port of the RAM 359 connected for supplying 8-bit bytes of (255, 191) TRS codewords to a first input port of the TRS decoder 151. The output port of the TRS decoder 151 is connected for supplying a second write-input port of the RAM 359 with bytes of corrected (255, 191) TRS codewords with bytes of corrected (204, 188) LRS codewords that have their extensions adjusted to lower levels of lack-of-confidence in those bytes being correct. If the TRS decoder 151 is incapable of correcting a (255, 191) TRS codeword, its bytes retain the values they had upon entry into the TRS decoder 151. This can be done by skipping the over-writing of storage locations within the RAM 359 that temporarily store the uncorrected (255, 191) TRS codeword.

FIG. 24 shows a second read-output port of the RAM 359 connected for supplying the extension bits for each of the bytes of RS codewords to an adaptive threshold detector 360 that replaces both the adaptive threshold detector 330 of FIG. 18 and the adaptive threshold detector 350 of FIG. 23. The adaptive threshold detector 360 comprises elements 361-369.

FIG. 24 shows a third read-output port of the RAM 359 connected for supplying the extended bytes of data-randomized IP packets to the input port of a data de-randomizer 373. The output port of the data de-randomizer is connected for supplying the extended bytes of IP packets to the input port of a decoder 374 for cyclic-redundancy-check (CRC) coding of IP packets. The CRC decoder 374 de-encapsulates the IP packets for CRC decoding. The CRC decoder 374 adjusts the byte extensions of IP packets it finds to be correct during CRC decoding so as to decrease their levels of lack-of-confidence and supplies the updated byte extensions to the RAM 150 for over-writing their previous values. The CRC decoder 374 supplies the updated byte extensions to a third write-input port of the RAM 359 for over-writing their previous values.

The LRS decoder 148 shown in FIG. 21 is replaced in FIG. 24 by an LRS decoder 378 having an input port connected for receiving extended-bytes of (204, 188) LRS codewords read thereto from a fourth read-output port of the plural-port RAM 359. The output port of the LRS decoder 378 is connected for supplying a fourth write-input port of the RAM 359 with bytes of corrected (204, 188) LRS codewords that have their extensions adjusted to lower levels of lack-of-confidence in those bytes being correct. If the LRS decoder 378 is incapable of correcting a (204, 188) LRS codeword, its bytes retain the values they had upon entry into the LRS decoder 378. This can be done by skipping the over-writing of storage locations within the RAM 359 that temporarily store the uncorrected (204, 188) LRS codeword.

In DVB-H the number of (255, 191) outer RS codewords in the MPE-FEC frame is signaled in the service information (SI) and may take any of the values 256, 512, 768, or 1024. In a newly developed system using COFDM for DTV broadcasting in the United States of America, it would be preferable if the number of (255, 191) outer RS codewords in the MPE-FEC frame were to be multiples of 185, rather than multiples of 256. The reason is that this makes it much, much simpler to perform 2-dimensional decoding of the cross-interleaved RS coding (CIRC) in a DTV receiver. The extended bytes that result from “soft” decoding the inner convolutional coding or other bit-wise FEC coding, when written to rows of extended-byte storage locations in a framestore memory, can then be aligned so that parity bytes of the inner RS coding are confined to columns of extended-byte storage locations separate from those containing the (255, 191) codewords of the outer RS coding. This considerably simplifies the addressing of such framestore memory during its writing and reading operations.

Suppose the convolutional byte interleaving of the (204, 188) LRS codewords is not coded or implied in nature, and the sixteen parity bytes of each (204, 188) LRS codewords are located the same as in the other LRS codewords. In such case, the write addressing of the RAM 359 during its being written with extended bytes from the extended-byte former 147 is such as to de-interleave the convolutional byte interleaving, so the extended bytes of those (204, 188) LRS codewords are temporarily stored in successive rows of extended-byte storage locations in the RAM 359. The extended bytes of data-randomized IPE packets in those (204, 188) LRS codewords will be temporarily stored in columns of extended-byte storage locations in the RAM 359 separate from the columns of extended-byte storage locations in which parity bytes of those (204, 188) LRS codewords will be temporarily stored. Reading of extended-bytes of IP packets from the RAM 359 to the CRC decoder 374 and updating byte extensions of those extended bytes will involve addressing portions of rows of extended-byte storage locations. Reading of extended-bytes of (204, 188) LRS codewords from the RAM 359 to the LRS decoder 378 and updating the extended bytes of newly corrected LRS codewords will also involve addressing portions of rows of extended-byte storage locations. Reading of extended-bytes of (255, 191) TRS codewords from the RAM 359 to the TRS decoder 151 and updating the extended bytes of newly corrected TRS codewords will involve addressing selected ones of the columns of extended-byte storage locations.

Suppose the convolutional byte interleaving of the (204, 188) LRS codewords is coded or implied in nature, as the inventor prefers, and the sixteen parity bytes of each (204, 188) LRS codewords are located the same as in the other LRS codewords. In such case, the write addressing of the RAM 359 during its being written with extended bytes from the extended-byte former 147 is such as to temporarily store successive extended bytes of the results of decoding convolutional coding in successive rows of extended-byte storage locations in the RAM 359. Presuming that the convolutional byte interleaving with wrap-around extends to a depth of 51 rows of bytes, the parity bytes of the (204, 188) LRS codewords will be temporarily stored in columns of extended-byte storage locations in the RAM 359 separate from the columns of extended-byte storage locations in which columns respective (255, 191) TRS codewords are temporarily stored. Reading of extended-bytes of IP packets from the RAM 359 to the CRC decoder 374 and updating byte extensions of those extended bytes will involve addressing portions of rows of extended-byte storage locations. Reading of extended-bytes of (204, 188) LRS codewords from the RAM 359 to the LRS decoder 378 and updating the extended bytes of newly corrected LRS codewords will involve addressing extended-byte storage locations so as to de-interleave the convolutional byte interleaving of the LRS codewords. Reading of extended-bytes of (255, 191) TRS codewords from the RAM 359 to the TRS decoder 151 and updating the extended bytes of newly corrected TRS codewords will involve addressing selected ones of the columns of extended-byte storage locations.

The adaptive threshold detector 360 of FIG. 24 includes an LRS and TRS decoding controller 364 besides a comparator 361, digital adder 362, multiplexer 363, OR gate 365, byte-error counter 366, digital subtractor 367 and minus-sign detector 368. The adaptive threshold detector 360 further includes a read-only memory 369 that supplies a minuend input signal to the digital subtractor 367 responsive to a write-input address supplied from the LRS and TRS decoding controller 364.

During operations of the LRS decoder 378, the LRS and TRS decoding controller 364 performs control functions similar to those that the LRS decoding controller 334 of FIG. 18 performs during operation of the LRS decoder 148. The LRS and TRS decoding controller 364 supplies the ROM 369 a write-input address that conditions it to supply a 1 0000 minuend input signal to the digital subtractor 367. The comparator 361, digital adder 362, multiplexer 363, OR gate 365, byte-error counter 366, digital subtractor 367 and minus-sign detector 368 in the adaptive threshold detector 360 of FIG. 24 perform similarly to the comparator 331, digital adder 332, multiplexer 333, OR gate 335, byte-error counter 336, digital subtractor 337 and minus-sign detector 338 in the adaptive threshold detector 330 of FIG. 18.

During operations of the TRS decoder 151 in FIG. 24, the LRS and TRS decoding controller 364 performs control functions similar to those the TRS decoding controller 354 performs during operation of the TRS decoder 151 in FIG. 23. The LRS and TRS decoding controller 364 supplies the ROM 369 a write-input address that conditions it to supply a 100 0000 minuend input signal to the digital subtractor 367. The comparator 361, digital adder 362, multiplexer 363, OR gate 365, byte-error counter 366, digital subtractor 367 and minus-sign detector 368 in the adaptive threshold detector 360 of FIG. 24 perform similarly to the comparator 351, digital adder 352, multiplexer 353, OR gate 355, byte-error counter 356, digital subtractor 357 and minus-sign detector 358 in the adaptive threshold detector 350 of FIG. 23.

The receiver apparatus depicted in FIG. 24 can be operated in a variety of ways to decode the cross-interleaved Reed-Solomon codes (CIRC) employed in DTV broadcasting to M/H receivers. The FIG. 24 receiver apparatus can be operated to decode LRS coding before TRS coding, as done in the FIG. 21 receiver apparatus that is replaced by the FIG. 24 receiver apparatus. Preliminary decoding of the CRC coding of IP packets by the CRC decoder 374 can improve the locating of erroneous byte errors for erasure decoding by the LRS decoder 378. If all the LRS codewords in a time-slice are correct after their decoding by the LRS decoder 378, decoding of the TRS coding in the time-slice by the TRS decoder 151 can be skipped over. The correctness of the IP packets within the time-slice can be confirmed by the CRC decoder 374 before skipping over the TRS decoding of the time-slice.

Alternatively, the FIG. 24 receiver apparatus can be operated to decode TRS coding before LRS coding. This begins the decoding of the CIRC using the (255, 191) RS coding that is stronger than the (204, 188) shortened RS coding. Preliminary decoding of the CRC coding of IP packets by the CRC decoder 374 can improve the locating of erroneous byte errors for erasure decoding by the TRS decoder 151. If all the TRS codewords in a time-slice are correct after their decoding by the TRS decoder 151, decoding of the LRS coding in the time-slice by the LRS decoder 378 can be skipped over. The correctness of the IP packets within the time-slice can be confirmed by the CRC decoder 374 before skipping over the LRS decoding of the time-slice.

The FIG. 24 receiver apparatus can be advantageously operated to perform LRS decoding and TRS decoding of the CIRC iteratively, repeating either of the methods described in the two immediately foregoing paragraphs. Iterated decoding procedures are more efficient if decoding is repeated only for those RS codewords not yet found to be correct. The FIG. 24 receiver apparatus preferably includes a memory register for storing information as to which LRS codewords in a time-slice the LRS decoder 378 has thusfar found to be correct. When that memory register is filled with indications that all LRS codewords in a time-slice have been found correct, decoding of the CIRC in that time-slice can be discontinued. The FIG. 24 receiver apparatus preferably includes another memory register for storing information as to which TRS codewords in a time-slice the TRS decoder 151 has thusfar found to be correct. When that memory register is filled with indications that all TRS codewords in a time-slice have been found correct, decoding of the CIRC in that time-slice can be discontinued. If no updates are made to either of these memory registers during a cycle of decoding the CIRC in a time-slice, decoding of that CIRC can be discontinued. If not earlier concluded, the iterative procedures for decoding the CIRC in a time-slice can progress until a prescribed maximum time for such decoding expires.

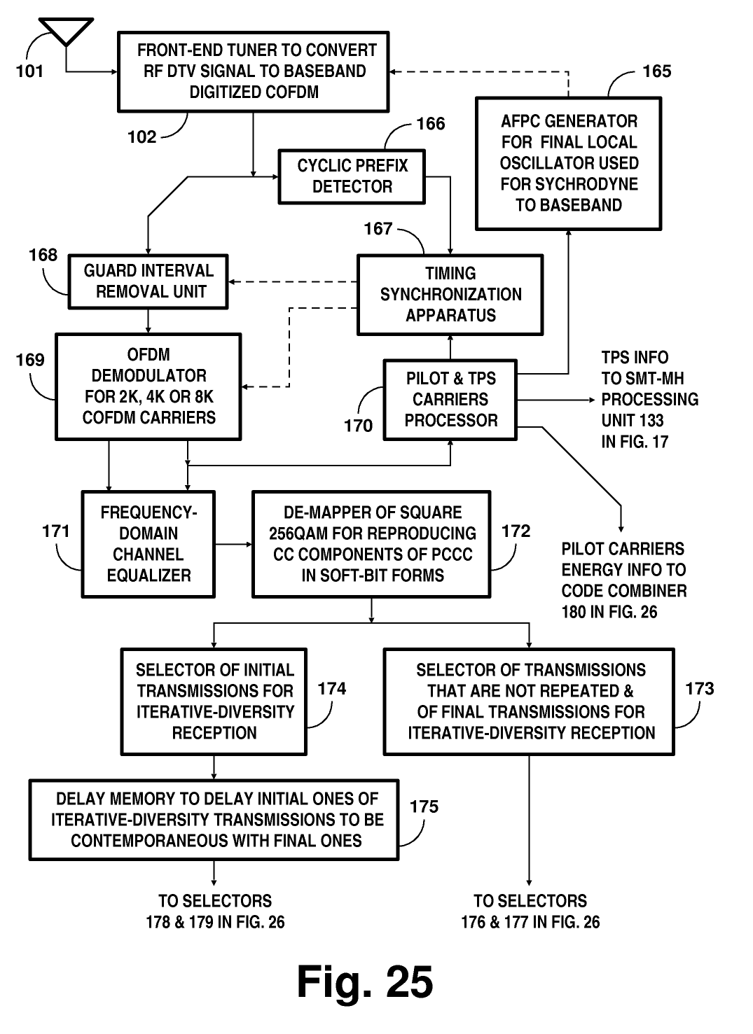

FIGS. 22, 23 and 14 together depict a stationary DTV receiver adapted for iterative-diversity reception of COFDM signals as transmitted at VHF or UHF by the portions of the DTV transmitter depicted in FIGS. 8 and 9. These COFDM signals for iterative-diversity reception employ 8K carrier waves, but employ square 256QAM symbol constellations rather than cruciform 512QAM symbol constellations. The initial portion of the stationary DTV receiver shown in FIG. 25 differs from the portion of the stationary DTV receiver shown in FIG. 15 insofar as to take this difference into account. Otherwise, however, elements 165, 166, 167, 168, 169, 170, 171 and 172 shown in FIG. 25 correspond in general function to elements 103, 104, 105, 106, 107, 108, 109 and 110, respectively, shown in FIG. 15.

In FIG. 25, as in FIG. 15, the reception antenna 101 captures the radio-frequency COFDM signal for application as input signal to the front-end tuner 102 of the receiver. FIG. 25 shows an AFPC generator 165 for generating the automatic frequency and phase control (AFPC) signal for controlling the final local oscillator within the front-end tuner 102. FIG. 25 shows the output port of the front-end tuner 102 connected for supplying digitized samples of baseband COFDM signal to the input port of a cyclic prefix detector 166. The cyclic prefix detector 166 differentially combines the digitized samples of baseband COFDM signal with those samples as delayed by the duration of an effective COFDM symbol and generates sharply defined indications of the phasing of COFDM symbols based on nulls in the resulting difference signal. The output port of the cyclic prefix detector 166 is connected to supply these indications to a first of two input ports of timing synchronization apparatus 167.

A first of two output ports of the timing synchronization apparatus 167 is connected for supplying gating control signal to the control input port of a guard-interval-removal unit 168, the signal input port of which is connected for receiving digitized samples of baseband COFDM signal from the output port of the front-end tuner 102. The output port of the guard-interval-removal unit 168 is connected for supplying the input port of an OFDM demodulator 169 with windowed portions of the baseband COFDM signal that contain effective COFDM samples. A second of the output ports of the timing synchronization apparatus 167 is connected for supplying the OFDM demodulator 169 with synchronizing information concerning the effective COFDM samples.

The output port of the front-end tuner 102 is connected for supplying digitized samples of baseband COFDM signal to the signal input port of the guard-interval-removal unit 168. The indications concerning the phasing of COFDM symbols that the cyclic prefix detector 166 supplies to the timing synchronization apparatus 167 is sufficiently accurate for initial windowing of the baseband COFDM signal that the guard-interval-removal unit 168 supplies to the OFDM demodulator 169.

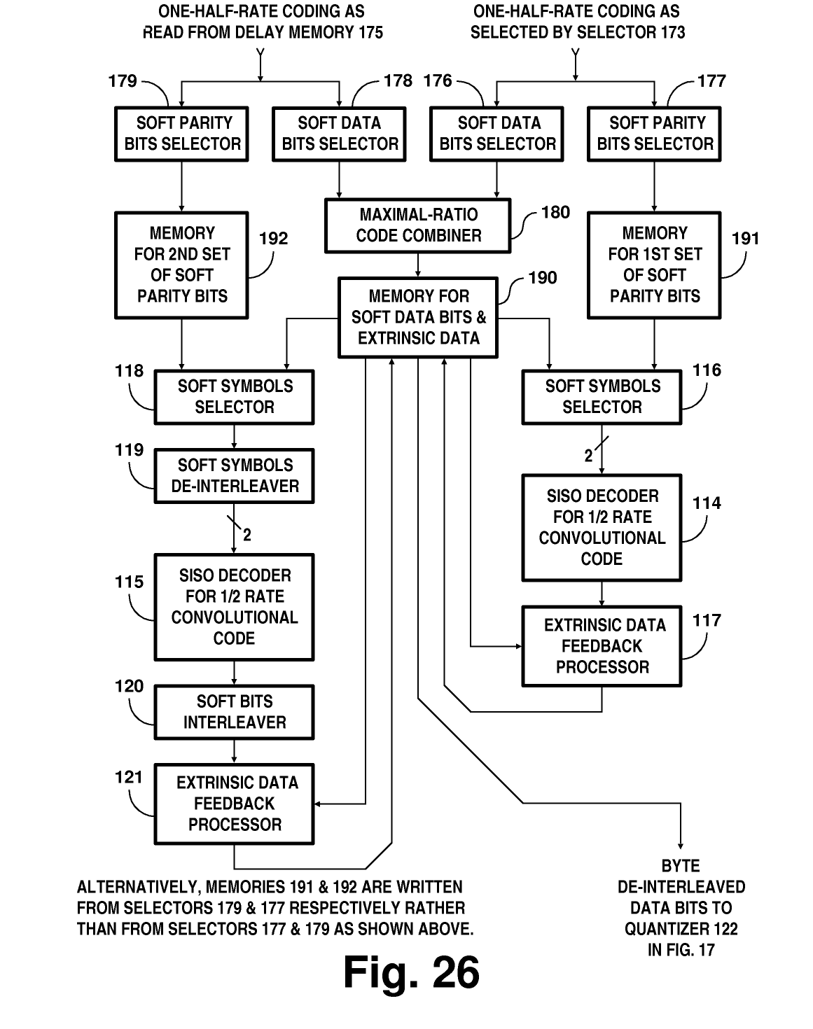

A first output port of the OFDM demodulator 169 is connected for supplying demodulated pilot carrier information to the input port of a pilot and TPS carriers processor 170. The information concerning unmodulated pilot carriers is processed in the processor 170 to support more accurate windowing of the baseband COFDM signal that the guard-interval-removal unit 168 supplies to the OFDM demodulator 169. The pilot and TPS carriers processor 170 demodulates the TPS information conveyed by modulated pilot signals. The second output port of the pilot and TPS carriers processor 170 is connected for supplying the TPS information to the SMT-MH processing unit 133 shown in FIG. 17. The third output port of the pilot and TPS carriers processor 170 is connected for forwarding unmodulated pilot carriers to the input port of the AFPC generator 165. The fourth output port of the pilot and TPS carriers processor 170 is connected for supplying information concerning the respective energies of unmodulated pilot carriers. This information is used for maximal-ratio code combining to be performed in the FIG. 26 portion of the receiver.

A second output port of the OFDM demodulator 169 is connected to supply demodulated complex digital samples of 256QAM to a first input port of a frequency-domain channel equalizer 171. FIG. 25 shows the frequency-domain channel equalizer 171 having a second input port connected for receiving pilot carriers supplied from the first input port of the OFDM demodulator 169. The output port of the channel equalizer 171 is connected for supplying equalized carriers conveying convolutional coding in QAM format to the input port of a de-mapper 172 for 256QAM symbols. The de-mapper 172 is operable for reproducing at an output port thereof the one-half-rate convolutional coding supplied as response from the time-division multiplexer 65 in the FIG. 9 portion of the DTV transmitter.

The output port of the de-mapper 172 is connected for supplying one-half-rate CC to the input port of a selector 173 for reproducing at its output port just those transmissions that are not repeated and the final ones of those transmissions that are repeated for iterative-diversity reception. The output port of the de-mapper 172 is further connected for supplying one-half-rate CC to the input port of a selector 174 for reproducing at its output port just the initial ones of those transmissions subsequently repeated for iterative-diversity reception. The output port of the selector 174 is connected for writing to the input port of a delay memory 175 which memory is employed to delay the one-half-rate CC of the initial transmissions subsequently once-repeated for iterative-diversity reception. The delay can be prescribed fixed delay or, alternatively, can be programmable responsive to delay specified by bits of TPS coding. In either case, the delay is such that the transmissions subsequently repeated for iterative-diversity reception are supplied from the output port of the delay memory 175 concurrently with the corresponding final transmissions as repeated for iterative-diversity reception that are supplied from the output port of the selector 173. The output port of the selector 173 connects to the input ports of selectors 176 and 177 shown in FIG. 26. The read output port of the delay memory 175 connects to the input ports of selectors 178 and 179 shown in FIG. 26.

FIG. 26 shows the selector 176 connected for selectively reproducing at its output port just the soft data bits from the one-half-rate CC selected to its input port by the selector 173. FIG. 26 shows the selector 178 connected for selectively reproducing at its output port just the soft data bits from the one-half-rate CC read to its input port from the delay memory 175. A maximal-ratio code combiner 180 is connected for receiving at a first of its two input ports the soft data bits selectively reproduced at the output port of the soft-data-bits selector 176. The second input port of the maximal-ratio code combiner 180 is connected for receiving the soft data bits selectively reproduced at the output port of the soft-data-bits selector 178. The output port of the maximal-ratio code combiner 180 is connected for supplying best soft estimates of the data bits of the one-half-rate CC as write input signal to a memory 190, which temporarily stores those soft data bits.

The memory 190 also temporarily stores soft extrinsic data bits determined during the subsequent turbo decoding procedures. Soft data bits are read from the memory 190 without being combined with corresponding soft extrinsic data bits during the initial half cycle of an iterative turbo decoding procedure. Thereafter, when soft data bits are read from the memory 190 during subsequent half cycles of the iterative turbo decoding procedure, the soft data bits have respectively corresponding soft extrinsic data bits additively combined therewith. The soft extrinsic data bits temporarily stored in the memory 190 are updated responsive to the results of decoding CC each half cycle of the iterative turbo decoding procedure.

FIG. 26 shows the selector 177 connected for selectively reproducing at its output port just the soft parity bits from the one-half-rate CC selected to its input port by the selector 173. The output port of the soft-parity-bits selector 177 is connected to supply these selectively reproduced soft parity bits as write input signal to a memory 191 for temporarily storing the soft parity bits of the one-half-rate CC for each successive even-numbered time-slice.

FIG. 26 shows the selector 179 connected for selectively reproducing at its output port just the soft parity bits from the one-half-rate CC read to its input port from the delay memory 175. The output port of the soft-parity-bits selector 179 is connected to supply these selectively reproduced soft parity bits as write input signal to a memory 192 for temporarily storing the soft parity bits of the one-half-rate CC for each successive delayed odd-numbered time-slice.

The memories 190, 191 and 192 together temporarily store all the components of the PCCC for a given service to be received by the stationary DTV receiver depicted in FIGS. 22, 23 and 14. The PCCC is turbo decoded by soft-input/soft-output decoders 114 and 115 in FIG. 26, which preferably employ the sliding-window log-MAP algorithm. During the initial half of each cycle of turbo decoding, the SISO decoder 114 decodes one-half-rate CC that includes soft parity bits from an even-numbered time-slice of the service being received. During the final half of each cycle of turbo decoding, the SISO decoder 115 decodes one-half-rate CC that includes soft parity bits from an odd-numbered time-slice of the service being received. The soft data bits that the SISO decoders 114 and 115 supply from their respective output ports as respective decoding results are compared to combined soft data bits and soft extrinsic data bits read from the memory 190. This is done to generate updated soft extrinsic data bits to be written back to the memory 190. At the conclusion of turbo decoding, combined soft data bits and soft extrinsic data bits are read from the memory 190 to supply an ultimate turbo decoding result to the input port of the quantizer 122 shown in FIG. 17.

FIG. 26 shows a soft-symbols selector 116 that selects soft data bits and soft parity bits to be supplied from first and second output ports thereof, respectively, to first and second input ports of the SISO decoder 114 during the initial half of each cycle of turbo decoding. The soft-symbols selector 116 relays soft data bits additively combined with soft extrinsic data bits, if any, as read to a first input port thereof from the memory 190, thus to generate the soft data bits supplied to the first input port of the SISO decoder 114. The soft-symbols selector 116 reproduces the soft parity bits read to a second input port thereof from the memory 191, thus generating the soft parity bits supplied to the second input port of the SISO decoder 114. In actual practice, the soft-symbols selector 116 will usually be incorporated into the structures of the memories 190 and 191.

The soft data bits supplied from the output port of the SISO decoder 114 as decoding results during the initial half of each cycle of turbo decoding are supplied to a first of two input ports of an extrinsic-data-feedback processor 117. The processor 117 differentially combines soft data bits read from the memory 190 with corresponding soft data bits of the SISO decoder 114 decoding results to generate extrinsic data feedback written into the memory 190 to update the soft extrinsic data bits temporarily stored therein.

FIG. 26 shows a soft-symbols selector 118 that selects soft data bits and soft parity bits to be supplied as input soft symbols to a soft-symbols de-interleaver 119. The soft-symbols de-interleaver 119 responds to supply de-interleaved soft data bits and de-interleaved soft parity bits from first and second output ports thereof, respectively, to first and second input ports of the SISO decoder 115 during the final half of each cycle of turbo decoding. The soft symbols selector 118 relays soft data bits additively combined with soft extrinsic data bits, if any, as read to a first input port thereof from the memory 190, thus to generate the soft data bits supplied to the soft-symbols de-interleaver 119. The soft-symbols selector 118 reproduces the soft parity bits read to a second input port thereof from the memory 192, thus to generate the soft parity bits supplied to the soft symbols de-interleaver 119. The de-interleaving provided by soft-symbols de-interleaver 119 complements the symbol interleaving provided by the symbols interleaver 64 in the FIG. 9 portion of the DTV transmitter.

The soft data bits supplied from the output port of the SISO decoder 115 as decoding results during the final half of each cycle of turbo decoding are supplied to the input port of a soft-bits interleaver 120 in FIG. 26. FIG. 26 shows the output port of the soft-bits interleaver 120 connected to a first of two input ports of an extrinsic data feedback processor 121. The interleaving provided by soft-bits interleaver 120 complements the bit de-interleaving provided by the bits de-interleaver 62 in the FIG. 9 portion of the DTV transmitter. The processor 121 differentially combines soft data bits read from the memory 190 with corresponding soft data bits of the soft-bits interleaver 120 response to generate extrinsic data feedback written into the memory 190 to update the soft extrinsic data bits temporarily stored therein.

In actual practice, the soft-symbols selector 118 will usually be incorporated into the structures of the memories 190 and 192. Usually, the soft-symbols de-interleaver 119 will not appear as a separate physical element either. Instead, its function is subsumed into the memories 190 and 191 by suitable addressing of them when reading soft data bits and soft parity bits directly to the first and second input ports of the SISO decoder 115. The soft-bits interleaver 120 need not appear as a separate physical element either, its function being subsumed into the memory 190 by suitable addressing during operation of the extrinsic feedback data processor 121. Since the operations of the SISO decoders 114 and 115 alternate in time, a single decoder structure is apt to be used for implementing both the SISO decoders 114 and 115. The foregoing description of turbo decoding describes each cycle as beginning with decoding of an even-numbered time-slice and concluding with the decoding of an odd-numbered time-slice. The order of decoding is arbitrarily chosen, however. Alternatively, turbo decoding can be done with each cycle thereof beginning with decoding of an odd-numbered time-slice and concluding with the decoding of an even-numbered time-slice.

The design of the FIG. 26 portion of a stationary DTV receiver is based on the presumption that the convolutional coding of initial transmissions of time-slices is symbol interleaved, but the convolutional coding of final transmissions of time-slices is not symbol interleaved. Alternatively, the convolutional coding of final transmissions of time-slices can be symbol interleaved, with the convolutional coding of initial transmissions of time-slices not being symbol interleaved. The FIG. 26 portion of the stationary DTV receiver is modified in the following ways to be able to receive such alternative transmissions usefully. The memory 191 is written with soft parity bits reproduced at the output port of the soft parity bits selector 179, rather than with soft parity bits reproduced at the output port of the soft parity bits selector 177. Furthermore, the memory 192 is written with soft parity bits reproduced at the output port of the soft parity bits selector 177, rather than with soft parity bits reproduced at the output port of the soft parity bits selector 179.

After a last half cycle of the iterative turbo decoding procedure, soft data bits as additively combined with respectively corresponding soft extrinsic data bits are read from the memory 190 to the input port of the quantizer 122 depicted in FIG. 17. The read addresses applied to the memory 190 are supplied in such order as to read the soft data bits of (204, 188) LRS codewords to the input port of the quantizer 122.

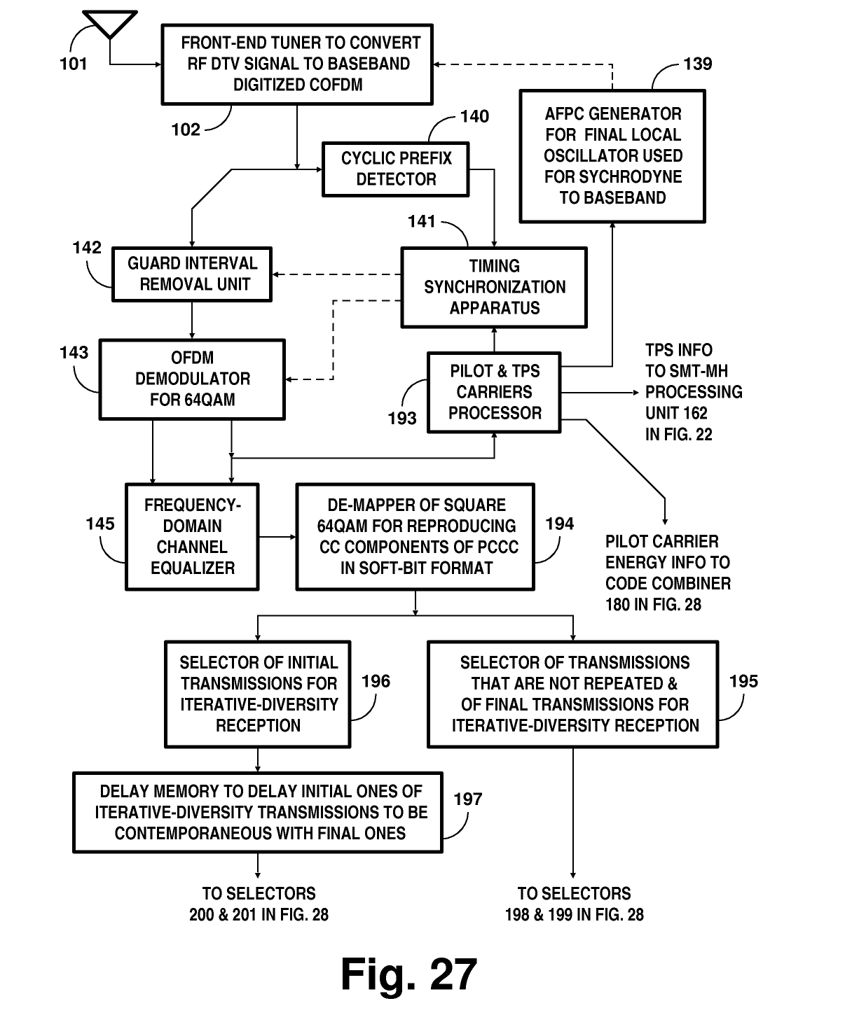

FIGS. 27, 28, 18 and 19 together provide a generic schematic diagram of a M/H DTV receiver adapted for iterative-diversity reception of COFDM signals as transmitted by the portions of the DTV transmitter depicted in FIGS. 10 and 11. These COFDM transmissions to M/H DTV receivers employ 64QAM symbol constellations, rather than the 256QAM symbol constellations used in transmissions to stationary DTV receivers for iterative-diversity reception. These COFDM transmissions use 4K carriers. The initial portion of the M/H DTV receiver shown in FIG. 27 is much the same as the initial portion of the M/H DTV receiver shown in FIG. 19. Elements 101, 102, 139, 140, 141, 142, 143, 145 and 146 shown in FIG. 27 correspond in structure, connection and function to similarly numbered elements shown in FIG. 19. The initial portion of the M/H DTV receiver shown in FIG. 27 includes a pilot and TPS carriers processor 193 that differs from the pilot and TPS carriers processor 144 shown in FIG. 19.

In FIG. 27, as in FIG. 19, the reception antenna 101 captures the radio-frequency COFDM signal for application as input signal to the front-end tuner 102 of the receiver. FIG. 27 shows the AFPC generator 139 for generating the AFPC signal for controlling the final local oscillator within the front-end tuner 102. In FIG. 27 the output port of the front-end tuner 102 is connected for supplying digitized samples of baseband COFDM signal to the input port of the cyclic prefix detector 140. The output port of the cyclic prefix detector 140 is connected to supply indications of the phasing of COFDM symbols to a first of two input ports of the timing synchronization apparatus 141. A first of two output ports of the timing synchronization apparatus 141 is connected to supply gating control signal to the control input port of a guard-interval-removal unit 142. The signal input port of the guard-interval-removal unit 142 is connected for receiving digitized samples of baseband COFDM signal from the output port of the front-end tuner 102. The output port of the guard-interval-removal unit 142 is connected for supplying the input port of an OFDM demodulator 143 with windowed portions of the baseband COFDM signal that contain effective COFDM samples. A second of the output ports of the timing synchronization apparatus 141 is connected for supplying the OFDM demodulator 143 with synchronizing information concerning the effective COFDM samples.

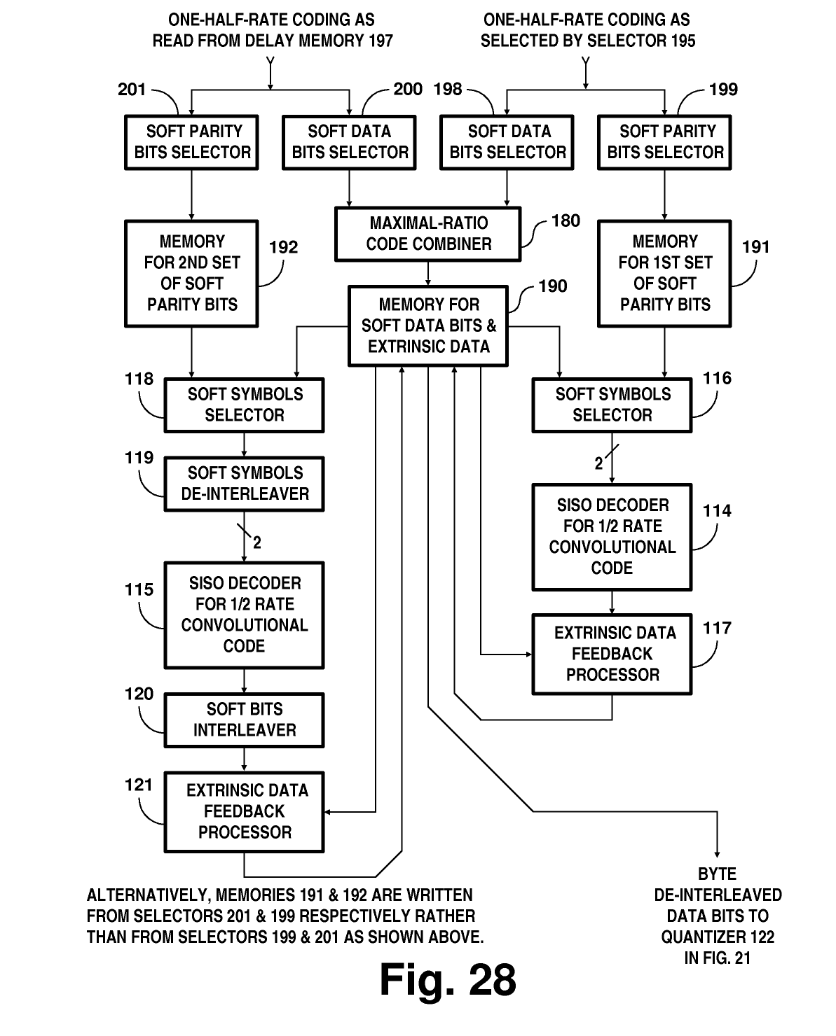

A first output port of the OFDM demodulator 143 is connected for supplying demodulated pilot carrier information to the input port of the pilot and TPS carriers processor 193. A first of four output ports of the pilot and TPS carriers processor 181 is connected for supplying more accurate window positioning information to the second input port of the timing synchronization apparatus 141. The second output port of the pilot and TPS carriers processor 193 is connected for supplying the TPS information to the SMT-MH processing unit 162 shown in FIG. 22. The third output port of the pilot and TPS carriers processor 193 is connected for forwarding unmodulated pilot carriers to the input port of the AFPC generator 139 that supplies AFPC signal to the front-end tuner 102 for controlling the final local oscillator therein. The fourth output port of the pilot and TPS carriers processor 193 is connected for supplying information concerning the respective energies of unmodulated pilot carriers to the maximal-ratio code combiner 180 in the FIG. 28 portion of the receiver.

The OFDM demodulator 143 is connected to supply demodulated complex digital samples of 64QAM to the frequency-domain channel equalizer 145. The output port of the channel equalizer 145 is connected for supplying equalized carriers conveying one-half-rate CC in QAM format to the input port of the de-mapper 194 for 64QAM symbols.

The output port of the de-mapper 194 is connected for supplying one-half-rate CC to the input port of a selector 195 for reproducing at its output port just those transmissions that are not repeated and the final ones of those transmissions repeated for iterative-diversity reception. The output port of the de-mapper 194 is further connected for supplying one-half-rate CC to the input port of a selector 196 for reproducing at its output port just the initial ones of those transmissions subsequently repeated for iterative-diversity reception. The output port of the selector 196 is connected for writing to the input port of a delay memory 197 that delays the one-half-rate CC of the initial transmissions subsequently once-repeated for iterative-diversity reception. The delay is such that the transmissions subsequently repeated for iterative-diversity reception are supplied from the output port of the delay memory 197 concurrently with the corresponding final transmissions as repeated for iterative-diversity reception that are supplied from the output port of the selector 195. The output port of the selector 195 connects to the input ports of selectors 198 and 199 shown in FIG. 28. The output port of the delay memory 197 connects to the input ports of selectors 200 and 201 shown in FIG. 28.

FIG. 28 shows the selector 198 connected for selectively reproducing at its output port just the soft data bits from the one-half-rate CC selected to its input port by the selector 195. FIG. 28 shows the selector 200 connected for selectively reproducing at its output port just the soft data bits from the one-half-rate CC read to its input port from the delay memory 197. A maximal-ratio code combiner 180 is connected for receiving at a first of its two input ports the soft data bits selectively reproduced at the output port of the soft-data-bits selector 198. The second input port of the maximal-ratio code combiner 180 is connected for receiving the soft data bits selectively reproduced at the output port of the soft-data-bits selector 200. The output port of the maximal-ratio code combiner 180 is connected for supplying best soft estimates of the data bits of the one-half-rate CC as write input signal to a memory 190, which temporarily stores those soft data bits.

The memory 190 also temporarily stores soft extrinsic data bits determined during the subsequent turbo decoding procedures. Soft data bits are read from the memory 190 without being combined with corresponding soft extrinsic data bits during the initial half cycle of an iterative turbo decoding procedure. Thereafter, when soft data bits are read from the memory 190 during subsequent half cycles of the iterative turbo decoding procedure, the soft data bits have respectively corresponding soft extrinsic data bits additively combined therewith. The soft extrinsic data bits temporarily stored in the memory 190 are updated responsive to the results of decoding CC each half cycle of the iterative turbo decoding procedure.

FIG. 28 shows the selector 199 connected for selectively reproducing at its output port just the soft parity bits from the one-half-rate CC selected to its input port by the selector 195. The output port of the soft-parity-bits selector 199 is connected to supply these selectively reproduced soft parity bits as write input signal to a memory 191 for temporarily storing the soft parity bits of the one-half-rate CC for each successive even-numbered time-slice.

FIG. 28 shows the selector 201 connected for selectively reproducing at its output port just the soft parity bits from the one-half-rate CC read to its input port from the delay memory 197. The output port of the soft-parity-bits selector 201 is connected to supply these selectively reproduced soft parity bits as write input signal to a memory 192 for temporarily storing the soft parity bits of the one-half-rate CC for each successive odd-numbered time-slice.

The memories 190, 191 and 192 together temporarily store all the components of the PCCC for a given service to be received by the M/H DTV receiver depicted in FIGS. 24, 25, 18 and 19. The PCCC is turbo decoded by soft-input/soft-output decoders 114 and 115 in FIG. 28. During the initial half of each cycle of turbo decoding, the SISO decoder 114 decodes one-half-rate CC that includes soft parity bits from an even-numbered time-slice of the service being received. During the final half of each cycle of turbo decoding, the SISO decoder 115 decodes one-half-rate CC that includes soft parity bits from an odd-numbered time-slice of the service being received. The soft data bits that the SISO decoders 114 and 115 supply from their respective output ports as respective decoding results are compared to combined soft data bits and soft extrinsic data bits read from the memory 190. This is done to generate updated soft extrinsic data bits to be written back to the memory 190. At the conclusion of turbo decoding, combined soft data bits and soft extrinsic data bits are read from the memory 190 to supply an ultimate turbo decoding result to the input port of the quantizer 122 in FIG. 21.

FIG. 28 shows the soft-symbols selector 116 connected for selecting soft data bits and soft parity bits to the SISO decoder 114 during the initial half of each cycle of turbo decoding. The soft-symbols selector 116 relays soft data bits additively combined with soft extrinsic data bits, if any, as read to a first input port thereof from the memory 190, thus to generate the soft data bits supplied to the first input port of the SISO decoder 114. The soft-symbols selector 116 reproduces the soft parity bits read to a second input port thereof from the memory 191, thus generating the soft parity bits supplied to the second input port of the SISO decoder 114.

The soft data bits supplied from the output port of the SISO decoder 114 as decoding results during the initial half of each cycle of turbo decoding are supplied to the extrinsic-data-feedback processor 117. The processor 117 differentially combines soft data bits read from the memory 190 with corresponding soft data bits of the SISO decoder 114 decoding results to generate extrinsic data feedback written into the memory 190 to update the soft extrinsic data bits temporarily stored therein.

FIG. 28 shows the soft-symbols selector 118 connected for selecting soft data bits and soft parity bits to the soft-symbols de-interleaver 119 during the final half of each cycle of turbo decoding. The soft symbols selector 118 relays soft data bits additively combined with soft extrinsic data bits, if any, as read to a first input port thereof from the memory 190 during the final half of each cycle of turbo decoding, thus to generate the soft data bits supplied to the soft-symbols de-interleaver 119. The soft-symbols selector 118 reproduces the soft parity bits read to a second input port thereof from the memory 192 during the final half of each cycle of turbo decoding, thus to generate the soft parity bits supplied to the soft symbols de-interleaver 119. The de-interleaving provided by soft-symbols de-interleaver 119 complements the bit interleaving provided by the bits interleaver 45 that either of FIGS. 5 and 6 shows being included in the PCCC encoder 10 or 35 of the DTV transmitter. The soft-symbols de-interleaver 119 responds to the soft data bits and soft parity bits supplied from the soft-symbols selector 118 during the final half of each cycle of turbo decoding to supply de-interleaved soft data bits and de-interleaved soft parity bits to the SISO decoder 115.

The soft data bits supplied from the output port of the SISO decoder 115 as decoding results during the final half of each cycle of turbo decoding are supplied to the input port of the soft-bits interleaver 120 in FIG. 28. The extrinsic data feedback processor 121 differentially combines soft data bits read from the memory 190 with corresponding soft data bits of the soft-bits interleaver 120 response to generate extrinsic data feedback written into the memory 190 to update the soft extrinsic data bits temporarily stored therein. After a last half cycle of the iterative turbo decoding procedure, soft data bits as additively combined with respectively corresponding soft extrinsic data bits are read from the memory 190 to the input port of the quantizer 122 depicted in FIG. 21.

In actual practice, the soft-symbols selector 116 may be incorporated into the structures of the memories 190 and 191, and the soft-symbols selector 118 may be incorporated into the structures of the memories 190 and 192. The soft-symbols de-interleaver 119 is apt not to appear as a separate physical element either. Instead, its function is subsumed into the memories 190 and 192 by suitable addressing of them when reading soft data bits and soft parity bits directly to the first and second input ports of the SISO decoder 115. The soft-bits interleaver 120 need not appear as a separate physical element either, its function being subsumed into the memory 190 by suitable addressing during operation of the extrinsic feedback data processor 121. Since the operations of the SISO decoders 114 and 115 alternate in time, a single decoder structure is apt be used for implementing both the SISO decoders 114 and 115. The foregoing description of turbo decoding describes each cycle as beginning with decoding of an odd-numbered time-slice and concluding with the decoding of an even-numbered time-slice. The order of decoding is arbitrarily chosen, however. Alternatively, turbo decoding can be done with each cycle thereof beginning with decoding of an odd-numbered time-slice and concluding with the decoding of an even-numbered time-slice.

The design of the FIG. 28 portion of an M/H DTV receiver is based on the presumption that the convolutional coding of initial transmissions of time-slices is symbol interleaved, but the convolutional coding of final transmissions of time-slices is not symbol interleaved. Alternatively, the convolutional coding of final transmissions of time-slices can be symbol interleaved, with the convolutional coding of initial transmissions of time-slices not being symbol interleaved. The FIG. 28 portion of the M/H DTV receiver is modified in the following ways to be able to receive such alternative transmissions usefully. The memory 191 is written with soft parity bits reproduced at the output port of the soft parity bits selector 201, rather than with soft parity bits reproduced at the output port of the soft parity bits selector 199. Furthermore, the memory 192 is written with soft parity bits reproduced at the output port of the soft parity bits selector 199, rather than with soft parity bits reproduced at the output port of the soft parity bits selector 201.

The temporary storage requirements for the memories 190, 191 and 192 shown in FIG. 28 are substantially smaller than the temporary storage requirements for the memories 190, 191 and 192 shown in FIG. 26. The memories 190, 191 and 192 shown in FIG. 26 each store respective bits from an entire frame of 256QAM symbol constellations, which frame is customarily one quarter of a super frame in duration. The memories 190, 191 and 192 shown in FIG. 28 each store respective bits from a single time-slice of 64QAM symbol constellations, which time-slice is customarily one thirty-secondth of a super frame in duration. The temporary storage requirements for the memories 190, 191 and 192 shown in FIG. 28 are smaller than the temporary storage requirements for the memories 190, 191 and 192 shown in FIG. 26 by a factor of eight, owing to a frame being eight times longer than a time-slice. The temporary storage requirements for the memories 190, 191 and 192 shown in FIG. 28 are smaller than the temporary storage requirements for the memories 190, 191 and 192 shown in FIG. 26 by an additional factor of four, owing to each 64QAM symbol constellation having four times fewer lattice points than each 256QAM symbol constellation. The temporary storage requirements for the memories 190, 191 and 192 shown in FIG. 28 are smaller than the temporary storage requirements for the memories 190, 191 and 192 shown in FIG. 26 by another additional factor of two, presuming OFDM transmissions for stationary reception use 8K carriers and OFDM transmissions for mobile reception use 4K carriers.

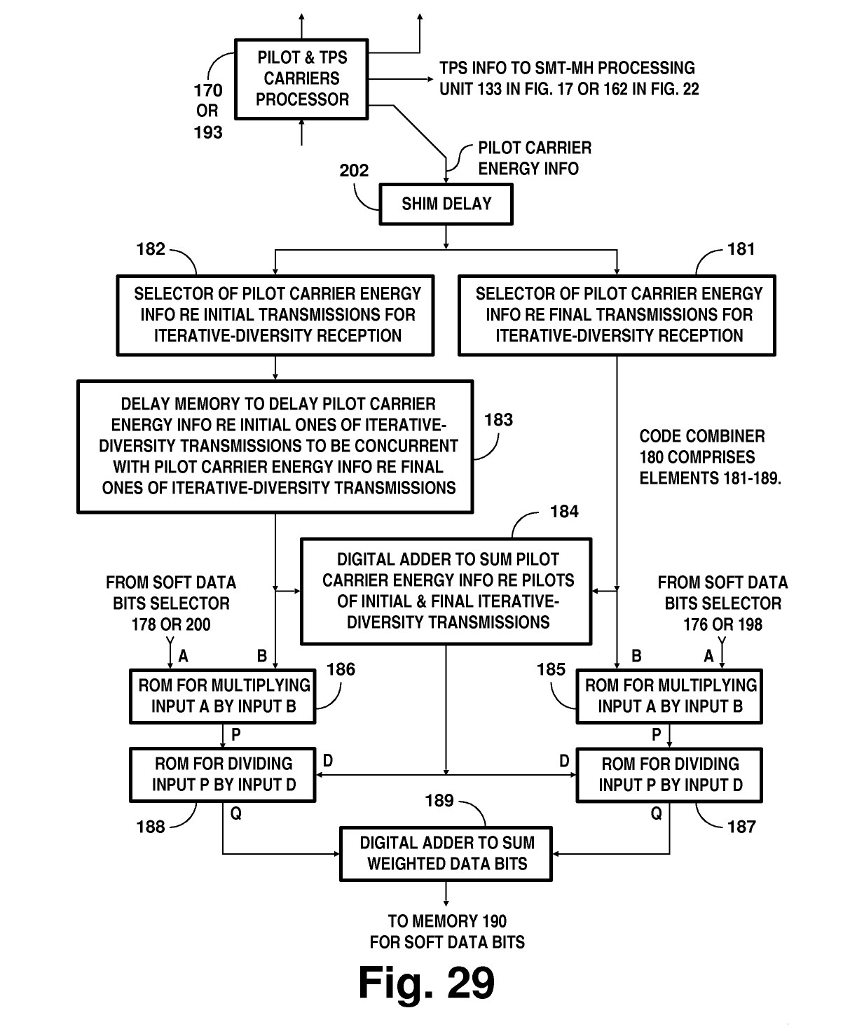

FIG. 29 is a more detailed schematic diagram showing the interconnection of elements 181, 182, 183, 184, 185, 186, 187, 188 and 189 of the maximal-ratio code combiner 180 shown in FIGS. 26 and 28. In the stationary DTV receiver of FIGS. 25, 26 and 17, the code combiner 180 shown in FIG. 29 is connected for receiving pilot-carrier-energy information from the pilot and TPS carriers processor 170. In the M/H receiver of FIGS. 27, 28, 21 and 22 the code combiner 180 shown in FIG. 29 is connected for receiving pilot-carrier-energy information from the pilot and TPS carriers processor 193. The pilot and TPS carriers processor 170 or 193 squares the real and imaginary terms of each unmodulated pilot carrier, sums the resulting squares and square-roots the sum to determine the root-mean-square (RMS) energy of that unmodulated pilot carrier. This procedure can be carried out for each unmodulated pilot carrier using read-only memory addressed by the real and imaginary terms of each successively considered unmodulated pilot carrier. The RMS energies of the unmodulated pilot carriers are then summed by an accumulator to determine the total RMS energy of the unmodulated pilot carriers for each OFDM symbol epoch.

The value of the total RMS energy supplied from the pilot and TPS carriers processor 170 or 193 is delayed by shim delay 202 for application to the respective input ports of selectors 181 and 182. The selector 181 reproduces at its output port the total energy of the unmodulated pilot carriers during those transmissions that are not repeated and the final ones of the those transmissions repeated for iterative-diversity reception. The selector 182 reproduces at its output port the total energy of the unmodulated pilot carriers during the initial ones of those transmissions repeated for iterative-diversity reception. A delay memory 183 is connected for delaying the selector 182 response for supplying a delayed selector 182 response concurrent with the selector 181 response.

In the stationary DTV receiver of FIGS. 25, 26 and 17 the length of delay afforded by the delay memory 183 is essentially the same as the length of delay afforded by the delay memory 175. Presumably, the latent delay of the pilot and TPS carriers processor 170 in generating the total energy of the unmodulated pilot carriers is shorter than the combined latent delays through the channel equalizer 171 and the de-mapper 172. The shim delay 202 compensates for this. However, the latent delay of the pilot and TPS carriers processor 170 in generating the total energy of the unmodulated pilot carriers could be longer than the combined latent delays through the channel equalizer 171 and the de-mapper 172. If so, the shim delay 202 is replaced by direct connection from the pilot and TPS carriers processor 170 to the selectors 181 and 182. Shim delay is instead introduced in the cascade connection of the channel equalizer 171 and the de-mapper 172.

In the M/H DTV receiver of FIGS. 27, 28, 21 and 22 the length of delay afforded by the delay memory 183 is essentially the same as the length of delay afforded by the delay memory 197. The latent delay of the pilot and TPS carriers processor 193 in generating the total energy of the unmodulated pilot carriers is supposedly shorter than the combined latent delays through the channel equalizer 145 and the de-mapper 194. The shim delay 202 compensates for this. The latent delay of the pilot and TPS carriers processor 193 in generating the total energy of the unmodulated pilot carriers may be longer than the combined latent delays through the channel equalizer 145 and the de-mapper 194, however. If so, the shim delay 202 is replaced by direct connection from the pilot and TPS carriers processor 193 to the selectors 181 and 182. Shim delay is introduced instead in the cascade connection of the channel equalizer 145 and the de-mapper 194.

A digital adder 184 is connected for adding the selector 181 response and the delayed selector 182 response read from the delay memory 183. The sum output response from the adder 184 combines the total energies of the initial and final transmissions for iterative-diversity reception, to be used for normalizing the weighting of the responses from the soft-data-bits selectors 176 and 178 or from the soft-data-bits selectors 198 and 200.

A read-only memory 185 is connected for multiplying the response from the soft-data-bits selector 176 in FIG. 26 (or 198 in FIG. 28) by the total energy of a final transmission for iterative-diversity reception. A read-only memory 186 is connected for multiplying the response from the soft-data-bits selector 178 in FIG. 26 (or 200 in FIG. 28) by the total energy of the corresponding initial transmission for iterative-diversity reception. The product from the ROM 185 is a weighted response from the soft-data-bits selector 176 (or 198) that is then normalized with respect to the total energies of the initial and final transmissions for iterative-diversity reception. A read-only memory 187 is connected for performing this normalization, dividing the product from the ROM 185 by the sum output response from the adder 184. The product from the ROM 186 is a weighted response from the soft-data-bits selector 178 (or 200) that is then normalized with respect to the total energies of the initial and final transmissions for iterative-diversity reception. A read-only memory 188 is connected for performing this normalization, dividing the product from the ROM 186 by the sum output response from the adder 184. A digital adder 189 is connected for summing the respective quotients from the ROMs 187 and 188 to generate the maximal-ratio code combiner response. This response is written to the memory 190 for soft data bits shown in FIG. 29 (or in FIG. 28).

One skilled in digital design is apt to perceive that, alternatively, normalization of the coefficients for weighting of the responses from the soft-data-bits selectors 176 and 178 or from the soft-data-bits selectors 198 and 200 can be performed before such weighting, rather than after. A single read-only memory can be designed to perform the combined functions of the ROMs 185 and 187; and a single read-only memory can be designed to perform the combined functions of the ROMs 186 and 188. Alternatively, a very large single read-only memory can be designed to perform the combined functions of the digital adder 189 and of the ROMs 185, 186, 187 and 188. The computations can be performed by digital circuitry other than read-only memories, but problems with proper timing are considerably more difficult.

The operation of the maximal-ratio code combiner 180 following a change in RF channel or sub-channel is of interest. Following such a change, a DTV receiver as described supra will not have correct foregoing initial transmissions for iterative-diversity reception stored in its delay memory 175 or 197. Accordingly, the DTV receiver erases in bulk the contents of the delay memory 175 or 197. The pilot and TPS carriers processor 170 or 193 will not have supplied the maximal-ratio code combiner 180 with correct information concerning the RMS-energy of pilot carriers accompanying the foregoing initial transmissions for iterative-diversity reception. Accordingly, the DTV receiver erases the contents of delay memory 183 within the maximal-ratio code combiner 180 that stores such information. This erasure conditions the maximal-ratio code combiner 180 for single-transmission reception until the delay memory 183 therein refills with information concerning the RMS-energy of pilot carriers accompanying the foregoing initial transmissions for iterative-diversity reception. During this delay in the maximal-ratio code combiner 180 beginning iterative-diversity reception, the delay memory 175 or 197 fills with initial transmissions for iterative-diversity reception to be supplied with delay to the code combiner 180 when iterative-diversity reception begins.

The maximal-ratio code combiner 180 combines one-dimensional, real-only coded data obtained from separately de-mapping paired QAM constellation maps. In accordance with a further aspect of the invention, the QAM constellation maps are designed so as not to admix data bits and parity bits of the PCCC in the bits that they respectively map. This makes it possible to use maximal-ratio code combining of the complex coordinates of the QAM constellation maps of data bits from the pairs of transmissions designed for iterative-diversity reception. When both the earlier transmissions of the QAM constellations and the later transmissions of the same QAM constellations are received in strength, such combining of the complex coordinates of paired QAM constellation maps of data bits permits improvement of coordinates estimation in the presence of additive white Gaussian noise (AWGN). This is because the complex coordinates of the paired QAM constellation maps of data bits should be correlated, while the AWGN is uncorrelated. Accordingly, errors in de-mapping are less likely to occur, as well as gaps in reception tending to be filled. Maximal-ratio code combining performed on the results of de-mapping QAM constellation maps of data bits tends to fill gaps in reception, but is not adapted to reducing AWGN. The two-dimensional maximal-ratio code combining of the complex coordinates of two similar QAM constellation maps is referred to as “maximal-ratio QAM combining” in the rest of this specification, and the apparatus for performing such code combining is referred to as a “maximal-ratio QAM combiner”. The operation of the maximal-ratio QAM combiner following a change in RF channel or sub-channel is analogous to the operation of a maximal-ratio coder combiner following a change in RF channel or sub-channel, as described in the paragraph just previous.

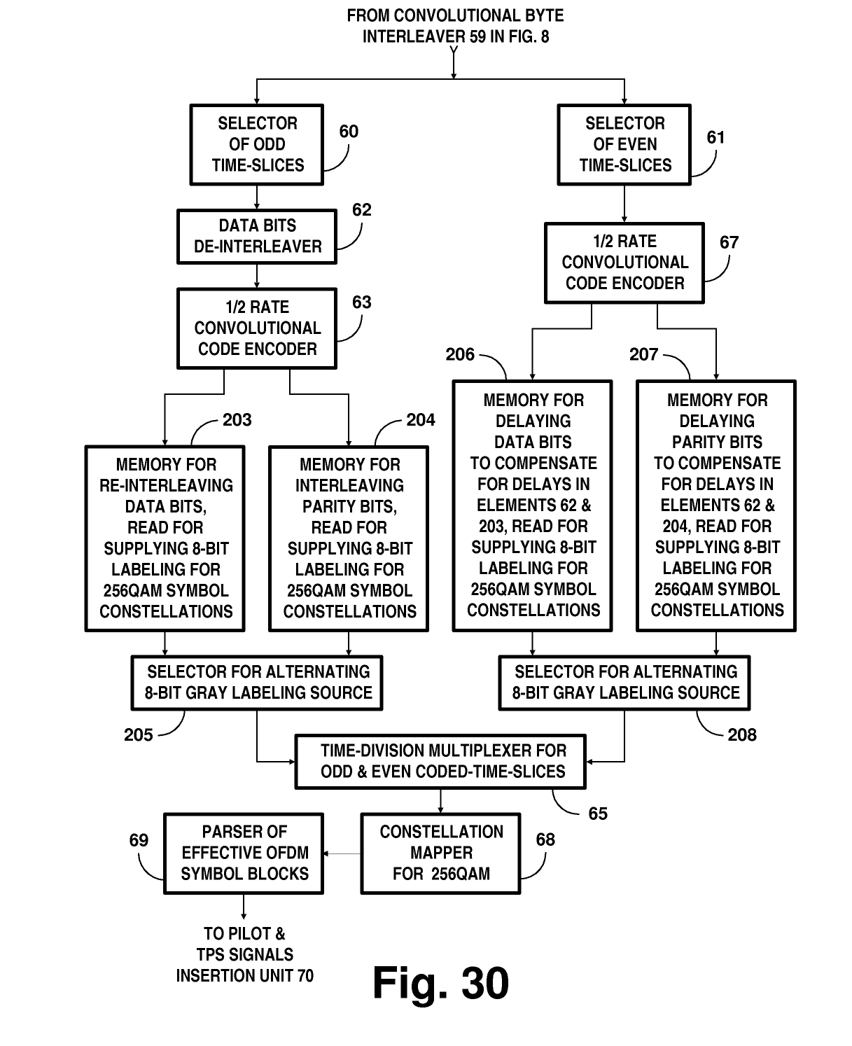

FIG. 30 shows modifications of the FIG. 9 portion of the COFDM transmitter. The respective input ports of the selectors 60 and 61 are still connected for receiving the response of the convolutional byte interleaver 59 shown in FIG. 8. The output port of the selector 60 of odd-numbered time-slices still connects to the input port of the data bits interleaver 62, and the output port of the data bits interleaver 62 still connects to the input port of the encoder 63 for one-half-rate convolutional coding (CC). However, in FIG. 30 the output port of the selector 61 of even-numbered time-slices connects directly to the input port of the encoder 67 for one-half-rate convolutional coding (CC) rather than connecting via delay memory as shown in FIG. 9.

In FIG. 30 the symbols interleaver 64 shown in FIG. 9 is replaced by random-access memories 203 and 204. The RAM 203 has a write-input port connected to be written with the data bits of one-half-rate CC of initial transmissions that subsequently are repeated for iterative-diversity reception, as supplied from a first output port of the CC encoder 63. The RAM 203 has a read-output port connected for supplying bytes of data bits to a first input port of a selector 205 of the 8-bit Gray labeling used by the 256QAM symbol constellation mapper 88 during odd-numbered time-slices. The RAM 204 has a write-input port connected to be written with the parity bits of the one-half-rate CC of the initial transmissions that subsequently are repeated for iterative-diversity reception, as supplied from a second output port of the CC encoder 63. The RAM 204 has a read-output port connected for supplying bytes of parity bits to a second input port of the selector 205 of the 8-bit Gray labeling used by the 256QAM symbol constellation mapper 68 during odd-numbered time-slices. The write addressing and read addressing of the RAMs 203 and 204 are co-operative to implement coded (or “implied”) symbol interleaving of the one-half-rate CC of initial transmissions that subsequently are repeated for iterative-diversity reception. This form of symbol interleaving cooperates with the bit de-interleaver 62 preceding the encoder 63 of one-half-rate CC to restore the order of the data bits supplied from the output port of the selector 205. FIG. 30 shows the output port of the selector 205 connected to supply a first input port of the time-division multiplexer 65 with 8-bit Gray labels for 256QAM constellation maps in odd-numbered time-slices of COFDM signals intended for iterative-diversity reception.

In FIG. 30 the delay to compensate for the latencies of the bits de-interleaver 62 and of the RAMs 203 and 204 is provided for by random-access memories 206 and 207. The RAM 206 has a write-input port connected to be written with the data bits of one-half-rate CC of those transmissions that are not repeated and of the final ones of those transmissions that are repeated, as supplied from a first output port of the CC encoder 67. The RAM 206 has a read-output port connected for supplying bytes of data bits to a first input port of a selector 208 of the 8-bit Gray labeling used by the 256QAM symbol constellation mapper 68 during even time-slices. The RAM 207 has a write-input port connected to be written with the parity bits of the one-half-rate CC of those transmissions that are not repeated and of the final ones of those transmissions that are repeated for iterative-diversity reception, as supplied from a second output port of the CC encoder 67. The RAM 207 has a read-output port connected for supplying bytes of parity bits to a second input port of the selector 208 of the 8-bit Gray labeling used by the 256QAM symbol constellation mapper 68 during even-numbered time-slices.

FIG. 30 shows the output port of the selector 208 connected to supply a second input port of the time-division multiplexer 65 with 8-bit Gray labels for 256QAM constellation maps in even-numbered time-slices of COFDM signals intended for iterative-diversity reception.

The time-division multiplexer 65 and the selectors 205 and 208 are depicted as physically separate elements as an aid to the reader in understanding the desired operation of the FIG. 30 configuration. In actual practice the functions of the time-division multiplexer 65 and of the selectors 205 and 208 can be subsumed into the read-control circuits of the RAMs 203, 204, 206 and 207, as one skilled in digital design will understand.

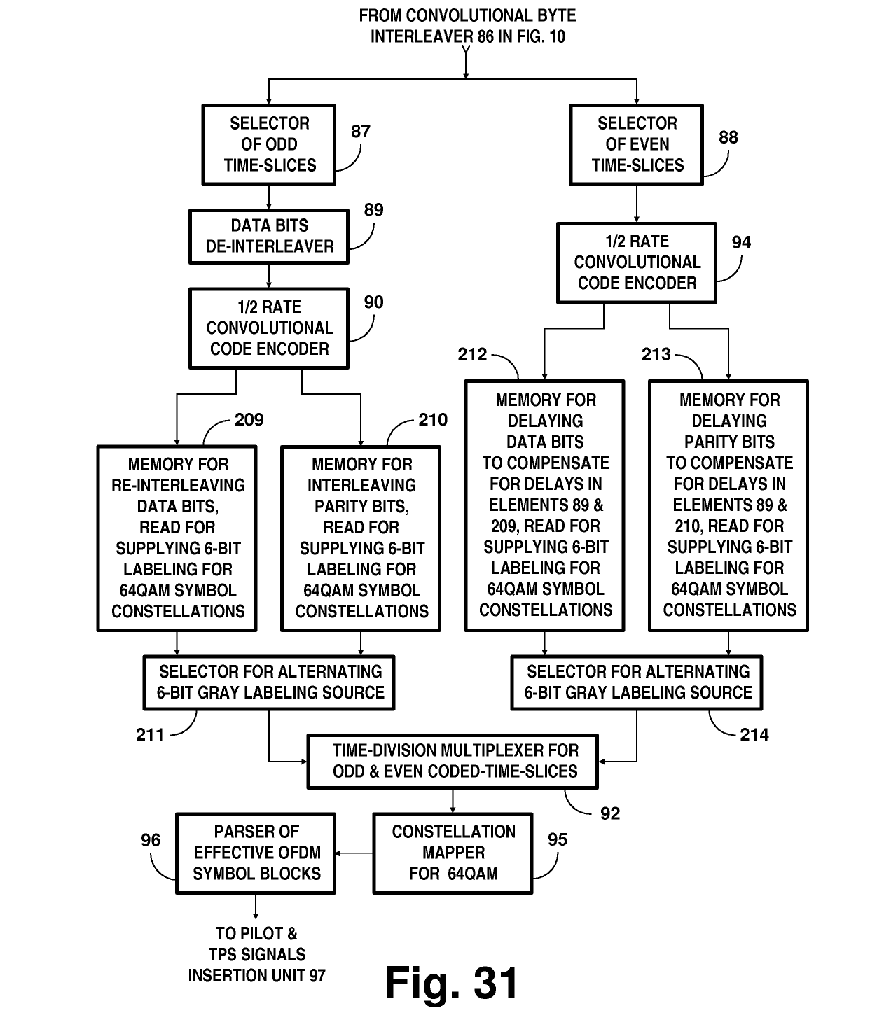

FIG. 31 shows modifications of the FIG. 11 portion of the COFDM transmitter. The respective input ports of the selectors 87 and 88 are still connected for receiving the response of the convolutional byte interleaver 86 shown in FIG. 10. The output port of the selector 87 of odd-numbered time-slices still connects to the input port of the data bits interleaver 89, and the output port of the data bits interleaver 89 still connects to the input port of the encoder 90 for one-half-rate convolutional coding (CC). The output port of the selector 88 of even-numbered time-slices still connects directly to the input port of the encoder 94 for one-half-rate convolutional coding (CC).

In FIG. 31 the symbols interleaver 91 shown in FIG. 11 is replaced by random-access memories 209 and 210. The RAM 209 has a write-input port connected to be written with the data bits of one-half-rate CC of initial transmissions that subsequently are repeated for iterative-diversity reception, as supplied from a first output port of the CC encoder 90. The RAM 209 has a read-output port connected for supplying data bits to a first input port of a selector 211 of the 6-bit Gray labeling used by the 64QAM symbol constellation mapper 95 during even-numbered time-slices. The RAM 210 has a write-input port connected to be written with the parity bits of the one-half-rate CC of the initial transmissions that subsequently are repeated for iterative-diversity reception, as supplied from a second output port of the CC encoder 90. The RAM 210 has a read-output port connected for supplying data bits to a second input port of the selector 211 of the 6-bit Gray labeling used by the 64QAM symbol constellation mapper 95 during odd-numbered time-slices. The write addressing and read addressing of the RAMs 209 and 210 are co-operative to implement coded (or “implied”) symbol interleaving of the one-half-rate CC of initial transmissions that subsequently are repeated for iterative-diversity reception. FIG. 31 shows the output port of the selector 211 connected for supplying a first input port of the time-division multiplexer 92 with 6-bit Gray labels for 64QAM constellation maps for just data bits, alternating with 6-bit Gray labels for 64QAM constellation maps for just parity bits.

In FIG. 31 the delay to compensate for the latencies of the bits de-interleaver 89 and of the RAMs 209 and 210 is provided for by random-access memories 212 and 213. The RAM 212 has a write-input port connected to be written with the data bits of one-half-rate CC of those transmissions that are not repeated and of the final ones of those transmissions that are repeated, as supplied from a first output port of the CC encoder 94. The RAM 213 has a read-output port connected for supplying data bits to a first input port of a selector 214 of the 6-bit Gray labeling used by the 64QAM symbol constellation mapper 95 during even-numbered time-slices. The RAM 213 has a write-input port connected to be written with the parity bits of the one-half-rate CC of those transmissions that are not repeated and of the final ones of those transmissions that are repeated for iterative-diversity reception, as supplied from a second output port of the CC encoder 94. The RAM 213 has a read-output port connected for supplying parity bits to a second input port of the selector 214 of the 6-bit Gray labeling used by the 64QAM symbol constellation mapper 95 during even-numbered time-slices. FIG. 31 shows the output port of the selector 214 connected for supplying a second input port of the time-division multiplexer 92 with 6-bit Gray labels for 64QAM constellation maps of just data bits, alternating with 6-bit Gray labels for 64QAM constellation maps of just parity bits.

The time-division multiplexer 92 and the selectors 211 and 214 are depicted as physically separate elements as an aid to the reader in understanding the desired operation of the FIG. 31 configuration. In actual practice the functions of the time-division multiplexer 92 and of the selectors 211 and 214 can be subsumed into the read-control circuits of the RAMs 209, 210, 212 and 213, as one skilled in digital design will understand.

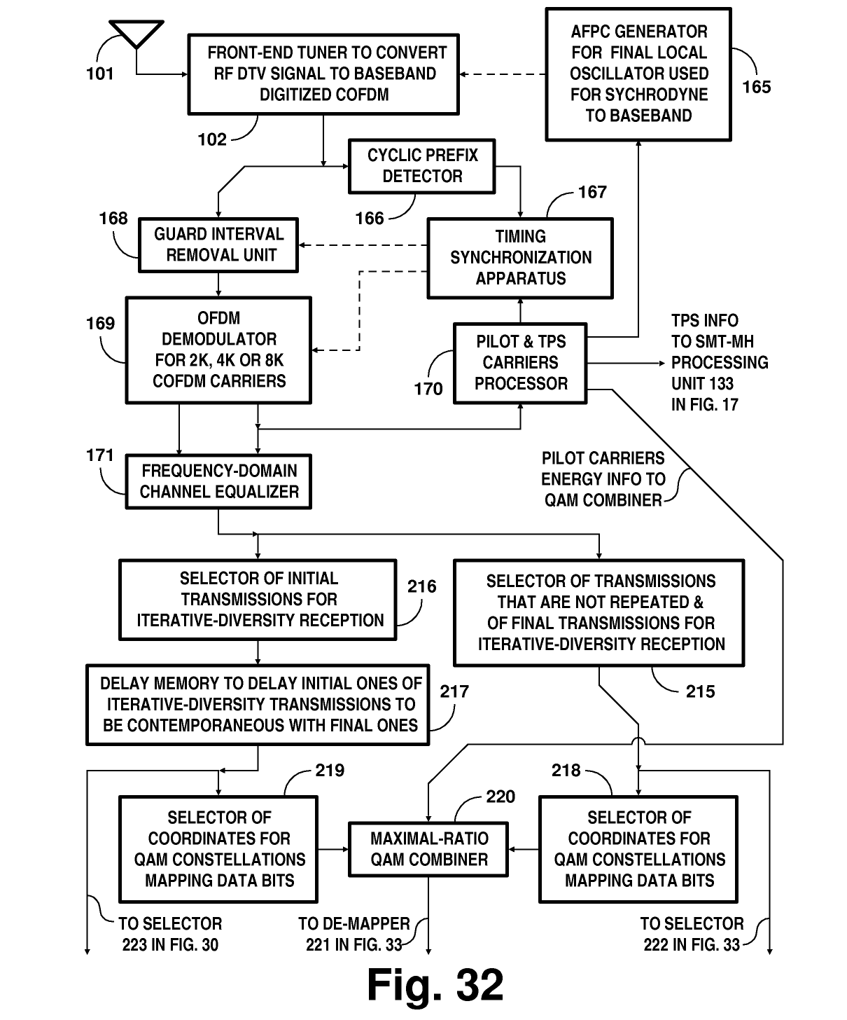

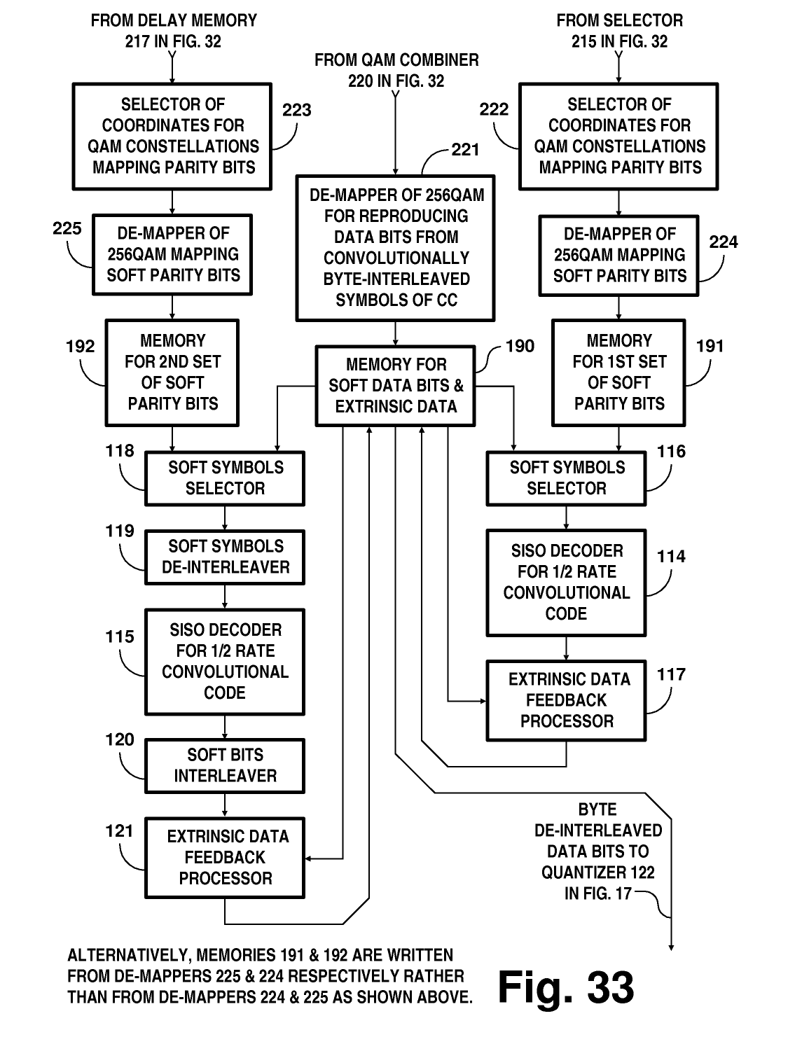

FIGS. 32 and 33 show modifications made to FIGS. 25 and 26 of the stationary DTV receiver of FIGS. 25, 26 and 17 in an alternative stationary DTV receiver suited for receiving transmissions from the DTV transmitter of FIGS. 1, 2, 3 and 4 with its FIG. 2 portion modified per FIG. 30. FIG. 32 differs from FIG. 25 in that the de-mapper 172 is omitted and the response of the frequency-domain channel equalizer 171 is supplied directly to the input ports of selectors 215 and 216. In the FIG. 32 configuration the selectors 215 and 216 selectively respond to the complex coordinates of 256QAM symbol constellations supplied from the frequency-domain channel equalizer 171, rather than to demodulated PCCC from the omitted de-mapper 172 of 256QAM symbol constellations. A delay memory 217 delays the complex coordinates of 256QAM symbol constellations from the initial transmissions that subsequently are repeated for iterative-diversity reception, as reproduced at the output port of the selector 216. The complex coordinates of 256QAM symbol constellations from the initial transmissions reproduced after delay at the output port of the delay memory 217 are concurrent with the complex coordinates of corresponding 256QAM symbol constellations from the final transmissions reproduced at the output port of the selector 215. The output port of the selector 215 is connected to the input port of a selector 218 that reproduces at its own output port the complex coordinates of 256QAM symbol constellations descriptive of data bits, as selected from the final transmissions for iterative-diversity reception. The output port of the delay memory 217 is connected to the input port of a selector 219 that reproduces at its own output port delayed complex coordinates of 256QAM symbol constellations descriptive of data bits, as selected from the initial transmissions for iterative-diversity reception.

FIG. 32 shows a maximal-ratio QAM combiner 220 for combining the complex coordinates of 256QAM symbol constellations descriptive of data bits, as selected by the selector 218 from the final transmissions for iterative-diversity reception, with the complex coordinates of corresponding 256QAM symbol constellations descriptive of data bits, as selected by the selector 219 from the delayed initial transmissions for iterative-diversity reception. The complex coordinates of 256QAM symbol constellations descriptive of data bits, as selected from the final transmissions for iterative-diversity reception, are supplied to a first input port of the QAM combiner 220 from the output port of the selector 218. The input port of the selector 218 is connected for receiving the complex coordinates of 256QAM symbol constellations from the final transmissions that are repeated for iterative-diversity reception, as reproduced at the output port of the selector 215. The complex coordinates of 256QAM symbol constellations descriptive of data bits, as selected from the delayed initial transmissions for iterative-diversity reception, are supplied to a second input port of the QAM combiner 220 from the output port of the selector 219. The input port of the selector 219 is connected for receiving the delayed response of the delay memory 217 to the complex coordinates of 256QAM symbol constellations, as selected by the selector 216 from the initial transmissions for iterative-diversity reception. The output port of the QAM combiner 220 connects to the input port of a de-mapper 221 for 256QAM symbol constellations, which de-mapper 221 is depicted in FIG. 33.

FIG. 33 shows the input port of the de-mapper 221 of 256QAM symbol constellations connected for receiving the response of the QAM combiner 220, which response supplies the complex coordinates of 256QAM symbol constellations descriptive of data bits of the PCCC. The de-mapper 221 de-maps these data bits, supplying soft data bits of the PCCC from its output port to the random-access port of the memory 190 for soft data bits and extrinsic data. The soft data bits are written into the storage locations for soft data bits within the memory 190.

FIG. 33 shows a selector 222 with an input port connected for receiving the response of the selector 215 shown in FIG. 32. The selector 222 is operable for selectively reproducing the complex coordinates of 256QAM symbol constellations descriptive of parity bits from the final transmissions for iterative-diversity reception. The output port of the selector 222 is connected for supplying these selectively reproduced complex coordinates to the input port of a de-mapper 224 of 256QAM symbol constellations. The de-mapper 224 de-maps a first set of PCCC parity bits, supplying them from its output port to the write-input port of the memory 191 for that first set of PCCC parity bits.

FIG. 33 shows a selector 223 with an input port connected for receiving the response of the delay memory 217 shown in FIG. 32. The selector 223 is operable for selectively reproducing the complex coordinates of 256QAM symbol constellations descriptive of parity bits from the delayed initial transmissions for iterative-diversity reception. The output port of the selector 223 is connected for supplying these selectively reproduced complex coordinates to the input port of a de-mapper 225 of 256QAM symbol constellations. The de-mapper 225 de-maps a second set of PCCC parity bits, supplying them from its output port to the write-input port of the memory 192 for that second set of PCCC parity bits.

The design of the FIG. 33 portion of a stationary DTV receiver is based on the presumption that the convolutional coding of initial transmissions of time-slices is symbol interleaved, but the convolutional coding of final transmissions of time-slices is not symbol interleaved. Alternatively, the convolutional coding of final transmissions of time-slices can be symbol interleaved, with the convolutional coding of initial transmissions of time-slices not being symbol interleaved. The FIG. 33 portion of the stationary DTV receiver is modified in the following ways to be able to receive such alternative transmissions usefully. The memory 191 is written with soft parity bits supplied from the output port of the 256QAM symbol constellation de-mapper 225, rather than with soft parity bits supplied from the output port of the de-mapper 224. Furthermore, the memory 192 is written with soft parity bits supplied from the output port of the 256QAM symbol constellation de-mapper 224, rather than with soft parity bits supplied from the de-mapper 225.

The memories 190, 191 and 192 together temporarily store all the components of the PCCC for a given service to be received by the stationary DTV receiver depicted in FIGS. 32, 33 and 17. The PCCC is turbo decoded by soft-input/soft-output decoders 114 and 115 in FIG. 33 in cooperation with the elements 116-121, operation being similar to that described supra with reference to FIGS. 26 and 16. At the conclusion of turbo decoding, combined soft data bits and soft extrinsic data bits are read from the memory 190 to supply an ultimate turbo decoding result to the input port of the quantizer 122 shown in FIG. 17.

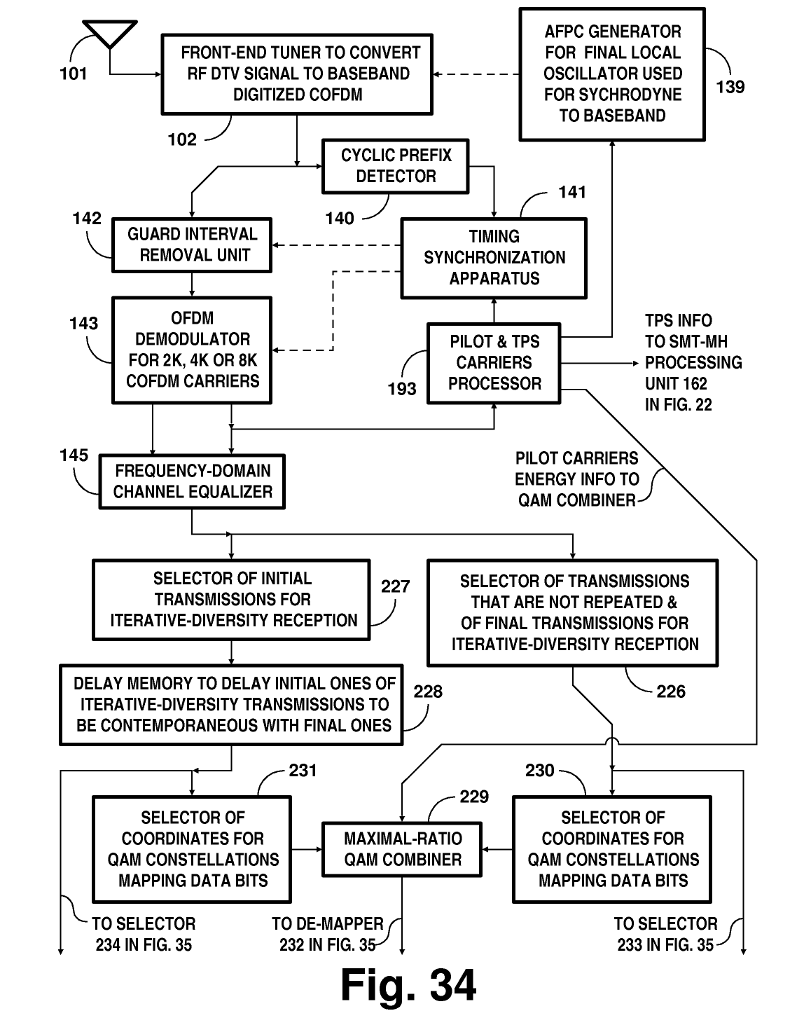

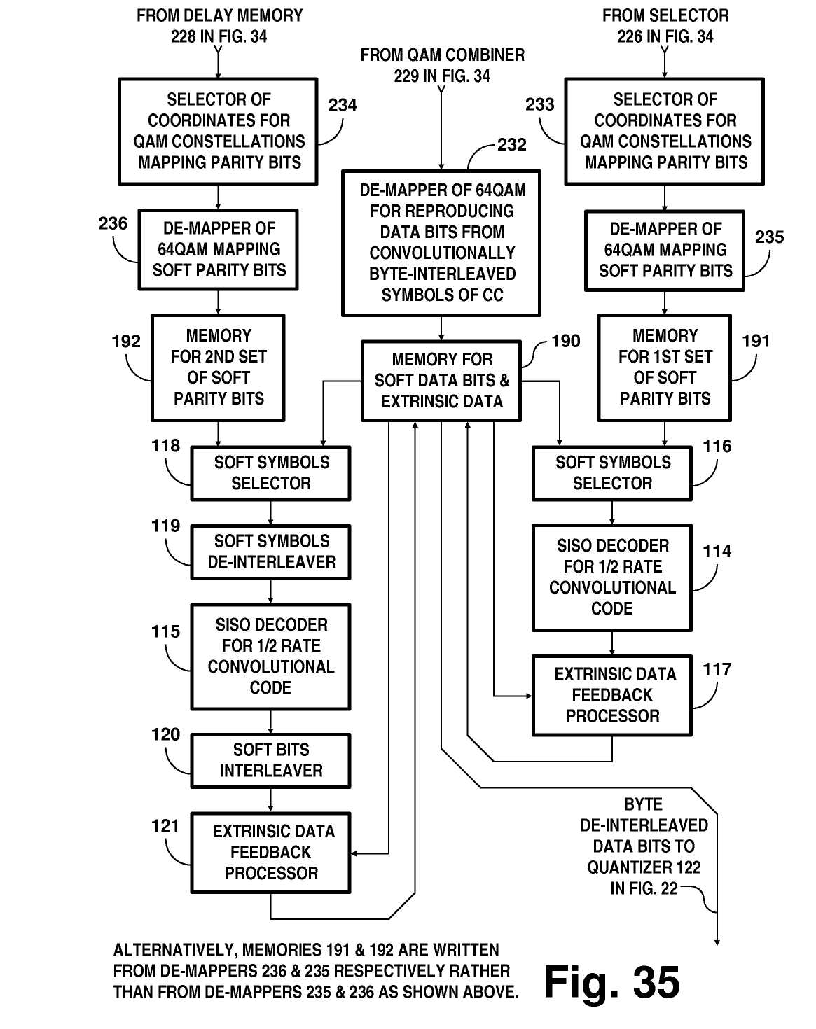

FIGS. 34 and 35 show modifications made to FIGS. 27 and 28 of the M/H DTV receiver of FIGS. 27, 28, 21 and 22 in an alternative M/H DTV receiver suited for receiving transmissions from the DTV transmitter of FIGS. 1, 2, 3 and 4 with its FIG. 4 portion modified per FIG. 31. FIG. 34 differs from FIG. 27 in that the de-mapper 194 is omitted and the response of the frequency-domain channel equalizer 145 is supplied directly to the input ports of selectors 226 and 227. In the FIG. 34 configuration the selectors 226 and 227 selectively respond to the complex coordinates of 64QAM symbol constellations supplied from the frequency-domain channel equalizer 145, rather than to demodulated PCCC from the omitted de-mapper 194 of 64QAM symbol constellations. A delay memory 228 delays the complex coordinates of 64QAM symbol constellations from the initial transmissions that subsequently are repeated for iterative-diversity reception, as reproduced at the output port of the selector 227. The complex coordinates of 64QAM symbol constellations from the initial transmissions reproduced after delay at the output port of the delay memory 228 are concurrent with the complex coordinates of corresponding 64QAM symbol constellations from the final transmissions reproduced at the output port of the selector 226.

FIG. 34 shows a maximal-ratio QAM combiner 229 for combining the complex coordinates of 64QAM symbol constellations descriptive of data bits, as selected by a selector 230 from the final transmissions for iterative-diversity reception, with the complex coordinates of corresponding 64QAM symbol constellations descriptive of data bits, as selected by a selector 231 from the delayed earlier initial transmissions for iterative-diversity reception. The output port of the selector 230 is connected for supplying a first input port of the QAM combiner 229 with complex coordinates of 64QAM symbol constellations descriptive of data bits, as selected from complex coordinates of corresponding 64QAM symbol constellations from the final transmissions that are supplied to the input port of the selector 230 from the output port of the selector 226. The complex coordinates of 64QAM symbol constellations descriptive of data bits, as selected from the delayed initial transmissions for iterative-diversity reception, are supplied to a second input port of the QAM combiner 229 from the output port of the selector 231. The input port of the selector 231 is connected for receiving the delayed response of the delay memory 228 to the complex coordinates of 64QAM symbol constellations, as selected by the selector 227 from the initial transmissions for iterative-diversity reception. The output port of the QAM combiner 229 connects to the input port of a de-mapper 232 for 64QAM symbol constellations, which de-mapper 232 is depicted in FIG. 35.

FIG. 35 shows the input port of the de-mapper 232 of 64QAM symbol constellations connected for receiving the response of the QAM combiner 229, which response supplies the complex coordinates of 64QAM symbol constellations descriptive of data bits of the PCCC. The de-mapper 232 de-maps these data bits, supplying soft data bits of the PCCC from its output port to the random-access port of the memory 190 for soft data bits and extrinsic data. The soft data bits are written into the storage locations for soft data bits within the memory 190.

FIG. 35 shows a selector 233 with an input port connected for receiving the response of the selector 226 shown in FIG. 34. The selector 233 is operable for selectively reproducing the complex coordinates of 64QAM symbol constellations descriptive of parity bits from the final transmissions for iterative-diversity reception. The output port of the selector 233 is connected for supplying these selectively reproduced complex coordinates to the input port of a de-mapper 235 of 64QAM symbol constellations. The de-mapper 235 de-maps a first set of PCCC parity bits, supplying them from its output port to the write-input port of the memory 191 for that first set of PCCC parity bits.

FIG. 35 shows a selector 234 with an input port connected for receiving the response of the delay memory 228 shown in FIG. 34. The selector 234 is operable for selectively reproducing the complex coordinates of 64QAM symbol constellations descriptive of parity bits from initial transmissions for iterative-diversity reception, as delayed by the delay memory 228. The output port of the selector 234 is connected for supplying these selectively reproduced complex coordinates to the input port of a de-mapper 236 of 64QAM symbol constellations. The de-mapper 236 de-maps a second set of PCCC parity bits, supplying them from its output port to the write-input port of the memory 192 for that second set of PCCC parity bits.

The design of the FIG. 35 portion of an M/H DTV receiver is based on the presumption that the convolutional coding of initial transmissions of time-slices is symbol interleaved, but the convolutional coding of final transmissions of time-slices is not symbol interleaved. Alternatively, the convolutional coding of final transmissions of time-slices can be symbol interleaved, with the convolutional coding of initial transmissions of time-slices not being symbol interleaved. The FIG. 35 portion of the M/H DTV receiver is modified in the following ways to be able to receive such alternative transmissions usefully. The memory 191 is written with soft parity bits supplied from the output port of the 64QAM symbol constellation de-mapper 236, rather than with soft parity bits supplied from the output port of the de-mapper 235. Furthermore, the memory 192 is written with soft parity bits supplied from the output port of the 64QAM symbol constellation de-mapper 235, rather than with soft parity bits supplied from the output port of the de-mapper 236.

The memories 190, 191 and 192 together temporarily store all the components of the PCCC for a given service to be received by the M/H DTV receiver depicted in FIGS. 34, 35, 21 and 22. The PCCC is turbo decoded by soft-input/soft-output decoders 114 and 115 in FIG. 35 in cooperation with the elements 116-121, operation being similar to that described supra with reference to FIGS. 28 and 20. At the conclusion of turbo decoding, combined soft data bits and soft extrinsic data bits are read from the memory 190 to supply an ultimate turbo decoding result to the input port of the quantizer 122 shown in FIG. 21.

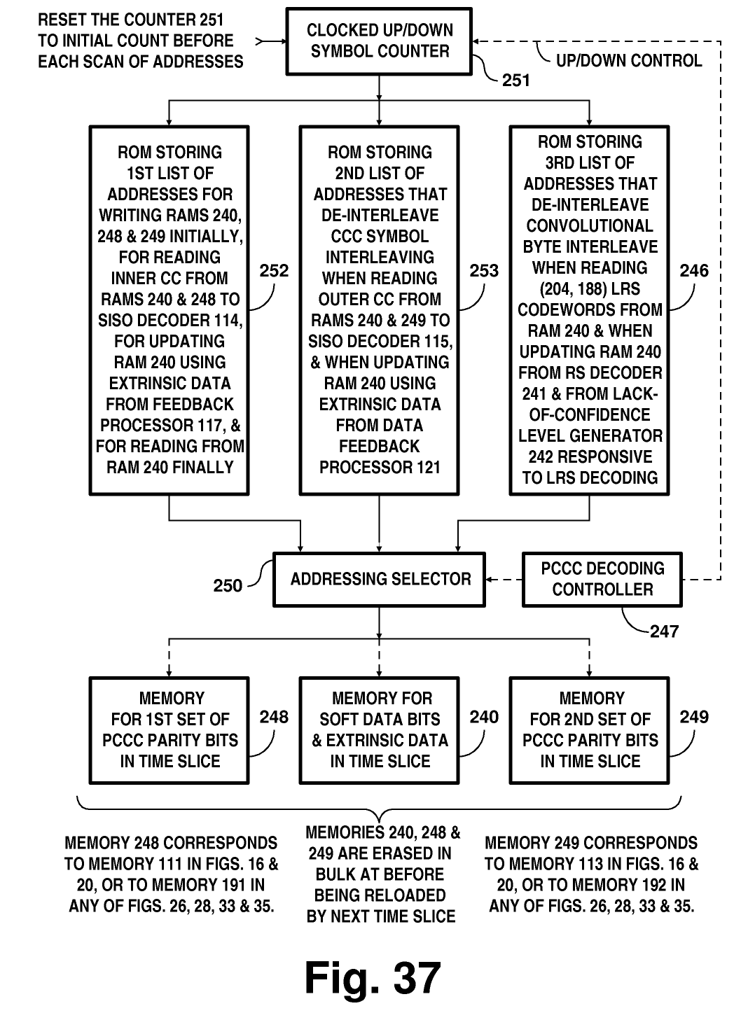

FIG. 36 shows further elements included in preferred connections to and from a memory 240 for soft data bits and extrinsic data that replaces the memory 112 in the turbo decoders of FIGS. 16 and 20, the memory 190 in the turbo decoders of FIGS. 26 and 33, or the memory 190 in the turbo decoders of FIGS. 28 and 35. These further elements are operable to decrease lack-of-confidence levels of data bits of correct (204, 188) lateral Reed-Solomon (LRS) codewords temporarily stored within the memory 240 during the performance of turbo decoding procedures. A third address generator comprising a read-only memory 246 shown in FIG. 37, but not explicitly shown in FIG. 36, is used for addressing the memory 240 so as to de-interleave the convolutional byte interleaving of soft bits of (204, 188) LRS codewords read from the memory 240 during a break in a normal cycle of turbo decoding procedure. The respective hard-decision bits of these soft bits of (204, 188) LRS codewords are supplied to the input port of an LRS decoder 241 for (204, 188) Reed-Solomon coding. The respective further bits of these soft bits expressive of confidence levels for their respective hard-decision bits are supplied to an input port of a generator 242 of lower or lowest lack-of-confidence levels for bits of (204, 188) RS codewords that are correct(ed). I. e., for bits of (204, 188) LRS codewords that were originally correct or that have been corrected by the LRS decoder 241 for (204, 188) LRS coding. The lack-of-confidence level generator 242 includes a temporary storage register for the lack-of-confidence levels of each successive (204, 188) LRS codeword.

The lack-of-confidence level generator 242 can include circuitry responsive to the lack-of-confidence levels of hard-decision bits in each (204, 188) LRS codeword to locate byte errors for the LRS decoder 241. This allows the LRS decoder 241 to use a byte-error-correction-only algorithm that can correct sixteen byte errors per (204, 188) LRS codeword, rather than a byte-error-location-and-correction-only algorithm that can correct only eight byte errors per (204, 188) LRS codeword. FIG. 36 shows a connection 243 for conveying byte-error-location information from the lack-of-confidence level generator 242 to the LRS decoder 241.

When the LRS decoder 241 finds a (204, 188) LRS codeword to be correct or is able to correct it, the LRS decoder 241 supplies the memory 240 an over-write enable signal conditioning the memory 240 to accept over-writing of the soft data bits regarding that (204, 188) RS codeword. The soft data bits used for such over-writing are composed of hard-decision bits supplied by the LRS decoder 241 and accompanying further bits indicative of the lack-of-confidence levels regarding those hard-decision bits, which further bits are supplied by the lack-of-confidence level generator 242. The over-write enable signal conditions the third address generator comprising the ROM 246, used to address the memory 240 during over-writing the soft data bits regarding a (204, 188) LRS codeword, so as to convolutionally interleave the bytes of the correct(ed) LRS codeword.

When the LRS decoder 241 finds a (204, 188) RS codeword to be correct or is able to correct it, the LRS decoder 241 supplies the lack-of-confidence level generator 242 a pulse indication that this is so. The lack-of-confidence level generator 242 responds to this pulse indication to decrease, if possible, the lack-of-confidence levels of the bits of the correct(ed) RS codeword written back to the memory 240. This can be done, for example, by subtracting a specified increment from the lack-of-confidence level of each soft data bit stored in the temporary storage register and replacing any negative lack-of-confidence level with a zero-valued lack-of-confidence level.

FIG. 36 shows an up-counter 244, the count input port of which is connected for receiving the pulse indications the RS decoder 241 supplies responsive to finding (204, 188) RS codewords to be correct(ed). The count supplied from the count output port of the up-counter 244 is reset to zero at the beginning of each cycle of turbo decoding. The count output port of the up-counter 244 is connected for supplying the count of correct (204, 188) LRS codewords per time-slice to the input port of a detector 245 of reaching the full count of correct LRS codewords per time-slice. That is, the count of correct LRS codewords per time-slice associated with every one of the (204, 188) LRS codewords in a time-slice being correct. The value for such full count for a time-slice is specified to the detector 245 from the pilot and TPS carriers processor 108, 144, 170 or 193. If the full count of correct LRS codewords per time-slice is reached at the conclusion of a cycle of turbo decoding, the detector 245 supplies an indication of this condition to a PCCC decoding controller 247. The PCCC decoding controller 247, shown in FIG. 37, can respond by concluding turbo decoding of the time-slice earlier than a prescribed maximum time for turbo decoding of the time-slice.

The up-counter 244 for counting correct LRS codewords per time-slice and the detector 245 of the full count of correct LRS codewords per time-slice being reached can be replaced by a down-counter and a detector for zero count being reached in an alternative arrangement for concluding turbo decoding of the time-slice earlier than a prescribed maximum time for turbo decoding of the time-slice. At the beginning of each cycle of turbo decoding, the count supplied from the count output port of the down-counter is reset to a top count specified by the pilot and TPS carriers processor 108, 144, 170 or 193. The count output from the down-counter is supplied to the input port of the detector for zero count being reached. If zero count has been reached at the conclusion of a cycle of turbo decoding, the PCCC decoding controller 247, shown in FIG. 37, can respond by concluding turbo decoding of the time-slice.

Variants of the lack-of-confidence level generator 242 described above simply replace the lack-of-confidence levels of all the soft bits of correct(ed) LRS codewords written back to the memory 240 with zero-valued or very-low-valued lack-of-confidence levels. The convolutional byte interleaving of a correct(ed) LRS codeword written back to the memory 240 disperses the soft data bits with decreased levels of lack-of-confidence throughout the CC presented to the SISO decoder 114 for decoding. The convolutional byte interleaving of the correct(ed) LRS codeword also disperses the soft data bits with decreased levels of lack-of-confidence throughout the CC presented to the SISO decoder 115 for decoding. The dispersal of data bits with low lack-of-confidence levels throughout the CC presented to the SISO decoder 114 facilitates its selecting data bit sequences most likely to be correct as its decoding results. The dispersal of data bits with low lack-of-confidence levels throughout the CC presented to the SISO decoder 115 facilitates its selecting data bit sequences most likely to be correct as its decoding results.

FIG. 37 depicts apparatus for addressing memories within of any of the turbo decoders shown in FIGS. 16, 20, 26, 28, 33 and 35, as modified per FIG. 36. FIG. 37 shows the memory 240, a memory 248 for a first set of PCCC parity bits in a time-slice, and a memory 249 for a second set of PCCC parity bits in a time-slice, all of which memories are connected for receiving addresses from an addressing selector 250. The addressing selector 250 is connected for receiving control signal from the PCCC decoding controller 247, which control signal determines the selection of addressing made by the addressing selector 250. The memory 248 corresponds to the memory 111 in either of FIGS. 16 and 20, or to the memory 191 in any of FIGS. 26, 28, 33 and 35. The memory 249 corresponds to the memory 113 in either of FIGS. 16 and 20, or to the memory 192 in any of FIGS. 26, 28, 33 and 35. The respective temporarily stored contents of the memories 240, 248 and 249 are erased in bulk before being reloaded to begin the processing of a succeeding time-slice.

A clocked up/down symbol counter 251 is reset to initial count, ordinarily arithmetic zero for an up count, at the beginning of each address scan of the memories 240, 248 and 249. The count from the symbol counter 251 is supplied as read addressing to each of three read-only memories 252, 253 and 246. The symbol counter 251 is connected for receiving an up/down control signal from the PCCC decoding controller 247. The symbol counter 251 is conditioned to count up when the memories 240, 248 and 249 are originally written using write addressing generated by scanning the first list of addresses stored in the ROM 252. The symbol counter 251 is conditioned to count down during the reversed-time scanning of symbols performed during turbo decoding procedures.

The ROM 252, storing a first list of addresses for the memories 248, 240 and 249, functions as a first address generator. The memories 248, 240 and 249 are addressed according to forward scanning of a suitable first list when they are initially written with soft bits of a new time-slice. Such operations are described more particularly, as follows. The memories 111, 112 and 113 in FIG. 16 are addressed according to forward scanning of a suitable first list when they are initially written with soft bits of a new time-slice supplied from the de-mapper 110 in FIG. 15. The memories 111, 112 and 113 in FIG. 20 are addressed according to forward scanning of a suitable first list when they are initially written with soft bits of a new time-slice supplied from the de-mapper 146 in FIG. 19. The memories 190, 191 and 192 in FIG. 26 are addressed according to forward scanning of a suitable first list when they are initially written with soft bits of a new time-slice supplied from the soft parity bits selector 177, from the code combiner 180 and from the soft parity bits selector 179, respectively. The memories 190, 191 and 192 in FIG. 28 are addressed according to forward scanning of a suitable first list when they are initially written with soft bits of a new time-slice supplied from the soft parity bits selector 199, from the code combiner 180 and from the soft parity bits selector 201, respectively. The memories 190, 191 and 192 in FIG. 33 are addressed according to forward scanning of a suitable first list when they are initially written with soft bits of a new time-slice from the de-mapper 221, from the de-mapper 224 and from the de-mapper 225, respectively. The memories 190, 191 and 192 as shown in FIG. 35 are addressed according to forward scanning of a suitable first list when they are written with soft-bit responses from the de-mapper 232, from the de-mapper 235 and from the de-mapper 236, respectively.

The memories 240 and 248 are addressed according to reversed scanning of a first list stored in ROM 252 when they read soft data bits, soft extrinsic-data bits and soft parity bits of first CC to the SISO decoder 114 for decoding of first CC in the time-slices. The memory 240 is addressed according to reversed scanning of a first list stored in ROM 252 when soft extrinsic data bits are updated by the extrinsic data feedback processor 117 responsive to decoding results from the SISO decoder 114.

The ROM 253, storing a second list of addresses for the memories 240 and 249, functions as a second address generator. The memories 240 and 249 are addressed according to this second list stored in the ROM 253 when reading soft data bits, soft extrinsic-data bits and soft parity bits of second CC to the SISO decoder 115 for decoding of second CC in the time-slices. Such read addressing provides de-interleaving to counteract symbol interleaving introduced at the DTV transmitter. The memory 240 is addressed according to this second list when soft extrinsic data bits are updated by the extrinsic data feedback processor 121 responsive to decoding results from the SISO decoder 115.

The ROM 246, storing a third list of addresses for the memory 240, functions as a third address generator. The memory 240 is addressed according to this third list stored in the ROM 246 when reading (204, 188) LRS codewords from the memory 240. Such read addressing provides de-interleaving to counteract the convolutional byte interleaving introduced at the DTV transmitter. The memory 240 is also addressed according to this third list stored in the ROM 246 when writing corrected (204, 188) LRS codewords back into the memory 240 together with updated confidence levels regarding the hard data bits in those codewords. Such write addressing restores the convolutional byte interleaving introduced at the DTV transmitter.

The addressing selector 250 is operable for reproducing at its output port the read output response from a selected one of the ROMs 252, 253 and 246 connected for supplying their respective read output responses to respective ones of first, second and third input ports of the addressing selector 250. The PCCC decoding controller 246 is connected for supplying a dual-bit control signal to the addressing selector 250 to control selection of the appropriate one of the addressing scans read from the ROMs 252, 253 and 246.

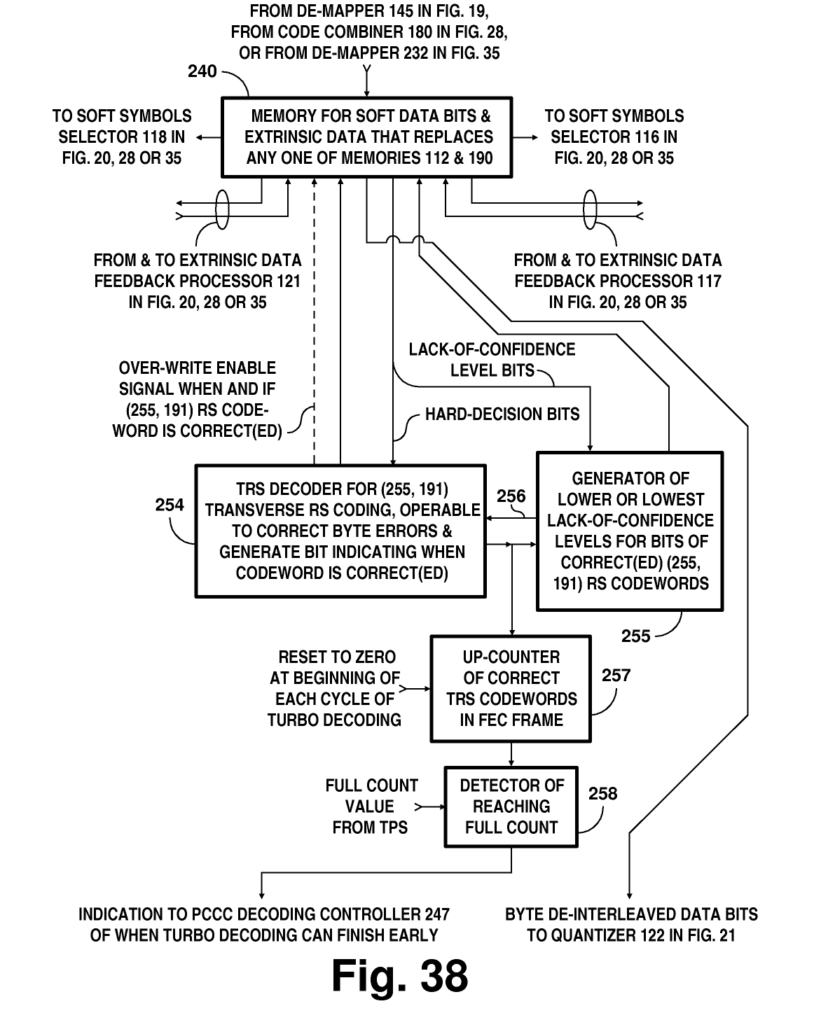

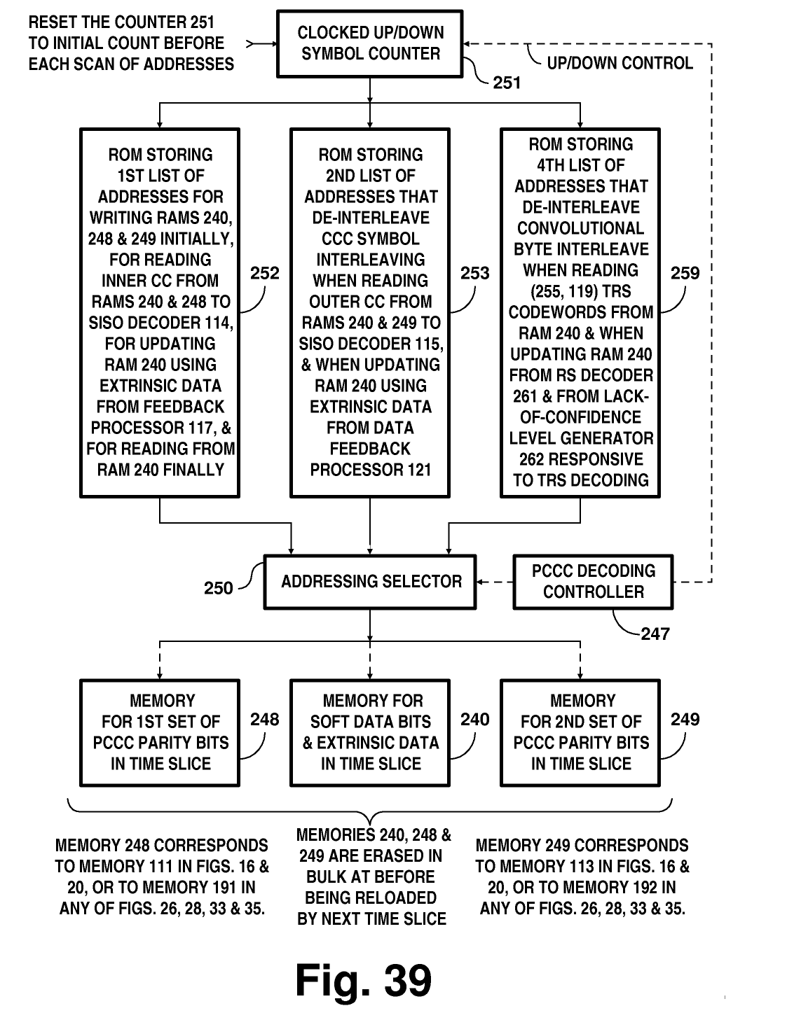

FIG. 38 shows further elements included in preferred connections to and from a memory 240 for soft data bits and extrinsic data that replaces any one of the memory 112 in the turbo decoder of FIG. 20, the memory 190 in the turbo decoder of FIG. 28 and the memory 190 in the turbo decoder of FIG. 35. These further elements are operable to increase confidence levels of data bits of correct (255, 191) transverse Reed-Solomon (TRS) codewords temporarily stored within the memory 240 during the performance of turbo decoding procedures. An address generator comprising a read-only memory 259 shown in FIG. 39, but not explicitly shown in FIG. 38, is used for addressing the memory 240 so as to de-interleave the byte interleaving of soft bits of (255, 191) TRS codewords read from the memory 240 during a break in a normal cycle of turbo decoding procedure. The respective hard-decision bits of these soft bits of (255, 191) TRS codewords are supplied to the input port of a TRS decoder 254 for (255, 191) transverse Reed-Solomon coding. The respective further bits of these soft bits expressive of confidence levels for their respective hard-decision bits are supplied to an input port of a generator 255 of low or lowest lack-of-confidence levels for bits of (255, 191) TRS codewords that are correct(ed). I. e., for bits of (255, 191) TRS codewords that were originally correct or that have been corrected by the TRS decoder 254 for (255, 191) TRS coding. The lack-of-confidence level generator 255 includes a temporary storage register for the confidence levels of each successive (255, 191) TRS codeword.

The lack-of-confidence level generator 255 can include circuitry responsive to the confidence levels of hard-decision bits in each (255, 191) RS codeword to locate byte errors for the TRS decoder 254. This allows the TRS decoder 254 to use a byte-error-correction-only algorithm that can correct sixty-four byte errors per (255, 191) TRS codeword, rather than a byte-error-location-and-correction-only algorithm that can correct only thirty-two byte errors per (255, 191) TRS codeword. FIG. 38 shows a connection 256 for conveying byte-error-location information from the lack-of-confidence level generator 255 to the TRS decoder 254.

When the TRS decoder 254 finds a (255, 191) TRS codeword to be correct or is able to correct it, the TRS decoder 254 supplies the memory 240 an over-write enable signal conditioning the memory 240 to accept over-writing of the soft data bits regarding that (255, 191) TRS codeword. The soft data bits used for such over-writing are composed of hard-decision bits supplied by the TRS decoder 254 and accompanying further bits indicative of the confidence levels regarding those hard-decision bits, which further bits are supplied by the lack-of-confidence level generator 255. The over-write enable signal conditions the fourth address generator comprising the ROM 259 to address the memory 240 during over-writing the soft data bits regarding a (255, 191) TRS codeword.

When the TRS decoder 254 finds a (255, 191) TRS codeword to be correct or is able to correct it, the TRS decoder 254 supplies the lack-of-confidence level generator 255 a pulse indication that this is so. The lack-of-confidence level generator 255 responds to this pulse indication to decrease, if possible, the lack-of-confidence levels of the bits of the correct(ed) TRS codeword written back to the memory 240. This can be done, for example, by subtracting a specified increment from the lack-of-confidence level of each soft data bit stored in the temporary storage register and replacing any “negative” lack-of-confidence level with a zero lack-of-confidence level.

FIG. 38 shows a counter 257, the count input port of which is connected for receiving the pulse indications the RS decoder 254 supplies responsive to finding (255, 191) RS codewords to be correct(ed). The count supplied from the count output port of the counter 257 is reset to zero at the beginning of each cycle of turbo decoding. The count output port of the counter 257 is connected for supplying the count of correct (255, 191) RS codewords per time-slice to the input port of a detector 258 of reaching the full count of correct (255, 191) RS codewords per time-slice. That is, the count of correct (255, 191) RS codewords per time-slice associated with every one of the (255, 191) RS codewords in a time-slice being correct. The value for such full count for a time-slice is specified to the detector 258 from the pilot and TPS carriers processor 108, 144, 170 or 193. If the full count of correct (255, 191) RS codewords per time-slice is reached at the conclusion of a cycle of turbo decoding, the detector 258 supplies an indication of this condition to a PCCC decoding controller 267. The PCCC decoding controller 267, shown in FIG. 39, can respond by concluding turbo decoding of the time-slice before the maximum allowed number of decoding iterations is reached.

The up-counter 257 for counting correct TRS codewords per time-slice and the detector 258 of the full count of correct TRS codewords per time-slice being reached can be replaced by a down-counter and a detector for zero count being reached in an alternative arrangement for concluding turbo decoding of the time-slice earlier than a prescribed maximum time for turbo decoding of the time-slice. At the beginning of each cycle of turbo decoding, the count supplied from the count output port of the down-counter is reset to a top count specified by the pilot and TPS carriers processor 108, 144, 170 or 193. The count output from the down-counter is supplied to the input port of the detector for zero count being reached. If zero count has been reached at the conclusion of a cycle of turbo decoding, the PCCC decoding controller 267, shown in FIG. 39, can respond by concluding turbo decoding of the time-slice.

Variants of the lack-of-confidence level generator 255 described above simply replace the lack-of-confidence levels of all the soft bits of correct(ed) RS codewords written back to the memory 240 with zero-valued or close to zero-valued lack-of-confidence levels. The convolutional byte interleaving of a correct(ed) RS codeword written back to the memory 240 disperses the soft data bits with decreased levels of lack-of-confidence throughout the CC presented to the SISO decoder 114 for decoding. The convolutional byte interleaving of the correct(ed) RS codeword also disperses the soft data bits with decreased levels of lack-of-confidence throughout the CC presented to the SISO decoder 115 for decoding. The dispersal of data bits with low lack-of-confidence levels throughout the CC presented to the SISO decoder 114 facilitates its selecting data bit sequences most likely to be correct as its decoding results. The dispersal of data bits with low lack-of-confidence levels throughout the CC presented to the SISO decoder 115 facilitates its selecting data bit sequences most likely to be correct as its decoding results.

FIG. 39 depicts apparatus for addressing memories within of any of the turbo decoders shown FIGS. 20, 28 and 35, as modified per FIG. 38. The FIG. 39 apparatus for addressing memories differs from the FIG. 37 apparatus for addressing memories in having a read-only memory 259, storing a fourth list of addresses for the memory 240. The ROM 259 functions as a fourth address generator for any of the turbo decoders shown FIGS. 20, 28 and 35, as modified per FIG. 38. The memory 240 is addressed according to this fourth list stored in the ROM 259 when reading (255, 191) TRS codewords from the memory 240. Such read addressing provides de-interleaving to counteract the byte interleaving of TRS codewords introduced at the DTV transmitter. The memory 240 is also addressed according to this fourth list stored in the ROM 259 when writing corrected (255, 191) TRS codewords back into the memory 240 together with updated confidence levels regarding the hard data bits in those codewords. Such write addressing restores the convolutional byte interleaving introduced at the DTV transmitter.

Although not shown in FIG. 39, the ROM 246 storing a third list of addresses that de-interleave the convolutional byte interleaving of (204, 188) LRS codewords read from the RAM 240 is retained. Scanning of this third list of addresses implements a third address generator used when reading (204, 188) LRS codewords to the quantizer 122 and the bank 136 of XOR gates, as shown in either FIG. 17 or in FIG. 21.

It is preferable to perform data-randomization of IPE packets before TRS encoding procedure as well as before LRS encoding procedure. This avoids the need for de-randomizing IPE packets as a preliminary substep in a step of incorporating decoding of TRS codewords within the turbo decoding procedures as performed by the FIG. 38 apparatus. It also avoids having to data-randomize IPE packets as a final substep of the step of incorporating decoding of TRS codewords within the turbo decoding procedures as performed by the FIG. 38 apparatus. De-randomizing IPE packets before the LRS encoding procedure avoids a preliminary substep of de-randomizing IPE packets in a step of incorporating decoding of LRS codewords within the turbo decoding procedures performed by the FIG. 36 apparatus. It also avoids having to data-randomize IPE packets as a final substep of the step of incorporating decoding of LRS codewords within the turbo decoding procedures as performed by the FIG. 38 apparatus.

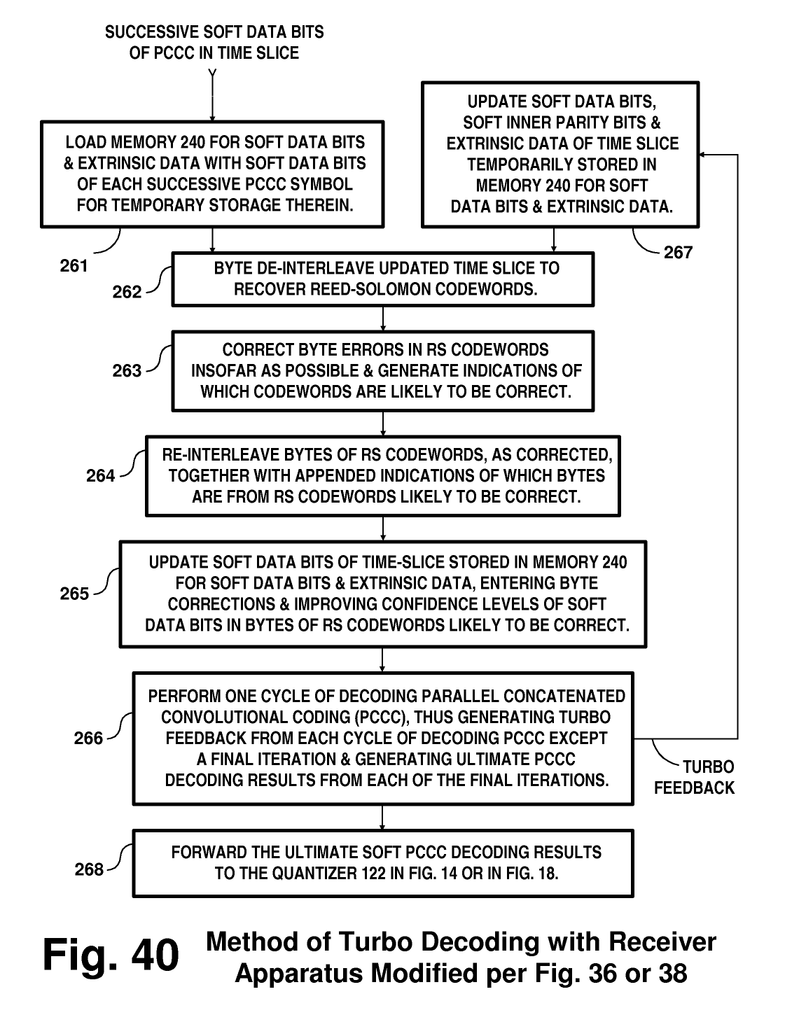

FIG. 40 is an informal flow chart that illustrates the improved method of turbo decoding employed by the turbo decoders shown in FIGS. 16, 20, 26, 28, 33 and 35 as modified to include the further elements shown in FIGS. 36 and 37. In an initial step 261 of the method, each set of three soft bits descriptive of a PCCC symbol are loaded into a respective one of the addressed storage locations within the turbo decoder memory composed of RAM 240 and further RAMs for PCCC parity bits.

FIG. 40 shows a next step 262 of the improved turbo decoding method, wherein the contents of the addressed storage locations within the RAM 240 temporarily storing PCCC data bits are read using addressing that de-interleaves the convolutional byte interleaving of the (204, 188) LRS codewords of the time-slice temporarily stored in turbo decoder memory. The step 262 supplies the LRS decoder 241 shown in FIG. 36 with (204, 188) LRS codewords of a time-slice, as transmitted only one time or as finally transmitted for iterative-diversity reception.

FIG. 40 shows a next step 263 of the improved turbo decoding method, wherein each of the (204, 188) LRS codewords are decoded and byte errors are corrected insofar as possible. In the portion of the turbo decoder shown in FIG. 36, the decoder 241 for (204, 188) LRS codewords performs this part of the step 263. The step 263 is a compound step in which indications are generated as to whether or not each byte of the (204, 188) LRS codewords is correct at the conclusion of the step 263. In this part of the step 263, the decoder 241 generates a respective bit indicating whether or not each LRS codeword it has processed will be correct at the conclusion of the step 263.

FIG. 40 shows a next step 264 of the improved turbo decoding method, wherein the bytes of (204, 188) LRS codewords are re-interleaved while being written back to the RAM 240 after LRS decoding and possible correction. The re-interleaved bytes, together with appended indications as to whether each byte is correct supplied by the generator 242 shown in FIG. 36, update the temporarily stored contents of the RAM 240 in step 265 of the improved turbo decoding method.

The steps 262, 263 and 264 provide the crux of the improvement in the FIG. 40 method of turbo decoding. FIG. 40 shows these steps being carried out successively, processing consecutive (204, 188) LRS codewords from each time-slice as a group, rather than individually. This facilitates understanding the general concept of what the improvement is in the turbo decoding method. However, processing the consecutive (204, 188) LRS codewords of each time-slice as a group, rather than individually, requires the LRS decoder 241 to have a considerable amount of memory of its own. This memory is needed to temporarily store each LRS codeword as it is corrected until such time as the group of corrected LRS codewords is written back to RAM 240 to update the contents temporarily stored therein. Preferably, the steps 262, 263 and 264 are performed sequentially for each (204, 188) LRS codeword read from the RAM 240. In the turbo decoding circuitry, such procedure substantially reduces the requirement for memory in the LRS decoder 241 shown in FIG. 36. Such procedure moves to the RAM 240 the temporary storage of (204, 188) LRS codewords required after their correction insofar as possible by the LRS decoder 241. The temporary storage of the (204, 188) LRS codewords after processing by the LRS decoder 241 updates addressed storage locations in the RAM 240, without requiring additional byte-storage capability.

After the steps 262, 263, 264 and 265 are carried out for all (204, 188) LRS codewords from a time-slice, one cycle of PCCC decoding is performed in step 266 of the improved method of PCCC decoding shown in FIG. 40. If the cycle of PCCC decoding performed in step 266 is not the sole one nor the final iteration of a series of PCCC decoding cycles in a turbo decoding procedure, the results from this cycle of PCCC decoding provide turbo feedback for a subsequent step 267. In the step 267 the extrinsic data concerning soft data bits from decoding the outer CC that are temporarily stored in the RAM 240 are updated dependent on the turbo feedback provided by the immediately preceding step 266. The step 267 concludes one cycle of PCCC decoding and begins the next cycle of PCCC decoding in which the step 267 is followed by repeated steps 262, 263 and 264.

The step 266 is followed by a step 268 if the cycle of PCCC decoding performed in step 266 is the sole one or is the final iteration of a series of PCCC decoding cycles in a turbo decoding procedure. In the step 268 the soft data bits of the ultimate PCCC decoding results are forwarded to the quantizer 122 as shown in FIG. 17 or in FIG. 21.

Alternatively, the FIG. 40 flow chart illustrates the improved method of turbo decoding employed by the turbo decoders shown in FIGS. 20, 28 and 35 as modified to include the further elements shown in FIGS. 38 and 39. In the initial step 261 of the method, each set of three soft bits descriptive of a PCCC symbol are loaded into a respective one of the addressed storage locations within the turbo decoder memory 240.

FIG. 40 shows a next step 262 of the improved turbo decoding method, wherein the contents of the addressed storage locations within the RAM 240 temporarily storing data bits are read using addressing that de-interleaves the convolutional byte interleaving of the (255, 191) TRS codewords of the time-slice temporarily stored in turbo decoder memory. The step 262 supplies the TRS decoder 254 shown in FIG. 38 with TRS codewords of a time-slice, as transmitted only one time or as finally transmitted for iterative-diversity reception.

FIG. 40 shows a next step 263 of the improved turbo decoding method, wherein each of the (255, 191) RS codewords are decoded and byte errors are corrected insofar as possible. In the portion of the turbo decoder shown in FIG. 38, the TRS decoder 254 performs this part of the step 263. The step 263 is a compound step in which indications are generated as to whether or not each byte of the (255, 191) TRS codewords is correct at the conclusion of the step 263. In this part of the step 263, the decoder 254 generates a respective bit indicating whether or not each TRS codeword it has processed will be correct at the conclusion of the step 263.

FIG. 40 shows a next step 264 of the improved turbo decoding method, wherein the bytes of (255, 191) TRS codewords are re-interleaved while being written back to the memory 240 after decoding and possible correction by the TRS decoder 254. The re-interleaved bytes, together with appended indications as to whether each byte is correct supplied by the generator 255 shown in FIG. 38, update the temporarily stored contents of the RAM 240 in step 265 of the improved turbo decoding method.

In this alternative improved turbo decoding method too, the steps 262, 263 and 264 provide the crux of the improvement in the FIG. 40 method of turbo decoding. FIG. 40 shows these steps being carried out successively, processing consecutive (255, 191) TRS codewords from each time-slice as a group, rather than individually. This facilitates understanding the general concept of what the improvement is in the turbo decoding method. However, processing the consecutive (255, 191) TRS codewords of each time-slice as a group, rather than individually, requires the TRS decoder 254 to have a considerable amount of memory of its own. This memory is needed to temporarily store each TRS codeword as it is corrected until such time as the group of corrected TRS codewords is written back to the RAM 240 to update the contents temporarily stored therein. Preferably, the steps 262, 263 and 264 are performed sequentially for each (255, 191) TRS codeword read from the RAM 240. In the turbo decoding circuitry, such procedure substantially reduces the requirement for memory in the TRS decoder 254 shown in FIG. 38. Such procedure moves to the RAM 240 the temporary storage of (255, 191) TRS codewords required after their correction insofar as possible by the TRS decoder 254. The temporary storage of the (255, 191) TRS codewords after processing by the TRS decoder 254 updates addressed storage locations in the RAM 240, without requiring additional byte storage capability.

After the steps 262, 263, 264 and 265 are carried out for all (255, 191) TRS codewords from a time-slice, one cycle of PCCC decoding is performed in step 266 of the improved method of PCCC decoding shown in FIG. 40. If the cycle of PCCC decoding performed in step 266 is not the sole one nor the final iteration of a series of PCCC decoding cycles in a turbo decoding procedure, the results from this cycle of PCCC decoding provide turbo feedback for a subsequent step 267. In the step 267 the extrinsic data concerning soft data bits from decoding the outer CC that are temporarily stored in the RAM 240 are updated dependent on the turbo feedback provided by the immediately preceding step 266. The step 267 concludes one cycle of PCCC decoding and begins the next cycle of PCCC decoding in which the step 267 is followed by repeated steps 262, 263 and 264.

The step 266 is followed by the step 268 if the cycle of PCCC decoding performed in step 266 is the sole one or is the final iteration of a series of PCCC decoding cycles in a turbo decoding procedure. In the step 268 the soft data bits of the ultimate PCCC decoding results are forwarded to the quantizer 122 shown in FIG. 21.

FIG. 40 shows the steps 262, 263 and 264 being performed after every cycle of decoding PCCC. The methods of turbo decoding illustrated by FIG. 40 may be modified so as to skip the steps 262, 263 and 264 in some cycles of decoding PCCC. For example, the steps 262, 263 and 264 can be skipped in the first few cycles of decoding PCCC when the accumulated value of the confidence levels of data bits is low enough to indicate that TRS codewords are likely not to be correct or correctable. The method of turbo decoding that FIG. 40 illustrates in which the step 263 corrects byte errors in (255, 191) TRS codewords can eliminate remnant errors in the PCCC in an earlier iteration of the turbo decoding procedure than can the method of turbo decoding that FIG. 40 illustrates in which the step 263 corrects byte errors in (204, 188) LRS codewords. This is because (255, 191) TRS codewords have greater redundancy in their FEC coding than (204, 188) LRS codewords do.

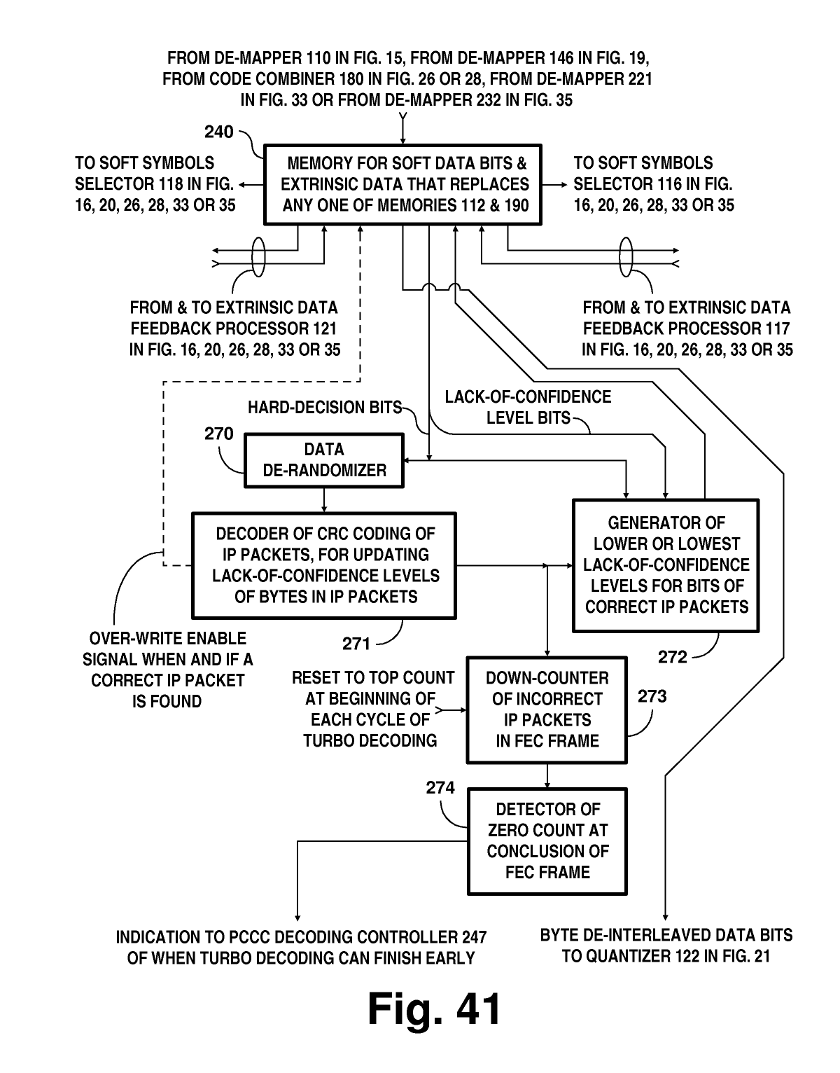

FIG. 41 shows further elements included in preferred connections to and from the RAM 240 for soft data bits and extrinsic data, which further elements are operable to increase confidence levels of soft data bits of correct IP packets temporarily stored within the RAM 240 during the performance of turbo decoding procedures. The respective hard-decision bits of the soft bits of IP packets temporarily stored within the RAM 240 are read therefrom, de-randomized by a data de-randomizer 270, and supplied to the input port of a decoder 271 for cyclic-redundancy-check (CRC) coding of IP packets. FIG. 41 shows connections for supplying the hard-decision bits of the soft bits of IP packets and the respective further bits of these soft bits expressive of lack-of-confidence levels for their respective hard-decision bits to an input port of a generator 272 of lower or lowest lack-of-confidence levels for bits of IP packets that the CRC decoder 271 finds to be correct. Typically, the lack-of-confidence level generator 272 includes a temporary storage register for the hard-decision bits of the soft bits of IP packets and further includes another temporary storage register for the lack-of-confidence levels for those soft bits.

The lack-of-confidence level generator 272 decreases, if possible, the lack-of-confidence levels of the bits of each IP packet apt to be written back to the RAM 240. This can be done, for example, by subtracting a specified increment from the lack-of-confidence level of each soft data bit stored in the temporary storage register and replacing any negative lack-of-confidence level with a zero-valued lack-of-confidence level.

When the CRC decoder 271 finds an IP packet to be correct, the CRC decoder 271 supplies the RAM 240 an over-write enable signal conditioning the RAM 240 to accept over-writing of the soft data bits regarding that IP packet. The soft data bits used for such over-writing are composed of hard-decision bits read from their temporary storage register and accompanying further bits indicative of the lack-of-confidence levels regarding those hard-decision bits. These further bits have been generated by the lack-of-confidence level generator 272, used to update the temporary storage register in the lack-of-confidence level generator 272 for such further bits, and are now used for over-writing soft data bits regarding an IP packet as temporarily stored in the RAM 240.

When the CRC decoder 271 finds an IP packet to be incorrect, the CRC decoder 271 simply withholds supplying the RAM 240 an over-write enable signal conditioning the RAM 240 to accept over-writing of the soft data bits regarding that IP packet. The soft bits of the IP packet temporarily stored in extended-byte storage locations in the RAM 240 are left unchanged.

In an alternative design, the RAM 240 is operated so that the hard-decision bits of soft bits of the IP packet are not over-written when the bits are that are indicative of the lack-of-confidence levels in those soft bits. In such an alternative design, the lack-of-confidence level generator 272 is not connected for receiving hard-decision bits read from the RAM 240 and does not include a temporary storage register for such hard-decision bits.

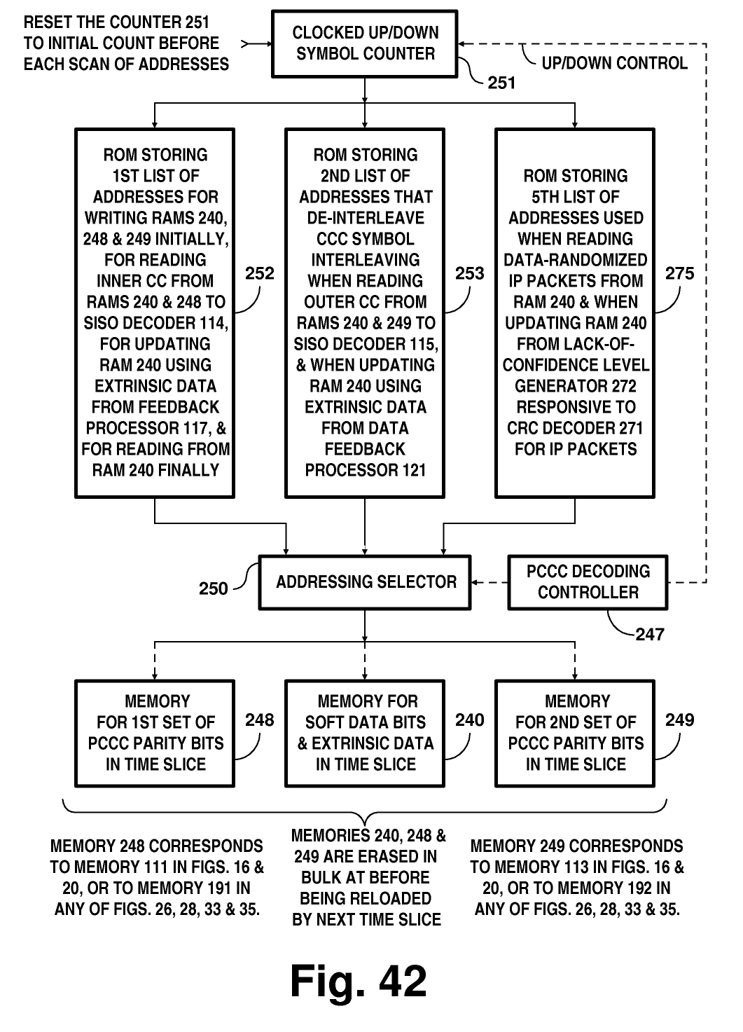

FIG. 41 shows a down-counter 273, the count input port of which is connected for receiving the pulse indications the CRC decoder 271 supplies responsive to finding IP packets to be correct. The count supplied from the count output port of the down-counter 273 is reset to topmost count at the beginning of each cycle of turbo decoding. The value for such topmost count for a time-slice is specified by the pilot and TPS carriers processor 108 or 162. The count output port of the down-counter 273 is connected for supplying the down count of correct IP packets per time-slice to the input port of a detector 274 of when zero count is reached. If zero count has been reached at the conclusion of a cycle of turbo decoding, the detector 274 supplies an indication of this condition to the PCCC decoding controller 247. The PCCC decoding controller 247 shown in FIG. 42 can respond by concluding turbo decoding of the time-slice.

FIG. 42 depicts apparatus for addressing memories within of any of the turbo decoders shown in FIGS. 20, 28 and 35, as modified per FIG. 41. The FIG. 42 apparatus for addressing memories differs from the apparatuses shown in FIGS. 37 and 39 in having a read-only memory 275 for storing a fifth list of addresses for the memory 240. Scanning of the fifth list of addresses stored in the ROM 275 provides a further address generator for any of the turbo decoders shown FIGS. 20, 28 and 35, as modified per FIG. 41. The RAM 240 is addressed according to this fifth list stored in the ROM 275 when reading data-randomized IP packets from the RAM 240. The RAM 240 is addressed according to this fifth list stored in the ROM 275 when the lack-of-confidence level generator 272 updates the lack-of-confidence levels of the soft bits of the data-randomized IP packets temporarily stored in the RAM 240. The order of addresses in this fifth list is similar to the order of addresses in the first list except for omitting addresses for soft-bit-storage locations that store soft bits of IPE packet headers, LRS parity and TRS parity. Although not shown in FIG. 42, the ROM 246 storing a third list of addresses that de-interleave the convolutional byte interleaving of (204, 188) LRS codewords read from the RAM 240 is retained. Scanning of this third list of addresses implements a third address generator used when reading (204, 188) LRS codewords to the quantizer 122 and the bank 136 of XOR gates, as shown in either FIG. 17 or in FIG. 21.

Further stationary DTV receivers embodying aspects of the invention comprise turbo decoders each including either or both of the modifications shown in FIGS. 36 and 41. Further M/H DTV receivers embodying aspects of the invention comprise turbo decoders each including two or three of the modifications shown in FIGS. 36, 38 and 41. For example, the FIG. 36 and FIG. 38 modifications can be used together in a modification of the FIG. 20 turbo decoder in a modification of the M/H DTV receiver shown in FIGS. 19, 20, 21 and 22. In this modified M/H DTV receiver the elements shown in FIG. 21 are replaced by direct application of hard-decision bits from the turbo decoding results to the input port of the data de-randomizer 153.

The CRC decoder 271 and the generator 272 of lowered lack-of-confidence levels can update extensions of the bytes of IP packets temporarily stored in the memory 240 during turbo decoding procedures, with little increase of latent delay in those procedures. Scanning of storage locations in the RAM 240 to support turbo decoding can concurrently provide for reading to the CRC decoder 271 and the generator 272 of lowered lack-of-confidence levels, as well as writing from the generator 272 of lowered lack-of-confidence levels. The correction of (204, 188) LRS codewords and the updating of the extended bytes of those codewords by the LRS decoder 241 requires special scanning of RAM 240 addresses for reading to and writing from the LRS decoder 241 and the generator 242 of lowered lack-of-confidence levels. The special scanning of RAM 240 addresses appreciably increases latent delay in turbo decoding procedures and perhaps is better deferred until near the conclusion of turbo decoding of a time-slice. The correction of (255, 191) TRS codewords and the updating of the extended bytes of those codewords by the TRS decoder 254 also requires special scanning of RAM 240 addresses for reading to and writing from the TRS decoder 254 and the generator 255 of lowered lack-of-confidence levels. This also appreciably increases latent delay in turbo decoding procedures and perhaps is better deferred until near the conclusion of turbo decoding of a time-slice.

Preferably, the CRC decoder 271 performs its decoding of CRC-coded IP packets before each cycle of turbo decoding of a time-slice and updates extensions of the bytes of IP packets temporarily stored in the RAM 240. This updating is apt to improve locating erroneous bytes for erasure decoding by the LRS decoder 241, which type of decoding can correct up to sixteen erroneous bytes in each (204, 188) LRS codeword. In an M/H DTV receiver this updating is also apt to improve locating erroneous bytes for erasure decoding by the TRS decoder 254, which type of decoding can correct up to sixty-four erroneous bytes in each (255, 191) TRS codeword. The operation of an M/H DTV receiver employing both the LRS decoder 241 and the TRS decoder 254 is considered in more detail, following.

Decoding of the (204, 188) LRS codewords in a time-slice can be performed by the LRS decoder 241 before decoding of the (255, 191) TRS codewords therein is performed by the TRS decoder 254. This has the advantage that extended bytes of the (204, 188) LRS codewords are temporarily stored in all the extended-byte storage locations of the RAM 240 that concern the time-slice being processed. So, the LRS decoder 241 is operable for correcting the parity bytes as well as the data bytes of the (255, 191) TRS codewords temporarily stored in the extended-byte storage locations of the RAM 240. If all the LRS codewords in a time-slice are correct after their decoding by the LRS decoder 241, any further decoding of the TRS coding in the time-slice by the TRS decoder 254 can be skipped over. Also, the LRS decoding of parity bits of the TRS coding by the LRS decoder 241 can be skipped over as well. The correctness of the IP packets within the time-slice can be confirmed by the CRC decoder 271 before skipping over the TRS decoding of the time-slice.

Alternatively, decoding of the TRS codewords in a time-slice can be performed by the TRS decoder 254 before decoding of the LRS codewords therein is performed by the LRS decoder 241. Decoding of the CIRC begins using the (255, 191) RS coding that is stronger than the (204, 188) shortened RS coding. If all the TRS codewords in a time-slice are correct after their decoding by the TRS decoder 254, any further decoding of the LRS coding in the time-slice by the LRS decoder 241 can be skipped over. The correctness of the IP packets within the time-slice can be confirmed by the CRC decoder 271 before skipping over the LRS decoding of the time-slice.

An M/H DTV receiver employing both the LRS decoder 241 and the TRS decoder 254 can be advantageously operated to perform LRS decoding and TRS decoding of the CIRC iteratively, repeating either of the methods described in the two immediately foregoing paragraphs. As noted supra regarding the FIG. 24 receiver apparatus, iterated decoding procedures are more efficient if decoding is repeated only for those RS codewords not yet found to be correct. The up-counter 244 and detector 245 of full count being reached that are shown in FIG. 36 can be replaced by a memory register for storing information as to which LRS codewords in a time-slice the LRS decoder 241 has thusfar found to be correct. When that memory register is filled with indications that all LRS codewords in a time-slice have been found correct, decoding of the CIRC in that time-slice can be discontinued. The up-counter 264 and detector 265 of full count being reached that are shown in FIG. 38 can be replaced by another memory register for storing information as to which TRS codewords in a time-slice the TRS decoder 54 has thusfar found to be correct. When that memory register is filled with indications that all TRS codewords in a time-slice have been found correct, decoding of the CIRC in that time-slice can be discontinued. If no updates are made to either of these memory registers during a cycle of decoding the CIRC in a time-slice, decoding of that CIRC can be discontinued. If not earlier concluded, the iterative procedures for decoding the CIRC in a time-slice can progress until a prescribed maximum time for such decoding expires.

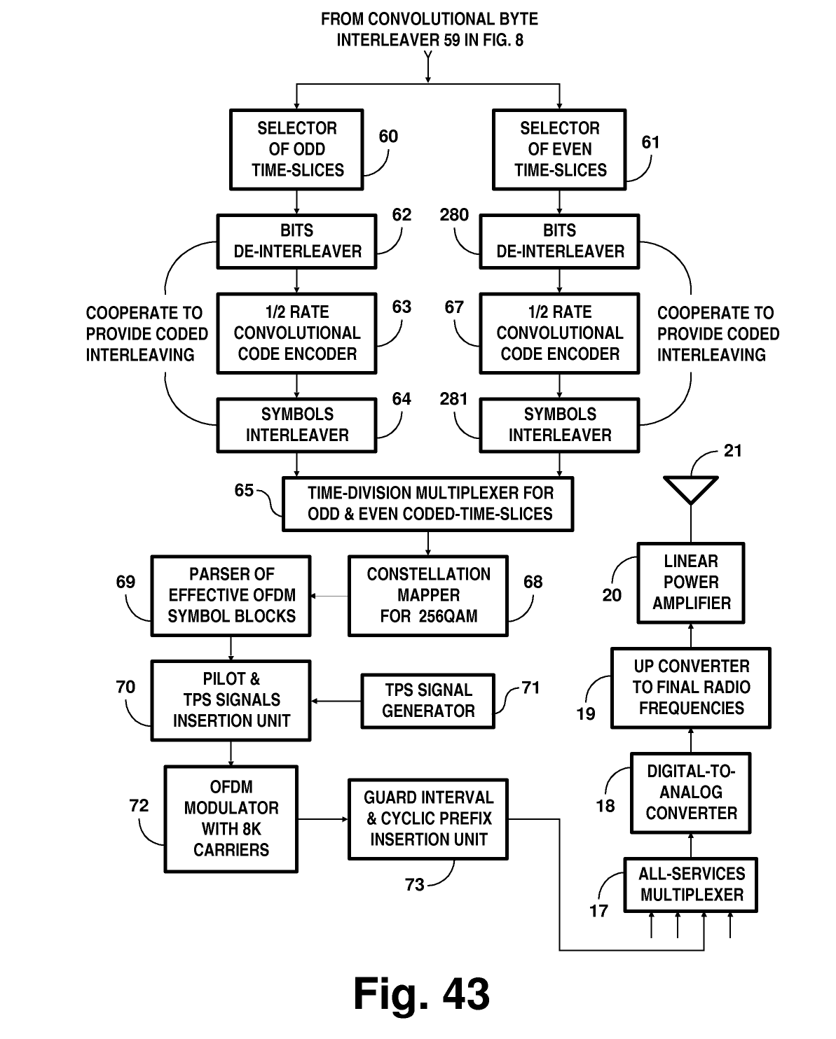

FIG. 43 shows a modification of the FIG. 9 portion of the DTV transmitter, which modification generates PCCC in which the first and second sets of parity bits have different coded interleaving. The output port of the selector 61 of even-numbered time-slices connects to the input port of a bits de-interleaver 280, and the output port of the bits de-interleaver 280 connects to the input port of the CC encoder 67 for one-half-rate convolutional coding. The output port of the CC encoder 67 connects to the input port of a symbols interleaver 281, the output port of which connects to the second input port of the time-division multiplexer 65 for odd-numbered and even-numbered coded time-slices. The bits de-interleaver 280 and the symbols interleaver 281 provide a different pattern of coded interleaving than the bits de-interleaver 62 and the symbols interleaver 64 do. Even-numbered coded time-slices can inherently interleave with odd-numbered coded time-slices in this modification, so the modified portion of the DTV transmitter depicted in FIG. 43 need not include delay memory similar to the delay memory 66 that the FIG. 9 portion of the DTV transmitter uses for this purpose. The modified portion of a DTV transmitter depicted in FIG. 43 is preferred over the portion of a DTV transmitter depicted in FIG. 9 for reasons similar to those set forth supra for preferring the FIG. 7 PCCC encoder over other encoders for one-third-rate PCCC.

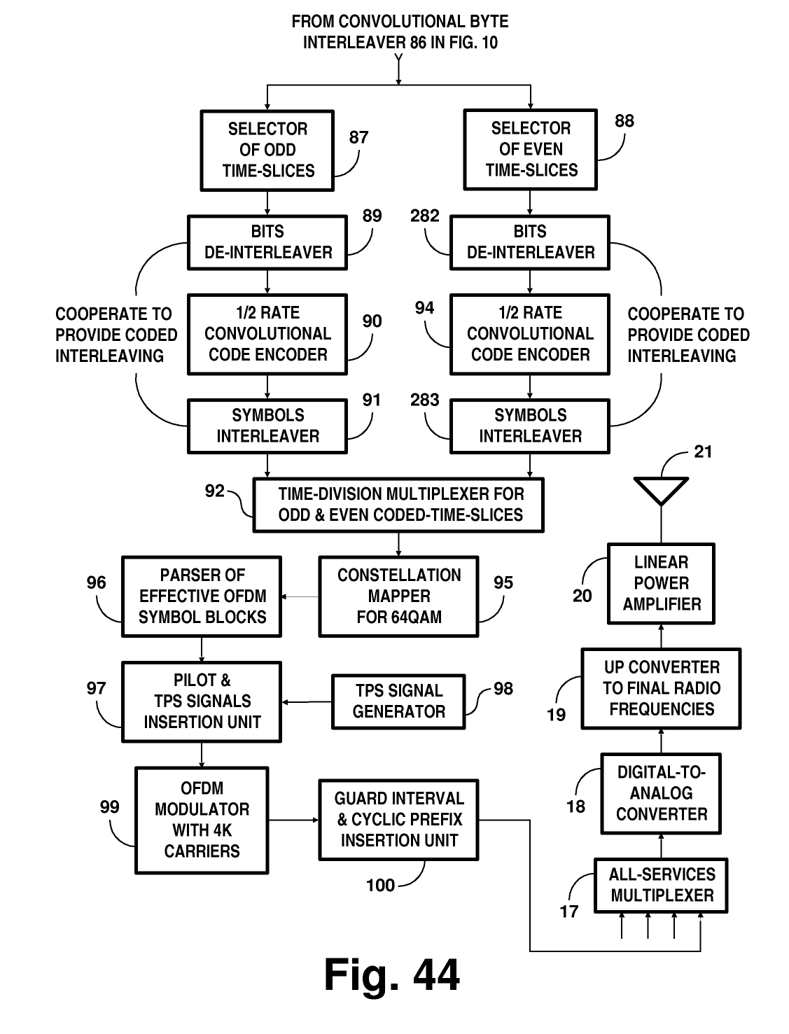

FIG. 44 shows a modification of the FIG. 11 portion of the DTV transmitter, which modification generates PCCC in which the first and second sets of parity bits have different coded interleaving. The output port of the selector 88 of even-numbered time-slices connects to the input port of a bits de-interleaver 282, and the output port of the bits de-interleaver 282 connects to the input port of the CC encoder 94 for one-half-rate convolutional coding. The output port of the CC encoder 94 connects to the input port of a symbols interleaver 283, the output port of which connects to the second input port of the time-division multiplexer 92 for odd-numbered and even-numbered coded time-slices. The bits de-interleaver 292 and the symbols interleaver 283 provide a different pattern of coded interleaving than the bits de-interleaver 89 and the symbols interleaver 91 do. Even-numbered coded time-slices can inherently interleave with odd-numbered coded time-slices in this modification, so the modified portion of the DTV transmitter depicted in FIG. 43 need not include delay memory similar to the delay memory 93 that the FIG. 11 portion of the DTV transmitter uses for this purpose. The modified portion of a DTV transmitter depicted in FIG. 44 is preferred over the portion of a DTV transmitter depicted in FIG. 11 for reasons similar to those set forth supra for preferring the FIG. 7 PCCC encoder over other encoders for one-third-rate PCCC.

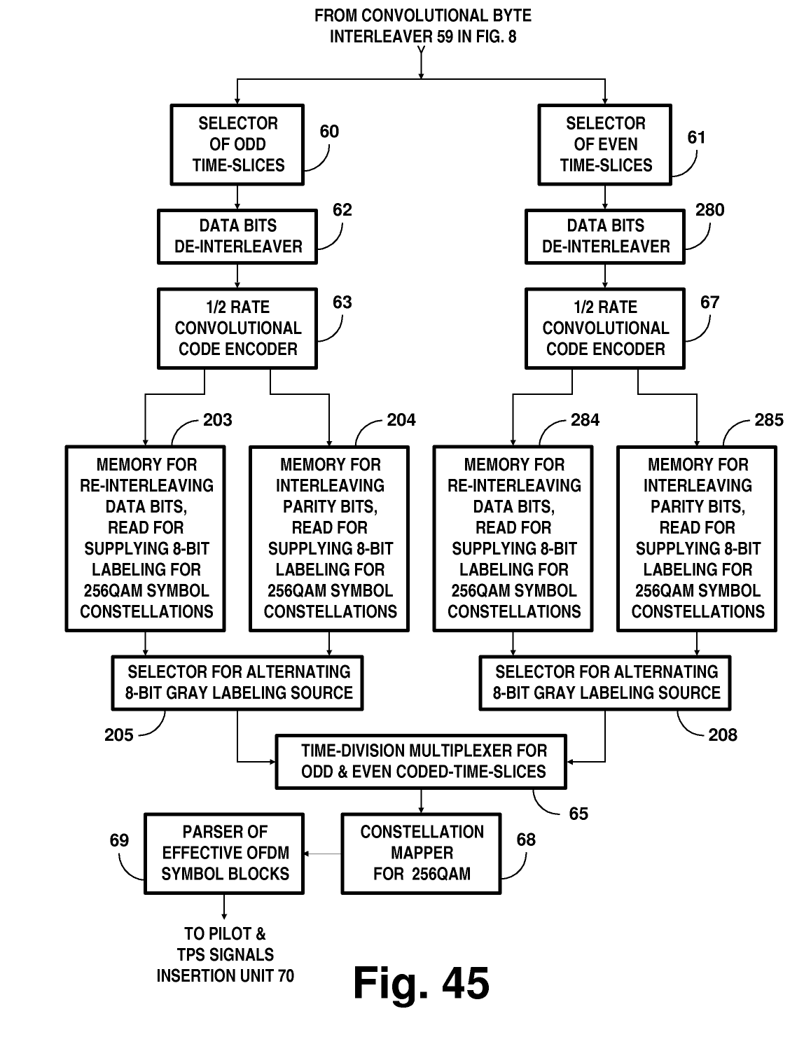

FIG. 45 shows a modification of the FIG. 30 portion of the DTV transmitter, which modification generates PCCC in which the first and second sets of parity bits have different coded interleaving. The output port of the selector 61 of even-numbered time-slices connects to the input port of a bits de-interleaver 280, and the output port of the bits de-interleaver 280 connects to the input port of the CC encoder 67 for one-half-rate convolutional coding. FIG. 45 shows the random-access memories 206 and 207 used for introducing delay in the FIG. 30 portion of the DTV transmitter being replaced by random-access memories 284 and 285 respectively. The RAM 284 has a write-input port connected to be written with the data bits of one-half-rate CC supplied from a first output port of the CC encoder 67. The RAM 284 has a read-output port connected for supplying bytes of data bits to a first input port of the selector 208 of the 8-bit Gray labeling used by the 256QAM symbol constellation mapper 68 during even-numbered time-slices. The RAM 285 has a write-input port connected to be written with the parity bits of the one-half-rate CC supplied from a second output port of the CC encoder 67. The RAM 285 has a read-output port connected for supplying bytes of parity bits to a second input port of the selector 208 of the 8-bit Gray labeling used by the 256QAM symbol constellation mapper 68 during even-numbered time-slices.

The RAMs 284 and 285 are both addressed by a first sequence of addresses during their writing and by a second sequence of addresses during their subsequently being read from. These first and second sequences of addresses differ, such that the de-interleaved data bits supplied from a first output port of the CC encoder 67 are re-interleaved by the RAM 284. The data bits appear in the read-out from the RAM 294 in the same sequential order they had at the output port of the selector 61 of even-numbered time-slices. The parity bits that appear in the read-out from the RAM 285 have coded interleaving respective to the data bits read from the RAM 284. The latent delay for the even-numbered coded time-slices supplied from convolutional byte interleaver 59 to the second input port of the time-division multiplexer 65 is equal to the latent delay for the odd-numbered coded time-slices supplied from convolutional byte interleaver 59 to the first input port of the time-division multiplexer 65. The modified portion of a DTV transmitter depicted in FIG. 45 is preferred over the portion of a DTV transmitter depicted in FIG. 30 for reasons similar to those set forth supra for preferring the FIG. 7 PCCC encoder over other encoders for one-third-rate PCCC.

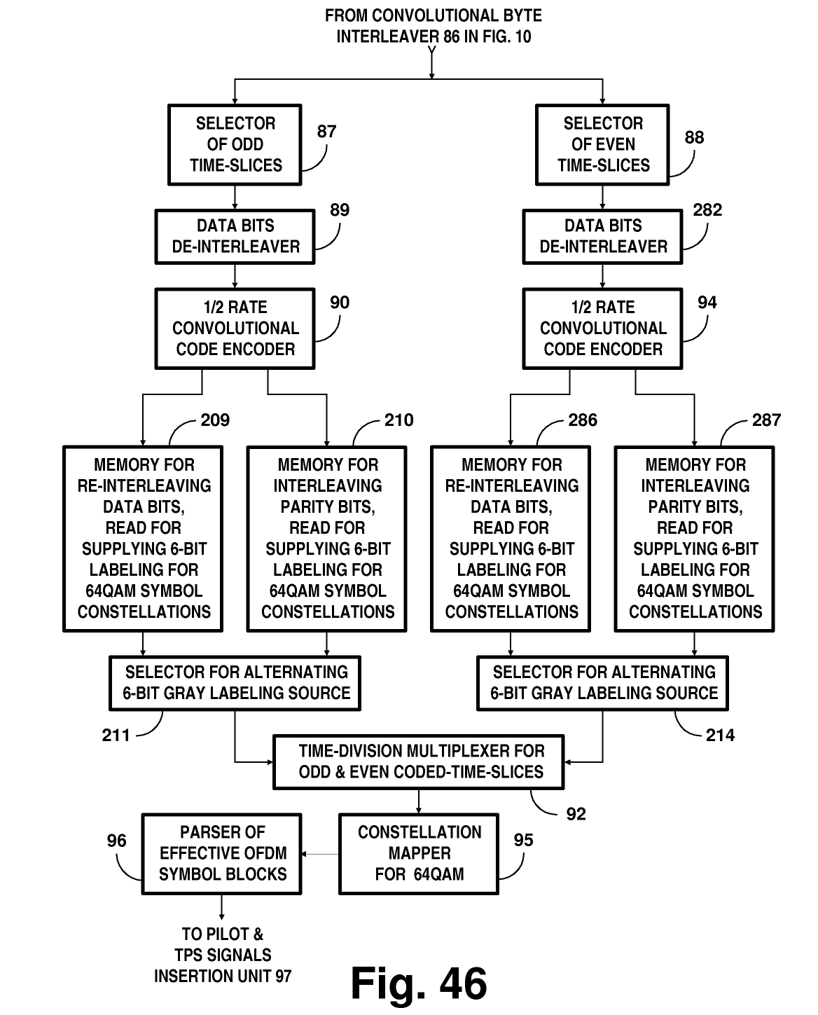

FIG. 46 shows a modification of the FIG. 31 portion of the DTV transmitter, which modification generates PCCC in which the first and second sets of parity bits have different coded interleaving. The output port of the selector 88 of even-numbered time-slices connects to the input port of a bits de-interleaver 282, and the output port of the bits de-interleaver 282 connects to the input port of the CC encoder 94 for one-half-rate convolutional coding. FIG. 46 shows the random-access memories 212 and 213 used for introducing delay in the FIG. 31 portion of the DTV transmitter being replaced by random-access memories 286 and 287, respectively. The RAM 286 has a write-input port connected to be written with the data bits of one-half-rate CC supplied from a first output port of the CC encoder 94. The RAM 286 has a read-output port connected for supplying bytes of data bits to a first input port of the selector 214 of the 8-bit Gray labeling used by the 64QAM symbol constellation mapper 95 during even-numbered time-slices. The RAM 287 has a write-input port connected to be written with the parity bits of the one-half-rate CC supplied from a second output port of the CC encoder 94. The RAM 287 has a read-output port connected for supplying bytes of parity bits to a second input port of the selector 214 of the 8-bit Gray labeling used by the 64QAM symbol constellation mapper 95 during even-numbered time-slices.

The RAMs 286 and 287 are both addressed by a first sequence of addresses during their writing and by a second sequence of addresses during their subsequently being read from. These first and second sequences of addresses differ, such that the de-interleaved data bits supplied from a first output port of the CC encoder 94 are re-interleaved by the RAM 286. The data bits appear in the read-out from the RAM 286 in the same sequential order they had at the output port of the selector 88 of even-numbered time-slices. The parity bits that appear in the read-out from the RAM 287 have coded interleaving respective to the data bits read from the RAM 286. The latent delay for the even-numbered coded time-slices supplied from convolutional byte interleaver 86 to the second input port of the time-division multiplexer 92 is equal to the latent delay for the odd-numbered coded time-slices supplied from convolutional byte interleaver 86 to the first input port of the time-division multiplexer 92. The modified portion of a DTV transmitter depicted in FIG. 46 is preferred over the portion of a DTV transmitter depicted in FIG. 31 for reasons similar to those set forth supra for preferring the FIG. 7 PCCC encoder over other encoders for one-third-rate PCCC.

FIG. 47 depicts a modification or further modification of any of the turbo decoders shown in FIGS. 16, 20, 26, 28, 33 and 35 so it can decode PCCC in which the first and second sets of parity bits have different coded interleaving. FIG. 47 shows the output port of the soft-symbols selector 116 connected for supplying soft symbols to the input port of a soft symbols de-interleaver 288, rather than connecting directly to the input port of the SISO decoder 114 for one-half-rate CC. The output port of the soft-symbols de-interleaver 288 is connected for supplying de-interleaved soft symbols to the input port of the SISO decoder 114. FIG. 47 does not show the output port of the SISO decoder 114 connected directly to the first input port of the extrinsic-data-feedback processor 117. FIG. 47 shows the output port of the SISO decoder 114 connected to the input port of a soft-bits interleaver 289 which re-interleaves soft data bits for application to the first input port of the extrinsic-data-feedback processor 117. In practice, the soft symbols selector 116 and the soft-symbols de-interleaver 288 will usually not appear as separate physical elements. Instead, their functions are subsumed into the memories 112 and 113, or 190 and 191 by suitably addressing them when reading soft data bits and soft parity bits directly to the first and second input ports of the SISO decoder 114. The soft-bits interleaver 289 need not appear as a separate physical element either, its function being subsumed into the memory 112 or 190 by suitable addressing during operation of the extrinsic feedback data processor 117.

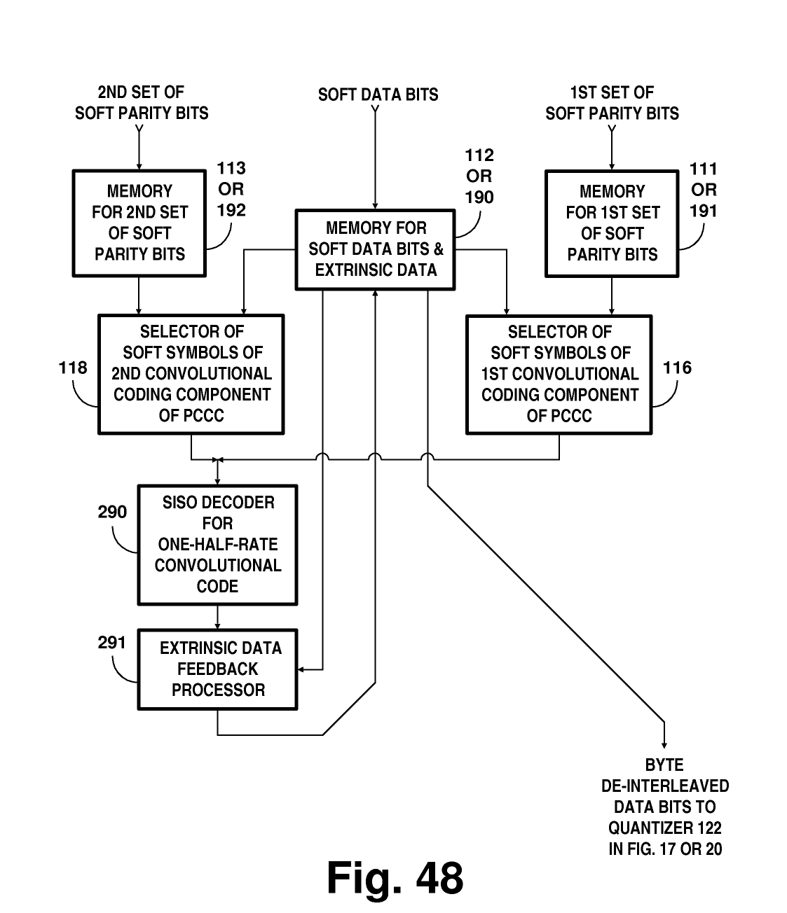

FIG. 48 is a schematic diagram of turbo decoding apparatus alternative to any of those shown in FIGS. 16, 20, 26, 28, 33, 35 and 46, which alternative turbo decoding apparatus employs a single SISO decoder 290 instead of the two SISO decoders 114 and 115. During one half of the turbo decoding cycle the selector 116 supplies the second CC component of the PCCC to the input port of the SISO decoder 290, and during the other half of the turbo decoding cycle the selector 118 supplies the first CC component of the PCCC to the input port of the SISO decoder 290. This alternative turbo decoding apparatus employs one extrinsic data feedback processor 291 rather than the two extrinsic data feedback processors 117 and 121. The extrinsic data feedback processor 291 differentially combines soft data bits read from the memory 112 or 190 with corresponding soft data bits of the SISO decoder 290 decoding results, thus to generate extrinsic data feedback written into that memory to update the soft extrinsic data bits temporarily stored therein.

Optimal Gray mapping and close-to-Gray mapping of bit-wise FEC coding at one-half and one-third code rates to QAM symbol constellations are employed in the DTV transmitter apparatus described supra. However, bit-wise FEC coding can be performed at other code rates, such as the ⅞, ⅚, ¾ and ⅔ code rates that together with ½ code rate are the valid code rates for DVB DTV broadcasting. Transmissions for iterative-diversity reception will halve the overall code rate for bit-wise FEC coding. The turbo decoding procedures in DTV receiver apparatus described supra have to be modified to accommodate these additional code rates, of course, which is done using known techniques.

The QAM symbol constellation mappers 11, 36, 68 and 95 may, per a customary DVB practice, include inner interleaving that permutes the temporal order of groups of bits before coding them into successive QAM symbols for constellation mapping. The bits should be grouped for such inner interleaving in such way as to maintain the nature of the bits at each lattice point of the QAM symbol constellations as specified in FIG. 32, FIG. 35, FIG. 38 or FIG. 40 of the above-referenced U.S. patent application Ser. No. 13/493,198 filed on 11 Jun. 2012. If inner interleaving is used in the DTV transmissions, inner de-interleaving of the results of de-mapping the QAM symbol constellations is required. In receiver apparatus as partially shown in any of FIGS. 16, 20, 47 and 48, suitable write addressing of the memories 111, 112 and 113 can implement this inner de-interleaving. In receiver apparatus as partially shown in any of FIGS. 26, 28, 33, 35, 47 and 48, suitable write addressing of the memories 190, 191 and 192 can implement this inner de-interleaving.

Various mappings of bit-wise FEC coding at one-half code rate to QAM symbol constellations are specifically described supra. However, bit-wise FEC coding can be performed at other code rates, such as the ⅞, ⅚, ¾ and ⅔ code rates that together with ½ code rate are the valid code rates for DVB DTV broadcasting. Transmissions for iterative-diversity reception will halve the overall code rate for bit-wise FEC coding, of course. Receivers that differ from those specifically described supra principally in regard to decoding bit-wise FEC coding at these higher code rates are alternative embodiments of various aspects of the invention, and the claims that follow should be construed to include these alternative embodiments within their scopes.

The foregoing specification considers DTV systems using RS coding serially concatenated with PCCC as the bit-wise FEC coding that is turbo decoded to generate soft bits of RS coding, the confidence levels of which soft bits are analyzed to locate byte error for subsequent decoding of the RS coding. The precepts of the invention extend to DTV systems using RS coding serially concatenated with species of turbo coding other than PCCC. More specifically, those precepts extend to RS coding that is serially concatenated with parallel concatenated low-density parity check (LDPC) coding.

Frequency-domain equalization is augmented by time-domain equalization in some receiver designs. Recent advances in analog-to-digital converters will allow them to replace much of the front-end tuners in DTV receivers. It will be apparent to persons skilled in the art that various other modifications and variations can be made in the specifically described apparatus without departing from the spirit or scope of the invention. Accordingly, it is intended that these modifications and variations of the specifically described apparatus be considered to result in further embodiments of the invention, which are included within the scope of the appended claims and their equivalents.

In some of the appended claims, lateral Reed-Solomon forward-error-correction coding is specified to be (204, 188) Reed-Solomon forward-error-correction coding. If a different industry standard is used instead of (204, 188) RS FEC coding, it is to be considered by application of the doctrine of equivalency to be equivalent to (204, 188) RS FEC coding when determining whether a receiver infringes upon such claims.

In some of the appended claims, transverse Reed-Solomon forward-error-correction coding is specified to be (255, 191) Reed-Solomon forward-error-correction coding. If a different industry standard is used instead of (255, 191) RS FEC coding, it is to be considered by application of the doctrine of equivalency to be equivalent to (255, 191) RS FEC coding when determining whether a receiver infringes upon such claims.

In the appended claims, the word “said” rather than the word “the” is used to indicate the existence of an antecedent basis for a term being provided earlier in the claims. The word “the” is used for purposes other than to indicate the existence of an antecedent basis for a term having being provided earlier in the claims, the usage of the word “the” for other purposes being consistent with customary grammar in the American English language.

1. Receiver apparatus for coded orthogonal frequency-division multiplex (COFDM) transmissions of digital television (DTV) signals, which COFDM transmissions each comprise a plurality of successive time-slices for conveying parallel concatenated redundant coding of convolutionally byte-interleaved lateral Reed-Solomon (LRS) codewords that encode 188-byte packets of digital information, a prescribed number of which said successive time-slices are included in each of successive super-frames of prescribed duration, said receiver apparatus comprising:
a front-end tuner for converting a selected radio-frequency analog COFDM signal to a digitized baseband COFDM signal;
a demodulator of said orthogonal frequency-division multiplex (OFDM) signal, for supplying complex samples of quadrature-amplitude-modulated (QAM) signal in response to said OFDM signal;
a guard-interval-remover unit connected for removing guard-interval digital samples including samples of cyclic prefixes from said digitized baseband COFDM signal to generate OFDM signal for application to said demodulator for OFDM signal as an input signal thereto;
a processor of unmodulated pilot carrier waves and of carrier waves modulated by Transmission Parameters Signaling (TPS) supplied from said demodulator for OFDM signal as a first output signal therefrom;
a frequency-domain channel equalizer for equalizing complex samples of QAM signal supplied from said demodulator for OFDM signal as a second output signal therefrom, said equalizing being performed responsive to said unmodulated pilot carrier waves supplied from said demodulator for OFDM signal as a portion of said first output signal therefrom;
de-mapping apparatus for de-mapping equalized complex samples of QAM signal supplied from said frequency-domain channel equalizer, thus to reproduce soft bits of said parallel concatenated redundant coding;
turbo decoding apparatus for decoding said soft bits of parallel concatenated redundant coding to recover soft bits of said LRS codewords in each successive time-slice;
byte-error-location apparatus for determining from the confidence levels of said soft bits of said LRS codewords recovered by said turbo decoding apparatus which bytes in each LRS codeword are more likely to be in error and generating indications of which bytes in each LRS codeword are more likely to be in error; and
an LRS decoder for correcting (204, 188) LRS codewords recovered by said turbo decoding apparatus and supplied to said LRS decoder, said LRS decoder employing an error-correction-only decoding algorithm that utilizes said indications of which bytes in each LRS codeword are more likely to be in error.

2. Receiver apparatus as set forth in claim 1, wherein said turbo decoding apparatus comprises:
a first memory for temporarily storing a first set of soft parity bits of said parallel concatenated redundant coding supplied from said de-mapping apparatus during each of selected time-slice intervals;
a second memory for temporarily storing soft data bits of said parallel concatenated redundant coding supplied from said de-mapping apparatus during each of said selected time-slice intervals, and for additionally temporarily storing soft bits of extrinsic data respectively accompanying ones of said soft data bits temporarily stored therein, said soft data bits of said parallel concatenated redundant coding as updated by respectively accompanying said soft bits of extrinsic data being read from said second memory at the conclusion of the turbo decoding of a time-slice as a portion of the output signal from said turbo decoding apparatus comprising said soft bits of said LRS codewords in each successive time-slice;
a third memory for temporarily storing a second set of soft parity bits of said parallel concatenated redundant coding supplied from said de-mapping apparatus during each of said selected time-slice intervals;
first and second soft-input/soft-output (SISO) decoders for redundant coding at a reduced code rate;
means for supplying said first SISO decoder with input signal thereto composed of soft symbols each composed of a respective soft data bit read from said second memory and a soft parity bit read from said first memory, said soft parity bits supplied to said first SISO decoder in the same first order as supplied to said first memory for temporary storage therein, and said soft data bits supplied to said first SISO decoder in the same first order as supplied to said second memory for temporary storage therein;
a first extrinsic data processor having a first input port connected for receiving soft data bits supplied from said first SISO decoder as output signal therefrom, having a second input port connected for receiving corresponding soft data bits and soft extrinsic data bits read from said second memory, and having an output port connected for updating soft extrinsic data bits temporarily stored in said second memory;
means for supplying said second SISO decoder with input signal thereto composed of soft symbols each composed of a respective soft data bit read from said second memory and a soft parity bit read from said third memory, said soft data bits supplied to said second SISO decoder in a second order de-interleaved respective to their order as supplied to said second memory for temporary storage therein, and said soft parity bits supplied to said second SISO decoder in said second order; and
a second extrinsic data processor having a first input port connected for receiving soft data bits supplied from said second SISO decoder as output signal therefrom, having a second input port connected for receiving corresponding soft data bits and soft extrinsic data bits read from said second memory, and having an output port connected for updating soft extrinsic data bits temporarily stored in said second memory.

3. Receiver apparatus as set forth in claim 2, wherein said first input port of said first extrinsic data processor is connected for receiving in said first order said soft data bits supplied from said first SISO decoder, said second memory is operable for reading soft data bits and soft extrinsic data bits to said second input port of said first extrinsic data processor in said first order, said second memory is operable for soft extrinsic data bits temporarily stored therein being updated by said first extrinsic data processor in accordance with said first order, and said turbo decoding apparatus includes:
a soft-bits interleaver for said soft data bits supplied from said second SISO decoder as output signal therefrom, said soft-bits interleaver operable for reproducing at an output thereof soft data bits from said second SISO decoder output signal as re-arranged to said first order, said output port of said soft-bits interleaver connected to said first input port of said second extrinsic data processor, said second memory operable for reading soft data bits and soft extrinsic data bits to said second input port of said second extrinsic data processor in said first order, and said second memory operable for soft extrinsic data bits temporarily stored therein being updated by said second extrinsic data processor in accordance with said first order.

4. Receiver apparatus as set forth in claim 2, wherein said first input port of said first extrinsic data processor is connected for receiving in said first order said soft data bits supplied from said first SISO decoder, said second memory is operable for reading soft data bits and soft extrinsic data bits to said second input port of said first extrinsic data processor in said first order, said second memory is operable for soft extrinsic data bits temporarily stored therein being updated by said first extrinsic data processor in accordance with said first order, said first input port of said second extrinsic data processor is connected for receiving in said second order said soft data bits supplied from said second SISO decoder, said second memory is operable for reading soft data bits and soft extrinsic data bits to said second input port of said second extrinsic data processor in said second order, and said second memory is operable for soft extrinsic data bits temporarily stored therein being updated by said second extrinsic data processor in accordance with said second order.

5. Receiver apparatus as set forth in claim 2, wherein said de-mapping apparatus for de-mapping equalized complex samples of QAM signal supplied from said frequency-domain channel equalizer comprises:
a de-mapper of close-to-Gray-mapped cruciform 512QAM symbol constellations for reproducing soft data bits of said parallel concatenated redundant coding, a first set of soft parity bits of said parallel concatenated redundant coding, and a second set of soft parity bits of said parallel concatenated redundant coding.

6. Receiver apparatus as set forth in claim 2, wherein said de-mapping apparatus for de-mapping equalized complex samples of QAM signal supplied from said frequency-domain channel equalizer comprises:
a de-mapper of Gray-mapped square 64QAM symbol constellations for reproducing soft data bits of said parallel concatenated redundant coding, a first set of soft parity bits of said parallel concatenated redundant coding, and a second set of soft parity bits of said parallel concatenated redundant coding.

7. Receiver apparatus as set forth in claim 2, wherein said de-mapping apparatus for de-mapping equalized complex samples of QAM signal supplied from said frequency-domain channel equalizer comprises:
a de-mapper of QAM symbol constellations for reproducing soft data bits and soft parity bits of redundant coding components of said parallel concatenated redundant coding, first redundant coding components of said parallel concatenated redundant coding being received during time-slices of final transmissions of a service transmitted for reception by DTV receivers, and second redundant coding components of said parallel concatenated redundant coding being received during time-slices of initial transmissions of a service transmitted for iterative-diversity reception by DTV receivers, the soft parity bits of said first redundant coding component of said parallel concatenated redundant coding being supplied for temporary storage within said first memory in said turbo decoding apparatus;
delay memory for delaying time-slices of said second redundant coding components of said parallel concatenated redundant coding to be concurrent with time-slices of said first redundant coding components of said parallel concatenated redundant coding that repeat similar soft data bits, the delayed soft parity bits of said second redundant coding component of said parallel concatenated redundant coding being supplied for temporary storage within said third memory in said turbo decoding apparatus; and
a maximal-ratio code combiner connected for receiving the soft data bits of said first redundant coding components of said parallel concatenated redundant coding as a first of two input signals to be code-combined, connected for receiving from said delay memory the delayed soft data bits of said second redundant coding components of said parallel concatenated redundant coding as a second of said two input signals to be code-combined, and connected for supplying code-combined soft data bits for temporary storage within said second memory in said turbo decoding apparatus.

8. Receiver apparatus as set forth in claim 2, wherein said de-mapping apparatus for de-mapping equalized complex samples of QAM signal supplied from said frequency-domain channel equalizer comprises:
a de-mapper of QAM symbol constellations for reproducing soft data bits and soft parity bits of redundant coding components of said parallel concatenated redundant coding, first redundant coding components of said parallel concatenated redundant coding being received during time-slices of initial transmissions of a service transmitted for reception by DTV receivers, and second redundant coding components of said parallel concatenated redundant coding being received during time-slices of final transmissions of a service transmitted for iterative-diversity reception by DTV receivers, the soft parity bits of said second redundant coding component of said parallel concatenated redundant coding being supplied for temporary storage within said third memory in said turbo decoding apparatus;
delay memory for delaying time slices of said first redundant coding components of said parallel concatenated redundant coding to be concurrent with time-slices of said second redundant coding components of said parallel concatenated redundant coding that repeat similar soft data bits, the delayed soft parity bits of said first redundant coding component of said parallel concatenated redundant coding being supplied for temporary storage within said first memory in said turbo decoding apparatus; and
a maximal-ratio code combiner connected for receiving the soft data bits of said second redundant coding components of said parallel concatenated redundant coding as a first of two input signals to be code-combined, connected for receiving from said delay memory the delayed soft data bits of said first redundant coding components of said parallel concatenated redundant coding as a second of said two input signals to be code-combined, and connected for supplying code-combined soft data bits for temporary storage within said second memory in said turbo decoding apparatus.

9. Receiver apparatus as set forth in claim 2, wherein said de-mapping apparatus for de-mapping equalized complex samples of QAM signal supplied from said frequency-domain channel equalizer comprises:
delay memory for delaying equalized complex samples of QAM signal received during time-slices of initial transmissions of a service transmitted for iterative-diversity reception by DTV receivers to be concurrent with equalized complex samples of QAM signal received during time-slices of final transmissions of said service transmitted for iterative-diversity reception;
a maximal-ratio QAM combiner for supplying combined equalized complex samples of QAM signal mapping data bits, said maximal-ratio QAM combiner connected for receiving as a first of two input signals to be combined said equalized complex samples of QAM signal mapping data bits received during said time-slices of said final transmissions of said service transmitted for iterative-diversity reception, said maximal-ratio QAM combiner connected for receiving as a second of said two input signals to be combined said equalized complex samples of QAM signal mapping data bits received during said time-slices of said initial transmissions of said service and delayed by said delay memory to be concurrent with said equalized complex samples of QAM signal mapping data bits received during said time-slices of said final transmissions of said service transmitted for iterative-diversity reception;
a first de-mapper of QAM symbol constellations responsive to said combined equalized complex samples of QAM signal supplied from said maximal-ratio QAM combiner for reproducing soft data bits of said parallel concatenated redundant coding, which are supplied to said second memory in said turbo decoding apparatus for temporary storage therein;
a second de-mapper of QAM symbol constellations for reproducing first sets of soft parity bits of said parallel concatenated redundant coding responsive to said equalized complex samples of QAM signal mapping parity bits received during said time-slices of said final transmissions of said service, which said first sets of soft parity bits of said parallel concatenated redundant coding are supplied to said first memory in said turbo decoding apparatus for temporary storage therein; and
a third de-mapper of QAM symbol constellations for reproducing second sets of soft parity bits of said parallel concatenated redundant coding responsive to said equalized complex samples of QAM signal mapping parity bits received during said time-slices of said initial transmissions of said service and delayed by said delay memory to be concurrent with said equalized complex samples of QAM signal mapping data bits received during said time-slices of said final transmissions of said service transmitted for iterative-diversity reception, which said second sets of soft parity bits of said parallel concatenated redundant coding are supplied to said third memory in said turbo decoding apparatus for temporary storage therein.

10. Receiver apparatus as set forth in claim 2, wherein said de-mapping apparatus for de-mapping equalized complex samples of QAM signal supplied from said frequency-domain channel equalizer comprises:
delay memory for delaying equalized complex samples of QAM signal received during time-slices of initial transmissions of a service transmitted for iterative-diversity reception by DTV receivers to be concurrent with equalized complex samples of QAM signal received during time-slices of final transmissions of said service transmitted for iterative-diversity reception by DTV receivers;
a maximal-ratio QAM combiner for supplying combined equalized complex samples of QAM signal mapping data bits, said maximal-ratio QAM combiner connected for receiving as a first of two input signals to be combined those equalized complex samples of QAM signal mapping data bits received during said time-slices of final transmissions of said service transmitted for iterative-diversity reception by DTV receivers, said maximal-ratio QAM combiner connected for receiving as a second of said two input signals to be combined those equalized complex samples of QAM signal mapping data bits received during said time-slices of said initial transmissions of said service and delayed by said delay memory to be concurrent with equalized complex samples of QAM signal mapping data bits received during said time-slices of said final transmissions of said service;
a first de-mapper of QAM symbol constellations responsive to said combined equalized complex samples of QAM signal supplied from said maximal-ratio QAM combiner for reproducing soft data bits of said parallel concatenated redundant coding, which are supplied to said second memory in said turbo decoding apparatus for temporary storage therein;
a second de-mapper of QAM symbol constellations for reproducing first sets of soft parity bits of said parallel concatenated redundant coding responsive to said equalized complex samples of QAM signal mapping parity bits received during said time-slices of said initial transmissions of said service, which said first sets of soft parity bits of said parallel concatenated redundant coding are supplied to said first memory in said turbo decoding apparatus for temporary storage therein; and
a third de-mapper of QAM symbol constellations for reproducing second sets of soft parity bits of said parallel concatenated redundant coding responsive to said equalized complex samples of QAM signal mapping parity bits received during said time-slices of said final transmissions of said service and delayed by said delay memory to be concurrent with said equalized complex samples of QAM signal mapping data bits received during said time-slices of said final transmissions of said service transmitted for iterative-diversity reception, which said second sets of soft parity bits of said parallel concatenated redundant coding are supplied to said third memory in said turbo decoding apparatus for temporary storage therein.

11. (canceled)

12. (canceled)

13. (canceled)

14. (canceled)

15. (canceled)

16. (canceled)

17. (canceled)

18. (canceled)

19. (canceled)

20. Receiver apparatus as set forth in claim 1, wherein said turbo decoding apparatus comprises:
a first memory for temporarily storing a first set of soft parity bits of said parallel concatenated redundant coding supplied from said de-mapping apparatus during each of selected time-slice intervals, said first set of soft parity bits of said parallel concatenated redundant coding being supplied in a first order from said de-mapping apparatus;
a second memory for temporarily storing soft data bits of said parallel concatenated redundant coding supplied from said de-mapping apparatus during each of said selected time-slice intervals, and for additionally temporarily storing soft bits of extrinsic data concerning ones of said soft data bits temporarily stored therein, said soft data bits of said parallel concatenated redundant coding being supplied in a first order from said de-mapping apparatus, said soft data bits of said parallel concatenated redundant coding as updated by respectively accompanying said soft bits of extrinsic data being read from said second memory at the conclusion of the turbo decoding of a time-slice as a portion of the output signal from said turbo decoding apparatus comprising said soft bits of said LRS codewords in each successive time-slice;
a third memory for temporarily storing a second set of soft parity bits of said parallel concatenated redundant coding from said de-mapping apparatus during each of said selected time-slice intervals, said second set of soft parity bits of said parallel concatenated redundant coding being supplied in a third order from said de-mapping apparatus, which said third order differs from said first order of said first set of soft parity bits of said parallel concatenated redundant coding supplied to said first memory;
first and second soft-input/soft-output (SISO) decoders for redundant coding at a reduced code rate;
means for supplying said first SISO decoder with input signal thereto composed of soft symbols each composed of a respective soft data bit read from said second memory and a soft parity bit read from said first memory, said soft symbols supplied to said first SISO decoder in de-interleaved order respective to said first order of said first set of soft parity bits of said parallel concatenated redundant coding as supplied to said first memory for temporary storage therein;
a first extrinsic data processor having a first input port connected for receiving soft data bits supplied from said first SISO decoder as output signal therefrom, having a second input port connected for receiving corresponding soft data bits and soft extrinsic data bits read from said second memory, and having an output port connected for updating soft extrinsic data bits temporarily stored in said second memory;
means for supplying said second SISO decoder with input signal thereto composed of soft symbols each composed of a respective soft data bit read from said second memory and a soft parity bit read from said third memory, said soft symbols supplied to said second SISO decoder in de-interleaved order respective to said third order of said second set of soft parity bits of said parallel concatenated redundant coding as supplied to said third memory for temporary storage therein; and
a second extrinsic data processor having a first input port connected for receiving soft data bits supplied from said second SISO decoder as output signal therefrom, having a second input port connected for receiving corresponding soft data bits and soft extrinsic data bits read from said second memory, and having an output port connected for updating soft extrinsic data bits temporarily stored in said second memory.

21. Receiver apparatus as set forth in claim 20, wherein said turbo decoding apparatus includes:
a first soft-bits interleaver for said soft data bits supplied from said first SISO decoder as output signal therefrom, said first soft-bits interleaver operable for reproducing at an output thereof soft data bits from said first SISO decoder output signal as re-arranged to said second order, said output port of said first soft-bits interleaver connected to said first input port of said first extrinsic data processor, said second memory operable for reading soft data bits and soft extrinsic data bits to said second input port of said first extrinsic data processor in said second order, and said second memory operable for soft extrinsic data bits temporarily stored therein being updated by said first extrinsic data processor in accordance with said second order; and
a second soft-bits interleaver for said soft data bits supplied from said second SISO decoder as output signal therefrom, said soft-bits interleaver operable for reproducing at an output thereof soft data bits from said second SISO decoder output signal as re-arranged to said second order, said output port of said soft-bits interleaver connected to said first input port of said second extrinsic data processor, said second memory operable for reading soft data bits and soft extrinsic data bits to said second input port of said second extrinsic data processor in said second order, and said second memory operable for soft extrinsic data bits temporarily stored therein being updated by said second extrinsic data processor in accordance with said second order.

22. Receiver apparatus as set forth in claim 20, wherein said de-mapping apparatus for de-mapping equalized complex samples of QAM signal supplied from said frequency-domain channel equalizer comprises:
a de-mapper of close-to-Gray-mapped cruciform 512QAM symbol constellations for reproducing soft data bits of said parallel concatenated redundant coding, a first set of soft parity bits of said parallel concatenated redundant coding, and a second set of soft parity bits of said parallel concatenated redundant coding.

23. Receiver apparatus as set forth in claim 20, wherein said de-mapping apparatus for de-mapping equalized complex samples of QAM signal supplied from said frequency-domain channel equalizer comprises:
a de-mapper of Gray-mapped square 64QAM symbol constellations for reproducing soft data bits of said parallel concatenated redundant coding, a first set of soft parity bits of said parallel concatenated redundant coding, and a second set of soft parity bits of said parallel concatenated redundant coding.

24. Receiver apparatus as set forth in claim 20, wherein said de-mapping apparatus for de-mapping equalized complex samples of QAM signal supplied from said frequency-domain channel equalizer comprises:
a de-mapper of QAM symbol constellations for reproducing soft data bits and soft parity bits of redundant coding components of said parallel concatenated redundant coding, first redundant coding components of said parallel concatenated redundant coding being received during time-slices of final transmissions of a service transmitted for reception by DTV receivers, and second redundant coding components of said parallel concatenated redundant coding being received during time-slices of initial transmissions of a service transmitted for iterative-diversity reception by DTV receivers, the soft parity bits of said first redundant coding component of said parallel concatenated redundant coding being supplied for temporary storage within said first memory in said turbo decoding apparatus;
delay memory for delaying time-slices of said second redundant coding components of said parallel concatenated redundant coding to be concurrent with time-slices of said first redundant coding components of said parallel concatenated redundant coding that repeat similar soft data bits, the delayed soft parity bits of said second redundant coding component of said parallel concatenated redundant coding being supplied for temporary storage within said third memory in said turbo decoding apparatus; and
a maximal-ratio code combiner connected for receiving the soft data bits of said first redundant coding components of said parallel concatenated redundant coding as a first of two input signals to be code-combined, connected for receiving from said delay memory the delayed soft data bits of said second redundant coding components of said parallel concatenated redundant coding as a second of said two input signals to be code-combined, and connected for supplying code-combined soft data bits for temporary storage within said second memory in said turbo decoding apparatus.

25. Receiver apparatus as set forth in claim 20, wherein said de-mapping apparatus for de-mapping equalized complex samples of QAM signal supplied from said frequency-domain channel equalizer comprises:
delay memory for delaying equalized complex samples of QAM signal received during time-slices of initial transmissions of a service transmitted for iterative-diversity reception by DTV receivers to be concurrent with equalized complex samples of QAM signal received during time-slices of final transmissions of said service transmitted for iterative-diversity reception;
a maximal-ratio QAM combiner for supplying combined equalized complex samples of QAM signal mapping data bits, said maximal-ratio QAM combiner connected for receiving as a first of two input signals to be combined said equalized complex samples of QAM signal mapping data bits received during said time-slices of said final transmissions of said service transmitted for iterative-diversity reception, said maximal-ratio QAM combiner connected for receiving as a second of said two input signals to be combined said equalized complex samples of QAM signal mapping data bits received during said time-slices of said initial transmissions of said service and delayed by said delay memory to be concurrent with said equalized complex samples of QAM signal mapping data bits received during said time-slices of said final transmissions of said service transmitted for iterative-diversity reception;
a first de-mapper of QAM symbol constellations responsive to said combined equalized complex samples of QAM signal supplied from said maximal-ratio QAM combiner for reproducing soft data bits of said parallel concatenated redundant coding, which are supplied to said second memory in said turbo decoding apparatus for temporary storage therein;
a second de-mapper of QAM symbol constellations for reproducing first sets of soft parity bits of said parallel concatenated redundant coding responsive to said equalized complex samples of QAM signal mapping parity bits received during said time-slices of said final transmissions of said service, which said first sets of soft parity bits of said parallel concatenated redundant coding are supplied to said first memory in said turbo decoding apparatus for temporary storage therein; and
a third de-mapper of QAM symbol constellations for reproducing second sets of soft parity bits of said parallel concatenated redundant coding responsive to said equalized complex samples of QAM signal mapping parity bits received during said time-slices of said initial transmissions of said service and delayed by said delay memory to be concurrent with said equalized complex samples of QAM signal mapping data bits received during said time-slices of said final transmissions of said service transmitted for iterative-diversity reception, which said second sets of soft parity bits of said parallel concatenated redundant coding are supplied to said third memory in said turbo decoding apparatus for temporary storage therein.

26. Receiver apparatus as set forth in claim 1, wherein said turbo decoding apparatus comprises:
a first memory for temporarily storing a first set of soft parity bits of said parallel concatenated redundant coding supplied from said de-mapping apparatus during each of first succession of selected time-slice intervals;
a second memory for temporarily storing soft data bits of said parallel concatenated redundant coding supplied from said de-mapping apparatus during each of a second succession of said selected time-slice intervals, and for additionally temporarily storing soft bits of extrinsic data respectively accompanying ones of said soft data bits temporarily stored therein, said soft data bits of said parallel concatenated redundant coding as updated by said soft bits of extrinsic data respectively accompanying them being read from said second memory at the conclusion of the turbo decoding of a time-slice as a portion of the output signal from said turbo decoding apparatus comprising said soft bits of said LRS codewords in each successive time-slice;
a third memory for temporarily storing a second set of soft parity bits of said parallel concatenated redundant coding supplied from said de-mapping apparatus during each of a third succession of said selected time-slice intervals, said selected time-slice intervals in said third succession of said selected time-slice intervals staggered with said selected time-slice intervals in said first succession of said selected time-slice intervals within said second succession of said selected time-slice intervals;
a soft-input/soft-output (SISO) decoder for redundant coding at a reduced code rate;
means for supplying said SISO decoder with input signal in the initial half of each cycle of turbo decoding, which input signal comprises soft symbols each composed of a soft parity bit read from said first memory and a respective data bit as updated by any extrinsic data read from said second memory, said soft symbols being supplied to said SISO decoder in a first order during the initial half of each cycle of turbo decoding;
means for supplying said SISO decoder with input signal in the final half of each cycle of turbo decoding, which input signal comprises soft symbols each composed of a soft parity bit read from said third memory and a respective data bit as updated by any extrinsic data read from said second memory, said soft symbols being supplied to said SISO decoder in a second order during the final half of each cycle of turbo decoding, said second order different from said first order; and
an extrinsic data processor having a first input port connected for receiving soft data bits supplied from said SISO decoder as the output signal therefrom, having a second input port connected for receiving corresponding soft data bits and soft extrinsic data bits read from said second memory, and having an output port connected for updating soft extrinsic data bits temporarily stored in said second memory.

27. Receiver apparatus as set forth in claim 26, wherein said de-mapping apparatus for de-mapping equalized complex samples of QAM signal supplied from said frequency-domain channel equalizer comprises:
a de-mapper of close-to-Gray-mapped cruciform 512QAM symbol constellations for reproducing soft data bits of said parallel concatenated redundant coding, a first set of soft parity bits of said parallel concatenated redundant coding, and a second set of soft parity bits of said parallel concatenated redundant coding.

28. Receiver apparatus as set forth in claim 26, wherein said de-mapping apparatus for de-mapping equalized complex samples of QAM signal supplied from said frequency-domain channel equalizer comprises:
a de-mapper of Gray-mapped square 64QAM symbol constellations for reproducing soft data bits of said parallel concatenated redundant coding, a first set of soft parity bits of said parallel concatenated redundant coding, and a second set of soft parity bits of said parallel concatenated redundant coding.

29. Receiver apparatus as set forth in claim 26, wherein said de-mapping apparatus for de-mapping equalized complex samples of QAM signal supplied from said frequency-domain channel equalizer comprises:
a de-mapper of QAM symbol constellations for reproducing soft data bits and soft parity bits of redundant coding components of said parallel concatenated redundant coding, first redundant coding components of said parallel concatenated redundant coding being received during time-slices of final transmissions of a service transmitted for reception by DTV receivers, and second redundant coding components of said parallel concatenated redundant coding being received during time-slices of initial transmissions of a service transmitted for iterative-diversity reception by DTV receivers, the soft parity bits of said first redundant coding component of said parallel concatenated redundant coding being supplied for temporary storage within said first memory in said turbo decoding apparatus;
delay memory for delaying time-slices of said second redundant coding components of said parallel concatenated redundant coding to be concurrent with time-slices of said first redundant coding components of said parallel concatenated redundant coding that repeat similar soft data bits, the delayed soft parity bits of said second redundant coding component of said parallel concatenated redundant coding being supplied for temporary storage within said third memory in said turbo decoding apparatus; and
a maximal-ratio code combiner connected for receiving the soft data bits of said first redundant coding components of said parallel concatenated redundant coding as a first of two input signals to be code-combined, connected for receiving from said delay memory the delayed soft data bits of said second redundant coding components of said parallel concatenated redundant coding as a second of said two input signals to be code-combined, and connected for supplying code-combined soft data bits for temporary storage within said second memory in said turbo decoding apparatus.

30. Receiver apparatus as set forth in claim 26, wherein said de-mapping apparatus for de-mapping equalized complex samples of QAM signal supplied from said frequency-domain channel equalizer comprises:
delay memory for delaying equalized complex samples of QAM signal received during time-slices of initial transmissions of a service transmitted for iterative-diversity reception by DTV receivers to be concurrent with equalized complex samples of QAM signal received during time-slices of final transmissions of said service transmitted for iterative-diversity reception by DTV receivers;
a maximal-ratio QAM combiner for supplying combined equalized complex samples of QAM signal mapping data bits, said maximal-ratio QAM combiner connected for receiving as a first of two input signals to be combined those equalized complex samples of QAM signal mapping data bits received during time-slices of final transmissions of said service transmitted for iterative-diversity reception by DTV receivers, said maximal-ratio QAM combiner connected for receiving as a second of said two input signals to be combined those equalized complex samples of QAM signal mapping data bits received during said time-slices of initial transmissions of said service and delayed by said delay memory to be concurrent with equalized complex samples of QAM signal mapping data bits received during time-slices of final transmissions of said service;
a first de-mapper of QAM symbol constellations responsive to said combined equalized complex samples of QAM signal supplied from said maximal-ratio QAM combiner for reproducing soft data bits of said parallel concatenated redundant coding, which are supplied said second memory in said turbo decoding apparatus for temporary storage therein;
a second de-mapper of QAM symbol constellations responsive to said equalized complex samples of QAM signal mapping parity bits received during said time-slices of final transmissions of said service for reproducing first sets of soft parity bits of said parallel concatenated redundant coding, which first sets of soft parity bits of said parallel concatenated redundant coding are supplied to said first memory in said turbo decoding apparatus for temporary storage therein; and
a third de-mapper of QAM symbol constellations responsive to said equalized complex samples of QAM signal mapping parity bits received during said time-slices of initial transmissions of said service for reproducing second sets of soft parity bits of said parallel concatenated redundant coding, which second sets of soft parity bits of said parallel concatenated redundant coding are supplied to said third memory in said turbo decoding apparatus for temporary storage therein.

31. Receiver apparatus as set forth in claim 1, said receiver apparatus further comprising:
means for restoring the convolutional byte interleaving of (204, 188) LRS codewords corrected by said LRS decoder; and
a data de-randomizer for de-randomizing data bits of 188-byte packets of digital information extracted from said (204, 188) LRS codewords with restored convolutional byte interleaving, thus to supply a stream of de-randomized data.

32. Receiver apparatus as set forth in claim 1, said receiver apparatus further comprising:
means for restoring the convolutional byte interleaving of (204, 188) LRS codewords corrected by said LRS decoder;
a data de-randomizer for de-randomizing data bits of 188-byte packets of digital information extracted from said (204, 188) LRS codewords with restored convolutional byte interleaving, thus to supply a stream of de-randomized data; and
an IP packet parsing unit for parsing said stream of de-randomized data into successive internet-protocol (IP) data packets.

33. Receiver apparatus as set forth in claim 1 for receiving COFDM transmissions in which at least some of said time-slices said 188-byte packets of digital information encapsulate bytes of (255, 191) transverse Reed-Solomon (TRS) codewords, said receiver apparatus further comprising:
a random-access memory (RAM) having addressable storage locations for respective extended bytes written thereto:
an extended-byte former for extending each byte recovered by said turbo decoding apparatus by appending thereto a respective byte extension to generate respective extended bytes to be written to said addressable storage locations in said RAM, each respective byte extension composed of bits descriptive of the lack of confidence in the correctness of the byte so extended and being generated at least in part by said byte-error-location apparatus; and
a TRS decoder for correcting (255, 191) TRS codewords read thereto from said addressable storage locations of said RAM, said TRS decoder employing an error-correction-only decoding algorithm that utilizes selected ones of said indications of which bytes in each LRS codeword are more likely to be in error.

34. Receiver apparatus as set forth in claim 33, wherein said extended-byte former is connected for supplying the extended bytes it forms to said LRS decoder for correction of said LRS codewords insofar as said LRS decoder is capable of doing, before extended bytes from said LRS codewords with any resulting corrections thereof are written to said addressable storage locations in said RAM.

35. Receiver apparatus as set forth in claim 34, further comprising:
a further random-access memory (RAM) having addressable storage locations for respective bytes, connected for having respective ones of its said storage locations written by respective bytes of 191-byte segments corrected by said TRS decoder, said further RAM operable to re-interleave said bytes of 191-byte segments read from its said addressable storage locations to restore bytes of randomized data to an original ordering of them;
a data de-randomizer for de-randomizing data bits of said bytes of randomized data restored to said original ordering of them, thus to supply a stream of de-randomized data; and
an IP packet parsing unit for parsing said stream of de-randomized data into successive internet-protocol (IP) data packets.

36. Receiver apparatus as set forth in claim 34, wherein said random-access memory is operable for updating the byte portions of extended bytes temporarily stored therein responsive to decoding results from said TRS decoder, and said random-access memory is further operable for reading the updated byte portions of the extended bytes temporarily stored therein to re-interleave the bytes of said 191-byte packets to recover randomized data, said receiver apparatus further comprising:
a data de-randomizer for de-randomizing data bits of said bytes of randomized data restored to an original ordering of them, thus to supply a stream of de-randomized data; and
an IP packet parsing unit for parsing said stream of de-randomized data into successive internet-protocol (IP) data packets.

37. Receiver apparatus for coded orthogonal frequency-division multiplex (COFDM) transmissions of digital television (DTV) signals, which COFDM transmissions each comprise a plurality of successive time-slices for conveying parallel concatenated redundant coding of byte-interleaved Reed-Solomon codewords, a prescribed number of which said successive time-slices are included in each of successive super-frames of prescribed duration, said receiver apparatus comprising:
a front-end tuner for converting a selected radio-frequency analog COFDM signal to a digitized baseband COFDM signal;
a demodulator of said orthogonal frequency-division multiplex (OFDM) signal, for supplying complex samples of quadrature-amplitude-modulated (QAM) signal in response to said OFDM signal;
a guard-interval-remover unit connected for removing guard-interval digital samples including samples of cyclic prefixes from said digitized baseband COFDM signal to generate OFDM signal for application to said demodulator for OFDM signal as an input signal thereto;
a processor of unmodulated pilot carrier waves and of carrier waves modulated by Transmission Parameters Signaling (TPS) supplied from said demodulator for OFDM signal as a first output signal therefrom;
a frequency-domain channel equalizer for equalizing complex samples of QAM signal supplied from said demodulator for OFDM signal as a second output signal therefrom, said equalizing being performed responsive to said unmodulated pilot carrier waves supplied from said demodulator for OFDM signal as a portion of said first output signal therefrom;
de-mapping apparatus for de-mapping equalized complex samples of QAM signal supplied from said frequency-domain channel equalizer, thus to reproduce soft bits of said parallel concatenated redundant coding;
turbo decoding apparatus for decoding said soft bits of parallel concatenated redundant coding to recover soft bits of said Reed-Solomon codewords in a succession of iterative cycles of turbo decoding of each successive time-slice; and
a Reed-Solomon decoder for correcting said recovered Reed-Solomon codewords if it can and updating just the soft data bits of those of said Reed-Solomon codewords supplied to said turbo decoding apparatus for decoding that said Reed-Solomon decoder has determined to be correct, said updating being performed before a next one of said of iterative cycles of turbo decoding of that said successive time-slice.

38. Receiver apparatus as set forth in claim 37, said receiver apparatus further comprising:
byte-error-location apparatus for determining from the confidence levels of said soft bits of said Reed-Solomon codewords recovered by said turbo decoding apparatus which bytes in each Reed-Solomon codeword are more likely to be in error and generating indications of which bytes in each Reed-Solomon codeword are more likely to be in error, said Reed-Solomon decoder operable for using said indications of which bytes in each Reed-Solomon codeword are more likely to be in error to implement erasure decoding of each said Reed-Solomon codeword.

39. Receiver apparatus as set forth in claim 37, operable for de-interleaving byte interleaving of lateral (204, 188) Reed-Solomon codewords as recovered by said turbo decoding apparatus and then decoding the resulting de-interleaved lateral (204, 188) Reed-Solomon codewords with said Reed-Solomon decoder.

40. Receiver apparatus as set forth in claim 39, operable for de-interleaving byte interleaving of transverse (255, 191) Reed-Solomon codewords encapsulated within said lateral (204, 188) Reed-Solomon codewords and then decoding the resulting de-interleaved transverse (255, 191) Reed-Solomon codewords with a further Reed-Solomon decoder, said further Reed-Solomon decoder operable for using said indications of which bytes in each Reed-Solomon codeword are more likely to be in error to implement erasure decoding of each said transverse (255, 191) Reed-Solomon codeword.

41. Receiver apparatus as set forth in claim 37, operable for de-interleaving byte interleaving of transverse (255, 191) Reed-Solomon codewords as recovered by said turbo decoding apparatus and then decoding the resulting de-interleaved transverse (255, 191) Reed-Solomon codewords with said Reed-Solomon decoder.

42. Receiver apparatus for coded orthogonal frequency-division multiplex (COFDM) transmissions of digital television (DTV) signals, which COFDM transmissions each comprise a plurality of successive time-slices for conveying parallel concatenated redundant coding of byte-interleaved lateral Reed-Solomon (LRS) codewords that encode 188-byte packets of digital information, at least some of said time-slices said 188-byte packets of digital information encapsulating bytes of (255, 191) transverse Reed-Solomon (TRS) codewords for conveying internet protocol (IP) packets, each IP packet provided with respective cyclic-redundancy-check (CRC) coding, a prescribed number of which said successive time-slices are included in each of successive super-frames of prescribed duration, said receiver apparatus comprising:
a front-end tuner for converting a selected radio-frequency analog COFDM signal to a digitized baseband COFDM signal;
a demodulator of said orthogonal frequency-division multiplex (OFDM) signal, for supplying complex samples of quadrature-amplitude-modulated (QAM) signal in response to said OFDM signal;
a guard-interval-remover unit connected for removing guard-interval digital samples including samples of cyclic prefixes from said digitized baseband COFDM signal to generate OFDM signal for application to said demodulator for OFDM signal as an input signal thereto;
a processor of unmodulated pilot carrier waves and of carrier waves modulated by Transmission Parameters Signaling (TPS) supplied from said demodulator for OFDM signal as a first output signal therefrom;
a frequency-domain channel equalizer for equalizing complex samples of QAM signal supplied from said demodulator for OFDM signal as a second output signal therefrom, said equalizing being performed responsive to said unmodulated pilot carrier waves supplied from said demodulator for OFDM signal as a portion of said first output signal therefrom;
de-mapping apparatus for de-mapping equalized complex samples of QAM signal supplied from said frequency-domain channel equalizer, thus to reproduce soft bits of said parallel concatenated redundant coding;
turbo decoding apparatus for decoding said soft bits of parallel concatenated redundant coding to recover soft bits of said Reed-Solomon codewords in a succession of iterative cycles of turbo decoding of each successive time-slice;
byte-error-location apparatus for determining from the confidence levels of said soft bits of said Reed-Solomon codewords recovered by said turbo decoding apparatus which bytes in each Reed-Solomon codeword are more likely to be in error and generating indications of which bytes in each Reed-Solomon codeword are more likely to be in error;
a CRC decoder for decoding said respective CRC coding of each said IP packet recovered in a cycle of turbo decoding and updating the soft data bits of those of said IP packets supplied to said turbo decoding apparatus for decoding that said CRC decoder has determined to be correct, said updating being performed before a next one of said of iterative cycles of turbo decoding of that said successive time-slice; and
a Reed-Solomon decoder for correcting if it can Reed-Solomon codewords recovered by said turbo decoding apparatus and supplied to said Reed-Solomon decoder, said Reed-Solomon decoder employing an error-correction-only decoding algorithm that utilizes said indications of which bytes in each Reed-Solomon codeword are more likely to be in error.

43. Receiver apparatus as set forth in claim 42, wherein said Reed-Solomon decoder is further operable for updating just the soft data bits of those of said Reed-Solomon codewords supplied to said turbo decoding apparatus for decoding that said Reed-Solomon decoder has determined to be correct, said updating being performed before a next one of said of iterative cycles of turbo decoding of that said successive time-slice.

44. Receiver apparatus as set forth in claim 43, operable for de-interleaving byte interleaving of lateral (204, 188) Reed-Solomon codewords as recovered by said turbo decoding apparatus and then decoding the resulting de-interleaved lateral (204, 188) Reed-Solomon codewords with said Reed-Solomon decoder.

45. Receiver apparatus as set forth in claim 44, operable for de-interleaving byte interleaving of transverse (255, 191) Reed-Solomon codewords encapsulated within said lateral (204, 188) Reed-Solomon codewords and then decoding the resulting de-interleaved transverse (255, 191) Reed-Solomon codewords with a further Reed-Solomon decoder, said further Reed-Solomon decoder operable for using said indications of which bytes in each Reed-Solomon codeword are more likely to be in error to implement erasure decoding of each said transverse (255, 191) Reed-Solomon codeword.

46. Receiver apparatus as set forth in claim 43, operable for de-interleaving byte interleaving of transverse (255, 191) Reed-Solomon codewords as recovered by said turbo decoding apparatus and then decoding the resulting de-interleaved transverse (255, 191) Reed-Solomon codewords with said Reed-Solomon decoder.

47. Receiver apparatus as set forth in claim 2 for receiving COFDM transmissions in which at least some of said time-slices said 188-byte packets of digital information encapsulate bytes of (255, 191) transverse Reed-Solomon (TRS) codewords, said receiver apparatus further comprising:
a random-access memory (RAM) having addressable storage locations for respective extended bytes written thereto;
an extended-byte former for extending each byte recovered by said turbo decoding apparatus by appending thereto a respective byte extension to generate respective extended bytes to be written to said addressable storage locations in said RAM, each respective byte extension composed of bits descriptive of the lack of confidence in the correctness of the byte so extended and being generated at least in part by said byte-error-location apparatus; and
a TRS decoder for correcting (255, 191) TRS codewords read thereto from said addressable storage locations of said RAM, said TRS decoder employing an error-correction-only decoding algorithm that utilizes selected ones of said indications of which bytes in each LRS codeword are more likely to be in error.

48. Receiver apparatus as set forth in claim 47, wherein said extended-byte former is connected for supplying the extended bytes it forms to said LRS decoder for correction of said LRS codewords insofar as said LRS decoder is capable of doing, before extended bytes from said LRS codewords with any resulting corrections thereof are written to said addressable storage locations in said RAM.

49. Receiver apparatus as set forth in claim 48, further comprising:
a further random-access memory (RAM) having addressable storage locations for respective bytes, connected for having respective ones of its said storage locations written by respective bytes of 191-byte segments corrected by said TRS decoder, said further RAM operable to re-interleave said bytes of 191-byte segments read from its said addressable storage locations to restore bytes of randomized data to an original ordering of them;
a data de-randomizer for de-randomizing data bits of said bytes of randomized data restored to said original ordering of them, thus to supply a stream of de-randomized data; and
an IP packet parsing unit for parsing said stream of de-randomized data into successive internet-protocol (IP) data packets.

50. Receiver apparatus as set forth in claim 48, wherein said random-access memory is operable for updating the byte portions of extended bytes temporarily stored therein responsive to decoding results from said TRS decoder, and said random-access memory is further operable for reading the updated byte portions of the extended bytes temporarily stored therein to re-interleave the bytes of said 191-byte packets to recover randomized data, said receiver apparatus further comprising:
a data de-randomizer for de-randomizing data bits of said bytes of randomized data restored to an original ordering of them, thus to supply a stream of de-randomized data; and
an IP packet parsing unit for parsing said stream of de-randomized data into successive internet-protocol (IP) data packets.

51. Receiver apparatus as set forth in claim 20, said receiver apparatus further comprising:
means for restoring the convolutional byte interleaving of (204, 188) LRS codewords corrected by said LRS decoder; and
a data de-randomizer for de-randomizing data bits of 188-byte packets of digital information extracted from said (204, 188) LRS codewords with restored convolutional byte interleaving, thus to supply a stream of de-randomized data.

52. Receiver apparatus as set forth in claim 20 for receiving COFDM transmissions in which at least some of said time-slices said 188-byte packets of digital information encapsulate bytes of (255, 191) transverse Reed-Solomon (TRS) codewords, said receiver apparatus further comprising:
a random-access memory (RAM) having addressable storage locations for respective extended bytes written thereto;
an extended-byte former for extending each byte recovered by said turbo decoding apparatus by appending thereto a respective byte extension to generate respective extended bytes to be written to said addressable storage locations in said RAM, each respective byte extension composed of bits descriptive of the lack of confidence in the correctness of the byte so extended and being generated at least in part by said byte-error-location apparatus; and
a TRS decoder for correcting (255, 191) TRS codewords read thereto from said addressable storage locations of said RAM, said TRS decoder employing an error-correction-only decoding algorithm that utilizes selected ones of said indications of which bytes in each LRS codeword are more likely to be in error.

53. Receiver apparatus as set forth in claim 52, wherein said extended-byte former is connected for supplying the extended bytes it forms to said LRS decoder for correction of said LRS codewords insofar as said LRS decoder is capable of doing, before extended bytes from said LRS codewords with any resulting corrections thereof are written to said addressable storage locations in said RAM.

54. Receiver apparatus as set forth in claim 53, further comprising:
a further random-access memory (RAM) having addressable storage locations for respective bytes, connected for having respective ones of its said storage locations written by respective bytes of 191-byte segments corrected by said TRS decoder, said further RAM operable to re-interleave said bytes of 191-byte segments read from its said addressable storage locations to restore bytes of randomized data to an original ordering of them;
a data de-randomizer for de-randomizing data bits of said bytes of randomized data restored to said original ordering of them, thus to supply a stream of de-randomized data; and
an IP packet parsing unit for parsing said stream of de-randomized data into successive internet-protocol (IP) data packets.

55. Receiver apparatus as set forth in claim 53, wherein said random-access memory is operable for updating the byte portions of extended bytes temporarily stored therein responsive to decoding results from said TRS decoder, and said random-access memory is further operable for reading the updated byte portions of the extended bytes temporarily stored therein to re-interleave the bytes of said 191-byte packets to recover randomized data, said receiver apparatus further comprising:
a data de-randomizer for de-randomizing data bits of said bytes of randomized data restored to an original ordering of them, thus to supply a stream of de-randomized data; and
an IP packet parsing unit for parsing said stream of de-randomized data into successive internet-protocol (IP) data packets.
